(19) United States
(12) Patent Application Publication
(10) Pub. No.: US 2026/0339300 A1
(43) Pub. Date: Oct. 29, 2026

(54) CYBER-PHYSICAL ARCHITECTURE FOR QUANTUM-ACCELERATED INDUSTRIAL MANUFACTURING AND AUTONOMOUS EXPERIMENTATION

(71) Applicant: Amedeo Scaramella, Naples (IT)

(72) Inventor: Amedeo Scaramella, Naples (IT)

(21) Appl. No.: 19/553,320

(22) Filed: Feb. 28, 2026

Related U.S. Application Data
(63) Continuation-in-part of application No. 18/972,929, filed on Dec. 7, 2024.
(60) Provisional application No. 63/765,498, filed on Feb. 28, 2025.

(51) Int. Cl. G05B 19/418; G06N 10/20; G06N 10/60

(52) U.S. Cl. CPC G05B 19/41835; G06N 10/20; G06N 10/60

(57) ABSTRACT

A hybrid quantum-classical cyber-physical control architecture for real-time optimization and automated actuation of complex industrial processes, including an industrial digestive system configured to transform heterogeneous feedstocks into valuable resources. The system continuously ingests streaming analog telemetry from physical sensor networks, utilizing a quantum industrial problem compiler to dynamically convert process states and multi-objective physical constraints into structurally bounded, quantum-computable representations. A latency-aware orchestrator dispatches these artifacts to quantum computing resources while managing deterministic classical fallbacks to ensure continuous operation. To safely bridge quantum optimization insights with rigid physical hardware limits, an actuation stability gateway decodes quantum candidate solutions, applies reverse-scaling, and utilizes mathematical gradient dampening on out-of-bounds parameters prior to mechanical actuation. The architecture further enables multi-site graph partitioning and an automated high-throughput experimentation discovery loop, providing continuous, self-learning adaptation and optimized resource recovery across dynamic manufacturing environments.

### CROSS-REFERENCE TO RELATED APPLICATIONS

This application is a continuation-in-part of U.S. Non-Provisional patent application Ser. No. 18/972,929, filed Dec. 7, 2024, titled “THE INDUSTRIAL DIGESTIVE SYSTEM: HARDWARE SUPPLY CHAIN ABLE TO PRODUCE BIOGAS, BIOFUEL, CHEMICALS AND REUSABLE CONGLOMERATE/COMPOSITE OUTPUT MATERIAL FROM POTENTIALLY CONSIDERABLY UNCATEGORIZED & MISCELLANEOUS BIOMASS, WASTE, MOLECULES AND ELEMENTS, INTEGRATED WITH SOFTWARE MACHINE LEARNING SYSTEM AND OPTIMIZATIONS ALGORITHMS FOR ENHANCED CONVERSION OF MOLECULAR, ELEMENTAL, AND WASTE MATERIALS INTO VALUABLE RESOURCES.”

This application claims the benefit of U.S. Provisional Patent Application No. 63/765,498, filed Feb. 28, 2025, titled “The Quantum Manufacturing Industrial Digestive System Machine Hamiltonian,” pursuant to 35 U.S.C. § 119(e).

### INCORPORATION BY REFERENCE

The disclosure of each application and document referenced in this specification is incorporated by reference herein in its entirety to the maximum extent permitted by law; however, in the event of any inconsistency between an incorporated disclosure and the present specification, the present specification controls.

A related international application is PCT/US2024/059078, filed Dec. 8, 2024, titled “THE INDUSTRIAL DIGESTIVE SYSTEM: HARDWARE SUPPLY CHAIN ABLE TO PRODUCE BIOGAS, BIOFUEL, CHEMICALS AND REUSABLE CONGLOMERATE/COMPOSITE OUTPUT MATERIAL FROM POTENTIALLY CONSIDERABLY UNCATEGORIZED & MISCELLANEOUS BIOMASS, WASTE, MOLECULES AND ELEMENTS, INTEGRATED WITH SOFTWARE MACHINE LEARNING SYSTEM AND OPTIMIZATIONS ALGORITHMS FOR ENHANCED CONVERSION OF MOLECULAR, ELEMENTAL, AND WASTE MATERIALS INTO VALUABLE RESOURCES.”

### FIELD OF THE INVENTION

Overview of the Industrial Digestive System (IDS). The Industrial Digestive System (IDS) is a multi-stage cyber-physical system designed to transform a wide range of inputs into valuable end products. It functions analogously to a biological digestive system, but for industry-ingesting heterogeneous feedstocks (e.g. mixed waste, biomass, plastics) as well as pure raw materials, and breaking them down into fundamental molecules and elements. These components are then reassembled or refined into useful products through coordinated mechanical, chemical, physical, and biological processes. Each stage of the IDS is tailored to handle specific transformations: for example, front-end mechanical units perform size reduction and sorting, chemical reactors and furnaces drive pyrolysis or hydrolysis, bioreactors carry out fermentations, and physical separators (like distillation columns or filters) isolate desired outputs. By integrating multiple process stages, the IDS can “use all component fractions” of a diverse input feedstock to produce a variety of co-products. This is a key principle also seen in biorefinery and petrorefinery concepts, where heterogeneous inputs (like biomass or crude oil) are fractionated and converted into fuels, chemicals, and materials with near-zero. The IDS pushes this idea further by handling even highly mixed or contaminated streams, aiming for maximum valorization of waste into products. Central to IDS is its cyber-physical architecture—a network of sensors, actuators, and control algorithms that monitor each transformation stage and adjust conditions in real time. In effect, IDS is a “smart factory” or Industry 4.0 system specialized for feedstock conversion. Industrial cyber-physical systems enable intelligent production by linking physical machinery with digital intelligence and adaptive control. In the IDS, this means sensors track variables like temperature, pressure, chemical composition, microbial activity, etc., throughout the pipeline, while control systems decide how to modulate each stage (e.g. adding reagents, changing mixer speeds, tuning heater power) to optimize overall performance. The result is a highly flexible plant that can adapt to varying input materials on the fly, ensuring that whether the feedstock is, for example, municipal solid waste, agricultural biomass, or scrap polymers, it is broken down and channeled into appropriate conversion pathways. This adaptive, multi-stage design allows IDS to achieve far higher resource recovery than traditional one-process facilities. For instance, where a conventional waste plant might only produce refuse-derived fuel (RDF) or biogas from organic matter, IDS can simultaneously generate biofuels, platform chemicals, purified elements, composite materials, and energy from the input mix. By the end of the “digestion” process, only minimal inert residue (if any) remains, since nearly every fraction of the input is converted into a saleable product or useful output. This not only creates economic value from waste streams but also aligns with environmental goals by diverting waste from landfills and offsetting the need for virgin raw materials. Overall, the IDS represents a new class of facility that combines mechanical, chemical, biological, and physical transformation steps in one unified, AI-driven system to enable circular resource utilization at an industrial scale. Quantum Optimization and Integration. A defining innovation of the IDS is its integration of quantum computing techniques to enhance and control the complex conversion process. The multi-stage nature of IDS, with myriad possible pathways for each molecule or material, presents a massive optimization challenge-one that quantum algorithms are uniquely suited to tackle. In the IDS, quantum computing plays several roles: quantum-assisted reaction simulation, system-wide optimization via QUBO/Ising formulations, and hybrid quantum-classical control loops for real-time decision-making. First, quantum simulation is leveraged to better understand and design the chemical and biological reactions occurring in the system. Many reactions (e.g. catalytic conversions of heavy hydrocarbons, enzymatic pathways in biomass digestion) are highly complex at the molecular level and difficult to model on classical computers. Quantum computers, however, excel at simulating quantum-mechanical systems. They can model molecular orbitals and reaction mechanisms with far greater accuracy, allowing the IDS designers to optimize catalysts and reaction conditions before implementation. For example, researchers have demonstrated that quantum computers can simulate chemical reaction dynamics in ways that classical computers cannot, by encoding and analyzing the intricate web of sub-atomic interactions involved. This capability can be used to discover more efficient catalysts and reaction pathways for the IDS. Riverlane's work on catalyst design shows that an error-corrected quantum computer could help design sustainable catalysts that speed up industrial reactions, which are impossible to accurately simulate on classical machines. In an IDS context, this means quantum-powered simulations might identify the optimal enzyme for a fermentation step or the ideal catalyst to crack a plastic into useful monomers, significantly improving reaction yields and energy efficiency. Such quantum-assisted reaction simulations shorten the R&D cycle for IDS process development by reducing the need for trial-and-error experimentation, as quantum computers can predict which conditions will yield the best outcomes. Secondly, quantum computing is integral to optimization and control in the running IDS plant. The entire system can be seen as a colossal optimization problem: deciding how to allocate feedstock through various routes (mechanical separation, chemical reactors, bio-digesters, etc.), how to set operating parameters, and how to schedule operations to maximize throughput and minimize cost/waste. Classical optimization for such a complex, combinatorial problem is intractable, but formulating it as a Quadratic Unconstrained Binary Optimization (QUBO) problem or an equivalent Ising model allows the use of quantum algorithms. Essentially, the control decisions (e.g. a binary decision to send a material either to reactor A or B, or a setting to turn on/off a certain process unit) can be represented by binary variables. The goal (objective function)—for instance, maximize total product value minus energy costs, subject to meeting environmental constraints—can be expressed as a quadratic function of these binary variables. This quadratic “energy” function serves as an effective Hamiltonian for the IDS optimization problem. By mapping the IDS decision space onto an Ising Hamiltonian, the problem becomes amenable to quantum annealers and quantum optimization algorithms, which search for the lowest-energy (optimal) configuration. In practical terms, the IDS employs a hybrid quantum-classical loop: a quantum solver is used to find optimal or near-optimal solutions for routing and control settings, and a classical control system applies those settings to the physical equipment. This loop runs continuously or periodically, so the plant is always adjusting towards optimal performance even as conditions (feedstock composition, demand for certain outputs, etc.) change. Notably, quantum annealing has already shown promise on similar industrial optimization tasks like scheduling and resource allocation. For example, D-Wave's quantum annealer can solve production scheduling and routing problems with competitive results. In a manufacturing context, quantum algorithms can optimize resource allocation, machine utilization, and process flows more efficiently than classical methods, By applying these algorithms, the IDS can achieve optimal coordination among its many subsystems-something very difficult to do with traditional control techniques. Finally, the IDS's control architecture is inherently hybrid, combining quantum and classical computing strengths. Certain problems (like global optimization over thousands of interdependent variables) are offloaded to quantum solvers, formulated as QUBOs or Ising models. Other tasks, such as lower-level feedback control, safety interlocks, and deterministic logic, are handled by classical programmable logic controllers (PLCs) and AI routines. The hybrid quantum-classical control loop might work as follows: real-time data from the plant (flow rates, compositions, etc.) is fed into an optimization routine which runs a quantum algorithm (such as QAOA or quantum annealing) to propose adjustments to setpoints; those adjustments are then vetted by classical algorithms for feasibility and stability, and finally enacted on the plant. This synergy plays to the strengths of each technology—the quantum part explores a vast solution space quickly, while the classical part ensures robust operation. As a result, the IDS can respond to disturbances or new objectives with unprecedented agility. For instance, if a new type of waste material is introduced into the feed, the system's quantum optimizer can rapidly evaluate how to incorporate it (perhaps by adjusting reactor temperatures or enzyme dosages) to maximize conversion, and the classical controllers can smoothly implement that transition. This is a pioneering approach in industrial automation: quantum computing working “in harmony” with classical systems to run a physical plant. The expected benefits include reaching higher efficiency operating points that classical heuristics might miss, and solving scheduling/sequencing problems (like maintenance timing or batch scheduling in the IDS) much faster. In summary, quantum computing is interwoven through the IDS's design and operation—from design-phase simulation of reactions, to formulation of control problems as QUBOs, to real-time hybrid control-yielding a smarter, more optimized industrial process than was previously possible.

### Mathematical and Algorithmic Formulations

To rigorously design and operate the Industrial Digestive System, formal mathematical models and algorithms are developed. At the core is the IDS Hamiltonian (H)—a constructed energy/cost function that quantifies the performance of the entire system for a given set of operational decisions. This Hamiltonian encapsulates terms for all relevant objectives: positive terms for product yields and values, negative terms (or penalties) for energy consumption, processing time, emissions, and unmet process constraints. By formulating the IDS's goals as minimizing this single scalar function H, the complex process optimization is converted into a standard problem that quantum algorithms can address. In practice, H might be expressed as: H=Σ_i−(C_i x_i)+Σ_{j,k}(D_{jk}x_j x_k)+(constraint penalty terms), x_i are binary or discrete decision variables representing choices (for instance, routing or on/off states of equipment), C_i are coefficients reflecting the linear contribution of each decision to the cost, and D_{jk} are quadratic interaction coefficients reflecting how pairs of decisions affect the outcome (for example, the combination of sending material to reactor A and turning on an extra separation unit might incur a certain cost or benefit). This quadratic form can be recognized as a QUBO (Quadratic Unconstrained Binary Optimization) formulation when the decisions are binary. Equivalently, it can be mapped to an Ising spin Hamiltonian, by associating each binary variable with a spin (±1) and translating the coefficients accordingly. The ground state of this Hamiltonian corresponds to the optimal (lowest-cost) operating configuration of the IDS. The task of the quantum optimization algorithms (QAOA, VQE, or quantum annealing) is to find this ground state—i.e., the combination of decisions that yields the best performance for the IDS. QUBO Mapping: All key operational decisions of the IDS are encoded into binary variables for quantum optimization. For example, a decision like “send feedstock fraction X to path A (variable=0) or path B (variable=1)” would be one binary variable. If there are dozens of such forks and on/off decisions, the IDS might have hundreds or thousands of binary variables. These are plugged into the Hamiltonian H(x_1, . . . , x_n). By doing so, the combinatorial optimization problem of the IDS is fully specified in a way a quantum solver can handle. This approach follows known techniques where industrial problems are mapped to QUBO/Ising models so that quantum computers can solve them. Notably, the objective function often needs additional quadratic penalty terms to enforce any constraints (for instance, a constraint that exactly one of two paths must be chosen can be enforced by a term that heavily penalizes x_j+*k≠1, etc.). After mapping, the coefficients C_i, D_{jk} define the “energy landscape” for the quantum algorithm to explore. Quantum Algorithms (QAOA, VQE, Quantum Annealing): With the QUBO in hand, the IDS's brain can utilize several quantum strategies: Quantum Annealing: Using a quantum annealer device (such as D-Wave), the system physically implements the Ising Hamiltonian corresponding to the IDS and then slowly lowers quantum fluctuations to let the system settle into a low-energy state. In effect, the annealer will find a combination of decision variables that yields a minimal H. This is particularly suitable for IDS because annealers can handle large QUBOs (thousands of variables) and have been shown effective on scheduling and routing problems similar in spirit to IDS optimization. The output of the annealer is a bitstring (a particular assignment of all binary decisions) which corresponds to a proposed operating plan (e.g. which reactor paths to use, which equipment to activate). If multiple near-optimal solutions are found, the control system can even choose among them (for example, preferring one that balances wear-and-tear on equipment).

QAOA (Quantum Approximate Optimization Algorithm): QAOA is a variational quantum algorithm that runs on gate-based quantum processors to find approximate solutions to combinatorial optimizations. In QAOA, one defines the problem Hamiltonian (the IDS H) and an initial mixing Hamiltonian, and then alternates applying them in a parameterized circuit. The parameters are optimized (by a classical outer loop) to minimize the expectation value of H. For the IDS, a QAOA can be set up where each qubit represents a decision (as mapped by the QUBO). The Ising-type Hamiltonian for the IDS is encoded onto the qubits, and QAOA drives the qubits toward the ground state that minimizes H. Researchers have successfully applied QAOA to similar NP-hard optimization tasks, indicating it can handle the IDS optimization as well. QAOA is attractive because it can be run on NISQ (noisy intermediate-scale quantum) devices and can incorporate problem structure into the ansatz. In simulation studies, QAOA has been used to find optimal scheduling with minimal changes (like minimizing paint color switches in a manufacturing line), which parallels minimizing configuration switches in IDS operations.

VQE (Variational Quantum Eigensolver): VQE is another hybrid algorithm where a quantum processor prepares a parameterized quantum state (ansatz) and measures its energy, and a classical optimizer tunes the parameters to lower the energy. While VQE is often associated with quantum chemistry (finding ground states of molecular Hamiltonians), it can also solve optimization problems by encoding the cost function as a Hamiltonian. The IDS Hamiltonian can be tackled with VQE by treating the optimization like finding the ground state of a bespoke quantum system. One could design an ansatz that reflects the structure of the IDS problem (perhaps a layering corresponding to process stages) and then let VQE vary angles to minimize H. VQE might be particularly useful for sub-problems of IDS, such as optimizing a continuous parameter that has been discretized (since VQE can potentially handle non-binary variables by encoding them in qubit rotations). Moreover, VQE could be used in quantum chemistry contexts within IDS—for example, to calculate the minimum energy state of a chemical reaction network occurring in one of the reactors, which informs how that reactor should be operated.

In summary, the IDS's mathematical formulation turns a sprawling industrial control problem into a well-defined optimization problem suitable for quantum computation. The Hamiltonian H encapsulates the IDS's objective, and quantum algorithms (QAOA, VQE, annealing) serve as the engines to minimize this Hamiltonian and thus find optimal operating strategies. By using these algorithms, the IDS can navigate a vast decision-space efficiently. Classical algorithms would struggle with the exponential combinations of decisions, but quantum methods exploit superposition and tunneling to explore many possibilities in parallel, seeking the lowest “energy” configuration that the plant should adopt. The result is that IDS can reach globally optimized states that maximize productivity and efficiency. Mathematically, this approach ensures that all trade-offs (yield vs energy, throughput vs quality, etc.) are balanced optimally according to a single objective function, giving a principled way to run the plant at peak performance.

### Example Embodiment (Non-Limiting): Software-Hardware Integrated Production of Chelonia Mbh Composite and Bioethanol

To further illustrate the practical reduction to practice, 35 U.S.C. § 112 enablement, and cyber-physical execution of the hybrid quantum-optimized Industrial Digestive System (IDS), the following detailed, non-limiting example demonstrates the complete lifecycle of converting a highly heterogeneous, probabilistically known waste input into two distinct, high-value measurable outputs (an advanced composite material and bioethanol). This embodiment explicitly translates continuous physical operations into a bounded, quantum-computable QUBO formulation utilizing the system's action tensor (ε_{mi}\hat{ }{P_n}).

### Physical Feedstock Vector (Input Stage).

A heterogeneous mixed feedstock batch is ingested by the IDS [100] (FIG. 1). The Quantum Model Builder and sensor arrays classify the input into an optimized mass percentage matrix X={x_1, x_2, . . . , x_l} required to achieve the targeted output state. The initial state ((D_{initial}) comprises approximately:
M_{plastic} (40.0%): Various synthetic polymers and resins (C, H, Br, Cl).
M_{msw} (25.0%): Municipal Solid Waste containing organics, paper, mixed plastics, and glass (C, H, O, N).
M_{agricultural} (15.0%): Plant residues, animal waste, and glucose (C, H, O, N, P, K).
M_{construction} (10.0%): Concrete, wood, drywall, asphalt, and structural metals (Ca, Si, Al, Fe).
M_{iron} (5.0%): Circuit boards, various metals, and magnetic fractions.
M_{silica} (2.5%): Mixed glass and manufacturing additives (SiO₂, Na₂CO₃, CaO).
M_{textile} (2.0%): Natural and synthetic fibers (polyester, nylon, cotton).
M_{hazardous} (0.5%): Solvents, heavy metals, and trace elements (Pb, Hg, Cd).

### Unit Operations and Cyber-Physical Parameters

The central Latency-Aware Hybrid Orchestrator dispatches a specific combinatorial process chain ((C_k)) to the hardware supply chain. The physical hardware executes the following sequential transformations under strict parametric bounds:
Mechanical Trituration [110, 120, 1223] (FIG. 1): Operating at 25 °C, 1.0 atm for 30 minutes. The feedstock is mechanically shredded and ground into a particulate paste (0.1 cm to 1.0 cm). Magnetic separation specifically extracts and controls the M_{iron} fraction required for the final composite matrix.
Thermal Hydrolysis [130.b] (FIG. 1): The applicable organic fractions are pumped into a thermal hydrolysis reactor operating at an optimized setpoint of 120 °C (bounded between 60 °C and 250 °C) and a pressure of 2.5 atm (bounded up to 10.0 MPa) for 30 minutes to break complex macromolecules into simpler monomers.
Dark Fermentation [130.c] (FIG. 1): The hydrolyzed paste is inoculated with a tailored bacterial cocktail, including Saccharomyces cerevisiae, operating at 25 °C (bounded between 10 °C and 200 °C), 1.0 atm, and a maintained pH between 4.0 and 7.0 for an extended dwell time (e.g., 50,000 minutes) to metabolize sugars into volatile biochemicals and bioethanol.
Phase Separation [140] (FIG. 1): Operating at 25 °C, 1.0 atm for 40 minutes, utilizing 100-micron to 1000-micron filters and centrifuges (operating under applied pressures up to 10.0 MPa) to strictly divide the processed paste into a liquid fraction and a solid fraction.
Heating, Mixing & Polymerization [150] (FIG. 1): The solid fraction is routed to a mixing reactor. Thermal energy is applied (heating phase at 120 °C, 3 atm for 37 minutes; mixing phase at 80 °C, 5 atm for 37 minutes). Mechanical transverse forces are applied at variable speeds between 20 and 3,000 RPM, forcing the M_{plastic} components to melt and encapsulate the M_{silica}, M_{construction}, and M_{iron} fillers.
Extrusion [170] (FIG. 1): The mixed solid paste is forced through a template at 100 °C and 7.0 atm, utilizing a mechanical pressure range bounded between 4 Pa and 5,000 Pa for 30 minutes.
Distillation [200] (FIG. 1): The liquid fraction is processed via a double-reactor continuous exchange distillation column with temperature profiles ranging from 60 °C to 120 °C (optimized setpoint: 100 °C) at 1.0 atm for 60 minutes, utilizing feed rates of 0.2 to 3.0 liters per cycle.

### 3. Measurable Outputs (Target State O_n)

The system physically yields and validates two primary outputs:
Liquid Output (Bioethanol [230]) (FIG. 1): High-yield fuel alcohol initially recovered at a measured batch volume of 22 ml with a pure ethanol concentration of 19% by volume, capable of continuous refinement.
Solid Output (CHELONIA MBH Composite [180]) (FIG. 1): An advanced thermoplastic composite material demonstrating exceptional physical properties: low density (ultralightweight), verified magnetic properties (derived from M_{iron} integration), waterproof characteristics, and low electrical conductivity. Laboratory analysis confirms a targeted empirical chemical formula of Fe_8Si_5O_{22}C_{282}H_{534}Ca 5, featuring a biopolymeric matrix (40-60% CHO) reinforced by metal-glass-concrete particulate fillers (60-40% CaFeSiCHO).

### 4. Quantum Formulation (QUBO and Action Tensor Integration)

To physically orchestrate this exact outcome dynamically, the Quantum Industrial Problem Compiler maps the continuous operational states into a logical Hamiltonian (H_{IDS}) solvable by a quantum processor.

Continuous variables (such as Extruder Pressure and Hydrolysis Temperature) are mapped to discrete binary decision variables ∈_{0,1}\hat{ }N. The cyber-physical transformational effects of each mechanical, thermal, and biological stage are mathematically represented by the action tensor ε_{mi}\hat{ }{P_n}(z), which calculates the cumulative physical alteration on material m for property i through process P_n.

The mathematical objective is to minimize the squared difference between the predicted final material state ((D_{final_predicted}) and the observed target state (D_{final_observed}) corresponding to the exact molecular formulation of the CHELONIA MBH material (O_{CHELONIA})—while simultaneously maximizing the bioethanol yield, and strictly penalizing the leakage of the hazardous input ({M_{hazardous}) into the final usable outputs.

The explicit QUBO Hamiltonian H_{IDS}(z) minimized by the quantum hardware is formulated as:

H_{IDS}(z)=α_{MBH}Σ_i((Π_n ε_{mi}\hat{ }{P_n}(z)·D_{initial}−O_{CHELONIA,−i})\hat{ }2)−β_{EtOH}Σ Yield_EtOH}(z)+λ_{haz}(Σ_Flow_{haz}(z)−L_{safe})_+\hat{ }2+λ_{mass}(Σ_j x_j−1)\hat{ }2,

### Where:

The α_{MBH} term acts as the multi-dimensional structure-matching objective, driving the quantum solver to find the specific sequence of binary switch states (z) that iteratively multiplies the action tensors (ε_{mi}\hat{ }{P_n}) to perfectly match the target empirical formula ((Fe_8Si_5O_{22}C_{282}H_{534}Ca_5).
The β_{EtOH} term maximizes the fractional recovery and concentration of the bioethanol yield derived from the fermentation and distillation stages.
The λ_{haz} term is a massive cyber-physical safety penalty ensuring that any quantum state routing the hazardous fraction (containing Pb, Hg, Cd) into the final composite material above a strict, rule-based environmental safety limit (L_{safe}) is energetically rejected by the solver.
The λ_{mass} term mathematically guarantees mass-balance conservation and stoichiometric feasibility across the entire hardware pipeline.

By submitting this unified quadratic equation to the quantum solver, the system simultaneously evaluates combinatorially massive routing pathways and parametric configurations, instantly returning the optimal ground-state setpoints (temperatures, RPMs, pressures, dwell times) that the classical control module executes to physically synthesize the CHELONIA MBH composite and bioethanol.

### Example Embodiment (Non-Limiting): Software-Hardware Integrated Production of Chelonia Mbh Composite and Bioethanol

To further illustrate the practical reduction to practice, 35 U.S.C. § 112 enablement, and cyber-physical execution of the hybrid quantum-optimized Industrial Digestive System (IDS), the following detailed, non-limiting example demonstrates the complete lifecycle of converting a highly heterogeneous, probabilistically known waste input into two distinct, high-value measurable outputs (an advanced composite material and bioethanol). This embodiment explicitly translates continuous physical operations into a bounded, quantum-computable QUBO formulation utilizing the system's action tensor (ε_{mi}\hat{ }{P_n}). Physical Feedstock Vector (Input Stage). A heterogeneous mixed feedstock batch is ingested by the IDS [100] (FIG. 1). The Quantum Model Builder and sensor arrays classify the input into an optimized mass percentage matrix X={x_1, x_2, . . . , x_l} required to achieve the targeted output state. The initial state (D_{initial}) comprises approximately: M_{plastic} (40.0%): Various synthetic polymers and resins (C, H, Br, Cl). M_{msw} (25.0%): Municipal Solid Waste containing organics, paper, mixed plastics, and glass (C, H, O, N). M_{agricultural} (15.0%): Plant residues, animal waste, and glucose (C, H, O, N, P, K). M_{construction} (10.0%): Concrete, wood, drywall, asphalt, and structural metals (Ca, Si, Al, Fe). M_{iron} (5.0%): Circuit boards, various metals, and magnetic fractions. M_{silica} (2.5%): Mixed glass and manufacturing additives (SiO₂, Na₂CO₃, CaO). M_{textile} (2.0%): Natural and synthetic fibers (polyester, nylon, cotton). M_{hazardous} (0.5%): Solvents, heavy metals, and trace elements (Pb, Hg, Cd). Unit Operations and Cyber-Physical Parameters. The central Latency-Aware Hybrid Orchestrator dispatches a specific combinatorial process chain (C_k) to the hardware supply chain. The physical hardware executes the following sequential transformations under strict parametric bounds: Mechanical Trituration [110, 120, 1223] (FIG. 1): Operating at 25 °C, 1.0 atm for 30 minutes. The feedstock is mechanically shredded and ground into a particulate paste (0.1 cm to 1.0 cm). Magnetic separation specifically extracts and controls the M_{iron} fraction required for the final composite matrix. Thermal Hydrolysis [130.b] (FIG. 1): The applicable organic fractions are pumped into a thermal hydrolysis reactor operating at an optimized setpoint of 120 °C (bounded between 60 °C and 250 °C) and a pressure of 2.5 atm (bounded up to 10.0 MPa) for 30 minutes to break complex macromolecules into simpler monomers. Dark Fermentation [130.c] (FIG. 1): The hydrolyzed paste is inoculated with a tailored bacterial cocktail, including Saccharomyces cerevisiae, operating at 25 °C (bounded between 10 °C and 200 °C), 1.0 atm, and a maintained pH between 4.0 and 7.0 for an extended dwell time (e.g., 50,000 minutes) to metabolize sugars into volatile biochemicals and bioethanol. Phase Separation [140] (FIG. 1): Operating at 25 °C, 1.0 atm for 40 minutes, utilizing 100-micron to 1000-micron filters and centrifuges (operating under applied pressures up to 10.0 MPa) to strictly divide the processed paste into a liquid fraction and a solid fraction. Heating, Mixing & Polymerization [150] (FIG. 1): The solid fraction is routed to a mixing reactor. Thermal energy is applied (heating phase at 120 °C, 3 atm for 37 minutes; mixing phase at 80 °C, 5 atm for 37 minutes). Mechanical transverse forces are applied at variable speeds between 20 and 3,000 RPM, forcing the M_{plastic} components to melt and encapsulate the M_{silica}, M_{construction}, and M_{iron} fillers. Extrusion [170] (FIG. 1): The mixed solid paste is forced through a template at 100 °C and 7.0 atm, utilizing a mechanical pressure range bounded between 4 Pa and 5,000 Pa for 30 minutes. Distillation [200] (FIG. 1): The liquid fraction is processed via a double-reactor continuous exchange distillation column with temperature profiles ranging from 60 °C to 120 °C (optimized setpoint: 100 °C) at 1.0 atm for 60 minutes, utilizing feed rates of 0.2 to 3.0 liters per cycle. Measurable Outputs (Target State O_n). The system physically yields and validates two primary outputs: Liquid Output (Bioethanol [230]) (FIG. 1): High-yield fuel alcohol initially recovered at a measured batch volume of 22 ml with a pure ethanol concentration of 19% by volume, capable of continuous refinement. Solid Output (CHELONIA MBH Composite [180]) (FIG. 1): An advanced thermoplastic composite material demonstrating exceptional physical properties: low density (ultralightweight), verified magnetic properties (derived from M_{iron} integration), waterproof characteristics, and low electrical conductivity. Laboratory analysis confirms a targeted empirical chemical formula of Fe_8Si_5O_{22}C_{282}H_{534}Ca_5, featuring a biopolymeric matrix (40-60% CHO) reinforced by metal-glass-concrete particulate fillers (60-40% CaFeSiCHO). Quantum Formulation (QUBO and Action Tensor Integration). To physically orchestrate this exact outcome dynamically, the Quantum Industrial Problem Compiler maps the continuous operational states into a logical Hamiltonian (H_{IDS}) solvable by a quantum processor. Continuous variables (such as Extruder Pressure and Hydrolysis Temperature) are mapped to discrete binary decision variables z∈{0,1}\hat{ }N. The cyber-physical transformational effects of each mechanical, thermal, and biological stage are mathematically represented by the action tensor ε_{mi}\hat{ }{P_n}(z), which calculates the cumulative physical alteration on material m for property i through process P_n. The mathematical objective is to minimize the squared difference between the predicted final material state (D_{final_predicted}) and the observed target state (D_{final_observed})—corresponding to the exact molecular formulation of the CHELONIA MBH material (O_{CHELONIA})—while simultaneously maximizing the bioethanol yield, and strictly penalizing the leakage of the hazardous input (M_{hazardous}) into the final usable outputs. The explicit QUBO Hamiltonian H_{IDS}(z) minimized by the quantum hardware is formulated as:

H_{IDS}(z)=α_{MBH}Σ_i((Π_nε_{mi}\hat{ }{P_n}(z)·D_{initial}−O_{CHELONIA,i})\hat{ }2)−β_{EtOH}ΣYield_{EtOH}(z)+λ_{haz}(ΣFlow_{haz}(z)−L_{safe})+\hat{ }2+λ{mass}(Σ_j x_j−1)\hat{ }2.

where: The α_{MBH} term acts as the multi-dimensional structure-matching objective, driving the quantum solver to find the specific sequence of binary switch states (z) that iteratively multiplies the action tensors (ε_{mi}\hat{ }{P_n}) to perfectly match the target empirical formula (Fe_8Si_5O_{22}C_{282}H_{534}Ca_5). The −β_{EtOH} term maximizes the fractional recovery and concentration of the bioethanol yield derived from the fermentation and distillation stages. The λ {haz} term is a massive cyber-physical safety penalty ensuring that any quantum state routing the hazardous fraction (containing Pb, Hg, Cd) into the final composite material above a strict, rule-based environmental safety limit (L_{safe}) is energetically rejected by the solver. The λ_{mass} term mathematically guarantees mass-balance conservation and stoichiometric feasibility across the entire hardware pipeline. By submitting this unified quadratic equation to the quantum solver, the system simultaneously evaluates combinatorially massive routing pathways and parametric configurations, instantly returning the optimal ground-state setpoints (temperatures, RPMs, pressures, dwell times) that the classical control module executes to physically synthesize the CHELONIA MBH composite and bioethanol.

### Example Embodiments (Non-Limiting)

To further illustrate the practical reduction to practice, enablement, and cyber-physical execution of the hybrid quantum-optimized Industrial Digestive System (IDS), the following non-limiting examples demonstrate the translation of continuous physical operations into bounded, quantum-computable QUBO and Ising formulations across distinct industrial workflows.

### Example 1: Thermochemical and Biological Conversion of Municipal Solid Waste (MSW)

Physical Feedstock: 5,000 kg/hr of heterogeneous Municipal Solid Waste (MSW), comprising intermixed organic matter and synthetic polyolefin plastics.
Unit Operations: Shredder [110] (FIG. 1). Separator [140] (FIG. 1), Stage 130 [130] (FIG. 1 configured as an Anaerobic Digester), and Depolymerization Reactor [130.a](FIG. 1). Operating Parameter Ranges:
   Biological (Stage 130): Temperature (T)=35 °C to 55 °C (mesophilic to thermophilic); Retention Time (t)=15 to 20 days; Catalyst=Methanogenic archaea consortia.
   Thermochemical (Depolymerization Reactor 130.a): Temperature (T)=400 °C to 600 °C; Pressure ((P))=1.0 to 5.0 atm; Catalyst=Zeolite ZSM-5 dosed at 1.0% to 5.0% by weight.
Measurable Outputs: Biogas yield ((m\hat{ }3/hr with target CH_4 purity>60%), Synthetic bio-oil yield (L/hr), and inert solid residue (kg/hr).
Quantum Formulation (QUBO):
Continuous flow routing and temperature setpoints are discretized into logical binary variables. Let x_i∈{0,1} represent the binary-encoded mass fraction of sorted plastics routed to the Depolymerization Reactor [130.a] (FIG. 1), and t_k∈{0,1} represent a one-hot encoding of discrete thermal levels. The cost Hamiltonian H_{EX1} seeks to maximize the combined energy output while explicitly penalizing states that exceed physical reactor capacity:

H_{EX1}=−(w_{bio}·Yield_{bio}(x_i)+w_{oil}·Yield_{oil}(t_k))+w_{heat}·Cost_{heat}(t_k)+λ_{cap}(Σ(x_i·Flow_{in})−_{max})+\hat{ }2.
where λ_{cap} is a massive constraint penalty ensuring the quantum solver structurally discards candidate solutions that mathematically overload the physical volumetric capacity (Cap_{max}) of the Depolymerization Reactor [130.a] (FIG. 1). Example 2: Biochemical Transformation of Agricultural Biomass to Bio-Ethanol.
Physical Feedstock: 2,000 kg/hr of homogeneous lignocellulosic agricultural biomass (e.g., wheat straw, corn stover).
Unit Operations: Grinder [120] (FIG. 1), Stage 130 [130] (FIG. 1) (configured as a Hydrolysis and Fermentation cascade), and Separator [140] (FIG. 1). Operating Parameter Ranges:
   Hydrolysis (Stage 130): Temperature (T)=120 °C to 160 °C; Pressure (P)=2.0 to 10.0 atm; Dwell Time=30 to 120 minutes; Catalyst=Dilute H_2SO_4 (0.5% to 2.0% v/v).
   Separator [140] (FIG. 1): Centrifugal extraction speed=1,000 to 3,000 RPM.
Measurable Outputs: Bio-ethanol purity (target>95%), output flow rate (L/hr), and residual lignin weight (kg/hr). Quantum Formulation (QUBO):

Acid dosing levels are mapped to binary variables c_j∈_{0,1}, and routing/separation speeds are mapped to discrete variables s_m. To prevent microbial starvation during fermentation, a strict carbon-to-nitrogen (C:N) ratio constraint must be maintained. The multi-objective Hamiltonian H_{EX2} balances maximum ethanol extraction against operational chemical costs:

H_{EX2}=−w_{EtOH}_Purity(c_j,s_m)+w_{acid}·Cost(c_j)+λ_{CN}(ΣRatio(C,N)−α)\hat{ }2+λ_{logic}(Σc_j−1)\hat{ }2,
The λ_{logic} term mathematically enforces a one-hot constraint, guaranteeing that the solver selects exactly one definitive catalyst dosing concentration before dispatching the decoded bitstring to the classical SCADA system.

### Example 3: Chemical Upcycling of Mixed Scrap Polymers to Composite Conglomerates

Physical Feedstock: 1,500 kg/hr of uncategorized scrap polymers (e.g., mixed PET, HDPE, and chemical contaminants).
Unit Operations: Shredder [110] (FIG. 1). Depolymerization Reactor [130.a] (FIG. 1). Polymerization Unit [150] (FIG. 1), and Extruder [170] (FIG. 1. Operating Parameter Ranges:
   Polymerization Unit [150] (FIG. 1): Mixing Temperature (T)=180 °C to 220 °C; Doping=5% to 15% glass fiber filler and compatibilizers.
   Extruder [170] (FIG. 1): Thermal setpoint (T)=200 °C to 280 °C; Mechanical Pressure (P_{ext})=50 bar to 150 bar.
Measurable Outputs: Composite material pellets hitting a target tensile strength (≥30 MPa) Extruder energy consumption (kWh), and off-gas Volatile [136] (FIG. 1) emissions (ppm). Quantum Formulation (Ising Spin Model):
To execute on an Ising-native transverse-field quantum annealer, blending ratios of recycled monomers to raw filler are mapped directly onto spin variables s_i, s_j∈{−1, +1}. This embodiment minimizes the divergence (Δ) between the resulting physical properties and a targeted optimal structural profile O_{target}, while strictly bounding mechanical pressure limits.

H_{EX3}(s)=β_{target}·∥Strength(s_i)−O_{target}∥\hat{ }2+Σ_{i,j}J_{ij}−s_i s_j+λ_{press}(P_{ext}(s)−P_{max})+\hat{ }2.
The coupling coefficients J_{ij} map the interactive chemical synergy between different polymer chains. The λ_{press} penalty strictly prevents the quantum solver from returning a highly viscous blend state that would exceed the 150 bar physical metallurgical safety threshold (P_{max}) of the Extruder [170] (FIG. 1), ensuring safe, reverse-scaled physical actuation.

### Example 4: Automated High-Throughput Experimentation (HTE) and “Alchemist” Discovery Loop

To satisfy the enablement of the autonomous scientific discovery capabilities, this non-limiting example details a closed-loop HTE workflow governed by the “Alchemist” hybrid quantum-classical machine learning engine (FIGS. 11 and 17), targeting the discovery of an optimal catalytic reaction pathway for a novel active molecule.
Physical Feedstock: Base precursors, candidate solvents, and a library of transition-metal catalysts.
Unit Operations (HTE Stack): Automated liquid handlers, micro-bioreactors, and in-line High-Performance Liquid Chromatography (HPLC) analytical sensors within the Local Cyber-Physical Execution Loop (FIG. 18). Operating Parameter Ranges: Temperature (T)=20 °C to 150 °C; Residence Time=5 to 60 minutes. Discrete choices include 6 candidate catalysts (one-hot variable c_i) and 3 candidate solvents (one-hot variable s_j).
Measurable Outputs: Target molecule yield (>90%), byproduct impurity concentration (ppm), and transition-state activation energy (E_a).
Quantum Formulation & Alchemist Orchestration:
Prior to physical pipetting, a Variational Quantum Eigensolver (VQE) simulates the electron-orbital transition state of the proposed catalyst-solvent pairs to compute the activation energy (E_a). This quantum-derived E_a is injected into the HTE QUBO formulation (H_{EX44}) to select the optimal experimental run:

H_{EX4}=α·E_a(c_i,s_j)−β_PredictedYield(c_i,s_j,T)+λ_{safety}(T−T_{boil}(s_j))+\hat{ }2+H_{mix_onehot}.

The HTE Orchestrator translates the solved discrete configuration (e.g., Catalyst 4, Solvent 2, T=85 °C) into vendor-agnostic instrument abstraction JSON code (e.g., {“cmd”: “DISPENSE”, “volume_ml”: 2.5, “temp_c”: 85}), dispatching precise robotic kinematic coordinates. Following the automated physical reaction, the in-line HPLC sensor measures the actual yield. To structurally differentiate hypothesis generation from an abstract mental process, the Alchemist engine utilizes a machine-executable falsification metric based on Bayesian inference. The posterior probability of the candidate reaction model (M_c) is updated programmatically:

P(M_c|D_{obs})=P(D_{obs}|M_c)P(M_c)/P(D_{obs}).

If the marginal likelihood falls below a strict rejection threshold, the candidate model is purged, and the quantum solver dynamically re-tasks the physical robotic payload with a new experimental vector.

### APPLICATIONS AND INDUSTRIAL IMPACT

The Industrial Digestive System, with its fusion of advanced hardware and quantum-optimized control, has broad applications across industries and promises significant impacts on efficiency and sustainability. Key application areas and benefits include:

Waste-to-Product Conversion and Circular Economy: One of the most non limitative transformative applications of IDS is in waste management and recycling. Traditional waste treatment might involve separate processes (sorting, incineration, anaerobic digestion) that still leave substantial residuals. In contrast, an IDS can serve as a comprehensive waste refinery, turning municipal solid waste, industrial scraps, or agricultural residues into a suite of valuable outputs (fuels, chemicals, fertilizers, clean water, etc.). For example, consider municipal solid waste (MSW): an IDS can sort and mechanically recycle materials like metals and certain plastics, biologically digest organics into biogas and compost, and chemically convert remaining plastics into synthetic crude or monomers. Research indicates that processes now exist (or are in development) to convert diverse feedstocks such as MSW in a single step into biofuels and biocrude (Waste-to-Energy from Municipal Solid Wastes); IDS builds on this by chaining multiple steps to improve yields of each fraction. The net effect is a dramatic reduction in landfill usage—the IDS can reduce the volume of residual waste to near-zero by ensuring each component is utilized. This aligns with zero-waste and circular economy goals, where materials are kept in use rather than disposed. Cities deploying IDS facilities could see most of their trash converted to energy and raw materials, closing the loop on resource cycles. Furthermore, by producing useful commodities from waste, the IDS creates new revenue streams that can fund waste management operations (instead of waste being a pure cost center). It also mitigates pollution; for instance, by capturing biogas from organic waste and using it as fuel, methane emissions are curbed compared to open landfills (Mechanical Biological Treatment (MBT) & Zero Waste—Zero Waste Europe). Overall, IDS technology could revolutionize recycling and waste-to-energy, moving society closer to sustainable resource circularity. Quantum-Enhanced Manufacturing and Industry 4.0: Beyond waste, the IDS concept is applicable to any complex manufacturing process that can benefit from multi-stage integration and quantum optimization. This includes biorefineries (processing biomass into fuels, power, and chemicals), chemical plants that handle multiple feedstocks (like refineries processing crude oil along with bio-oils or waste oils), and even advanced material fabrication systems that have multiple steps (for example, an integrated facility turning mined minerals into battery components with minimal waste). By incorporating quantum computing, such facilities become part of the next wave of Industry 4.0—the “smart factory” paradigm extended with quantum intelligence. The impact is seen in efficiency and agility: Quantum optimization can significantly improve scheduling, supply chain logistics, and process settings, leading to leaner operations. For instance, in a conventional plant, changing the production mix or feedstock might be done cautiously with suboptimal settings for a while; in a quantum-optimized IDS, the system can almost immediately calculate the new optimal settings, so downtime and transition losses are minimized. Studies have shown that quantum algorithms can optimize manufacturing resource use, reducing energy consumption and waste while improving throughput (Quantum Computing in Production) (Quantum Computing in Production). This means an IDS-based factory could outperform a traditional one on key metrics like energy per unit output, scrap rate, and utilization rate of equipment. In economic terms, quantum-enhanced optimization can cut operational costs (through energy savings and higher yields) and increase profit margins. Moreover, such a facility can respond faster to market changes (e.g., quickly shifting to produce a different product if demand changes, since the optimal conditions for the new product are found efficiently via quantum computation). The adaptive process control capability also ensures consistent product quality even as inputs vary, which is a significant advantage in sectors like chemicals and food processing where feed variability is an issue. Adaptive Process Control and Resilience: The IDS's advanced control system yields an industrial process that is self-optimizing and resilient. Traditional plants operate with fixed recipes and are prone to suboptimal performance if conditions deviate. In contrast, the IDS continuously fine-tunes itself. One practical benefit is energy efficiency: The IDS can find the least energy-intensive way to achieve a processing goal at any given moment (for example, if certain stages can be temporarily bypassed or run at lower intensity without affecting output, the quantum optimizer will identify that). As noted by ESA Automation, using quantum computing in production can make processes more efficient and ensure maximum production with minimal energy, supporting sustainability goals (Quantum Computing in Production). Another benefit is reduced downtime-predictive maintenance is enhanced by quantum data analysis, meaning the IDS can anticipate equipment failures and adjust schedules proactively. For example, the system might use quantum-accelerated analytics on sensor data to detect subtle signs of wear in a reactor, then rearrange processing (perhaps routing feed to alternate paths) to allow maintenance without stopping the entire plant. This kind of intelligent scheduling maximizes uptime and extends equipment life. Additionally, the IDS can maintain optimal operation under disturbance: if part of the system goes offline unexpectedly, the control can instantly re-route materials and re-optimize the remaining operations to keep productivity as high as possible. Such fault-tolerant control is akin to how robust natural ecosystems adapt to the loss of one component. This makes IDS-operated facilities more reliable and safer, an important industrial impact especially for critical infrastructure. Environmental and Economic Impact: The convergence of waste conversion and efficiency has dual benefits for sustainability and profit. By massively increasing the fraction of waste turned into product, IDS helps reduce pollution (less landfill leachate, fewer toxic incinerator emissions) and conserves resources (recovered materials mean less mining and drilling). For instance, every ton of plastic that an IDS converts into new plastics or fuel is a ton of plastic not entering oceans or being burned for disposal. On the climate front, the IDS can contribute to lower greenhouse gas emissions by capturing gases like CO₂ and either utilizing them (powering the Sabatier reaction for methane, or feeding algae bioreactors, etc.) or sequestering them, effectively acting as an emissions control hub. If deployed widely, IDS units could form a key part of smart cities and sustainable industrial parks, where the waste of one process becomes the feed for another in a tightly integrated loop—a concept known as industrial symbiosis. Economically, the IDS model adds value in places that used to incur cost. Waste management becomes resource production; fluctuating multi-feedstock supply (like seasonal agricultural waste) becomes an opportunity rather than a problem, because the IDS can absorb whatever is available and convert it optimally. Early analysis suggests that adopting quantum-optimized manufacturing can increase productivity significantly and save billions in certain sectors by 2035. Thus, companies that implement IDS-style systems could gain a competitive edge through lower operating costs and new revenue from by-products. Moreover, the versatility of the IDS means the same core facility can pivot to produce different outputs as needed-providing flexibility in responding to market demand or supply shocks. For example, if a sudden shortage of a chemical occurs, an IDS handling diverse inputs might quickly be instructed (via quantum optimization) to maximize output of that chemical from whatever feedstock is on hand, mitigating supply chain disruptions.

In conclusion, the Industrial Digestive System heralds a quantum leap in industrial process integration and optimization. Its ability to take a measurable “Input” and produce a measurable “output”-under the guidance of quantum-enhanced control-could reshape manufacturing and different industries such as, but not limited to waste management, pharma, chemicals and material production. By maximizing waste-to-product efficiency, or generally maximizing INPUT-to-OUTPUT efficiency it supports environmental sustainability; by boosting productivity and adaptability through quantum computing, it drives economic efficiency. The IDS exemplifies the future of industry where advanced technology (AI, quantum, automation) meets circular economy principles, resulting in smart factories that are both highly productive and profoundly sustainable. As these systems are developed and scaled, we can expect a significant industrial impact: cleaner production, reduced waste and emissions, new business models around resource recovery, and a robust step toward truly sustainable industrial development in the era of Industry 4.0 and beyond.

### BACKGROUND OF THE INVENTION

Industrial processing systems such as the “Industrial Digestive System” (IDS) handle complex transformations of materials (e.g. converting organic waste into biogas, biofuels, chemicals, and reusable composites) through multiple stages. Managing such a system involves multi-objective decision-making: selecting optimal processing routes, controlling material composition and mixture, and maximizing energy output while minimizing waste and cost. The decision space is enormous and highly constrained by physics and engineering limits (e.g. reactor capacities, chemical balance requirements, and energy consumption limits). Classical optimization methods-such as linear programming, mixed-integer nonlinear programming, or evolutionary algorithms-struggle to find global optima in this setting. These methods often get trapped in local optima or face exponential time complexity as the number of decision variables grows. For example, mapping the full process optimization to a classical quadratic binary program is NP-hard, making exhaustive search or brute-force impractical. In practice, classical solvers must simplify the problem (e.g. considering single objectives or linearized models), which leads to suboptimal performance. Dynamic and real-time operation of the IDS further exacerbates the challenge, as the system must adapt to varying input materials and operating conditions on the fly-something classical optimizers cannot easily keep up with due to computational latency.

There is a need for a more powerful optimization approach that can navigate the combinatorial explosion of possible configurations and handle multiple competing objectives simultaneously. Recent advances in quantum computing promise novel optimization capabilities beyond classical limits. Quantum algorithms can exploit superposition and quantum parallelism to evaluate many possible states at once, and quantum tunneling effects allow escaping local minima in complex energy landscapes. However, integrating quantum computing into an industrial cyber-physical system introduces new considerations in problem formulation and system architecture. The following sections describe a quantum software system designed to overcome the limitations of classical methods by harnessing quantum optimization algorithms within the Industrial Digestive System.

### SUMMARY OF THE INVENTION

The present invention is a quantum-enabled optimization software system integrated with an Industrial Digestive System (IDS) to intelligently control and configure industrial processes. The system formulates the multi-objective optimization problem inherent in the IDS-including decisions about process selection, material ingredient composition, and energy efficiency trade-offs-into a format that can be solved by quantum algorithms. By doing so, it enhances the IDS's performance beyond what classical controllers achieve, finding configurations that maximize desirable outputs (e.g. energy yield and product quality) while minimizing costs (e.g. energy input, waste byproducts).

In essence, the quantum software system continuously ingests sensor data and system parameters from the cyber-physical IDS and translates the operational goals into a unified objective function. This objective function may encapsulate, for example, maximizing biogas production, optimizing the mix of chemical outputs, and minimizing energy consumption and emissions, all at once. The software then employs advanced quantum computing techniques-such as Quadratic Unconstrained Binary Optimization (QUBO) solving, Grover's quantum search, and variational algorithms (QAOA and VQE)—to compute an optimal or near-optimal set of control decisions. The resulting optimal process configuration (for instance, which processing unit to route a material to, in what proportions, and under what operating settings) is fed back to the physical system's actuators in real time. The system operates in an iterative, closed-loop fashion, constantly refining process settings as conditions change or new data become available. By leveraging quantum algorithms' ability to explore a vast search space more efficiently, the invention addresses the scalability and convergence issues of classical optimizers. The outcome is an improved Industrial Digestive System that achieves higher throughput and energy efficiency, better product yields, and more adaptive operation than was previously possible with classical optimization methods alone.

### BRIEF DESCRIPTION OF THE DRAWINGS

The accompanying drawings, which are incorporated in and constitute a part of this specification, illustrate one or more embodiments of the invention and, together with the general description given above and the detailed description given below, serve to explain the principles and implementations of the system and method. In the drawings:

FIG. 1 is a schematic flow diagram illustrating the physical hardware supply chain stages of an Industrial Digestive System.

FIG. 2 is a schematic block diagram illustrating the system architecture of a hybrid quantum-optimized industrial control system integrated with a physical industrial process.

FIG. 3 is a flowchart depicting the iterative, real-time adaptive control workflow of a closed-loop hybrid quantum-classical optimization process.

FIG. 4 is a schematic block diagram illustrating a dynamic quantum formulation compiler pipeline configured to ingest physical analog telemetry and digitally convert it into a structurally bounded quantum-computable artifact.

FIG. 5 is a state machine flowchart illustrating a cyber-physical runtime orchestrator and validation gateway configured to mediate quantum computation attempts, classical fallback routing, and safety decoding prior to physical actuation.

FIG. 6 is a schematic flow diagram illustrating a general Industrial Digestive System quantum optimization flow, including feedstock and sensor data collection, variable partitioning, construction of H_IDS, quantum algorithm execution, quantum-classical merging, and closed-loop control feedback.

FIG. 7 is a conceptual mathematical block diagram illustrating the structural assembly of an overarching system Hamiltonian and the restriction of a computational search space via specialized constraint-preserving mixers.

FIG. 8 is a schematic block diagram illustrating a classical and quantum pipeline architecture configured to mitigate hardware constraints via problem decomposition, embedding optimization, and error mitigation.

FIG. 9 is a schematic block diagram illustrating a hybrid optimization engine orchestrating problem formulation, hardware interfacing, and data exchange between classical and quantum computing subsystems.

FIG. 10 is a schematic diagram illustrating a quantum circuit model mapping physical hardware stages of the Industrial Digestive System to corresponding qubits, entangled dependencies, and constraint-based controlled gates.

FIG. 11 is a schematic block diagram illustrating a fully automated High-Throughput Experimentation (HTE) workflow and quantum-assisted reaction simulation integrated within a quantum-enabled Industrial Digestive System framework.

FIG. 12 is a schematic flow diagram illustrating the algorithmic stage-by-stage encoding of continuous industrial unit operations into discrete quantum variables and constraint penalty terms within a real-time feedback loop.

FIG. 13 is a network topology diagram illustrating a distributed multi-site quantum partitioning architecture used to route localized edge computing variables separately from centralized quantum cloud dependencies.

FIG. 14 is a composite block diagram and flowchart illustrating a system, method, and computer-readable medium instructions for executing decomposed sub-problems using pipeline parallelism across hybrid computational resources.

FIG. 15 is a schematic block diagram illustrating a control system interface configured for input detection, valves and path control, operational control functions, computer-based control, and data storage.

FIG. 16 is a flowchart illustrating a hybrid quantum-classical method for combining operational transformations and market data to generate financial forecasts and optimize resource allocation across an industrial network.

FIG. 17 is a flowchart illustrating a self-learning hybrid quantum-classical machine learning engine (the “Alchemist”) configured for automated scientific hypothesis generation, closed-loop experimental testing, and principle discovery across a network of industrial sites.

FIG. 18 is a network topology diagram illustrating a central orchestrator partitioning and managing a hybrid quantum-classical optimization system across multiple distributed industrial or research sites.

FIG. 19 is a schematic block diagram illustrating a parameter-based transformation optimization model bridging atomic-level variational quantum eigensolver (VQE) outputs to macroscopic factory-floor model predictive control (MPC) boundaries.

FIG. 20 is a schematic block diagram illustrating an experiment-input-transformation-output loop configured to generate and update algorithm training data.

FIG. 21 is a schematic block diagram illustrating a bidirectional input-algorithm-output relationship for algorithmic processing embodiments.

FIG. 22 is a schematic block diagram illustrating an algorithm-centric operational model in which an algorithm cloud communicates with input, operations, and output functions.

### DETAILED DESCRIPTION

Any numeric values, product names, solver outputs, variable symbols, or equation instances described herein are provided only as non-limiting examples. In some embodiments, equivalent parameterizations, encodings, discretizations, and objective/constraint forms may be used. Where a term, label, or figure-reference appears that is not otherwise defined in the specification, it is to be treated as an illustrative placeholder rather than a required element. In some embodiments, normalized identifiers may be used to disambiguate entities across data sources.

### Mathematical Formulation of Industrial Process Optimization.

In one embodiment, the multi-stage industrial process is modeled as a multi-objective optimization problem. Let there be a set of processes P_i (e.g. mechanical separation, anaerobic digestion, chemical conversion units, etc.) and a set of material streams or components M_j (different feedstock types or ingredients). We define decision variables representing how materials flow and how processes are configured. For example, a binary decision variable x_{ij} can indicate whether material M_i is treated by process P_i (1=selected, 0=not selected). Continuous operating parameters (such as temperature or retention time) can be discretized into binary variables as needed (e.g. by binary encoding of a setpoint value). The transformation relationships are captured by known chemical/physical models: if process P_i converts input M_j into output products (like biogas or chemical compounds), these yields are represented by functions (or lookup data) Y_{ij} embedded in the optimization.

The system's performance is evaluated by multiple objective metrics: for instance,
f_1=total energy output (from biogas or combustion),
f_2=total mass of valuable chemicals produced, and
f_3=total energy consumed or cost incurred by running the processes.

Additional objectives could include minimizing residual waste volume or emissions. We formalize a composite objective function F as a weighted sum of these metrics, converting the multi-objective problem into a single objective for optimization:

max_x F(x)=w_E·E_out(x)+w_C·C_out(x)−w−{En_in}·E_in(x)−w−{cost}·C_cost(x),

where E_out(x) might represent energy output (e.g. in MJ of biogas), C_out(x) is a measure of chemical product output (in appropriate units), E_in(x) is energy input or consumption, and C_cost(x) is an aggregated cost (e.g. operational cost, or penalty for e/emissions). The weights w_E, w_C, w−{E_in}, w_{cost} are coefficients reflecting the priority of each objective. By tuning these weights, different trade-offs can be explored (alternatively, in another embodiment, the system can perform a Pareto optimization by scanning different weight combinations to identify a Pareto frontier of solutions). Constraints are then applied to reflect physical and chemical limits in the IDS. Examples of constraints include:
Material Conservation: Each material stream must be allocated in full. For each material M_j, Σ_i x_{ij}=1, ensures it is assigned to exactly one processing path (or adjusted if splitting among processes is allowed, e.g. Σ_i x_{ij}=1 with x_{ij} as fractional allocation).
Process Capacities: For each process P_i, Σ_j(a_j x_{ij})≤Capacity i, where a_j is the amount (or flow) of material M_j fed to process P_i. This enforces that no process is overloaded beyond its design throughput.
Input-Output Balance: The outputs from upstream processes can serve as inputs to downstream processes. If process P_k uses the output of P_i, a constraint links them (e.g., the flow out of P_i equals the flow into P_k that is designated to come from P_i). These flow conservation constraints ensure consistency across the entire “digestive” pipeline.
Composition and Quality Constraints: Certain processes require input mixtures in specific ratios (for example, an anaerobic digester might need a balanced carbon-to-nitrogen ratio). This can be enforced by linear constraints like: c_1 x_{i1}+c_2 x_{i2}≤α−(n_1 x_{i1}+n_2 x_{i2}), for a C:N ratio bound, or by pre-computing feasible combinations of inputs for a process and encoding those as allowed configurations.
Operational Constraints: Binary or discrete variables may also encode whether a process is turned on/off, or at a certain discrete setting. If a process has to either run at a certain fixed rate or not at all, an indicator variable and implication constraints handle that (e.g. if y_i=0 means process off, then all x_{ij} feeding it must be 0).

These objectives and constraints together define a large-scale combinatorial optimization problem. It can be highly nonlinear due to the coupling of decisions (for instance, yield Y_{ij} might be nonlinear in mix proportions or operating temperature). To use quantum computing, the software formulates this problem into a quadratic binary form. Nonlinear terms or higher-order interactions are converted to quadratic form by introducing auxiliary variables or penalty terms (a common technique in QUBO formulations). The end result is an objective function H_cost(z) expressed in terms of binary decision variables z∈{0,1}\hat{ }n (or spin variables s∈{±1}\hat{ }n for Ising model form). This objective can be written as a Hamiltonian (energy function):

H_cost=Σ_{p,q}Q_{pq}z_p z_q+Σ_p Q_p z_p,

where the coefficients Q_{pq} encode the contributions of variable interactions (including both original objective terms and encoded constraints as penalty terms). For example, if a constraint E_i x_{ij}=1 must hold, the software adds a penalty term λ=Σ_i x_{ij}−1)\hat{ }2 to the cost function, which expands to quadratic terms λΣ_{i,k}(x_{ij}x_{kj})−2λΣ_i x_{ij}+const, thus fitting in the quadratic form. By adjusting a large penalty coefficient λ, any violation of the constraint raises the energy sharply, so the ground state (minimum energy configuration) of H_cost will tend to satisfy all the encoded constraints.

### Quantum Algorithmic Approaches for Optimization

To solve the formulated optimization problem, the system leverages a suite of quantum algorithms known to handle complex combinatorial searches more effectively than classical algorithms. Key quantum techniques applicable to this invention include:
Quantum Annealing (QUBO/Ising Solver): The quadratic binary optimization problem is naturally suited for quantum annealers. In this mode, the cost function is mapped to an Ising Hamiltonian: H=Σ_{i,j}J_{ij}s_i s_j+Σ_i h_i s_i, (with s_i∈{−1, +1} corresponding to each decision qubit). Quantum annealing starts with an initial Hamiltonian (e.g. a transverse-field inducing a superposition of all states) and slowly morphs into the problem Hamiltonian H_cost. Through adiabatic evolution, the system quantum-mechanically tunnels through energy barriers, seeking the global minimum of H_cost. QUBO problems like this are a central class targeted by adiabatic quantum optimizers. By exploiting quantum tunneling, the annealer can escape local minima that would trap a classical annealing or gradient descent method, thereby finding better solutions for the IDS configuration problem. In practice, the software transmits the Q_{pq} coefficients of the QUBO to a quantum annealing processor, which then returns an optimal binary vector z\hat{ }* representing the recommended configuration (e.g. which processes to run, which material to route where, etc.). This quantum annealing approach addresses classical limitations by evaluating many candidate solutions in parallel (through superposition) and converging via quantum-mechanical effects to a high-quality solution without exhaustive search.
Grover's Quantum Search: For certain decision sub-problems or when searching for a configuration that optimizes a specific criterion, the system can employ Grover's algorithm (amplitude amplification). Grover's search provides a quadratic speed-up for unstructured search problems, which can be adapted to optimization by transforming the task of “find the best solution” into a series of search queries. In the context of the IDS, the quantum software can define an oracle that flags any state (configuration) that meets or exceeds a certain performance threshold (for example, configurations where energy output is above a set value and all constraints are satisfied). Starting with an initial broad threshold, the system uses Grover's algorithm to find any solution that meets this criterion. Then, it iteratively tightens the threshold towards optimality—a procedure known as Grover Adaptive Search. Essentially, after each Grover search finds a satisfactory solution, that solution's objective value is used to set a higher benchmark, and Grover's algorithm is run again to find an even better solution, and so on. This iterative quantum search narrows down the search space by eliminating regions that don't contain better solutions, homing in on the optimum. Grover's approach is particularly powerful when the solution space is large and unstructured; it guarantees that if a better solution exists, it will be found in O(√N) iterations (where N is the number of possible configurations), as opposed to O(N) in a classical linear search. In the patent system, this means a potentially drastic reduction in the time to identify the best process configuration, especially when combined with the adaptive threshold technique that leverages partial results to speed up subsequent searches.
Quantum Approximate Optimization Algorithm (QAOA): QAOA is a gate-based quantum algorithm that can solve combinatorial optimization problems by preparing a parameterized quantum state that encodes candidate solutions and then optimizing those parameters. In this invention, the cost Hamiltonian corresponding to the IDS's objective (with all constraints encoded) is used as the “problem Hamiltonian” H_C. The QAOA routine begins with an initial equal superposition over all possible configurations or a problem-informed initial state. It then applies a sequence of quantum operations: first, a phase separation operator U_C(γ)=exp(−iγ H_C),
   which imparts phase shifts on basis states proportional to their cost (so low-cost states accumulate favorable phase), and then a mixing operator: U_B(β)=exp(−iβ H_B), where H_B is a mixing Hamiltonian (often a sum of Pauli-X rotations on each qubit) that propagates amplitude between states. A sequence of these alternating operators for p layers produces a trial state |ψ(γ, β) [symbol] =U_B(β_p) U_C(γ_p) . . . U_B(β)_1) U_C(γ)_1|s_0 [symbol] . The algorithm uses a classical optimizer to adjust the 2p parameters (γ_1, β_1, . . . , γ_p, β_p) in order to minimize the expectation value [symbol] ψ|H_C|ψ [symbol] . A lower expectation indicates the trial state concentrates probability on lower-cost configurations. At the end of this variational loop, QAOA outputs a set of qubit measurements corresponding to a high-quality (often near-optimal) configuration for the IDS. The advantage of QAOA is that it can be tuned to the specific problem structure (for instance, one can design custom mixer Hamiltonians to ensure the algorithm only explores feasible states that obey hard constraints). It is a hybrid quantum-classical algorithm requiring fewer quantum resources per iteration and can work on noisy quantum processors. For the Industrial Digestive System, QAOA offers a way to find good configurations with modest-depth circuits, making it suitable for current quantum hardware. It addresses classical limitations by efficiently probing the solution space through quantum interference and by potentially delivering better optima than heuristic methods given enough circuit depth.

In some embodiments, the compiler emits a parameterized quantum circuit corresponding to a cost Hamiltonian H_C (or H_cost) and a mixing Hamiltonian H_B (or H_mix). Illustratively, unitary operators may be expressed as:

U_C(γ)=exp(−iγH_C),−U_B(β)=exp(−iβH_B),

producing a parameterized state:

|ψ(γ,β) [symbol] =U_B(β_p)U_C(γ_p) . . . U_B(β_1)U_C(γ_1)|s_0 [symbol] .

In some embodiments, parameters (γ,_β) are updated by a classical optimizer based on measured objective values, including an expectation of the cost Hamiltonian, to obtain candidate solutions.
Variational Quantum Eigensolver (VQE): Another hybrid algorithm, VQE is used to find ground states of Hamiltonians and is adapted here to find the minimum of the cost Hamiltonian H_cost. In the VQE approach, the software defines a parametrized quantum circuit (ansatz) that can represent a wide range of possible solution states. This could be a problem-inspired ansatz (for example, a circuit that mirrors the structure of the IDS decision graph) or a hardware-efficient ansatz on the available quantum processor. The quantum computer prepares a state |φ(θ) [symbol] according to these parameters θ, and measures the expectation value

E(θ)=(φ(θ)|H_cost|φ(θ) [symbol] .

A classical optimizer then adjusts the parameters θ to minimize E(θ). By iteratively updating θ and re-running the quantum circuit, the system converges towards an approximation of the ground state of H_cost, i.e. an optimal or near-optimal solution for the IDS optimization problem. VQE is flexible in that it can incorporate knowledge of the problem into the ansatz (for example, enforcing certain symmetry or constraint satisfaction by construction in the circuit). It also can leverage classical computation to guide the quantum search (hence “hybrid”). Though VQE typically has been applied to molecular energy minimization problems, in this invention it serves as a general optimizer for the industrial multi-objective function. The benefit over classical methods lies in the quantum circuit's ability to represent complex superpositions of configurations, potentially exploring the solution space more broadly than a deterministic classical algorithm. Even if the quantum hardware is noisy, the hybrid loop can find good solutions by circumventing some local minima entrapment that classical algorithms face.

In some embodiments employing a variational quantum eigensolver (VQE), a parameterized quantum state (ansatz) |φ(θ) [symbol] is prepared and an expectation value is evaluated as:

E(θ)= [symbol] φ(θ) [symbol] |H_cost|φ(θ) [symbol] .

A classical optimizer updates parameters θ to reduce E(θ), and in some embodiments the resulting properties or solution features are passed to other system modules, including scaling or bounding components used for operational decision-making. To directly bridge these atomic-level discoveries with factory-floor execution, the system may utilize a kinetic macroscopic scaling engine. This engine automatically translates VQE-derived ground states, molecular properties, and atomic activation energies into macroscopic thermodynamic boundaries, such as precise temperature and pressure envelopes. These mathematically derived boundaries are then injected directly as updated constraints into the classical Model Predictive Control (MPC) algorithms or SCADA systems of the physical plant, enabling automated scaling from quantum molecular simulation to continuous industrial control without manual human transcription. In an illustrative embodiment of this macroscopic scaling, the Macroscopic Thermodynamic Scaling Engine utilizes the minimum ground-state energy derived by the VQE to calculate an atomic activation energy (E_a). To translate this directly into an executable boundary constraint for the classical MPC, the engine applies an inverted Arrhenius transfer function to determine the minimum required absolute temperature (T_{min}) to achieve a target industrial reaction rate (k_{target}): T_{min}=E_a/(R·ln(A/k_{target})),

where R is the universal gas constant and A is the pre-exponential collision factor for the specific reactor topology. By programmatically solving for T_{min}, the cyber-physical system directly translates quantum-chemical wavefunction simulations into rigid thermodynamic boiler setpoints.
Hybrid Quantum-Classical Heuristic Approaches: The system can also combine quantum algorithms with classical optimization heuristics in creative ways to maximize solution quality and computational efficiency. For instance, a quantum-classical divide-and-conquer may be used: the overall problem might be decomposed into subproblems (e.g., separate optimization of different sections of the IDS or different objectives), solved partly by classical means and partly by quantum means, and then coordinated for a global solution. One approach is to use a classical machine learning model to approximate the objective landscape (a surrogate model of the IDS performance) and use that model within a quantum solver to evaluate configurations faster. Another approach is seeding a classical optimizer with quantum results: e.g., use a quantum annealer or QAOA to quickly find a good feasible solution, then feed that as the initial state of a classical local search or linear programming solver to polish the solution. Conversely, the system might use classical preprocessing to reduce the problem size (eliminating clearly suboptimal choices or aggregating variables) and then apply a quantum algorithm to the trimmed problem for a global optimization. These hybrid strategies leverage the strengths of both worlds: the global search capability of quantum algorithms and the fine-tuning and complex logic handling of classical algorithms. By iterating between quantum and classical solvers, the system ensures robust performance even when quantum resources are limited or when certain parts of the problem are easier for classical computation. This hybrid methodology is an important aspect of practical deployment, ensuring that the quantum software system improves upon classical-only methods in a real industrial environment where robustness and solution quality are paramount.

### Encoding Scheme for Quantum Representation

To apply the above quantum algorithms effectively, the multi-objective chemical process optimization problem is encoded into quantum-friendly representations. The encoding scheme is a critical part of the invention, translating real-world process parameters and objectives into binary variables and Hamiltonians without losing essential problem structure:
Binary Encoding of Decisions: All decision variables (process on/off decisions, routing choices, etc.) are represented in binary form. For inherently binary choices (e.g. use Process A vs Process B), a single qubit can represent the choice. For variables that have more than two options or a range of values (such as proportion of material or multi-level settings), the system uses binary expansions or one-hot encodings. For example, if a mixer can blend a feedstock in 5 possible ratio settings, the software might use three qubits to encode the ratio (since 2\hat{ }3=8 provides enough states to represent 5 levels). Each combination of those qubit states corresponds to one of the allowable ratio configurations. As another example, if temperature in a reactor can be low/medium/high, two qubits can be used in one-hot form: 100 for low, 010 for medium, 001 for high (with an additional encoding rule to allow only one of them to be 1 at a time). This ensures that discrete choices are correctly captured in the QUBO/Ising formulation.
Objective Function Encoding: The multiple objectives are combined into a single scalar cost (or reward) as described earlier (via weighted sum or other scalarization). This combined objective is then mapped onto the coefficients of the QUBO matrix Q_{pq} or the corresponding quantum circuit. Normalization may be applied so that different terms of the objective are scaled appropriately relative to each other and fit within the dynamic range of the quantum solver. The encoding ensures that a lower energy (for minimization) or higher reward (for maximization) in the quantum Hamiltonian truly corresponds to a more optimal trade-off in the original multi-objective sense. In some embodiments, the encoding scheme can be adjusted on the fly—for instance, if one objective (like energy efficiency) is found to dominate the others, the system can rescale weights to balance the search and explore more diverse solutions.
Constraint Enforcement: Hard constraints are encoded using penalty methods or by custom state encoding. The simplest approach (used in many QUBO formulations) is to add penalty terms to the objective as described, which incurs an energy cost whenever a constraint is violated. The penalty coefficients are chosen high enough that any violation makes the solution suboptimal relative to any feasible solution. Another, more quantum-native approach, is to design the quantum circuit (for QAOA or VQE) such that it operates only on the subspace of states that are feasible. For example, one can use a clever mixing Hamiltonian in QAOA that preserves the feasibility of constraints. In this system, for important hard constraints like material conservation or one-hot encodings, the mixer operation can be defined to not toggle a bit if doing so would violate the constraint (or use multi-qubit mixers that flip bits in a correlated way to maintain validity). By way of a non-limiting mathematical example, to strictly enforce a “one-hot” routing constraint or mass-balance (maintaining a constant Hamming weight across routing variables), the specialized mixer Hamiltonian H_{mix} is constructed using Pauli-X (σ\hat{ }x) and Pauli-Y (σ\hat{ }y) exchange operators. An illustrative XY-mixer between adjacent valid routing nodes i and j is formulated as:

H_{mix}=½Σ_{(i,j)∈E}β(σ_i\hat{ }xσ_j\hat{ }x+σ_i\hat{ }yσ_j ŷ).

Because this operator exclusively swaps amplitudes between degenerate feasible states (e.g., transitioning ∥01 [symbol] ↔|10 [symbol] ), the QAOA evolution is mathematically restricted to the Feasible Subspace Boundary, structurally preventing the quantum solver from wasting coherence time evaluating physically impossible material states.

Similarly, the initial state can be chosen as a feasible state, and the ansatz can be structured to inherently satisfy certain equalities. By reducing the penalty burden on the quantum objective, this approach can improve solution quality, as the quantum algorithm doesn't waste effort exploring invalid combinations. The invention contemplates both methods: a straightforward penalty encoding for general applicability, and an advanced constraint-aware encoding for improved performance in specialized scenarios.

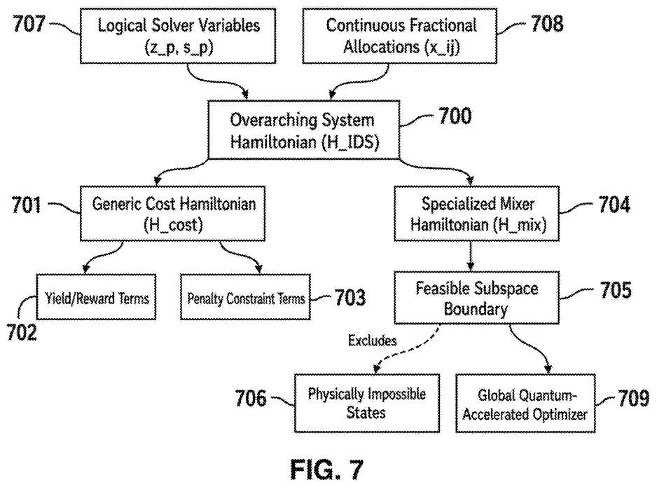

For a more detailed understanding, reference is made to FIG. 7. Brief Description: FIG. 7 is a conceptual mathematical block diagram illustrating the structural assembly of the overarching system Hamiltonian and the restriction of the computational search space via specialized constraint-preserving mixers. Detailed Description: FIG. 7 visually maps the deep mathematical topology required to ensure physical plant feasibility. The overarching assembly yields an Overarching System Hamiltonian (H_{IDS}) [700]. Within this architecture, a Generic Cost Hamiltonian (H_{cost}) [701] combines positive Yield/Reward Terms [702] with structural Penalty Constraint Terms [703]. A distinct Specialized Mixer Hamiltonian (H_{mix}) [704] is applied to establish a strict Feasible Subspace Boundary [705]. This boundary dynamically filters amplitude transfers, ensuring that parameters violating mass-balance, represented as Physically Impossible States [706], are systematically excluded from exploration. Symbolic Logical Solver Variables (z_p, s_p) [707] and interaction coupling lines derived from Continuous Fractional Allocations (x_{ij}) [708] map the inputs into the matrices. The entirely restricted mathematical landscape is finally evaluated by a Global Quantum-Accelerated Optimizer [709] to discover the optimal ground state within hard operational guardrails.
Chemical Reaction and Process Modeling Data: The complex physics and chemistry of the Industrial Digestive System (such as reaction yield curves, degradation rates, energy conversion efficiencies) are incorporated into the quantum optimization model through pre-computation and encoding. For instance, if a certain combination of materials in a digester yields X amount of biogas and Y amount of residue, those results might be calculated by a classical simulation or machine learning model beforehand. The yield results are then encoded as part of the objective coefficients fed into the quantum solver. In practical terms, the software might maintain a database or functional model f_yield(i, j) that gives the expected outcome of processing material j in unit i. During each optimization cycle, the software queries these models to get numerical coefficients (like how much energy E_{ij} or product C_{ij} results from that action) and inserts those into the QUBO or Hamiltonian. This way, the quantum algorithm is always evaluating configurations on a realistic landscape that mirrors the actual Industrial Digestive System's behavior. The encoding scheme thus serves as the translator between real-world process performance and the quantum bit-based representation needed for computation.
   Integration with Cyber-Physical System Components

A key aspect of the invention is the seamless integration of the quantum optimization software with the physical industrial system. The Industrial Digestive System is a cyber-physical system (CPS), meaning it has networked sensors, control systems (PLCs, SCADA systems), and actuators (valves, motors, feeders, etc.) that interact with physical processes. The quantum optimization component operates as an intelligent higher-level control layer in this CPS. Its integration points include:
Sensor Interface: The system receives real-time data from sensors monitoring the IDS. This data can include feedstock properties (composition, moisture content, calorific value), process states (temperatures, pressures, fill levels in reactors), and output measurements (energy production rates, chemical composition of outputs, emissions). A data acquisition module feeds this information into the quantum software. The incoming data is used to update the parameters of the optimization model—for example, if sensors detect a shift in input material composition (more food waste vs. green waste), the yields Y_{ij} or constraints in the model are adjusted accordingly. High-frequency data might be filtered or aggregated so that the optimization deals with relevant timescales (e.g. hourly averages or batch-wise measurements rather than noisy minute-by-minute fluctuations, unless rapid control is intended).
Actuator/Control Output: Once the quantum computation (annealing run, QAOA circuit, etc.) produces an optimal configuration, the result is translated into concrete control commands. This could involve setting programmable logic controller (PLC) setpoints such as: how to split incoming waste between different processing lines, what temperature to maintain in each digester, how long to let a batch ferment, or when to switch on/off certain equipment. The software includes a hardware interface layer that communicates these setpoints to the existing control system of the plant. In one implementation, the quantum optimizer runs on a separate server or cloud service, and communicates with the plant's control system via an industrial protocol (such as OPC UA, MQTT, or MODBUS/TCP) to send commands and receive sensor updates. In another implementation, the quantum optimization might be embedded within the control system's computational platform, directly interfacing with internal APIs of the plant's control software.
Machine Learning Integration: The dynamic and potentially noisy environment of an industrial plant calls for predictive and adaptive capabilities. The invention integrates machine learning (ML) models as supportive components. These ML models can serve multiple roles: (1) State estimation and prediction: Using sensor history and possibly external factors, an ML model can predict near-future conditions (e.g., expected feedstock supply or quality in the next hour, or the trajectory of reactor performance). This prediction can inform the quantum optimizer to be proactive (for instance, if a certain waste type is expected to increase, the optimizer might preemptively adjust the configuration). (2) Surrogate modeling: As mentioned, complex chemical kinetics might be too slow to compute within each optimization run, so ML regression models (trained on simulations or past data) predict outcomes (yield, emissions, etc.) for given process settings instantly. The quantum optimizer queries these surrogate models as part of evaluating the objective function for different configurations. (3) Reinforcement learning controller tuning: In some embodiments, the quantum optimizer works in tandem with a reinforcement learning agent that fine-tunes continuous control variables. For example, the quantum part might choose which process steps to use and an RL agent adjusts a continuous valve opening. The integration is designed such that the quantum optimization provides a global search or planning function, and ML/AI provides local adaptation and prediction, resulting in a robust overall control strategy.
Cloud and On-Premises Quantum Resources: Depending on the availability of quantum hardware, the system can operate with either a local quantum processing unit (QPU) or remote/cloud-based quantum services. If using a cloud quantum service, the integration includes a cryptographically secure cyber-physical communication link to the quantum backend. To protect the industrial plant from malicious intrusion or payload tampering, every compiled Serialized Artifact (e.g., the QUBO matrix) and Timestamped Optimization Snapshot is mathematically hashed (e.g., via SHA-256) and cryptographically signed using asymmetric key pairs at the edge gateway. Upon returning the candidate solution bitstring, the receiving gateway authenticates the payload signature to verify data provenance. If a signature mismatch is detected, the Latency-Aware Hybrid Orchestrator automatically rejects the cloud payload and instantly routes control to the deterministic offline classical fallback, structurally preventing compromised cloud APIs from altering the physical plant's thermodynamic or mechanical states-. The software prepares the QUBO or quantum circuit, sends it to the quantum service, and retrieves the results. Latency is managed by scheduling the optimization at appropriate intervals (e.g., it might run a new optimization every time a batch process is complete, or when there is a significant change in inputs, rather than every second). In cases where latency must be minimized (near-real-time control), the system can use a hybrid approach: e.g., precompute a library of optimal solutions for different scenarios using quantum computing offline, then deploy those solutions in real-time via a fast classical lookup or interpolation when sensors detect a matching scenario. The patent covers these integration scenarios to ensure the quantum optimizer can practically function within industrial timing and reliability requirements.
User Interface and Supervisory Control: The operators of the industrial plant can interact with the quantum optimization system through a user interface which is part of the CPS integration. This might allow them to set high-level goals (e.g., prioritize maximizing fuel output today, or prioritize reducing waste due to regulatory constraints), which adjust the objective weights w_E, w_C, . . . in the optimization. The interface can also display the recommended configurations and forecasted outcomes, giving human supervisors insight into why the quantum system is making certain decisions. Safety is also a consideration: the system can be configured such that any quantum-derived control action is validated by a rule-based safety checker (to ensure it doesn't violate any critical safety constraint) before execution. This integration ensures that the quantum optimizer is not a black box but a well-incorporated component of the overall industrial control architecture.

### Iterative Quantum-Classical Optimization Workflow

The optimization process in this invention is iterative and adaptive, forming a closed-loop workflow that continuously improves system performance. An exemplary workflow proceeds as follows: 1. Initialization and Data Ingestion: The system starts by collecting current state data from the IDS. This includes sensor readings (feedstock types/amounts, current output levels, etc.), the active status of processes, and any external conditions (e.g., electricity price if energy cost is a factor). It also loads or updates any predictive model outputs (such as an ML forecast of incoming waste supply). The multi-objective goals and any operator inputs are read (for instance, an operator could emphasize one objective at certain times). Using this information, the software formulates or updates the optimization problem instance (objective function coefficients and constraints as described in the Mathematical Formulation section). 2. Problem Encoding for Quantum Solver: The current optimization instance is translated into a quantum-compatible format. If using a quantum annealer, this means constructing the QUBO matrix Q (or Ising model parameters J, h). If using a gate-based algorithm (QAOA/VQE/Grover), it means generating the required quantum circuit or oracle definitions. This step applies the encoding scheme ensuring all objectives and constraints are correctly represented by qubits and logical operations. Any necessary scaling or qubit reuse optimizations are performed here (for example, reducing the problem size by fixing certain decisions that are obvious from context or aggregating variables to fit hardware limits). 3. Quantum Optimization Execution: The encoded problem is then submitted to the quantum algorithm. Depending on the implementation, this could be: ⋅ Sending the QUBO to a quantum annealer and initiating the annealing process (possibly with multiple runs to sample the ground state with high confidence). ⋅ Running a QAOA routine: initialize qubits, run the parameterized circuit for a certain number of iterations, using a classical optimizer in the loop to adjust parameters and re-running the quantum circuit as needed until convergence.
Running a VQE: similar hybrid loop where the quantum circuit's parameters are iteratively tuned via classical feedback. ⋅ Executing Grover's adaptive search: calling the oracle and diffusion operators in a loop, adjusting the threshold and repeating until the best solution is found. Throughout this execution, the quantum-classical hybrid control is orchestrated by the software. For example, in QAOA/VQE the software monitors the improvement of the objective expectation value and decides when to stop (convergence criteria or a set number of iterations). If the quantum hardware yields multiple candidate solutions (as annealers often do by sampling), the software can evaluate each candidate using the objective function to pick the best feasible one. Advanced embodiments might run several quantum solvers in parallel (or different parameter settings in parallel) and then choose among the returned candidates the one with minimum cost. 4.

Solution Decoding and Verification: The best solution produced by the quantum computation is decoded back into engineering terms. In some embodiments, continuous process variables are discretized or encoded into binary (or spin) representations prior to solving, and the resulting solver output is reverse-mapped to physical control parameters. Illustratively, a solver returns a bitstring z (or spins s) that is interpreted via a selected discretization method, including binary expansion, bucketing, unary encoding, or other parameterized encoding, to reconstruct values in engineering units. In some embodiments, reverse scaling applies an inverse of any normalization used during compilation, and reconstructed values are validated against feasibility and safety checks prior to actuation. This means translating the binary string result into meaningful instructions: e.g., binary variables [1, 0, 0, 1, . . . ] might correspond to “send material type A to Process 1, send material type B to Process 4, set Process 4 to high temperature, and keep Process 2 idle,” etc. The software verifies that this solution is feasible and safe. Feasibility in terms of constraints is usually guaranteed by the encoding (if all penalties are satisfied, the solution should meet constraints; still, a quick check is done to confirm no constraint is violated by numerical rounding issues).

Safety and practical checks (like ensuring no equipment is asked to operate beyond its limits or switching delays) are applied. In some embodiments, during reverse-scaling and validation, an actuation stability and validation gateway applies rate limiting and/or gradient dampening to decoded engineering setpoints to reduce mechanical shock and maintain stable operation. In some embodiments, a rate of change is restricted by a bounding function such that an absolute difference between a current state and a proposed setpoint is constrained by a hardware-specific maximum delta parameter over a time interval.

Mathematically, this rate-limiting gradient dampening applied by the Actuation Stability & Validation Gateway is executed via a bounding function. If u_{raw}(t) is the de-quantized setpoint from the quantum solver and u_{act}(t−1) is the current physical state, the dispatched setpoint u_{act}(t) is clamped as:

u_{act}(t)=u_{act}(t−1)+max(min(−u_{raw}(t)−u_{act}(t−1),Δ_{max}), −Δ_{max}),

where Δ_{max} is the maximum permissible rate of change per control cycle for the targeted industrial hardware. If the raw target violates these bounds, the system automatically projects the command to the nearest safe boundary, thereby mechanically decoupling quantum solver latency or erratic variance from physical plant stability.

In some embodiments, out-of-bounds parameters are projected, clamped, or otherwise adjusted to remain within allowable safe boundaries prior to command execution by a controller. If the solution is somehow infeasible or suboptimal due to an edge case, the system can fall back to a secondary solution or adjust parameters and re-run the optimization quickly. Following the execution of the optimization algorithm, an Actuation Stability & Validation Gateway may be configured to process the raw outputs of the solver (e.g., flattened logical bitstrings, spin configurations, or parameterized continuous variables) into actionable engineering setpoints and discrete routing decisions. In some embodiments, this decoding gateway utilizes the variable dictionary to map the abstract logical variables back to their corresponding physical plant tags or experimental identifiers. For variables that represent discretized continuous ranges, the gateway may perform a generic reverse-scaling or de-quantization operation to convert the encoded discrete values back into continuous engineering setpoints, applying the appropriate unit transformations.

Prior to dispatching these translated setpoints to the control layer, a validation gate evaluates the proposed commands against physical bounds, operational feasibility checks, and safety constraints. If a proposed setpoint falls outside allowed operational guardrails, the gateway may implement protective behaviors. These protective behaviors may include clamping the value to the nearest safe boundary, enforcing rate limits for gradual ramping, attempting a generic heuristic repair to project the invalid solution into a feasible region, or rejecting the solution entirely. A rejected solution may automatically flag a failure and trigger the orchestrator's classical fallback mode.

### Non-Limiting Illustrative Example: Decoding and Validation Mapping Sequence

Raw Solver Output Received: solution bitstring=[1, 0, 1, 1, 0]
Reverse Mapping (Dictionary Lookup):
   Logical indices [z_0, z_1, z_2] map to mapping_id: “Reactor_Temp_Target”.
   Logical indices [z_3, z_4] map to mapping_id: “Valve_Feed_Routing”.
   De-quantization & Reverse-Scaling:
   [z_0=1, z_1=0, z_2=1] interpreted via a discretization method (e.g., binary expansion)→Temp_Target_Raw.
   Validation Gate (Bounds & Feasibility Checks):
   Bounds Check: Is Temp_Target_Raw within [min_temp_parameter, max_temp_parameter]?
   Rate Limit Check: Is abs(Temp_Target_Raw−Current_Temp)<max_delta_temp_parameter?
   Feasibility Check: Is the selected Valve_Feed_Routing physically available?
Outcome Routing:
   If Pass: setpoints accepted→dispatch to PLC.
   If Fail (Bounds Exceeded): clamp Temp_Target_Raw to allowed limit→dispatch clamped value or attempt repair.
   If Fail (Critical Constraint): reject solution→trigger FALLBACK_CLASSICAL routine or SAFE_HOLD.

### Automated Penalty Tuning and Feasibility Loop:

To prevent continuous classical fallbacks and programmatically resolve constraint failures, the Quantum Industrial Problem Compiler executes an automated Penalty Tuning Subroutine. If a physical constraint k is violated by a magnitude of v_k, the compiler automatically escalates its associated penalty multiplier λ_k for the subsequent compilation cycle using a gradient-ascent update rule:

λ_k\hat{ }{(t+1)}=λ_k\hat{ }{(t)}+η·exp(γ·v_k),

where η is a base learning rate and γ is a severity scalar. This programmatic feedback loop dynamically warps the quantum energy landscape, structurally burying the invalid configuration in a high-energy penalty state and forcing the solver's rapid convergence to a physically executable setpoint without manual human-in-the-loop tuning.

5. Deployment of Control Actions: Once verified, the solution is implemented in the Industrial Digestive System. The system sends the appropriate commands to actuators and updates setpoints in the control system (as described in the Integration section). For example, valves are adjusted to route materials according to the optimized plan, setpoints for mixers or reactors are changed, and schedules for batch processing are updated. This effectively reconfigures the IDS to the new optimal state. 6. Monitoring and Feedback: After deployment, the system closely monitors the outcome via sensor data. It compares actual performance (energy output, product yields, etc.) against the predicted performance from the optimization model. Any deviations can be recorded—for instance, if a certain yield was overestimated, the system will learn from this and adjust the model (possibly through an ML model update or a tweak in the yield coefficients). The monitoring phase also watches for disturbances or changes (e.g., a new type of waste input coming in, or a piece of equipment becoming unavailable). The quantum software system is designed to react to these changes. 7. Iterate/Update Cycle: The optimization cycle repeats at a suitable frequency. This could be a periodic schedule (e.g., every hour or at the start of each new batch of material) or event-driven (e.g., whenever output efficiency drops below a threshold or when a significant change in input is detected). In each new iteration, the latest data and state are used to update the optimization problem. Over time, this iterative quantum-classical loop drives the system toward an optimal operating regime and maintains it there adaptively. Each iteration improves upon the last as the system learns the landscape (with the help of ML models updating) and as quantum algorithms potentially find better solutions with more runs or as hardware improves. Crucially, because the quantum optimization can consider combinatorially many adjustments simultaneously, the system can co-optimize things that traditionally were optimized in isolation. For example, rather than separately tuning one process at a time, the quantum approach might decide a coordinated shift: “slightly lower the temperature in digester A but increase flow to reactor B to compensate and improve overall yield,” a nuanced strategy that classical heuristics might miss. Through this iterative workflow, the invention continuously adapts and optimizes the Industrial Digestive System in real-time or near-real-time, something not achievable with prior static optimization methods. The result is a quantum-enhanced cyber-physical system that consistently operates at peak efficiency across multiple objectives, even as conditions change. This addresses the core limitations identified earlier: the quantum software can handle the problem scale and complexity (via advanced algorithms and encodings) and can respond to dynamics by iterating rapidly-yielding a smarter, more autonomous Industrial Digestive System than previously possible. Each element described—from the mathematical formulation, the specific quantum algorithms, the encoding scheme, to the integration and workflow-contributes to the overall novelty of using quantum computation to drive industrial process optimization, marking a significant departure from conventional industrial control systems.

Deep Mathematical Specification Specifying whether certain variables are strictly binary or fractional, (2) ensuring the objective's sign convention is consistent when converting to QUBO form (where one often minimizes an energy rather than maximizes a profit), and (3) clearly stating each constraint's indexing and domain.

Any numeric values, product names, solver outputs, variable symbols, or equation instances described herein are provided only as non-limiting examples. In some embodiments, equivalent parameterizations, encodings, discretizations, and objective/constraint forms may be used. Where a term, label, or figure-reference appears that is not otherwise defined in the specification, it is to be treated as an illustrative placeholder rather than a required element. In some embodiments, normalized identifiers may be used to disambiguate entities across data sources.

In some embodiments, decision variables are declared explicitly as binary, integer, or continuous, including fractional allocations, and the selected domain controls later discretization and encoding. By way of example, assignment variables may be binary x_{ij}∈{0,1} with an “exactly-one” constraint Σ_i x_{ij}=1 for each item j. In some embodiments, splitting among paths or processes is permitted by relaxing integrality, for example x_{ij}≥0 with Σ_i x_{ij}=1, while still allowing additional capacity limits, logic constraints, process-on/off constraints, and other feasibility constraints to be applied.

In some embodiments, an optimization objective is expressed as maximizing a utility (or profit) function and then converted into an equivalent minimization form for quantum-computable representations. For example, an illustrative multi-objective utility may be written as:

max_x F(x)=w_1f_1(x)+w_2f_2(x)=−w_3f_3(x).

where weights w and objective components f(⋅) are parameterized per application. In some embodiments, a composite objective may alternatively be expressed illustratively as:

max_x_F(x)=w_E E_out(x)+w_C C_out(x)−w_{E_in}E_in(x)−w_cost C_cost(x),

where E_out and C_out represent desired outputs, E_in and C_cost represent consumptions and operational penalties, and weights are adjustable to balance trade-offs without requiring structural alterations to the physical system model. In some embodiments, a corresponding cost Hamiltonian (or cost function) is defined as a monotone transformation of the maximization objective, such as:

H_cost(x)==F(x),

so that minimizing H_cost corresponds to maximizing F.

In some embodiments, constraints are incorporated into a single objective via penalty terms, including squared penalties, with weights parameterized to reflect relative priority. Illustratively, an “exactly-one” constraint may be enforced as:

λ(Σ_i x_i=1)\hat{ }2,

and selection constraints may be written as:

α_sel(Σ_k y_k=−1)\hat{ }2.

In some embodiments, conservation, capacity, or flow constraints are expressed as penalty sums, for example:

α_flow Σ_r(Σ_i x_{i,r}+−1)\hat{ }2,

and/or

α_capΣ_p−(Flow(p,z)+−Cap(p))_+\hat{ }2,

with optional logic-gating penalties such as:

α_logic Σ_p−(Flow(p,z)=−M·v_p)\hat{ }2,

where weights and M are selected per embodiment. In some embodiments, penalty magnitudes (e.g., λ) are selected sufficiently large relative to objective scales such that infeasible states are assigned unfavorable cost/energy profiles, thereby discouraging violation without requiring specialized solver primitives.

In some embodiments, physical equipment capabilities and compositions are parameterized and bounded prior to quantum compilation. For example, a volumetric, thermal, or throughput capacity limit for a process i may be bounded by an inequality:

Σ_j a_j x_{ij}≤Capacity_i,

where a_j represents an incoming material parameter. In some embodiments, compositional ratio constraints are preserved via inequalities, for example:

c_1x_{i1}+c_2x_{i2}≤α(n_1x_{i1}+n_2x_{i2}),

thereby maintaining required bounds (e.g., quality, safety, or process chemistry tolerances). In some embodiments, such inequalities are enforced directly where supported or are converted into penalty terms and incorporated into a compiled objective representation.

In some embodiments, the compiled formulation is expressed in quadratic unconstrained binary optimization (QUBO) form over binary variables z. An illustrative energy may be written as:

H_cost(z)=Σ_{p,q}Q_{pq}z_p z_q+Σ_p Q_p z_p

where Q encodes quadratic couplings and linear terms, and where constraint penalties are included directly in Q and/or appended as additional quadratic/linear contributions. In some embodiments, the compiler outputs Q as a dense matrix, sparse matrix, list of weighted edges, coordinate-list tuples, or another equivalent serialization for dispatch to a selected backend.

In some embodiments, a formulation is represented in an Ising model using spin variables s_i∈{−1,+1}. An illustrative Ising Hamiltonian may be expressed as:

H(s)=Σ_{i,j}J_{ij}s_i s_j+Σ_i h_i s_i,

with couplings J and biases h derived from a QUBO representation or compiled directly from objectives and constraints. In some embodiments, a binary decision variable z_p∈{0,1} is transformed into a spin variable s_p∈{−1,+1} using:

s_p=2z_p=−1

yielding an equivalent energy landscape in an Ising-compatible form. In some embodiments, the formulation may also be described generically as:

H=Σ_i C_i x_i+Σ_{j,k}D_{jk}x_j x_k+(constraint penalty terms),

where coefficients are parameterized by the instance.

The mathematical expressions and equations described in the present invention are illustrative and non-limiting, and are provided to enable concrete compilation pathways without narrowing implementation. In some embodiments, the Quantum Industrial Problem Compiler and associated “Problem Formulation Engine” compiler stages translate declared variables, objectives, and constraints into one or more backend-ready artifacts, including QUBO coefficients, Ising couplings, and/or parameterized circuit descriptions. In some embodiments, these artifacts are emitted in serialized forms suitable for dispatch to a selected solver backend, while maintaining a backend-agnostic stance such that equivalent representations and monotone transformations may be substituted without changing the intended optimization semantics.

### Decision Variables:

Binary vs. Fractional Allocation: If each material M_j must go to exactly one process P_i (no splitting), then: x_{ij}∈{0,1}, and Σ_i x_{ij}=1 for all j. If splitting among processes is allowed, then: x_{ij}≥0, and Σ_i x{ij}=1 for all j. In this case, x_{ij} represents the fraction of material j routed to process i
i. On/Off or Discrete “Mode” Variables. If a process P_i can be either running or stopped: y_i∈{0,1}, where y_i=1 means “process i is on”. Often these y_i appear in capacity or logic constraints (e.g., if y_i=0 then all x_{ij}=0).

Quantized Operating Parameters. For temperature or flow-rate settings that take on discrete levels, you may introduce extra binary variables or use a binary expansion. For instance, if reactor i has three modes {low,_medium,_high}: t_{i,low}, t_{i,med}, t_{i,high}∈{0,1}, and t_{i,low}+t_{i,med}+t_{high}=1. Or can use └log_2(#_levels)┐ qubits/variables in a Gray code or standard binary code. Objective Function. Let E_out(x)=total energy output (e.g., biogas energy), C_out(x)=total quantity of valuable chemical(s) produced, E_in(x)=total energy input or consumption, C_cost(x)=aggregated operational cost or penalty (including waste disposal, emissions, etc.). A weighted combination to maximize might be:

max_x_F(x)=w_E E_out(x)+w_out(x)w_{E_in}E_in(x)−w_cost C_cost(x).
If you are using a QUBO solver (which typically minimizes an energy function H_cost), you would convert:

max F(x)⇔min[−F(x)].
So in QUBO terms, you might encode H_cost(x)=−(w_E E_out+w_C C_out− . . . ) plus any penalty terms. The key is to keep track of sign flips carefully.
Alternatively, define it directly as a cost: H_cost=F(x).

### Constraints

Material Conservation
   No splitting scenario: Σ_i x_{ij}=1, x_{ij}∈{0,1}, for all j.
   Splitting scenario: E_i x_{ij}=1, x_{ij}≥0, for all j. Here, x_{ij} either picks (binary) or allocates (fractional) each material j to one or more processes
i. Process Capacities
   If a_j is the total available amount (or flow) of material j, then for each process P_i: Σ_j a_j x_{ij}≤Capacity i
If x_{ij}∈{0,1}, the left side is either 0 or a_j. If x_{ij} is fractional, this is a linear sum of fractions
Composition or Quality Constraints; For instance, a required carbon-to-nitrogen ratio C:N. If process iii receives materials 1, 2 with carbon contents c_1, c_2 and nitrogen contents n_1, n_2: c_1 x_{i1}+c_2 x_{i2}≤α(n_1 x_{i1}+n_2 x_{i2}).
Logical On/Off Constraints; If y_i==0 (process i off) implies no material can flow to it: x_{ij}≤y_i, for binary variables, this forces x_{ij}=0 if y_i==0. If a process must run at a certain fixed flow rate or not at all, you can add “big-M” constraints or direct equality constraints that tie x_{ij} to y_i.

### 4. QUBO/Ising Form

Hard constraint E_i x_{ij}=1 can be enforced as: λ·(Σ_i x_{ij}−1)\hat{ }2, which expands to (constant+linear+quadratic terms). A large enough λ ensures any violation is energetically unfavorable. The final Hamiltonian (to minimize) becomes: H_cost(z) Σ_{p,q} Q_{pq} z_p, z_q+Σ_p Q_p)+(constant terms if needed), where z_p∈{0,1} or {±1} are the binary/spin variables (the same or a suitably mapped version of x_{ij}, y_i, etc.), where Σ_{p,q}Q_{pq}z_p z_q represents objective & penalty interactions, and Σ_p Q_p z_p represents linear terms, non-limitative exemplary mathematical model: Below is a unified non-limitative exemplary mathematical model that begins with the sets, parameters, and objective function S_{IDS} for an Industrial Digestive System and continues through to the final quantum Hamiltonian H_{IDS}. This model captures both criteria-based scoring and output matching to given optimum targets {O_1, O_2}. It is written in a stepwise manner, showing how one can move from a conventional optimization objective into a quantum (QUBO/Ising) Hamiltonian.

### In Detail:

### 1. DEFINITIONS AND SETS

Process P={p_1, p_2, . . . , p_n} (set of n chemical or industrial processes).
Input Materials M={m_1, m_2, . . . , m_l} (set of l input materials).
Process Combinations C_k={c_{k1}, c_{k2}, . . . , c_{km}} (the k-th combination of processes considered). For instance, C_1 could be a certain chain of processes {p_1→p_3→p_5}, C_2 might be {p_2→p_4}, etc.
Criteria: Each process p_i (or each chain C_k) can be associated with m different criteria that one wants to optimize or measure, e.g. energy output, cost, yield, reaction time, etc. Let C\hat{ }k={c\hat{ }i_{k1}, c\hat{ }i_{k2}, . . . , c\hat{ }i_{km}} be the set of criteria values for process (or chain) p_i under-combination. Each c\hat{ }i_{kj} is the value of the j-th criterion.
Weights
   W={w_1, w_2, . . . , w_m} (weights for each of the m criteria). A higher w_j indicates that criterion j is more important in the overall objective.
Optimum Outputs O_n={O_1, O_2}
   (a set of target outputs or target property profiles). For illustration, O_1 might correspond to a “steel-like” product property, and O_2 to an “ethanol” property.
Input Fractions or Percentages X={x_1, x_2, . . . , x_l} where each x_i is the fraction of material m_i used in the chosen process or chain. Often, Σ_{i=1}\hat{ }1 x_i=1 if exactly 100% of the total input is allocated among materials, or 0≤x_i≤1 if partial usage is allowed.
Production Matrix A=[a_{ij}], i=1, . . . , l, j=1, . . . , r, where a_{ij} represents the amount of an output product o_j obtained by using 1 unit of material m_i in process p. (If multiple processes are chained, one composes or sums the transformations accordingly.)
Decision or “Best” Variables V={v_1, v_2, . . . , v_r} (auxiliary decision variables controlling process-parameters or chain-selection). These could be on/off bits, temperature settings, or other discrete operating modes that define how the chosen process combination C_k is run.
Score Function for a Given Combination

Let C_k be a particular chain of processes. Denote: c\hat{ }i_{kj}=value of the j-th criterion for process p_i in combination k, w_j=weight for criterion j. We define an overall score function S(C_k, X) that includes:

### Sum of Weighted Criteria:

Σ_{i∈C_k}Σ_{j=1}\hat{ }m w_j_{kj},

which accounts for how “good” or “bad” each process in the chain is across all criteria, scaled by the weights w_j. Contribution of Outputs Relative to Targets: Σ_{i=1}\hat{ }1 Σ_{j=1}\hat{ }r (x_i·a_{ij}·o_j).

Here, x_i is how much of material m_i is used, a_{ij} is the amount of product o_j produced per unit of m_i, and o_j can be interpreted as a partial measure of how close we get to a desired property (like “ethanol yield” or “steel-like property”). Alternatively, if we want to measure the difference from a target product property, we can define a difference function Δ(o_j, O_1), etc. The exact expression depends on how you want to measure closeness to O_1 or O_2. Putting these parts together, one might write a simplified version:

S(C_k,X)=Σ_{i∈C_k}Σ_{j=1}\hat{ }m w_j c\hat{ }i_{kj}+Σ_{i=1}\hat{ }1Σ_{j+1}\hat{ }r(x_i·a_{ij}·o_j).

where Σ_{i∈C_k}Σ_{j=1}\hat{ }m_w j_c{kj} represents weighted criteria terms, and Σ_{i=1}\hat{ }1 Σ_{i=1}\hat{ }r (x_i a_{ij} o_j) represents outputs or property alignment.

### Global Optimization Problem

Given several possible process chains C_1, C_2, . . . , C_M and feasible fraction vectors X_1, X_2, . . . , X_M, we want to pick the best combination C_k and corresponding X_k that minimizes the overall score S. Symbolically: (C_optimal, R_optimal, V_optimal, X_optimal)=arg min_k {S(C_1, X_1), S(C_2, X_2), . . . , S(C_M, X_M)}. Here. R optimal might refer to an overall route or recipe (a more detailed specification of how the chosen chain is executed), and V_optimal are the best process-specific parameters (temperatures, reaction times, etc.) within the chosen chain. The minimization indicates that a lower score corresponds to better performance according to our weighting of criteria and closeness to desired outputs. If you specifically want to match your outputs to O_1 and O_2, you might incorporate a difference penalty such as ∥productProfile−O_1∥ or ∥productProfile−O_2∥ into S(⋅). For instance, if we want to be close to O_1 in certain properties, you add ∥Σ_i x_i a_{ij}−O_1∥ or a similar difference measure. Constraints: Typical constraints include: Material Fraction Constraint: Σ_{i=1\hat{ }1 x_i=1, x_i≥0, for all i. All fractions sum to 1, or at most 1 if not all materials must be used.)

### Process Capacity Constraints:

If each process p∈P has capacity Cap(p), and C_k uses processes {p_{k1}, . . . , p {ku}}, then

Σ_i=1}\hat{ }1x_i·flow(p,m_i)≤Cap(p),

for each p∈C_k. (The exact form depends on how flow is modeled.)

### On/Off or Discrete Modes:

If certain variables v_r∈{0,1} represent whether a process is active, add constraints to ensure x_i≤v_r if that process must be “on” to accept materials.
Converting to a Quantum Optimization Model

Quantum solvers like QUBO or Ising minimize a cost Hamiltonian. Therefore:

### Define Cost Function

Since we want min S(C_k, X), we can treat S itself as the cost. If we were to maximize something, we would flip the sign. But here, it's already a minimization objective, so we can adopt Cost=S(C_k, X).
For QUBO, we typically have a purely quadratic polynomial in binary variables. If any of our x_i or v_i are continuous or fractional, we discretize them into binary expansions.
Binary Encoding
   If x_i∈{0, 0.2, 0.4, 0.6, 0.8, 1.0}, we can represent that with ┌log_2(6)┐=3 bits, or a more direct “one-hot” scheme.
   If the system absolutely requires “only one process,” a single binary variable might suffice.
If multiple discrete states exist (e.g., temperature mode low/medium/high), use 2 bits or a 3-bit one hot.
Add Constraint Penalties
Constraints like

Σ_i x_i=1 or x_i≤v_r,
can be encoded as penalty terms in the cost function, e.g.

Σ_{i=1}\hat{ }1x_i−1)\hat{ }2 λ(x_i−v_r)\hat{ }2,
so that any violation increases the cost heavily, pushing the solution to satisfy the constraint.

### The Final Hamiltonian H_IDS

Once the entire objective S(C_k, X) and constraints are expressed in binary variables (denoted collectively as a vector z∈{0,1}\hat{ }N), we assemble a QUBO (Quadratic Unconstrained Binary Optimization) function: H_IDS(z)=Σ_{p,q} Q_{p,q} z_p z_q+Σ_p Q_p z_p+constant term.

Where:

The linear and quadratic coefficients Q_p, Q_{p,q} reflect (1) the original scoring (⋅) and (2) the penalty terms for constraints. A sufficiently large λ ensures constraints remain satisfied in the minimum-energy (ground) state. Minimizing H_IDS(z) on a quantum solver (e.g. quantum annealer or QAOA on a gate-based quantum computer) seeks to find the bitstring z\hat{ }* that yields the lowest cost, which corresponds to the optimal or near-optimal combination of processes and material allocations (C_optimal, X_optimal, V_optimal).

In Ising form, we may convert each binary z_p∈{0,1} to a spin variable s_p∈{−1,+1} using z_p=½(1+s_p). The Hamiltonian typically is written as:

H_IDS(s)=Σ_{p,q}J_{p,q}s_p s_q+Σ_p h_p s_p+constant

### Hamiltonian Explicit Formulation

the Industrial Digestive System (IDS) Hamiltonian in a single, explicit expression that directly encodes both (1) the industrial process objectives and (2) the relevant constraints as penalty terms. This Hamiltonian H_IDS(z) is suitable for a QUBO or Ising-based quantum solver that seeks to minimize the total “energy” (cost). Notation for the Binary Variables: Process-Combination Selection. Let y_k∈{0.1} indicate whether we select combination C_k of processes. Often, we require Σ_k y_k=1 if exactly one chain of processes must be chosen. Material Flow Discretization: For each material m_i, we define a set of binary variables {x_{i,r}} that encode possible fractions or discrete amounts of m_i. For instance: x_{i,r}=1 if material m_i takes fraction level r, and 0 otherwise. Alternatively, if we have a multi-bit binary expansion for each m_i, we can denote them x_{i,1}, x_{i,2}, . . . ; On/Off or Discrete Mode Variables

If a process p can be “off” (0) or “on” (1), let v_p∈{0,1}. If we have multi-level modes (low/med/high), introduce one-hot or multi-bit binary variables. All these binary variables collectively form a vector z∈{0,1}\hat{ }N.

### Objective Function Components

Weighted Criteria Sum
Each combination C_k has criteria values c\hat{ }i_{kj} (the j-th criterion for process p in combination k) with weight w_j. When C_k is active (y_k==1), we add its total weighted criteria:

Obj_criteria(z)=Σ_k[y_k·(Σ_{p_i∈C_k}Σ_{j=1}\hat{ }m w_j c\hat{ }i_{kj})].
Output Mismatch or Desired-Output Term: Suppose we want to measure how closely the final product profile matches (O_1, O_2). Let Δ( . . . ) represent the difference (or penalty) from a target. We can define:

Obj_outputs(z)=Σ_k[y_k·Δ(AggregateOutputs(C_k, {x_{i,r}}),O_1,O_2)],

where AggregateOutputs(C_k, {x_{i,r}}) is a function of how the materials (encoded by x_{i,r}) flow through the processes in C_k.
If we merely sum up produced outputs, you might see an explicit sum: Σ_i, Σ_r x_{i,r}·a_i(C_k), and Δ compares that to (O_1,O_2).

### Penalty Terms (Constraints)

We encode constraints via penalty squares or penalty products. Examples:
Select Exactly One Combination
   Penalty_sel=α_sel(Σ_k y_k−1)\hat{ }2.
Flow Consistency
   If each material fraction must sum to 1 across discrete levels: Penalty_flow=α_flow Σ_{i=1}\hat{ }1(Σ_r x_{i,r}1\hat{ }2
Process Capacity
   If a process p has capacity Cap(p), we approximate the total flow Flow(p,z). A violation is penalized by: Penalty_cap=α_cap Σ_p(Flow(p,z)−Cap(p))_+\hat{ }2, where (⋅)_+ denotes max (⋅,0) if you only penalize exceeding capacity, or a full squared term if you do not allow any slack.
On/Off Logic
   If v_p=0 means a process cannot receive any flow: Penalty_logic=α_logic Σ_p[Flow(p,z)−M·v_p]\hat{ }2, with M a suitable “big enough” constant to represent full flow if v_p=1, or 0 if v_p=0.
      (Each α is a large coefficient ensuring the penalty is severe enough to enforce the constraint.)

### Putting It All Together: The IDS Hamiltonian

Combining the objective components and the penalty terms yields a single cost function:

H_IDS(z)=β_crit Σ_k[y_k·(Σ_{p_i∈C_k}Σ_{j=1}\hat{ }m w_j c\hat{ }j{kj})]+β_out Σ_k[y_k·Δ(AggregateOutputs(C_k, {x_{i,r}}), O_1,O_2)]+α_sel(Σ_k y_k−1)\hat{ }2+α_flow Σ_{i=1}\hat{ }1(Σ_r x_{i,r}−1)\hat{ }2+α_cap Σ_p(Flow(p,z)−Cap(p))_+\hat{ }2+α_logic Σ_p[Flow(p,z)−M·v_p]\hat{ }2+ . . . (any other relevant penalties).

### Key Structure:

β_crit and β_out weight how heavily we care about criteria vs. output mismatch.
α_sel, α_flow, α_cap, α_logic are large penalty multipliers ensuring constraint satisfaction.
All terms are in a form that can be expanded into purely linear and quadratic products of the binary variables z. For instance, (Σ_r x_{i,r}−1)\hat{ }2 expands into Σ_r x_{i,r}\hat{ }2−2Σ_r x_{i,r}+1+Σ_{r≠r′} x_{i,r}x_{i,r′}. Because x_{i,r}∈{0,1}, x_{i,r}\hat{ }2=x_{i,r}.

When minimizing H_IDS(z), the quantum solver will seek the assignment of binary variables that yields the lowest energy (best feasible solution).

### Ising Conversion (Optional).

If the quantum hardware uses Ising spins s_p∈{−1,+1} rather than 0/1 bits, each binary variable z_p can be mapped via: z_p=(1+s_p)/2⇔s_p=2z_p−1.

One simply rewrites the Hamiltonian with Σ_{p,q}J_{p,q} s_p s_q+Σ_p h_s_p form. The cost function is equivalent but expressed in {±1}-space. H_IDS(z) encodes all objectives (criteria satisfaction, desired outputs) and all constraints (selecting exactly one process chain, flow sums, capacity, on/off logic, etc.) in a single function to be minimized by the quantum solver. By choosing proper penalty coefficients, the lowest-energy (ground) state corresponds to a solution that respects constraints and optimizes the Industrial Digestive System's performance according to the stated metrics. The exact numeric coefficients α, . . . , β, . . . , M and the function Δ depend on the real industrial system's data and priorities. This explicit Hamiltonian format is what one typically sends to a QUBO solver (like a quantum annealer) or transforms into an Ising model for gate-based algorithms such as QAOA or VQE.

### Prior Art Analysis

Quantum Optimization in Industrial Processes and Manufacturing. Several existing patents and applications explore quantum optimization techniques for industrial and business problems. Many focus on formulating a classical optimization (e.g. scheduling, routing, resource allocation) as a problem that quantum computers or quantum-inspired solvers can tackle, often via hybrid quantum-classical approaches: Accenture's Multi-State Quantum Optimization Engine: Accenture's 2018 patent (Accenture Global Solutions Limited, U.S. Pat. No. 10,095,981) “Multi-state quantum optimization engine,” issued Oct. 9, 2018: press release cited as “Accenture Awarded U.S. Patent for Combining Classical and Quantum Computing With Potential to Address Previously Unsolvable Business Problems”) describes a hybrid engine that leverages quantum computing to improve business decision-making. It can run many simulations in parallel by combining classical and quantum processing. For example, in supply chain logistics, current classical solutions can only handle one or two simplified scenarios, whereas Accenture's approach lets a distributor explore significantly more what-if scenarios to optimize truck routes and delivery schedules (Accenture Global Solutions Limited, U.S. Pat. No. 10,095,981, “Multi-state quantum optimization engine,” issued Oct. 9, 2018: press release cited as “Accenture Awarded U.S. Patent for Combining Classical and Quantum Computing With Potential to Address Previously Unsolvable Business Problems”). This patent illustrates quantum algorithms being used to augment classical planning (e.g. optimizing delivery frequency and fleet usage) for better outcomes. However, it's essentially an offline decision support tool—it runs simulations to find optimal plans, not a live control system. Real-time process feedback or multi-objective control is not discussed. Infosys' Hybrid Quantum-Classical Optimization (2024): Infosys secured a patent for an enhanced hybrid quantum-classical mechanism that blends quantum and classical computing to solve combinatorial optimization problems (Infosys Limited, U.S. Pat. No. 11,907,807, “Method and system of enhanced hybrid quantum-classical computing mechanism for solving optimization problems,” issued Feb. 20, 2024, Justia Patents Search). The method uses a quantum-inspired genetic algorithm: it stores certain parameters (rotation angles θ) in classical memory to iteratively reinitialize a quantum circuit and generate improved candidate solutions (Infosys Limited, U.S. Pat. No. 11,907,807, “Method and system of enhanced hybrid quantum-classical computing mechanism for solving optimization problems,” issued Feb. 20, 2024, Justia Patents Search). This approach compensates for current hardware limits (like the lack of quantum RAM) by using classical memory as a workaround (Infosys Limited, U.S. Pat. No. 11,907,807, “Method and system of enhanced hybrid quantum-classical computing mechanism for solving optimization problems,” issued Feb. 20, 2024, Justia Patents Search). The patent suggests the technique can tackle problems like the Traveling Salesman Problem, vehicle routing in logistics, or optimal sensor placement in manufacturing (Infosys Limited, U.S. Pat. No. 11,907,807, “Method and system of enhanced hybrid quantum-classical computing mechanism for solving optimization problems,” issued Feb. 20, 2024, Justia Patents Search). This shows prior art on algorithms that mix classical and quantum steps to find better solutions. Like Accenture's, Infosys' approach targets static optimization instances (find the best route, layout, etc.) rather than controlling an ongoing industrial process in real-time. It does not address domain-specific issues of industrial systems (e.g. chemical reactions or waste flows), focusing instead on improving solution quality for generic combinatorial tasks. Entanglement, Inc. QUBO Formulations for Optimization: A number of patent applications by Entanglement, Inc. exemplify how industrial and financial optimization problems are encoded into QUBO (Quadratic Unconstrained Binary Optimization) form for quantum solving. One application for logistics management describes converting a distribution optimization problem into a QUBO, sending it to a quantum computer or quantum-inspired solver, and then converting the result back into actionable instructions for transferring items between inventory and demand locations (Entanglement, Inc., U.S. Patent Application Publication No. 2024/0394653, “Method and apparatus for logistics management using quantum computing,” published Nov. 28, 2024, Justia Patents Search). This method can dynamically choose the appropriate solver (quantum or classical) based on problem complexity (Entanglement, Inc., U.S. Patent Application Publication No. 2024/0394653, “Method and apparatus for logistics management using quantum computing,” published Nov. 28, 2024, Justia Patents Search). Similarly, for financial portfolio optimization, Entanglement proposes defining a probabilistic objective function from historical data and mapping it into a QUBO representation, which a quantum or quantum-inspired computer then solves (Entanglement, Inc., U.S. Patent Application Publication No. 2025/0014107, “QUBO Computing for Investment Optimization,” published Jan. 9, 2025, Justia Patents Search). These patents highlight a common prior-art strategy: formulate the industrial problem as a QUBO or Ising model, solve it with a quantum annealer or hybrid solver, and use the solution to guide decisions (e.g. how to allocate resources or schedule tasks). This is effective for discrete decision problems (routing, scheduling, investment allocation). The limitation is that the problem must be pre-defined and encoded before running on the QPU—so the approach is batch-oriented. There's no inherent mechanism for continuous sensor feedback or real-time updating within these patent disclosures. Other Quantum Applications in Industry: Beyond patents, industry efforts (e.g. by D-Wave and others) have demonstrated quantum optimization in manufacturing contexts such as production scheduling and supply chain management. These typically reduce complex scheduling problems to an Ising or QUBO model solvable by quantum annealers (Accenture Global Solutions Limited, U.S. Pat. No. 10,095,981, “Multi-state quantum optimization engine,” issued Oct. 9, 2018, press release cited as “Accenture Awarded U.S. Patent for Combining Classical and Quantum Computing With Potential to Address Previously Unsolvable Business Problems”). In general, prior art in this category shows quantum computing applied to industrial-scale optimization by translating real-world constraints into a form quantum hardware can handle. The focus is on achieving faster or better solutions to NP-hard problems (like scheduling, routing, resource planning) than classical methods alone. However, they largely address planning or design optimization, not the continuous control of a running industrial process.

Cyber-Physical Systems in Waste Processing and Chemical/Biofuel Production In parallel to quantum computing developments, there's rich prior art on cyber-physical systems (CPS) for industrial processes (waste management, chemical plants, biofuel production), typically using classical control and optimization techniques: Real-Time Optimization in Waste Management: A recent example is LoCI Controls' patent for optimizing landfill gas collection using real-time emissions data. LoCI's system places sensors to measure methane and CO₂ concentrations at landfill sites and adjusts gas extraction in real-time to maximize capture. This patent—the first to use direct emissions measurements for control-highlights how live sensor data and automated control can dramatically improve process efficiency (in this case, reducing greenhouse emissions). The approach is a classical one: sensors feed data to a cloud-based software which dynamically tunes valves and vacuum levels in the gas collection system. It embodies a CPS for waste processing (landfill gas is a form of waste-to-energy) with automated feedback control. Importantly, no quantum computing is involved—the optimization (balancing maximum gas capture vs. safety constraints) is handled by classical algorithms, likely rules or classical optimization (potentially model-predictive control or heuristic tuning). This indicates that prior art in waste processing does value real-time optimization, but has so far relied on classical computing. Complex decisions (e.g. adjusting dozens of wells across a landfill) must be simplified enough for classical solvers to handle quickly. Advanced Control in Biofuel and Chemical Processes: Industrial chemical processes (like biofuel production) commonly use Model Predictive Control (MPC) or similar advanced control algorithms to optimize performance. For instance, Rockwell Automation developed MPC techniques to optimize bioethanol production, by controlling a distillation process using steam from an upstream step. Their patented approach adjusts the steam temperature in real-time to balance energy usage against ethanol yield, improving overall efficiency of the distillation and dehydration stages. This is a classical optimization in a CPS: a predictive model of the process is used to find optimal control inputs (steam flow/temperature) that maximize throughput or yield while minimizing energy consumption. Such patents demonstrate that multi-objective optimization (energy vs. yield) is addressed in classical control systems by solving constrained optimization problems on-the-fly. However, classical MPC often requires a relatively tractable model (usually linear or quadratic) and can struggle with combinatorial or highly non-linear decisions. In cases where process conditions change or the system is very complex (e.g. heterogeneous reaction networks in waste-to-fuel conversion), classical controllers might need frequent re-tuning or may operate suboptimally because they cannot exhaustively search all control possibilities in real-time. AI and Automation in Process Industries: Some prior art also integrates machine learning with process control (though typically not quantum). For example, patents exist on using machine learning to predict reactor conditions or to perform adaptive control in chemical processes (fusion reactors, polymerization, etc.). These show that learning-based prediction and optimization can improve industrial processes, but again, they leverage classical computation. In waste-to-energy or recycling facilities, one might find patented systems for automated sorting, process monitoring, and route optimization (for waste collection) (LoCI Controls, Inc., press release titled “LoCI Controls Granted First-Ever Patent on Using Emissions Measurement to Optimize Landfill Gas Collection Operations”), all of which are part of the broader CPS landscape. They establish that industrial processes can be dynamically optimized by digital systems. Yet, none of this prior art applies quantum algorithms to these domains—the complexity of waste streams or chemical reactions hasn't been tackled with quantum computing in patents to date. This gap is precisely where the proposed Industrial Digestive System Quantum Optimization aims to innovate, by injecting quantum decision-making into a CPS that handles highly variable materials. Existing Hybrid Quantum-Classical Workflows in Industry Applications. Because current quantum hardware is limited (in qubit count, coherence time, etc.), many solutions use a hybrid workflow: splitting tasks between classical and quantum resources. Several patents emphasize this synergy: Hybrid Simulation and Optimization: Accenture's and Infosys' patents (mentioned above) are inherently hybrid-they propose running parts of the computation on classical machines (simulation of scenarios, storage of intermediate data) and offloading the hard optimization kernel to a quantum device (Accenture Global Solutions Limited, U.S. Pat. No. 10,095,981, “Multi-state quantum optimization engine,” issued Oct. 9, 2018; press release titled “Accenture Awarded U.S. Patent for Combining Classical and Quantum Computing With Potential to Address Previously Unsolvable Business Problems”) (Infosys Limited, U.S. Pat. No. 11,907,807, “Method and system of enhanced hybrid quantum-classical computing mechanism for solving optimization problems,” issued Feb. 20, 2024, Justia Patents Search). Accenture's system, for instance, might use classical computing to set up the scenario parameters and interpret results, while a quantum optimizer evaluates many combinations in parallel (Accenture Global Solutions Limited, U.S. Pat. No. 10,095,981, “Multi-state quantum optimization engine,” issued Oct. 9, 2018; press release titled “Accenture Awarded U.S. Patent for Combining Classical and Quantum Computing With Potential to Address Previously Unsolvable Business Problems”). This reflects a common pattern: use quantum where it potentially offers speed-up (e.g. evaluating many possibilities or escaping local optima), but surround it with classical pre- and post-processing.

Dynamic Solver Selection: Some prior art even explicitly allows choosing between quantum or classical solvers. In the logistics optimization method by Entanglement, Inc., the system can select a quantum computer, a quantum-inspired solver, or a classical computing array depending on the problem size and required speed (Entanglement, Inc., U.S. Patent Application Publication No. 2024/0394653, “Method and apparatus for logistics management using quantum computing,” published Nov. 28, 2024, Justia Patents Search). This kind of flexibility ensures that if the quantum hardware is unavailable or not efficient for a particular scale, a classical fallback (like a heuristic or GPU-based solver) can be used. The workflow remains hybrid and can be seen as an early form of adaptive orchestration between classical and quantum resources. However, this selection is typically manual or predetermined—it's about picking the right tool for a static problem rather than continuous collaboration during execution. Quantum+AI (Machine Learning) Workflows: A notable example of hybrid innovation is BASF's patent on quantum-assisted protein design. While not an industrial process control system, it's relevant as a domain-specific quantum-classical workflow. BASF's method uses AI/ML to generate an initial protein configuration, then uses a quantum computing algorithm to optimize that design by trying variations and scoring them (BASF SE, source titled “BASF's patent uses quantum computing to optimize protein design”. The highest-scoring protein candidate is selected as optimal, and importantly, experimental data from lab tests is fed back into the ML model to refine future iterations (BASF SE source titled “BASF's patent uses quantum computing to optimize protein design”. This closed-loop approach (AI proposes, quantum disposes, human or lab verifies, then AI learns) is a form of iterative hybrid workflow. It shows prior art where quantum algorithms and machine learning cooperate for a complex optimization task. The domain (protein engineering) is quite different from industrial waste processing, but the concept of using classical intelligence (ML) to guide quantum optimization—and using real-world feedback to update the model—is something the proposed invention similarly envisions (with sensors and process data instead of wet-lab experiments). One key difference: BASF's loop is batch iterative (design, then test, then redesign), not real-time control. Still, it underscores that patents are already recognizing the power of quantum-classical-physical interplay in solving hard problems. Overall, prior hybrid workflows show that quantum computing is rarely used in isolation. Classical computing is used to handle parts of the problem (e.g. data gathering, problem encoding, result verification) while the quantum part tackles the core optimization or simulation. This ensures robustness given current quantum limitations. What none of these hybrid prior solutions fully address is real-time or continuous operation in synchrony with a physical system-they solve discrete problem instances. The Industrial Digestive System Quantum Optimization is novel in proposing a truly cyber-physical hybrid loop that continuously runs. Encoding Methods for Quantum-Friendly Problem Representations. Formulating industrial optimization problems into quantum-friendly formats is a crucial step in most prior art. Common encodings include QUBO, Ising models, or parameters for quantum circuits: QUBO and Ising Encodings: As noted, many patents reduce problems to a QUBO or Ising Hamiltonian representation. In Entanglement's portfolio and logistics optimization methods, the objectives and constraints (whether investment returns vs risk, or fulfilling demands from warehouses) are encoded into a quadratic binary form (Entanglement, Inc., U.S. Patent Application Publication No. 2025/0014107, “QUBO Computing for Investment Optimization,” published Jan. 9, 2025, Justia Patents Search (Entanglement, Inc., U.S. Patent Application Publication No. 2024/0394653, “Method and apparatus for logistics management using quantum computing,” published Nov. 28, 2024, Justia Patents Search). Each decision variable becomes a bit/qubit, and penalties for violating constraints are added to the quadratic objective function. This encoding allows the use of quantum annealers (like D-Wave systems) or quantum-inspired algorithms to find low-energy (optimal) solutions. It's effective for combinatorial problems, but requires translation of real-world constraints into binary variables and penalty weights. For complex industrial processes, this translation can be non-trivial—e.g. how to encode a nonlinear chemical reaction yield or a continuous process variable into binary form. Prior art typically focuses on problems naturally suited to binary decision encoding (yes/no decisions, discrete choices). If a problem has continuous parameters or multiple objectives, the common approach is to discretize or linearize them, then embed into the QUBO. This classical preprocessing can introduce simplifications. Parameterized Quantum Circuits and Advanced Algorithms: Some emerging methods go beyond simple QUBO. For example, a recent patent application proposes encoding a portfolio optimization into an Ising Hamiltonian and then applying a digitized counter-diabatic driving method to design a parameterized quantum circuit that finds the solution efficiently (U.S. Patent Application Publication No. 2025/0045833, “Method for the Optimization of a Portfolio,” published Feb. 6, 2025, Justia Patents Search. In essence, it generates a tailored variational circuit (with minimal depth) for the specific optimization problem. This approach is related to the Quantum Approximate Optimization Algorithm (QAOA) and other variational algorithms, where one defines a parameterized circuit that is iteratively tuned (often with a classical optimizer) to minimize the problem's cost function. The existence of such patents indicates that variational hybrid algorithms (quantum circuits guided by classical parameter updates) are part of the prior art toolbox. They still require the problem to be expressed in a quantum operator form (Ising Hamiltonian or similar), but they avoid brute-force search by smartly navigating the solution space with the quantum circuit's interference patterns. Domain-Specific Encodings: While most patents use fairly general encodings, some implicitly include domain knowledge. For instance, if optimizing a chemical process, one might encode conservation laws or equipment capacities as constraint penalties in the QUBO. Rockwell's MPC approach (classical) doesn't involve quantum, but it's instructive: they created a model of how steam injection affects distillation and dehydration (Maina A. Macharia, Rockwell Automation-related research works, source listed as “Maina A. Macharia's research works|Rockwell Automation and other places” (Maina A. Macharia. Rockwell Automation-related research works, source listed as “Maina A. Macharia's research works|Rockwell Automation and other places”. An analogous quantum encoding would need to capture those cause-effect relationships in the cost function. Prior art in quantum optimization has not explicitly dealt with heterogeneous or time-varying inputs in encoding-usually all parameters are assumed known upfront when formulating the QUBO/Ising. If an industrial process has randomness (e.g. varying feedstock composition), classical approaches might use robust optimization or adaptive control, but quantum formulations to date haven't tackled that in a single model. In summary, encoding real industrial problems for quantum solvers is a known challenge. Prior solutions use QUBO/Ising for things like routing, scheduling, portfolio selection, where variables naturally map to bits. More complex or continuous problems are linearized or otherwise transformed. This often necessitates classical preprocessing and tuning of penalty weights to ensure the quantum solver gets a well-formed problem. The proposed invention builds on these encoding methods but extends them (e.g. combining multiple objectives and dynamic data streams into the encoded problem) in a novel way. Comparison to the Proposed Industrial Digestive System Quantum Optimization Invention. The Industrial Digestive System Quantum Optimization invention distinguishes itself from prior art in several key ways. Below we compare relevant prior approaches to this invention, focusing on quantum computing usage, integration with real-time process control, support for heterogeneous transformations, and other features: ⋅ Real-Time Quantum-Classical Process Control: Prior patents utilize quantum computing for planning or optimization in static scenarios, not for live control of an ongoing industrial process. For example, Accenture's supply chain optimizer runs simulations to pick an optimal strategy offline (Accenture Global Solutions Limited, U.S. Pat. No. 10,095,981, “Multi-state quantum optimization engine,” issued Oct. 9, 2018; press release titled “Accenture Awarded U.S. Patent for Combining Classical and Quantum Computing With Potential to Address Previously Unsolvable Business Problems”), and Entanglement's logistic QUBO yields a one-time distribution plan (Entanglement, Inc., U.S. Patent Application Publication No. 2024/0394653, “Method and apparatus for logistics management using quantum computing,” published Nov. 28, 2024, Justia Patents Search). None of these operate in a continuous feedback loop with a physical system. In contrast, the proposed invention integrates a quantum optimization engine directly into a real-time control system. Sensor data from the “industrial digestive” process (e.g. waste composition, reactor temperatures, output quality) is continuously fed into the optimization module, which uses quantum algorithms to compute optimal control actions on the fly. This real-time quantum-classical integration is novel-prior art in waste processing (like LoCI's landfill gas control) does use real-time data but only with classical control logic (LoCI Controls, Inc., press release titled “LoCI Controls Granted First-Ever Patent on Using Emissions Measurement to Optimize Landfill Gas Collection Operations”).
The presented invention is the first to embed a quantum solver within the control loop of an industrial plant, enabling quantum-informed adjustments in real time (for example, dynamically tuning a reactor's settings or flow rates in response to fluctuations in input waste). This capability addresses a gap in prior approaches, which lacked the speed or the approach to incorporate quantum decisions in millisecond-to-minute control cycles. Handling of Complex, Heterogeneous Material Transformations: The invention targets waste-to-(energy & materials) and chemical transformation systems with highly variable, multi-component inputs, akin to an “industrial digestive system” that must handle everything thrown into it. Prior quantum optimization patents mostly deal with well-defined, homogeneous problem spaces (e.g. a set of delivery routes, or a fixed network of investments) with clearly defined variables. They do not describe managing heterogeneous mixtures or unpredictable chemical reactions. By contrast, the proposed system is domain-adaptive: it's designed for processes like waste processing where feedstock composition can change unpredictably (mixed wastes, biomass, etc.), and where multiple conversion steps (sorting, chemical reactions, separations) are involved. The invention's algorithms incorporate domain-specific models (e.g. reaction kinetics, material flow constraints) into the quantum optimization. This is a significant differentiation-no prior patent explicitly teaches a quantum optimization method tailored to heterogeneous industrial feedstocks or complex multi-phase processes. Moreover, the invention supports complex transformation sequences (for example, optimizing a cascade of reactors, distillation columns, and generators in a waste-to-fuel plant), whereas prior art typically optimizes a single stage or a static combinatorial problem. In essence, the Industrial Digestive System optimizer acts like a brain (or the enteric nervous system) that can ingest messy, multi-faceted process data and make globally optimal decisions, something prior quantum solutions (focused on cleaner, discrete problems) were not equipped to do. ⋅ In general This multi-stage quantum cyber-physical system converts heterogeneous, potentially unclassified feedstocks into one or more usable products by orchestrating mechanical, chemical, physical, and biological operations across a network of processing stages, each stage targeting distinct forms and compositions of input material. It manages both well-defined feedstocks (such as pure chemical streams) and uncategorized or mixed waste, dynamically routing them to the most suitable transformation pathways via quantum-optimized control, ensuring seamless synergy among diverse process steps. ⋅ Multi-Objective Optimization with Quantum Penalty Encoding: Unlike earlier approaches that often optimize a single objective (e.g. cost, speed, or yield) at a time, the proposed invention tackles multiple objectives simultaneously by encoding them into the quantum problem. Traditional industrial optimizations frequently involve trade-offs—for instance, maximize throughput and energy efficiency and minimize emissions. Classical control (like MPC) handles this by combining objectives into a weighted sum or setting one objective as primary and others as constraints (Maina A. Macharia, Rockwell Automation-related research works, source listed as “Maina A. Macharia's research works|Rockwell Automation and other places”. Prior quantum patents tend to simplify or assume a single aggregate objective; any additional goals are handled by adding fixed penalty terms in the QUBO or by manual tweaking. Our invention explicitly formalizes a multi-objective cost function for the quantum optimizer: it uses quantum penalty terms to represent each objective and constraint within one unified formulation. For example, if increasing throughput starts to raise emissions, a penalty qubit representing emissions cost will incur a higher cost, guiding the quantum solver to find a better balance. This approach means the quantum computer is effectively evaluating a vector of objectives at once, finding solutions that best satisfy all (according to priority weights that can be adjusted in real-time). No prior art was found where quantum computing is used to natively handle multiple objectives of an industrial process in real-time. The novelty lies in how dynamic and flexible this encoding is—the penalty weights or constraints can be updated on the fly based on operator priorities or regulatory limits, and the quantum optimization immediately reflects those changes. Prior systems would require re-formulating the QUBO offline if objectives change, whereas here it's built into the live system.

Dynamic Adaptation and Learning: The proposed system is inherently adaptive, continuously updating its optimization model as conditions evolve. Prior quantum optimization methods lack dynamic adaptation-they solve a problem for given input parameters and output a static solution. If conditions change (new data, different constraints), one must manually set up a new optimization run. In our invention, the quantum-classical optimizer works in an iterative loop: it takes new sensor readings, updates the optimization problem (e.g. recalculates the state of the system and any deviations from targets), and invokes the quantum solver to re-optimize the control settings. This could be happening on a rolling basis (e.g. every few minutes or whenever significant deviations are detected). Essentially, optimization is not a one-shot computation but a continuous service in the system. This dynamic re-optimization draws inspiration from classical adaptive control and AI techniques, but applies them in a quantum context. Prior art like BASF's patent showed an iterative improve-and-learn cycle (with experiments feeding ML) (BASF SE, source titled “BASF's patent uses quantum computing to optimize protein design, but that cycle operates on design iterations, not a live process. Our invention's loop is closed and real-time: sensors→quantum optimizer→control actions→updated sensors, and so on. It effectively handles non-stationary conditions and process drifts, which prior quantum solutions (assuming static inputs) did not address. Additionally, by integrating machine learning (as mentioned in the next section of Embodiments), the system can improve its optimization model over time, learning from each cycle-something prior patents have only just started to explore in off-line contexts. Reduced Classical Preprocessing & Scalability: The novel system architecture mitigates some scalability and preprocessing issues seen in prior approaches. Because it is domain-specific, certain repetitive classical tasks (e.g. translating sensor data into a QUBO formulation) can be automated and accelerated. The invention likely employs on-site edge computing or dedicated preprocessors that instantly convert raw sensor readings into the normalized inputs required for the quantum optimizer, and does so in a streaming fashion. Prior art often required a human or an external system to set up the optimization problem (deciding the objective function, tuning penalty weights, etc. as a separate step) (Entanglement, Inc., U.S. Patent Application Publication No. 2025/0014107, “QUBO Computing for Investment Optimization,” published Jan. 9, 2025, Justia Patents Search). Here, those steps are built into the system's software: as data comes in, it automatically formulates the quantum optimization problem according to predefined models and objectives. This not only saves time but also reduces errors and ensures the quantum optimizer is always solving the current problem, not yesterday's approximation of it. Regarding scalability, current quantum hardware is a limiting factor (few tens of qubits for gate model, or a few thousand for annealing but with limited connectivity). The invention addresses this by using a hybrid approach and focusing quantum resources on the most computationally complex sub-problems. For example, a large industrial process might be decomposed: high-level scheduling and setpoints could be handled classically, while a particularly thorny combinatorial sub-problem (like optimal routing of material through parallel processors or an optimal selection of catalyst mix) is offloaded to the quantum solver. This selective use of quantum power ensures the system can scale to industrial-size problems today, even if that means using quantum annealers or small gate-model devices in tandem with classical optimizers. Prior patents acknowledge quantum computers are not yet fully capable for large-scale use and often resort to quantum-inspired classical solvers as a fallback (Infosys Limited, U.S. Pat. No. 11,907,807, “Method and system of enhanced hybrid quantum-classical computing mechanism for solving optimization problems,” issued Feb. 20, 2024, Justia Patents Search). Our invention turns that on its head: it puts quantum in the loop and uses classical methods as the backup or complementary support. The result is a more seamless integration—the system is built to get the best out of available quantum tech, without requiring impractical problem sizes. This is a clear differentiator from earlier approaches that treated quantum more as an experimental add-on rather than a core component of an industrial control system. In summary, the Industrial Digestive System Quantum Optimization invention introduces real-time, adaptive, multi-objective quantum control in a complex industrial domain, which is a substantial leap beyond the prior art. Previous patents show pieces of the puzzle (quantum optimization of static problems, classical real-time control of processes, hybrid computing frameworks), but none combine those pieces into a unified system that can handle the messy, dynamic reality of waste-to-energy & materials and biochemical, physical and mechanical transformation processes. The novel aspects-continuous quantum-classical feedback, quantum-encoded multi-objective optimization, and domain-specific adaptations-set this invention considerable from the existing patent landscape.

### Detailed Background.

System and Method for Hybrid Quantum Optimization in an Industrial Digestive System Background.

Industrial process optimization, especially in complex systems like waste-to-energy & materials converters and multi-stage chemical transformation plants, poses significant challenges. These “industrial digestive systems” process varied inputs (e.g. municipal waste, biomass, chemical feedstocks) through sequential reactions to generate useful energy and products. Optimizing such processes requires balancing multiple objectives in real-time—for example, maximizing energy output and throughput while minimizing emissions, cost, or undesired byproducts. The state space of possible control actions (valve positions, feed rates, temperatures, etc.) is enormous, and system dynamics are often non-linear and time-varying. Traditional optimization and control techniques struggle to meet these demands. Model Predictive Control (MPC) and advanced process control methods rely on mathematical models and solve an optimization problem at each step, but they become computationally intensive as the system size and number of constraints grow. In large-scale applications with many coupled variables, classical solvers can require exponential computation time as problem size increases. Heuristic approaches and rule-based controllers, commonly used to simplify operations, are typically tuned to nominal conditions. These methods cannot guarantee truly optimal performance and often only find suboptimal or steady-state solutions. They also lack flexibility: heuristic rules might not adapt well to unusual situations or rapid changes in feedstock or operating conditions. The limitations of classical techniques become pronounced in multi-objective, real-time optimization. Combinatorial explosion of possibilities means exhaustive search is impractical, and simplifying assumptions (such as linear models or decoupled control loops) lead to performance trade-offs. For instance, a waste-to-energy plant might need to decide the mix of various waste streams to feed, the oxygen levels, and catalyst settings—a combinatorial decision space where classical solvers (or human operators) resort to fixed schedules or trial-and-error. As industrial systems scale up, the number of design and operational constraints makes finding the optimal operating point extremely hard. In practice, operators often settle for a feasible solution rather than the true optimum due to time and computational limits. Quantum computing has emerged as a promising avenue to address these challenges. Quantum computers leverage phenomena like superposition and entanglement to process combinations of states in parallel, offering potential speed-ups for certain classes of problems. Notably, many industrial optimization problems can be mapped to forms (such as discrete combinatorial optimizations) that quantum algorithms may solve more efficiently than classical algorithms. For example, Grover's quantum search algorithm can find target solutions in roughly √N steps instead of N for an unstructured search, and quantum annealing can exploit quantum tunneling to escape local minima in complex energy landscapes. Early research indicates that quantum computing could dramatically outperform classical computing for complex optimization, exploring a broader solution space in less time (Accenture Global Solutions Limited, U.S. Pat. No. 10,095,981, “Multi-state quantum optimization engine,” issued Oct. 9, 2018; press release titled “Accenture Awarded U.S. Patent for Combining Classical and Quantum Computing With Potential to Address Previously Unsolvable Business Problems”). This potential is especially relevant for large-scale, real-time optimization of industrial processes, where classical methods either cannot handle the complexity or require unacceptable computation time to respond to live data, in summary, there is a clear need for a new optimization approach in industrial digestive systems. Existing control methods (MPC, heuristics, rule-based logic) are limited in scalability, adaptiveness, and solution quality for multi-variable, multi-objective scenarios. Quantum computing offers a fundamentally new toolset to tackle these optimization challenges, enabling the evaluation of many possible control configurations simultaneously and finding near-global optima under tight time constraints. The background therefore sets the stage for integrating quantum computing into the control architecture of industrial processes to overcome classical limitations and achieve superior real-time optimization performance.

### SUMMARY OF THE INVENTION

The present invention introduces a Hybrid Quantum Optimization Module integrated into an Industrial Digestive System (IDS) to vastly improve real-time, multi-objective process control. In essence, the invention augments a conventional industrial process control loop with a quantum computing element, creating a hybrid quantum-classical control system. This system continuously adjusts and optimizes the industrial process (e.g. a waste-to-energy plant) by leveraging quantum algorithms to evaluate complex control decisions, while classical control mechanisms maintain stability and handle routine adjustments. At a high level, the invention works as follows. Sensor data from the industrial process (temperatures, pressures, flow rates, compositions, etc.) are fed into a control system that includes the quantum optimization module. The module formulates an optimization problem reflecting the current state and goals of the process-such as maximizing energy output, maintaining safe operating conditions, and minimizing waste byproducts. This optimization problem is then solved using quantum computing resources in tandem with classical computing. The quantum module explores a vast combination of potential control settings simultaneously, enabled by quantum parallelism, and identifies an optimal or near-optimal set of control parameters (Accenture Global Solutions Limited, U.S. Pat. No. 10,095,981, “Multi-state quantum optimization engine,” issued Oct. 9, 2018: press release titled “Accenture Awarded U.S. Patent for Combining Classical and Quantum Computing With Potential to Address Previously Unsolvable Business Problems”). These optimized parameters (for example, setpoints for valves, feed rates, or reactor temperatures) are then fed back to the industrial system's actuators through the classical control interface. The classical control components (like PLCs or DCS controllers) implement the changes smoothly and safely. This process is repeated continuously or at high frequency, forming a feedback loop that keeps driving the system towards optimal performance even as conditions change. Crucially, the invention uses a hybrid quantum-classical approach. Rather than relying solely on a quantum computer or a classical computer, it combines the strengths of both. Quantum algorithms handle the combinatorial and high-dimensional aspects of the optimization-effectively searching through many possible configurations—while classical algorithms and controllers handle tasks like fine-grained control, constraint enforcement, and any parts of the optimization that are simpler or continuous in nature. This hybrid loop is adaptive: it updates the optimization in real-time based on live sensor data, meaning the system can respond to disturbances (like a sudden change in waste input composition or an equipment performance drift) by re-optimizing on the fly. Machine learning components can be incorporated to enhance this adaptivity, for example by predicting future trends or refining the optimization model as more data becomes available, but always in service of guiding the quantum optimization toward more effective solutions. In summary, the invention provides a quantum-enhanced control system for industrial processes. It introduces a new module into the industrial digestive system that continually seeks the best operating configuration via quantum optimization algorithms, and feeds those decisions into the process in real-time. By doing so, it overcomes the speed and complexity limitations of classical optimizers and achieves superior performance in waste-to-energy conversion efficiency, product yield, and operational stability. This hybrid system ensures that even extremely complex, multi-objective industrial processes can be optimized dynamically, unlocking higher efficiency and reliability than was previously possible with conventional control techniques.

Key features of the invention include:
Hybrid Quantum-Classical Control Loop: A feedback loop where a quantum optimization engine and classical controllers work together to adjust process parameters continuously.
Adaptive, Real-Time Optimization: The system iteratively updates the optimal setpoints based on live data, enabling rapid response to changes and disturbances.
Multi-Objective Decision Making: The quantum optimization module can handle multiple objectives (e.g. efficiency, throughput, and emission targets) by exploring trade-offs in a high-dimensional solution space that classical methods cannot fully search in real-time.
Integration with Existing Industrial Systems: The invention is designed to interface with standard industrial sensors and actuators, acting as an add-on module that enhances existing control systems. It is compatible with typical industrial hardware and protocols, ensuring it can be retrofitted or integrated into current plants.
Quantum Algorithm Flexibility: Depending on the problem at hand, the module can employ different quantum algorithms (quantum annealing, gate-based quantum circuits, or hybrid variational algorithms) best suited for the optimization problem formulation. This flexibility ensures the best use of available quantum hardware for each task.
Machine Learning Enhanced: Optionally, artificial intelligence models are incorporated to assist in modeling the process and fine-tuning the optimization parameters, improving the efficiency of the quantum computations and providing predictive insights that further refine control actions.
Through this combination of features, the invention provides a robust and powerful Industrial Digestive System Quantum Optimization capability that significantly outperforms conventional control and optimization methods in complex industrial environments.

### DETAILED DESCRIPTION

### System Architecture.

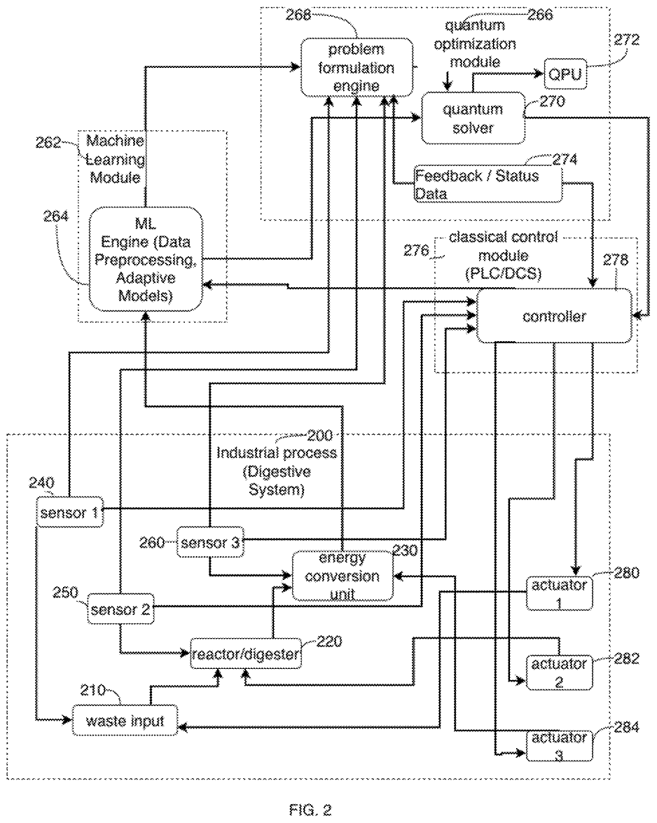

The hybrid quantum-optimized industrial control system is organized in a layered architecture integrating physical process components with advanced computational modules. FIG. 2 provides an overview of the system architecture, illustrating how sensors [240, 250, 260], controllers [278], and quantum computing elements [266, 270, 272] interact in the process loop. At the base is the Industrial Digestive System (IDS) process itself—the physical plant [200]. This encompasses all reactors, digesters [220], conveyors, burners, or other units [230] that transform waste [210] into energy or chemical products. The process [200] is instrumented with an array of sensors [240, 250, 260] (temperature probes, pressure sensors, flow meters, chemical composition analyzers, pH sensors, etc.) throughout various stages. These sensors [240, 250, 260] continuously monitor the state of the process [200], capturing crucial data about operating conditions and performance (for example, reactor temperatures, biogas production rate, exhaust composition, etc.). The sensor outputs feed into a Data Acquisition and Processing Layer. In this layer, raw sensor signals are aggregated, filtered, and time synchronized. Preliminary computations may be done here by classical means—for instance, calculating derived values (like efficiency or conversion rate from multiple sensor inputs) or detecting anomalies. This layer ensures that the subsequent optimization module [266] receives a coherent, up-to-date snapshot of the system's state at each control interval. It may also incorporate simple predictive models (using machine learning [262, 264] or statistical methods) to forecast short-term trends, such as an impending spike in reactor pressure, which can be factored into the optimization.

To prevent noisy physical sensor data from corrupting continuous mathematical optimization loops, the Data Acquisition and Processing Layer may employ a dual-layer error mitigation pipeline. In a first layer, detected physical hardware anomalies or analog sensor drifts are translated into quantitative uncertainty weights. These uncertainty weights are appended to the optimization state vector, dynamically altering the exploration variance of the downstream quantum optimization [266] without requiring a strict probabilistic framework. Specifically, the Dual-Layer Error Mitigation Pipeline calculates a dynamic penalty modifier based on the real-time physical variance (σ²_sensor) of the analog telemetry over a temporal window. For a given constraint penalty λ, the error-mitigated penalty injected into the compiled Hamiltonian is modified by a confidence decay function, for instance:

λ′=λ·exp(−κ·σ\hat{ }2),

where κ is a tunable sensitivity parameter. This programmatic linkage ensures that as a physical sensor [240, 250, 260] degrades or drifts, the quantum compiler [268] dynamically softens the mathematical boundaries around that specific variable, steering the optimization solver [270] away from relying on faulty hardware.

In a second layer, post-execution quantum processing unit (QPU) [272] noise mitigation is applied to the solver [270] outputs. Central to the invention is the Quantum Optimization Module [266], which resides in the control architecture above the data processing layer. This module [266] comprises both software and hardware elements dedicated to formulating and solving the optimization problem using quantum computing resources. It includes:
A Quantum Industrial Problem Compiler [268], which translates the current state and objectives of the industrial process [200] into a mathematical optimization problem (detailed in the next sections). This engine [268] uses the sensor data and desired performance targets (set by operators or preset objectives) to set up the cost function, constraints, and decision variables representing the problem to be solved. In some embodiments, the Quantum Industrial Problem Compiler [268] may act as an industrial problem compiler configured to convert live continuous and discrete industrial or experimental states, objectives, and constraints into quantum-computable forms. To capture the live process state, the engine [268] may generate a timestamped optimization snapshot representing a coherent state vector of the physical environment at a specific instant. This optimization snapshot may include current objective terms and categorized constraints, such as hard safety limits or soft operational targets. The engine [268] may be configured to perform continuous-variable discretization, transforming continuous analog parameters into quantum-compatible variables using generic methods such as binary expansions or discrete binning.

To provide traceability between the quantum solver [270] and the physical plant [200], the system may employ a variable dictionary. This dictionary maps the compiled logical variables back to physical plant identifiers, equipment mapping IDs, or experimental parameters. The variable dictionary may also store metadata such as variable IDs, engineering units, allowable bounds, and the generic discretization method applied. Following compilation, the formulation engine [268] may emit a serialized artifact suitable for solver ingestion. The emitted artifact may comprise, but is not limited to, QUBO coefficients, Ising spin coefficients, a Hamiltonian term list, or parameterized circuit descriptors, thereby ensuring the system can interface with generic quantum or quantum-inspired backends without hardware lock-in.

In some embodiments, the problem formulation engine [268] may generate a structured optimization snapshot and associated solver artifact to preserve traceability between the physical industrial process [200], the logical variables processed by the quantum solver [270], and the solver-compatible representation submitted to a quantum processing unit (QPU) [272] or other backend. The following non-limiting illustrative example shows one possible schema for such an optimization snapshot and emitted solver artifact.

### Non-Limiting Illustrative Example: Optimization Snapshot and Artifact Schema

(Fields and names are illustrative and do not need to appear verbatim.)

```
{
- ″snapshot_id″: ″snap_generic_001″,
  ″timestamp″: ″YYYY-MM-DDTHH:MM:SSZ″,
  ″objectives″: [
  {″metric″: ″maximize_yield″, ″weight_parameter″: ″w_yield_param″},
  {″metric″: ″minimize_energy″, ″weight_parameter″: ″w_energy_param″, ″type″: ″penalty″}

[symbol]

[symbol]


  ″constraints″: [
  {″tag″: ″capacity_limit″, ″type″: ″hard_inequality″, ″penalty_multiplier″:
″lambda_cap_param″},
  {″tag″: ″mass_balance″, ″type″: ″hard_equality″, ″constraint_representation″:
″penalty_or_constraint_preserving_method″}

[symbol]

[symbol]


  ″variable_dictionary″: [

[symbol]

{
  ″logical_id″: ″z_0_to_z_3″,
  ″mapping_id″: ″plant_tag_reactor_temp_A″,
  ″units″: ″Celsius″,
  ″bounds″: {″min″: ″T_min_param″, ″max″: ″T_max_param″},
  ″discretization_method″: ″binary_expansion″

[symbol]

[symbol]


},
{
  ″logical_id″: ″z_4″,
  ″mapping_id″: ″plant_tag_valve_B″,
  ″units″: ″boolean″,
  ″bounds″: {″min″: 0, ″max″: 1},
  ″discretization_method″: ″native_binary″

[symbol]

[symbol]


}

[symbol]

  ″emitted_artifact″: {
  ″artifact_type″: ″QUBO_coefficient_matrix″,
  ″payload″: ″serialized_matrix_or_term_list″,
  ″mapping_table_ref″: ″variable_dictionary_id_or_pointer″
}

[symbol]

[symbol]


{
```

After generation of the solver-compatible artifact, the artifact may be passed to a Quantum Solver Interface configured to connect the problem formulation engine [268] and the quantum solver [270] to quantum computing hardware, including a quantum processing unit (OPU) [272] or a remote quantum backend.
A Quantum Solver Interface, which connects to quantum computing hardware.

Depending on implementation, this could be a direct interface to an on-site quantum processing unit (QPU) [272] or a network/cloud interface to remote quantum computers. The interface handles preparing the optimization problem in the format required by the quantum algorithm (for example, constructing a QUBO matrix or encoding an oracle circuit) and sending it to the quantum hardware. It also retrieves the results (candidate optimal solutions) returned by the quantum computer [272].
Optionally, a Hybrid Coordinator, which manages the interplay between quantum and classical computations. For instance, it may decompose the optimization into sub-problems (solving part on classical hardware and part on quantum, if needed), or iteratively refine the problem based on partial results. This component ensures a seamless integration so that any limitations of the quantum hardware (like qubit count or runtime) are mitigated by offloading parts of the computation to classical solvers when necessary.
Alongside the quantum module, the architecture retains a Classical Control Module [276] that works in parallel. This includes traditional control systems (PID controllers, PLCs, DCS logic, or MPC solvers) responsible for low-level actuation and safety. The Classical Control Module [276] receives either direct control setpoints from the Quantum Optimization Module [266] or works collaboratively by providing baseline control actions that the quantum recommendations can fine-tune. For example, a PID loop may maintain a reactor temperature near a target, while the quantum module [266] periodically adjusts that target for optimal efficiency. This dual-layer control ensures that even between quantum optimization cycles, the process is kept stable and within safe limits by classical feedback controllers [278].
The Actuators [280, 282, 284] form the output layer of the control system. These include devices such as valves, pumps, heaters, coolers, mixers, and motors that physically adjust the process. The actuators [280, 282, 284] respond to control signals coming from either the classical controllers [278] or directly from the quantum module's output (depending on configuration). In practice, the Quantum Optimization Module [266] might compute high-level setpoints (e.g. “increase feed rate to X kg/hour and heater temperature to Y °C”) which are then handed off to the classical control system [276] to execute. The classical system [276] might ramp valves or adjust power gradually to reach the new setpoints without overshoot, ensuring smooth implementation of the quantum module's decisions.
Finally, all layers form a closed-loop system. Once actuators [280, 282, 284] implement changes, the process state shifts, sensors [240, 250, 260] detect the new state, and the data is fed back into the optimization cycle. This feedback loop, enhanced by quantum computation, continuously drives the system toward optimal operating conditions. The architecture is designed to be modular and hardware-agnostic: the quantum module [266] can interface with different quantum computing platforms (annealers, gate-based QPUs, etc.), and the whole system can be attached to various industrial setups with minimal modifications. Through this layered integration, the invention creates a unified system architecture where quantum computing is embedded into the heart of industrial process control. The result is a highly adaptive “smart” industrial digestive system that can self-optimize in real time, coordinating advanced computational resources with physical equipment to achieve performance levels unattainable by conventional architectures.

### Quantum Optimization Methods

The core of the invention is the mathematical and algorithmic formulation of the industrial optimization problem in a manner amenable to quantum solution.

The system converts the real-world process optimization into an abstract problem that a quantum computer can solve efficiently. There are multiple methods to achieve this, depending on the nature of the decision variables (discrete vs. continuous) and the available quantum hardware. The invention supports several formulation techniques, ensuring that the most suitable quantum method can be applied to each sub-problem of the industrial process. At the heart of most formulations is casting the optimization as a combinatorial problem. Many control decisions in an industrial process [200] can be represented in binary or discrete terms: for example, turning on/off a specific subsystem, choosing one of several operational modes, or selecting a discrete level for a setting (high/medium/low). Even ostensibly continuous parameters (like flow rates or temperatures) can be discretized into a finite set of levels for the purposes of an optimization step. By representing decision variables as binary or discrete values, the optimization can be expressed as finding the best combination of those binary choices that optimizes the objectives while satisfying constraints.

One powerful formulation used in this invention is the Quadratic Unconstrained Binary Optimization (QUBO) model. In a QUBO representation, the problem is encoded as a quadratic cost function of binary variables. Each binary variable might represent a decision (e.g., whether to open a valve, or whether to allocate waste to Digester A vs. Digester B). The cost function is constructed such that its minimum corresponds to the optimal or desired outcome. For example, the cost function could include terms that penalize low energy output, high emissions, or violation of constraints (like exceeding a pressure limit). It may also include terms that encourage energy efficiency- or throughput. The quadratic terms allow representation of interactions between decisions—for instance, if opening valve 1 and valve 2 together creates an inefficiency, a positive quadratic penalty term can represent that interaction. The goal is then to find the set of binary variable values (0/1 decisions) that minimize this cost function.

Quantum annealers (such as those from D-Wave Systems) and certain gate-model algorithms are naturally suited to solving QUBO formulations. A QUBO problem can be directly mapped onto the energy landscape of a quantum annealer: binary variables correspond to qubits (or groups of qubits), and the cost function is interpreted as an Ising Hamiltonian (with linear and pairwise interaction terms) that the annealer will attempt to find the lowest-energy state for. In practice, this means the annealer tries many configurations of the variables simultaneously (through quantum superposition and tunneling) and tends to settle on the combination that yields the lowest cost, thus solving the optimization. This invention leverages that capability by formulating the industrial control optimization as a QUBO whenever appropriate. For example, determining the optimal combination of waste feedstock distribution to multiple digesters and the on/off states of auxiliary burners could be framed as a QUBO, with constraints (like resource limits or required outputs) added as penalty terms in the cost. The quantum annealer then finds the combination of feed distribution and burner states that minimize the penalty-weighted cost, effectively giving an optimal operating plan.

For problems that involve continuous variables or more complex relationships, the invention employs a hybrid quantum-classical decomposition. Not all aspects of an industrial process [200] can be neatly discretized without loss of fidelity. For instance, fine control of a continuous parameter like temperature might require more precision than a binary variable can directly offer. In such cases, one method (as an embodiment) is to split the optimization problem into sub-problems: a discrete part and a continuous part. The discrete part (such as on/off decisions, or discrete choices like which reactor to route flow into) is handled via quantum optimization (e.g., QUBO or other quantum algorithms), while the continuous part (like optimizing around a setpoint given those discrete choices) is handled by a classical solver or control algorithm. The system can iterate between these: for example, fix a candidate set of discrete decisions and optimize continuous parameters classically, then adjust the discrete decisions via quantum computing given the refined continuous outcomes, and repeat-until convergence or improvement stops (Akshay Ajagekar, Travis Humble, and Fengqi You, “Quantum Computing based Hybrid Solution Strategies for Large-scale Discrete-Continuous Optimization Problems,” arXiv:1910.13045, 2019: DOE). This approach harnesses quantum power for the combinatorial explosion where it's most needed, and uses classical computation for the parts it handles well (continuous convex optimizations, etc.). The invention's architecture explicitly allows such iterative quantum-classical solving to ensure all types of variables are optimized.

Another formulation strategy included in the invention is using oracle-based search for certain problems. In scenarios where the goal is to find any solution (or a particular solution) that meets a set of criteria (as opposed to optimizing a continuous cost metric), the problem can be framed for Grover's quantum search algorithm. For example, suppose there is a specific target output (a desired range of calorific value in the output gas) and we want to find which combination of settings yields that target. We can construct a quantum oracle that, given a candidate set of control variables (encoded in qubits), checks whether the resulting outcome meets the target criteria. Grover's algorithm can then amplify the amplitudes of qubit states that satisfy the oracle (i.e., “good” solutions) and find such a solution in roughly √N iterations (where N is the number of possible combinations). While constructing an oracle for a physical process [200] might involve a simplified model or training a binary classifier as part of the quantum circuit, the invention contemplates such use for cases where a yes/no feasibility or threshold objective is key. This approach can be useful for constraint satisfaction problems within the industrial system—for instance, finding a configuration that does not violate any safety constraints while still meeting a minimum performance level.

In the context of gate-model quantum computers, the invention also leverages variational algorithms for optimization, notably the Quantum Approximate Optimization Algorithm (QAOA) and the Variational Quantum Eigensolver (VQE). QAOA is a procedure where a parameterized quantum circuit alternates between applying an operator related to the cost function and a mixing operator, with classical parameters that are tuned to gradually improve the solution. QAOA can produce approximate solutions for combinatorial optimization problems and is well-suited for current quantum hardware (NISQ devices). Within the invention, QAOA could be used instead of (or in addition to) quantum annealing for problems formulated as QUBO/Ising models, especially if using gate-based quantum hardware. The VQE, on the other hand, is a hybrid algorithm where a quantum computer prepares a parameterized quantum state and a classical optimizer adjusts those parameters to minimize the expected value of a given Hamiltonian (which represents the cost). VQE is traditionally used for finding ground-state energies in quantum chemistry, but the invention envisions its use in scenarios where the industrial process optimization can be mapped onto finding the minimal energy (or cost) of a constructed Hamiltonian. For example, if one needs to optimize a continuous function or a nonlinear objective, one could encode that as a Hamiltonian and let VQE iteratively approach the optimum with the quantum system evaluating the “energy” of each trial state. The advantage is that the quantum device can encode complex superposition states that might represent mixtures of configurations, potentially exploring the landscape more broadly than a classical heuristic.

In summary, the invention encompasses multiple quantum optimization methods: Using QUBO/Ising formulations to represent industrial optimization problems and solving them via quantum annealing or QAOA on gate-based QPUs. Utilizing hybrid decomposition, solving discrete decision parts on quantum hardware and continuous parts on classical systems, possibly iterating between them for refinement (Akshay Ajagekar, Travis Humble, and Fengqi You, “Quantum Computing based Hybrid Solution Strategies for Large-scale Discrete-Continuous Optimization Problems,” arXiv:1910.13045, 2019; DOE). Framing certain tasks as quantum search problems and using Grover's algorithm for rapid identification of feasible solutions among many possibilities. Employing variational quantum algorithms (QAOA, VQE) for problems that fit those frameworks, benefiting from their hybrid nature to tackle optimization with limited quantum resources. This flexible methodology ensures that the system can tackle a wide range of optimization challenges within an industrial digestive system, picking the right tool for each problem element to achieve an overall optimal solution.

### Encoding Strategies

To utilize the quantum optimization methods described, the invention provides robust encoding strategies for translating real-world industrial parameters and objectives into quantum-representable forms. Encoding is a critical step—it involves defining how sensor readings, control variables, and performance goals are transformed into bits and qubits for processing by classical and quantum algorithms, respectively. The invention supports several encoding techniques to accommodate different data types and constraints in the industrial process.

Binary Variable Encoding: Many control decisions can naturally be encoded as binary variables. For example, the state of a pump (on/off), the selection of one process path versus another, or whether a certain threshold is exceeded can all be represented by a bit (1 or 0). The encoding strategy first involves identifying all such decision points in the process that can be treated in binary terms. Each such decision is then assigned to a qubit or a bit in the QUBO formulation. The cost function is encoded such that these bits interacting will model the objective. For instance, if two actions should not be taken simultaneously due to a conflict, the encoding includes a term in the QUBO that heavily penalizes the bit configuration where both corresponding qubits are 1 at the same time. Similarly, if a particular action is highly desired, the cost function gives a lower penalty when that action's bit is 1. By these means, the encoding translates operational preferences and constraints into numerical coefficients in the QUBO or Hamiltonian that the quantum solver [270] will handle.

Multi-Objective Encoding: Industrial optimizations typically involve multiple objectives (e.g., maximize output, minimize cost, minimize emissions). The encoding strategy handles this by constructing a single composite cost function that reflects all objectives. A common approach included in the invention is weighted-sum encoding: each objective is given a weight reflecting its importance, and all are summed into one cost function. These weights can be tuned (and even adaptively adjusted by the system or via machine learning [262, 264]) to guide the optimization towards different trade-off solutions. Alternatively, a lexicographic or hierarchical encoding can be used, where the most critical objective is encoded as the primary part of the cost function and secondary objectives are added as penalties that come into play only when primary objectives are equal. The flexibility in encoding multi-objective functions allows the system to either find a single balanced optimum or to run multiple optimizations with varying weights to map out a Pareto optimal set of solutions. The invention's architecture allows rapid re-encoding with different weights. To facilitate rapid adaptation, the system may expose a Dynamic Multi-Objective Weight Tuning API. This API is configured to ingest real-time external signals—such as fluctuating market commodity prices, financial risk factors, or grid energy demands—and programmatically inject updated scalar weights directly into a pre-compiled quantum Hamiltonian in-memory. By utilizing continuous state injection, the system applies targeted delta-updates to active optimization model parameters, bypassing the latency of a complete graph recompilation when minor sensor drifts or economic shifts occur.

Constraint Encoding: Constraints (such as physical limits or safety requirements) are encoded directly into the optimization formulation to ensure that any solution the quantum solver [270] returns is valid for the real system. In a QUBO model, constraints are typically handled by adding penalty terms. For example, if a constraint says “valve A and valve B cannot both be open at the same time,” the encoding adds a large positive coefficient to the quadratic term for the pair of binary variables (A, B) such that the cost is high (undesirable) when both A and B are 1. For numerical constraints like “temperature must stay below T_max,” the encoding might involve discretizing the temperature range into binary variables (bits representing the temperature level) and adding penalties for states that correspond to exceeding T_max. In a quantum circuit model, constraints can be encoded via the oracle (for Grover's algorithm) or baked into the Hamiltonian for QAOA/VQE such that states violating constraints have high energy and thus are avoided. By penalizing constraint violations heavily, the quantum optimization is effectively steered to consider only those states that satisfy all requirements, or else the few that violate are clearly suboptimal and thus not chosen as the result.

Mapping Continuous Variables: For parameters that are continuous (like flow rates, concentrations, etc.), the invention uses discretization or binary expansion encoding. Discretization means defining a finite set of allowable values for a parameter (for instance, low/medium/high or a stepwise range 0%, 20%, 40%, . . . , 100% of a pump's capacity). Each discrete level can either be represented by a dedicated binary variable (which would require one-hot encoding with additional constraints to ensure only one level is chosen at a time), or by binary digits (bits) that in combination represent the magnitude (like a binary number). For example, a temperature setpoint could be represented by 3 qubits giving 8 possible levels of adjustment. The encoding ensures that the cost function gives favorable values to the appropriate combination of those bits corresponding to the optimal temperature. One consideration is precision: more qubits allow finer resolution but increase problem size. The invention's adaptive approach allows using coarser encoding initially and refining it if needed (possibly by zooming into a range with a subsequent optimization).

Temporal Encoding: In processes with sequential decision-making or scheduling (e.g., scheduling waste input batches or timing of maintenance actions), time can be encoded by replicating variables across time steps. For example, if optimizing a 1-hour horizon in 5-minute intervals, a control decision like “add chemical X” might be represented by 12 separate binary variables (one for each interval). The cost function would then include terms coupling these across time if there are dynamic penalties (like frequent switching costs). The invention includes strategies to manage the large number of qubits such temporal expansions would require, such as focusing the quantum optimization on the most critical time windows or using sliding time windows to optimize in phases rather than all at once.

Example Encoding: To illustrate, consider a simplified waste-to-energy optimization: decide how to split an input waste stream [210] between two digesters A and B to maximize total biogas output, under the constraint that each digester has a processing capacity. We could encode the fraction of waste [210] to A in increments of 10% (giving 11 levels from 0 to 100%). That can be represented by four binary variables (which can make 16 combinations, of which 11 are actually used). We add a constraint penalty to ensure only one combination representing 100% allocation is chosen (or two variables approach via binary representation). The cost function might be Cost=−(Gas_A+Gas_B)+Penalty where Gas_A and Gas_B are functions of the allocation represented by the binary variables (perhaps obtained from a model or interpolation of known data), and Penalty term is large if allocation exceeds capacity or if the binary combination is invalid. This QUBO is sent to the quantum solver [270]. The encoding thus turns a fluid allocation problem into a series of bits that the quantum hardware can manipulate, finding the bit pattern that gives the lowest cost (highest gas output without violating capacity). By employing these encoding strategies, the invention ensures that real-world industrial parameters are accurately and efficiently translated into the quantum domain. The result is that the quantum algorithms operate on a representation that truly corresponds to the industrial objectives and constraints, guaranteeing that solutions found by the quantum optimizer are meaningful and directly applicable to the physical system.

### Quantum Algorithm Selection

Depending on the formulated problem and the available quantum hardware, the system selects appropriate quantum algorithms to solve the optimization. The invention is not restricted to a single quantum algorithm; rather, it provides a framework that can deploy various quantum algorithms as needed, either individually or in combination. The selection is adaptive—the system may choose one algorithm for one type of problem or subsystem and another for a different context, even switching on the fly if conditions change or if one approach is not yielding good results. Some of the key quantum algorithms and approaches supported include:—

Quantum Annealing (QUBO Solvers): For many discrete optimization problems encoded as QUBO or Ising models, quantum annealing is a natural choice. A quantum annealer (like D-Wave) physically implements a process where an initial superposition of all possible states is gradually evolved (via quantum fluctuations) towards a state that minimizes the given Ising Hamiltonian (which corresponds to the cost function). The system uses quantum annealing solvers for tasks such as scheduling, resource allocation, and configuration optimization in the IDS [200]. Quantum annealing has been demonstrated to solve certain optimization instances faster than classical heuristics. In this invention, when a QUBO is formulated (as described in earlier sections), the controller [278] sends it to a quantum annealer which returns one or more candidate solutions (bit strings with low cost). If the hardware supports it, the system can also retrieve a distribution of low-energy solutions, not just one, which can be useful to evaluate multiple near-optimal configurations (for example, giving the operator a choice or preparing fallback settings). The selection of annealing parameters (like anneal time, number of runs) can be tuned by the system or via an AI assistant to balance speed vs. solution quality.

Quantum Gate Algorithms (QAOA): On gate-model quantum computers (such as IBM Quantum or Rigetti QPUs), the Quantum Approximate Optimization Algorithm (QAOA) is utilized for similar discrete optimization tasks. QAOA involves preparing a trial solution as a quantum state through a circuit with adjustable angles. The system sets up the QAOA by encoding the cost function as part of the quantum circuit (using phase separator operators corresponding to cost terms) and then runs the circuit multiple times, adjusting parameters to maximize the probability of measuring a low-cost solution. QAOA is particularly useful on near-term devices because it's somewhat robust to noise at shallow depths and can be combined with classical parameter optimizers. The invention's controller [278] can run QAOA in a loop: it chooses an initial set of parameters (possibly informed by prior solutions or an educated guess), runs the quantum circuit to evaluate the cost (obtained by measuring the qubits and computing the cost from the measurement outcomes), then uses a classical optimizer to tweak the parameters, and repeats. This hybrid cycle continues until it converges to a good solution. QAOA can naturally handle constraints by phase-encoding heavy penalties for illegal states, similar to annealing. The system might prefer QAOA over annealing in cases where more control over the algorithm is desired or when using cloud-based gate QPUs where QAOA can be executed.

Grover's Search: As mentioned in encoding strategies, when the problem is framed as finding a needle in a haystack (a specific configuration satisfying an oracle), Grover's algorithm is selected. The system constructs the quantum oracle as a circuit that flags valid/target states (for example, outputs a particular qubit state |1> for solutions that meet certain output criteria). Then it runs the Grover iterative amplification process, which consists of applying the oracle and a diffusion operator repeatedly. After ~√N iterations (N being the search space size), measuring the qubits yields the solution with high probability. In practice, Grover's may be used sparingly in this invention, for example for calibration or initialization tasks: the system might employ it to find initial feasible configurations that satisfy hard constraints, which then become starting points for further optimization by other algorithms. Or, if the system needs to solve a discrete choice problem with a clear success criteria (yes/no outcome), Grover's provides a quadratic speedup advantage. The controller [278] ensures the oracle is correctly constructed and that the quantum hardware can support the necessary number of qubits and gate operations for Grover's algorithm (which can be demanding). In some embodiments, when strict constraint satisfaction is required across an unstructured logical search space, a feasibility oracle implements an iterative thresholding mechanism (Grover Adaptive Search). In some embodiments, the oracle flags combinatorial states exceeding a baseline operational threshold. Upon discovery of a successful candidate configuration via amplitude amplification, an orchestrator tightens the benchmark threshold and re-executes the search. This adaptive refinement loop reduces the evaluated feasibility subspace over iterations, accelerating identification of candidate setpoints consistent with constraints.

Variational Quantum Eigensolver (VQE): For problems that involve continuous optimization or quantum chemistry aspects (e.g., optimizing a reaction pathway or catalyst performance within the industrial process [200]), VQE might be selected. In VQE, the system defines a Hamiltonian representing the energy or cost of the system configuration. This could be directly related to the industrial process [200] for instance, a Hamiltonian whose ground state energy corresponds to the minimum energy state of a chemical reaction network or a state of maximum efficiency. The quantum computer [272] then prepares a parameterized quantum state, and through repeated measurements, the expectation value of the Hamiltonian (the “energy”) is estimated. A classical algorithm adjusts the parameters to lower this energy, iteratively approaching the ground state (optimal solution). The invention can use VQE to incorporate quantum simulations into the optimization loop. For example, if part of the process [200] involves a complex chemical reaction, a small quantum circuit might simulate that reaction's yield at a quantum level, and VQE would adjust parameters (like a catalyst's properties encoded as qubit rotations) to maximize yield. This is an advanced embodiment, showing that the system is extensible into domains where quantum simulation and optimization intersect. VQE has shown exceptional performance for certain problems by splitting work between quantum and classical resources, and our system uses it to refine solutions when an accurate quantum-mechanical model is beneficial (though often this might be offline or slower than annealing/QAOA, so potentially used in lower-frequency optimization tasks or design phases).

Hybrid Quantum-Classical Solvers: The system can also utilize hybrid algorithms offered by quantum solution providers, such as hybrid solvers that combine classical algorithms with quantum calls internally. For instance, D-Wave's Hybrid Solver Service can automatically partition a large problem into pieces that fit on the quantum annealer and solve iteratively, or it might use classical heuristics to guide the quantum search. The invention's architecture is flexible to call such solvers through its interface. In practice, this means the system doesn't always manually handle the decomposition; it can offload to a black-box hybrid solver that returns an answer, benefiting from the vendor's optimized methods. The selection mechanism in the controller [278] will decide if a problem is too large for direct quantum solving and if so, route it to a hybrid solver. The selection criteria for choosing among these algorithms involve considerations such as problem size, variable count, time available for computation, and the nature of the objective/constraints. For example, if the control cycle is extremely fast (say sub-second adjustments) and only a relatively small decision needs to be made, the system might choose a simpler or faster algorithm (like a quick QAOA with one or two layers, or an analog quantum device if available) to meet the time requirement. If the problem is large but can be split, it might simultaneously run multiple smaller QUBOs on an annealer (or sequentially if limited by one QPU) [272] focusing on different parts of the plant. If certain decisions are identified as the bottleneck for optimal performance, those might be singled out for quantum treatment while others are handled classically. In sum, the invention's control system is algorithm-agnostic but optimization-centric—it will deploy whichever quantum algorithm is best suited to solve the current optimization problem given the hardware and time constraints. This dynamic selection ensures maximum effectiveness of the quantum resources and integrates seamlessly with the classical parts of the controller [278]. By having this flexibility, the system is future-proof as well: new quantum algorithms or improved versions of the above can be incorporated as they become available, further enhancing the system's optimization capabilities.

### Real-Time Adaptive Control.

A defining aspect of this invention is its ability to perform optimization in real-time, continuously adapting to the changing state of the industrial process. Traditional optimizers might compute a static optimal plan and then attempt to follow it, but in a live industrial setting, disturbances and uncertainties (like feedstock variability or equipment aging) can quickly render any static plan suboptimal. The invented system, by contrast, implements an ongoing adaptive control strategy, where it repeatedly re-optimizes and steers the process toward optimal conditions at each moment.

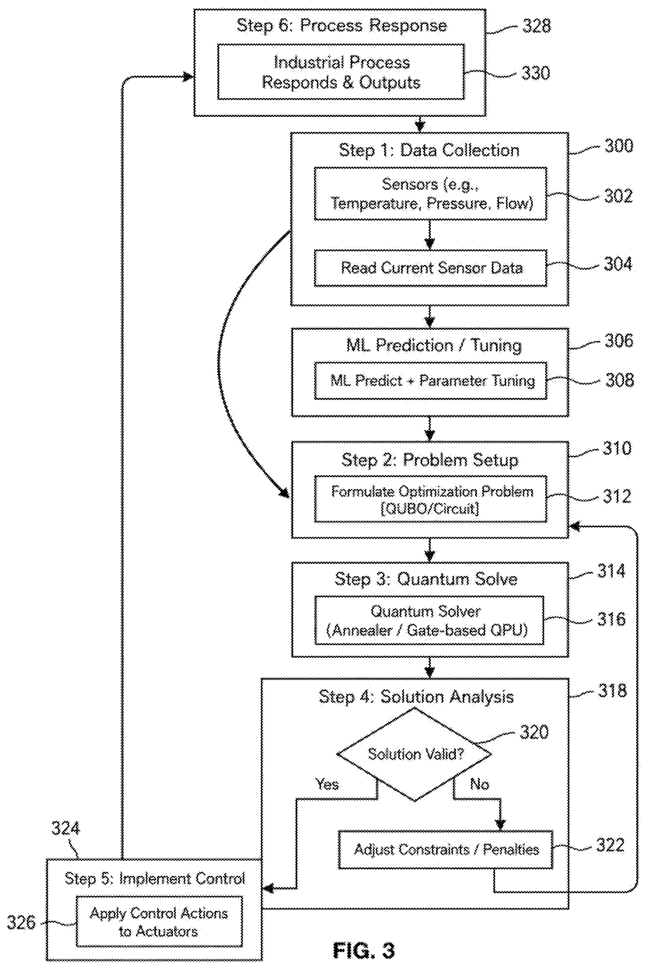

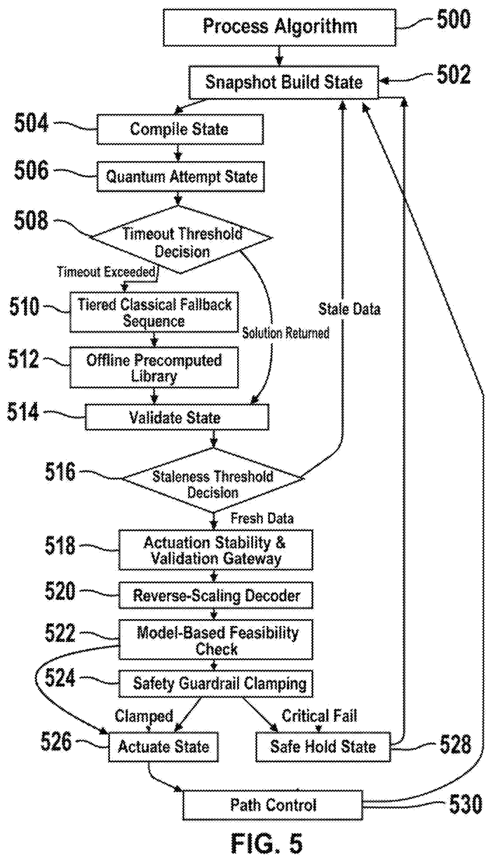

The real-time control workflow, illustrated in FIG. 3, can be described as an iterative loop with the following steps:
Data Acquisition [300]: At time t_0, the system collects the latest sensor measurements [302] from across the industrial digestive process. This yields a comprehensive snapshot of the state (e.g., current temperatures, pressures, tank levels, reaction rates, etc.) along with key performance indicators (current energy output, emissions readings, etc.). The data may also include recent historical trends or predictions (for instance, the rate of change of temperature, or an expected increase in feedstock moisture content based on upstream sensing).
Optimization Problem Update [310]: The Quantum Industrial Problem Compiler updates the optimization model with the new data. This means recalculating the cost function with the current state as the starting point. Constraints are checked and updated—for example, if a certain component is nearing a safety threshold, that will be reflected as a constraint to not exceed in the optimization. Objectives might be dynamically adjusted if needed (for example, during peak energy demand hours, the weighting on energy output objective might be increased). Essentially, the mathematical representation (QUBO or otherwise) [312] is refreshed to reflect “If I were to choose control actions now, what is the optimal choice from this new state?”.
Quantum-Computation Trigger [314]: The system decides whether a quantum optimization cycle is needed at this moment. In many cases, it will run every cycle (continuous mode). In others, it might skip if the state hasn't changed significantly or if a prior solution is still near-optimal (this is a configurable aspect to save unnecessary computation). Suppose at t_0 it decides to run—the updated optimization problem is sent to the quantum solver [316] (annealer or gate QPU or hybrid solver as selected). The quantum hardware then processes the problem. During this quantum computation phase, which could last from microseconds to a few seconds depending on hardware and algorithm, the classical control module continues to manage the process (maintaining the last setpoints, keeping things stable). To robustly manage asynchronous quantum optimization tasks alongside deterministic classical control loops, the system may employ a Latency-Aware Hybrid Orchestrator. The orchestrator, as shown in FIG. 5, may govern solve selection and execution flow via a defined state machine or equivalent policy, mediating between a quantum computation attempt [506] and a classical fallback solver [510]. In some embodiments, the orchestrator evaluates a configurable staleness threshold parameter [516] against the optimization snapshot's timestamp. If the latency between snapshot generation and solver return exceeds this staleness threshold parameter [516], the snapshot may be deemed stale, and the orchestrator may discard the proposed solution and trigger a recompile to ensure actuation relies on fresh physical data. Additionally, the orchestrator may monitor a configurable timeout threshold parameter [508] during the quantum execution phase. Upon a timeout or hardware delay, the orchestrator may transition control to a deterministic classical fallback solver [510] to maintain continuous operation. Validated solutions that pass these temporal checks may be required to pass through a strict cyber-physical safety gate [518] before any actuation commands are dispatched to the programmable logic controllers (PLCs) or downstream actuators. In scenarios involving persistent computational failures, stale data, or severe environmental disturbances, the orchestrator may direct the system into a predefined safe-hold mode [528].

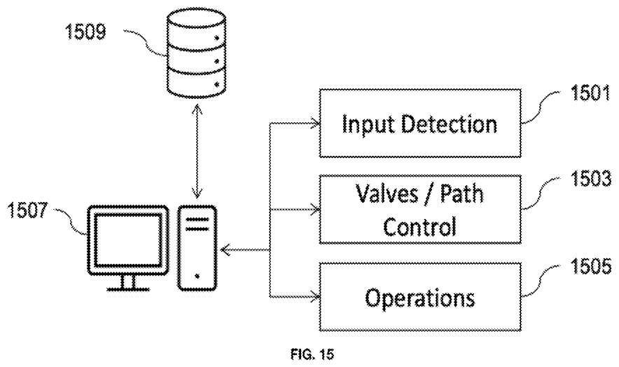

FIG. 5 is a state machine flowchart illustrating a cyber-physical runtime orchestrator and validation gateway configured to mediate quantum computation attempts, classical fallback routing, and safety decoding prior to physical actuation. FIG. 5 illustrates the state management and deterministic safety logic governed by the central Process Algorithm [500]. The continuous control loop advances through a Snapshot Build State [502] and Compile State [504]. Upon entering the Quantum Attempt State [506], the system monitors a Timeout Threshold Decision [508] leveraging a symbolic timeout_threshold parameter. If execution exceeds the specified threshold, control routes to a Tiered Classical Fallback Sequence [510] that utilizes an Offline Precomputed Library [512] to maintain plant operation. If a solution is successfully returned, it transitions to a Validate State [514] featuring a Staleness Threshold Decision [516] to discard outdated control parameters. Fresh logical bitstrings enter the Actuation Stability & Validation Gateway [518]. A Reverse-Scaling Decoder [520] de-quantizes the variables, passing them to a Model-Based Feasibility Check [522]. Parameter violations trigger Safety Guardrail Clamping [524] to project variables into safe operational bounds, or transition the system to a Safe Hold State [528] if unrecoverable. Validated setpoints advance to the Actuate State [526], routing bounded actuator commands directly to Path Control [530], corresponding to the Valves/Path Control function [1503] shown in FIG. 15, before returning to close the continuous loop.

### Non-Limiting Illustrative Example: Orchestrator State Machine Policy

| Current State | Transition Condition/Event | Next State/Action |
|---|---|---|
| SNAPSHOT_BUILD | State vector captured & dictionary | COMPILE [504] |
| [502] | mapped | |
| COMPILE [504] | Artifact serialization complete | QUANTUM_ATTEMPT [506] |
| QUANTUM_ATTEMPT | Solution returned within | VALIDATE [514] |
| [506] | timeout threshold parameter [508] | |
| QUANTUM_ATTEMPT | Wait time exceeds | FALLBACK_CLASSICAL |
| [506] | timeout threshold parameter [508] | [510] |
| VALIDATE [514] | Solution timestamp exceeds | RECOMPILE/return to |
| | staleness threshold parameter [516] | COMPILE [504] |
| VALIDATE [514] | Solution violates cyber-physical | SAFE_HOLD [528] |
| | safety limits | |
| VALIDATE [514] | Solution passes safety bounds and | ACTUATE [526] |
| | freshness | |
| ACTUATE [526]/ | Control actions dispatched/handled | SNAPSHOT_BUILD [502] |
| FALLBACK_ | | |
| CLASSICAL [510] | | |

Quantum Result Processing: The quantum solver [316] returns a result-typically a set of optimized decision variables. For a QUBO on an annealer, this might be the lowest-energy bit string found (e.g., which valves to open=1, which to close=0, which discrete level for each pump, etc.). For a QAOA or VQE, it may be the measurement outcome that corresponds to the optimal found or the parameters that give best result. If multiple solutions are returned (some solvers can return a list of top candidates), the system can either choose the best or further evaluate them via a classical model (for example, simulate each candidate quickly through a digital twin of the plant to see which performs best, providing a double-check). The machine learning component [262] can assist here by quickly estimating the outcomes of each candidate solution, if needed, to pick the best one.
Actuation: The chosen optimal control actions are then transmitted to the actuators through the classical control interface, as part of the implement-control stage [324]. This could be instantaneous if the action is discrete (like an on/off switch), or gradual if it's a continuous change (the classical controller might ramp a setpoint to avoid shocks). For example, if the quantum optimizer suggests increasing Digester A's feed and decreasing Digester B's feed, the control system will start adjusting the feed valve positions accordingly. The system ensures that these changes are done within safe limits—it might impose rate-of-change limits or coordinate multiple actuators to maintain balance (like not shutting one feed completely before the other ramps up to avoid starving the system). This implementation step [326] is critical and leverages the reliability of classical control to implement quantum decisions.
Monitoring and Verification: As soon as the control changes begin to take effect (or even concurrently), the system closely monitors sensor feedback [302] to verify that the changes are producing the expected effect. For instance, if the goal was to increase biogas output, the system watches the gas flow rate and composition to ensure it is trending up without undesired side effects like a temperature spike. If the outcome deviates from what the optimization model predicted (perhaps due to an unmodeled disturbance or noise), the system can flag this discrepancy. Minor deviations might simply be absorbed in the next cycle's re-optimization. Major deviations or any sign of constraint violation triggers immediate safety controls (the classical system might override and stabilize first).
Iteration: The process then repeats at the next time step t_1=t_0+Δt. The frequency Δt of this loop can vary—it could be as fast as milliseconds in some sub-systems or every few minutes in slower processes. The key is that over time, the loop continuously nudges the system toward optimal conditions. If a disturbance occurs at 2:00 pm, by 2:01 pm the system might have already re-optimized and adjusted controls to counter it. The adaptive loop can catch trends—for example, if feedstock quality is gradually dropping over an hour, the quantum optimizer will gradually shift the operating strategy to compensate, maintaining optimal output as much as possible throughout. ⋅ This real-time iterative optimization effectively implements a self-learning control mechanism. Each cycle, the system learns from the latest data [300] and applies the best known action. Over many cycles, especially with the integration of machine learning [262], the system can improve its model of the process (for example, better predict how the process responds to certain actions), which in turn makes future optimizations more accurate. Thus, the longer the system runs, the better it can potentially perform, as it refines both its understanding of the plant and finds improved strategies. ⋅ It's important to note that the invention is designed to operate within practical time constraints of real industrial processes. Quantum computing currently may have latency (especially if using remote cloud QPUs) or require multiple runs for statistical confidence. The control loop is configured to accommodate this by either running asynchronous to the main control (the classical controllers keep things stable while quantum compute takes perhaps a slightly longer interval and updates setpoints when ready) or by using fast quantum hardware like on-premises annealers that can deliver solutions in sub-second times. The hybrid nature ensures that even if a quantum computation occasionally takes longer, the classical backup is always regulating the system in the interim. Once the quantum result arrives, it can be applied at the next feasible moment. This ensures no single-point failure or delay compromises safety or stability. In summary, the real-time adaptive control enabled by the invention means the industrial digestive system is always operating at the “peak” of its performance curve given current conditions. Rather than periodically resetting or needing manual, re-tuning, the system is continuously self-optimizing. This leads to improved efficiencies (because any drift from optimum is quickly corrected), better handling of disturbances (the system reacts faster than human operators or off-line optimizations could), and the ability to juggle objectives dynamically (for example, if market prices or demands change, the system can re-target a new optimal output mix immediately).

Machine Learning Integration. Machine learning (ML) is incorporated into the invention as a complementary component [262] that enhances the effectiveness of the quantum optimization and overall control. While the quantum algorithms handle the heavy lifting of combinatorial search and optimization, machine learning provides predictive analytics, system modeling, and parameter tuning that make the optimization smarter and more efficient over time. Several integration points for ML are included:

Predictive Modeling: One of the primary uses of ML in the system is to create predictive models or “digital twins” of the industrial process. Using historical operational data, the system can train models (e.g., neural networks, gradient boosted trees, or even simple regression models) that predict the outcome of certain control actions. For example, given a set of proposed control inputs (like feed rates and temperatures), the model could predict the expected energy output and emission levels. These predictions can serve as a fast proxy for evaluating the cost function of different candidate solutions without always running the full physical process or a complex first-principles simulation. In the context of the quantum optimizer, an ML model might be used to estimate the cost for a candidate solution during iterative optimization (especially in hybrid or variational algorithms). This speeds up the optimization by providing quick feedback on solution quality, guiding the search away from poor regions of the solution space early. Additionally, predictive models can forecast disturbances—e.g., predicting how the composition of incoming waste will change in the next hour-allowing the quantum optimization to proactively adjust before changes actually hit the process. Optimization Parameter Tuning: Many aspects of the quantum optimization require choosing certain parameters—e.g., weights in the multi-objective cost function, annealing schedule settings, QAOA initial angles, or penalty coefficients for constraints. Instead of relying solely on human experts to set these, the invention uses AI algorithms to auto-tune them. A reinforcement learning (RL) agent could be deployed that observes the performance of the system (reward being, say, total efficiency or profit) and tweaks these parameters over many trials to maximize the reward. Similarly, Bayesian optimization or evolutionary strategies can be used to adjust parameters like the trade-off weights between objectives or to calibrate the penalty strengths such that constraints are respected without over-penalizing (which can make the optimization too conservative). Overtime, this ML-driven tuning [306] finds a sweet spot for these parameters, which directly improves the quality of the quantum optimization outcomes. For example, if the ML agent learns that the quantum solver [316] tends to find better solutions when the cost function emphasizes one particular metric slightly more, it will adjust the weights accordingly in future iterations.

State Classification and Scenario Recognition: The ML component [262] can classify the current state of the industrial process or detect which “scenario” is happening. Industrial processes often have modes or regimes (e.g., startup, steady operation, high-load, low-load, maintenance mode). Using techniques like clustering or classification (e.g., a decision tree or a neural network classifier), the system can identify the current regime based on sensor patterns. This is useful because different regimes might benefit from different optimization strategies or algorithm choices. For instance, during startup, safety and stability might be prioritized over efficiency (so the cost function weights change), and the controller might temporarily not push certain optimizations. Or in a high-load scenario, the quantum module might focus more on redistributing loads to avoid bottlenecks. Recognizing the scenario via ML allows the system to dynamically switch configurations or select pre-trained models/optimizers suited for that regime. It's akin to having multiple playbooks and using ML to pick the right one for current conditions.
Anomaly Detection and Fault Management: ML techniques (like anomaly detection algorithms or predictive maintenance models) can identify when the system's behavior is deviating abnormally-perhaps due to a sensor fault, equipment degradation, or an unexpected situation not seen in training. If the ML detects an anomaly (for example, a sensor reading combination that doesn't make physical sense, or a performance metric that suddenly drops out of pattern), it can alert the optimization module. The optimization might then incorporate additional constraints (like assuming that part of the system is malfunctioning and re-routing flows) or trigger a safe mode. This integration ensures that the quantum optimization isn't operating under false assumptions—e.g., if a sensor is reading incorrectly, the ML-detected anomaly can prevent the optimizer from trusting that data blindly. It effectively acts as a safeguard and ensures robustness.
Learning from Quantum Results: Another novel integration is using ML to learn patterns from the solutions provided by the quantum optimizer. Over time, as the system runs, it will generate a lot of optimized configurations for various situations. These can be fed into a machine learning model to discern patterns like “When feedstock has property X, the optimal strategy often involves setting parameter Y high.” The system can then generalize these patterns to speed up future decisions. In practice, this might mean the next time a similar situation arises, the system has a good initial guess (derived from ML memory) of what the optimal solution might look like, which it can then use to initialize the quantum solver [316] or to narrow the search space. This hybrid of quantum output and ML pattern recognition essentially leads to a continuously improving system—as if the controller is learning heuristics from the quantum computer's behavior. This can also shorten quantum computation time since a better initialized QAOA or a smaller QUBO (focusing on likely active variables) can converge faster.
Neural Network Quantum Circuit Co-design: In advanced embodiments, the boundary between ML and quantum can blur. There are approaches where a neural network can output the parameters for a quantum circuit (for QAOA or VQE) given the current state, essentially learning a direct mapping from plant state to good quantum solutions. Such a network could be trained offline via simulation or historical data. At runtime, it would provide a near-instant estimate of the optimal control, which can either be directly used or used as a warm start for the quantum optimization. This is at the cutting-edge, but the invention allows such extensions, demonstrating its forward-looking design.
By integrating machine learning at multiple levels, the invention ensures that the quantum optimization is not working in isolation but is augmented by intelligence that evolves with the system. ML helps to handle uncertainties, tune the system, and even compensate for some limitations of quantum hardware by guiding it. The outcome is a more reliable, faster, and smarter optimization process. Over the lifespan of the industrial plant, as more data is gathered, the combination of ML and quantum computing in this system can lead to continuous improvement, adapting not just to immediate changes but also to long-term shifts like catalyst aging or seasonal feedstock variation. The synergy between ML and quantum makes the whole greater than the sum of its parts: quantum algorithms explore solutions in ways classical ML cannot, while ML provides context and learning that quantum algorithms lack. Together, they enable the industrial digestive system to achieve near-optimal performance consistently and autonomously, with minimal human intervention needed for retuning or oversight.

### Automated Discovery Engine Grounding (“Alchemist” Mode):

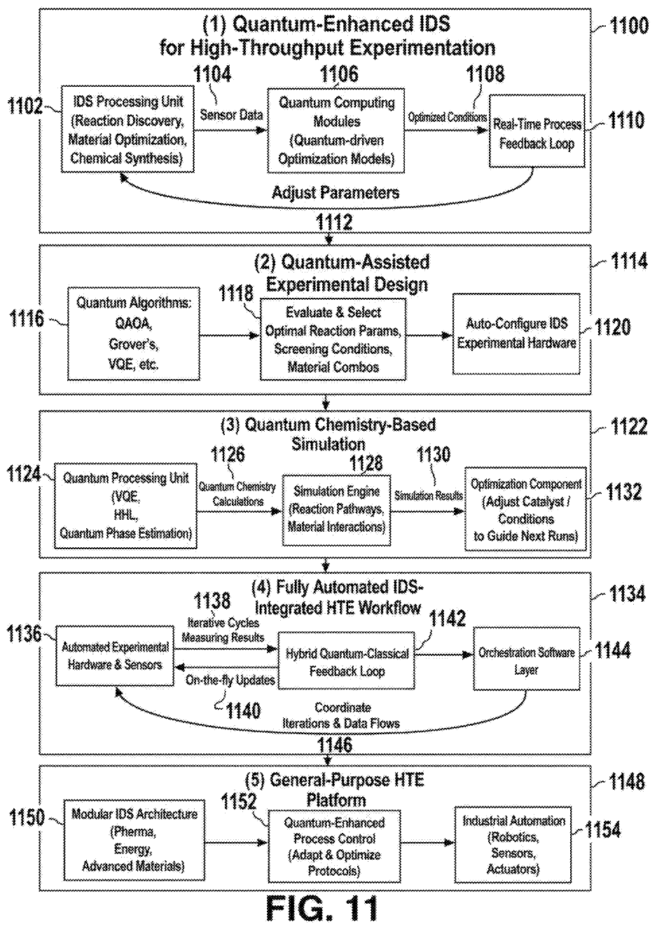

In advanced embodiments serving as an automated discovery engine, the system is strictly grounded as a closed-loop driver of physical experimentation hardware, as shown in FIG. 17, 11, 4. Rather than abstractly deriving scientific laws as a mental process, the hybrid quantum-classical machine learning module [1712] generates hypothesis states [1716] parameterized strictly as programmatic data vectors [1714]. These vectors are automatically dispatched via an instrument abstraction API to physical robotic payloads FIG. 11 [1136, 1154] to trigger real-world material assays. The system computationally scores the divergence between the predicted state vector and the resulting physical assay telemetry [1734], iteratively adjusting its formulation constraints [1740] to mechanically falsify operational hypotheses without manual human-in-the-loop intervention.

In some embodiments, the Alchemist orchestrator [1712] applies its closed-loop optimization logic [1742] to an Industrial Digestive System (IDS) mathematical model in which industrial inputs I (feedstocks or material lots) are processed through a sequence and/or network of transformations {T_k} to produce measured outputs ŷ [1710, 1734] (product properties and yields). In some embodiments, Alchemist constructs a target specification vector y\hat{ }* (desired product signature) and compiles an objective that minimizes a discrepancy between the target and empirically observed outcomes, for example L(x)=∥y\hat{ }*−ŷ(z))∥ (or another monotone error metric), subject to equipment, safety, and quality constraints [416]; decision variables x may include continuous or discretized setpoints [410], allocation variables, and discrete on/off or routing selections [412], while fixed variables encode immutable plant conditions and validated operating envelopes. In some embodiments, the quantum compiler maps this objective and its constraint penalties [416] into a bounded solver-ready representation (e.g., QUBO/Ising and/or a parameterized circuit) and emits serialized artifacts [418] for backend dispatch [420] and Alchemist selects or routes to one or more backends and interprets returned bitstrings/spins into engineering setpoints for actuation after feasibility checks

FIG. 5 [520, 522, 526] By way of an illustrative petrochemical IDS example, we can include a hydrocarbon feed characterized by assay telemetry [1710, 1734], {T_k} may include a conversion unit (e.g., severity-controlled cracking or hydroprocessing) followed by separation and blending, and y\hat{ }* may specify a target product slate and properties (e.g., sulfur, boiling-curve indices, and yield distribution). In some embodiments, x includes unit severity indices, recycle ratios, cut-point settings, and blend fractions, optionally with discrete routing/gating variables for enabling or bypassing polishing paths, and constraints include capacity limits and safety envelopes encoded as penalties [416] in the compiled form, [418]. In some embodiments, Alchemist [1712] executes a closed loop [1742] in which telemetry [402] updates the IDS state [408] (e.g., feed composition proxies and analyzer measurements), the formulation is recompiled by the quantum compiler, candidate solutions are solved, decoded, validated, and dispatched [520, 522, 526], and subsequent measurements [1734] update ŷ(x) to iteratively reduce deviation from y\hat{ }*.

### Non-Limiting Illustrative Example: Pharmaceutical Discovery Closed-Loop Via Alchemist IDs (FIGS. 11 and 17)

To further illustrate the closed-loop grounding of the “Alchemist” discovery engine [1712], the system may apply the Industrial Digestive System (IDS) mathematical model directly to an automated pharmaceutical High-Throughput Experimentation (HTE) pipeline [1134]. In an illustrative embodiment, the objective is to synthesize a novel drug formulation by minimizing the mathematical divergence (Δ) between empirical physical results and an optimal target product profile (O_n, such as a specific dissolution rate or pharmacokinetic property).

The problem formulation engine [268] defines a set of physical input materials M (e.g., an active pharmaceutical ingredient such as acetylsalicylic acid m_1, alongside selected excipients m_2), a set of available physical processes P (e.g., micronization p_1, wet granulation p_2, and tablet compression p_3), and a set of operating variables V (e.g., solubility pH, mechanical compression force). The Alchemist engine [1712] computationally generates a scientific hypothesis formatted as a specific combinatorial process chain (C_k). For example, the engine may hypothesize a combination specifying a micronization transformation (p_1) fixed at an operating variable of pH=7.0, followed by a granulation transformation (p_2).

This hypothesis is encoded into the overarching system Hamiltonian (H_IDS) [700], specifically targeting the output mismatch penalty term [703]: Δ(AggregateOutputs(C_k, {x_i}), O_n). The global quantum-accelerated optimizer [709] explores the combinatorial space of fractional material allocations (x_i) [708] for the acetylsalicylic acid and excipients to find the optimal energetic state that minimizes this predicted Δ.

Crucially, the quantum solver's candidate solution [270] is automatically translated via an instrument abstraction API into executable machine instructions. The cyber-physical IDS robotic handlers and automated reactors [1136, 1154] physically execute the precise micronization, granulation, and compression sequence on the acetylsalicylic acid batch. In-line analytical sensors [1136] then empirically measure the resulting physical tablet's actual solubility profile. The Alchemist engine [1712] ingests this real-world telemetry [1104, 1734], calculates the true empirical Δ against the target O_n, and autonomously updates its internal surrogate models and Hamiltonian penalty weights [1718, 1740] for the next iteration. This closed loop physically mechanizes a modelization of classical scientific method, anchoring quantum-derived chemical hypotheses to deterministic robotic actuation [1154] and empirical physical validation, [1738].

### Hardware Compatibility

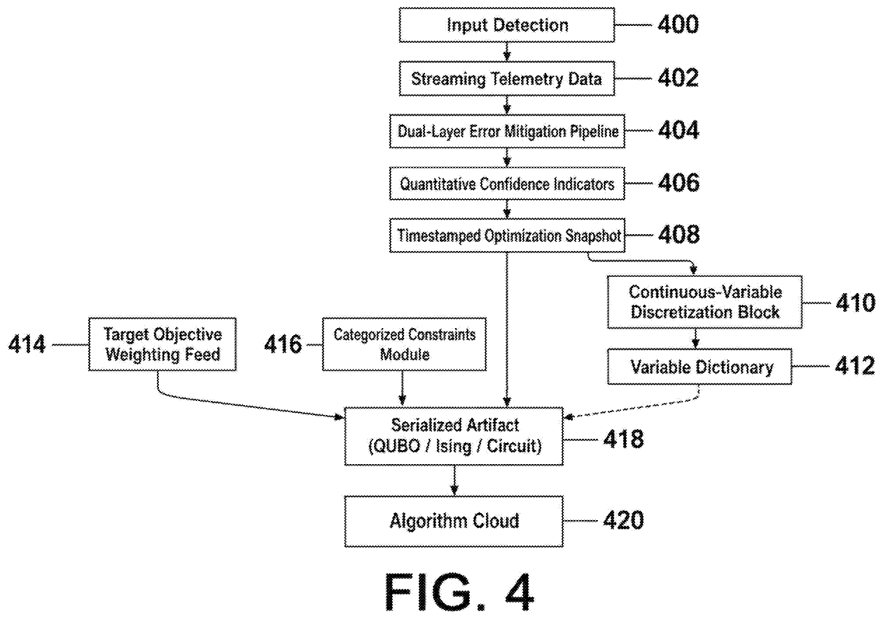

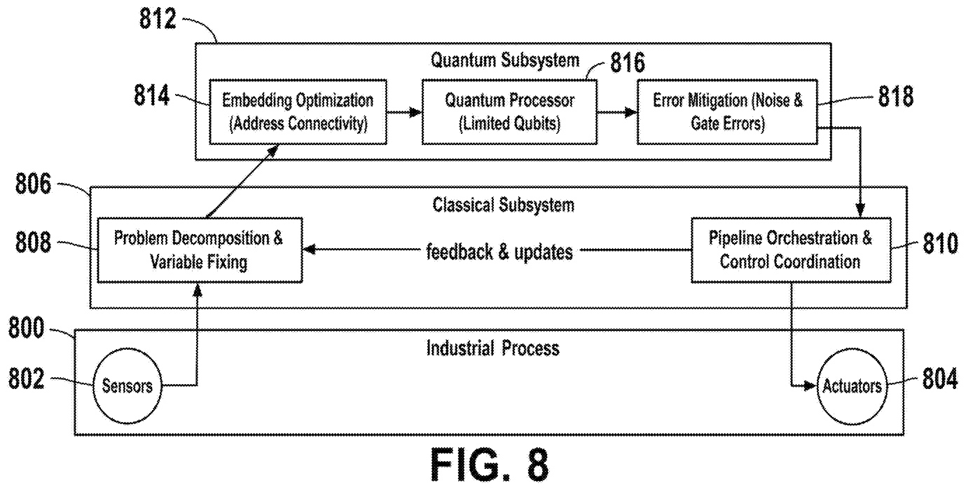

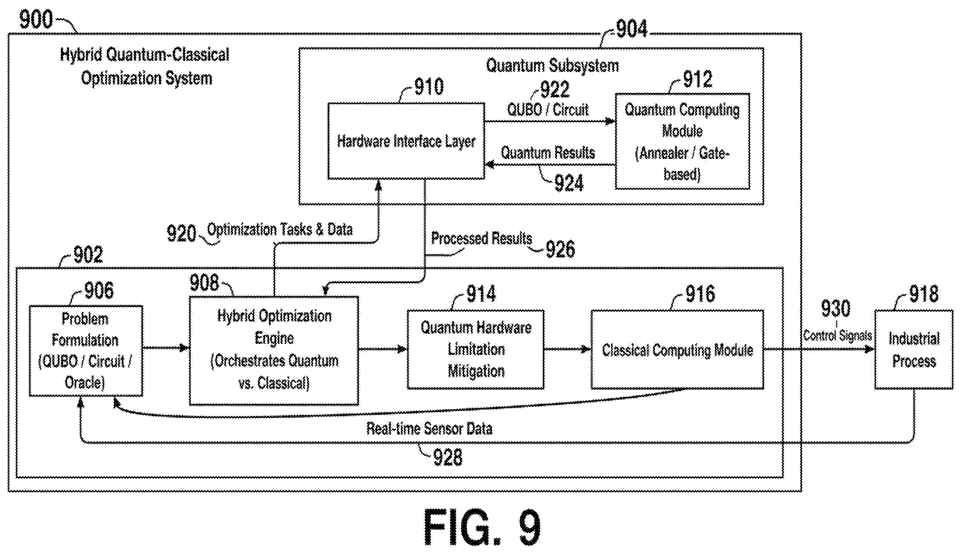

The invention is designed to be hardware-agnostic with respect to quantum computing technologies, ensuring that it can work with current and future quantum hardware. It explicitly supports multiple types of quantum processors, as illustrated in FIG. 9 [912] and employs a hybrid approach [900] to mitigate the limitations inherent in today's quantum devices [914]. Below we detail the compatibility and usage with various hardware paradigms:
Quantum Annealers (Ising Machines): The system is compatible with quantum annealing hardware, such as those produced by D-Wave Systems. These machines excel at solving QUBO/Ising formulated problems, as illustrated in FIG. 4, 7 [418, 701] by physically realizing a network of qubits that evolve to the lowest energy state. For example, D-Wave's 2000Q system provides over 2000 qubits arranged in a Chimera graph topology (newer models use a Pegasus topology with even more qubits). The invention takes advantage of this by mapping the formulated industrial optimization (typically in QUBO form) [418] onto the qubits of the annealer. The Quantum Solver Interface [910] in our system handles the specifics: using programmatic minor-embedding graph algorithms to map the logical QUBO variables [707] onto the restricted physical qubit connectivity graph of the specific hardware topology (e.g., Chimera, Pegasus, or Zephyr graphs). Because industrial optimizations are highly coupled, a single logical decision variable is often distributed across a “ferromagnetic chain” of multiple physical qubits. To prevent thermal noise from causing “chain breaks” (where physical qubits representing the same logical variable collapse into conflicting binary states), the compiler dynamically calibrates the intra-chain coupling strength (J_chain) to strictly exceed the maximum logical problem weight: J_chain≥max |J_{ij}|. Following this topological embedding, as illustrated in FIG. 8, 14 [814, 1420, 1430], the system executes the annealing cycles [1432]. The system can adjust annealing parameters like anneal time, pause and quench schedules, or spin reversal transforms to improve results. Quantum annealers currently operate at cryogenic conditions and often via cloud access. The system is equipped to communicate with such devices through APIs (for instance, using D-Wave's Ocean SDK) and can retrieve results [924] in seconds or less. Since annealers inherently return a result quickly (in terms of quantum processing, usually within microseconds to milliseconds for a single run, plus some overhead for communication), they are well-suited for near real-time updates if the problem size is within the hardware limits. The hardware limitation here is primarily the number of qubits and their connectivity-if the problem requires more logical qubits than available or denser connections, the system either uses the hybrid decomposition [808, 1428] or solves parts sequentially. The invention mitigates this by dividing large problems into chunks that fit onto the hardware, solving them in pieces, and combining partial solutions [1426, 1434], a strategy that can be automated by hybrid solvers as mentioned. Also, for constraints beyond annealer's direct capability (like higher-order interactions or certain constraint forms), the system either reformulates them into quadratic penalties [703] or falls back to a gate-model approach if needed.
Gate-Model Quantum Computers: The system supports gate-based quantum processors [912] such as superconducting qubit systems (IBM Quantum, Google, Rigetti, etc.), trapped ion systems (IonQ, Quantinuum), photonic qubit systems, and others. These universal quantum computers allow implementation of algorithms like QAOA, Grover's, VQE, and more [1222]. Our invention's modular Quantum Solver Interface [910] can translate the optimization problem into quantum circuits [418, 922] that run on these devices. For instance, if using IBM Quantum, the interface would generate a Qiskit circuit for QAOA corresponding to the cost Hamiltonian [701] of the optimization problem, then execute it on a chosen backend [420] (either real quantum hardware or a high-performance simulator if used for testing). We account for the current limitations of gate-model hardware: decoherence (qubits losing their state due to environmental interaction), limited number of qubits (as of this writing, on the order of tens to a few hundred for state-of-the-art devices), and gate errors, [818, 914]. These limitations mean that large problems might need to be truncated or simplified to run on gate QPUs [912]. The invention addresses this by using shallow circuits and hybrid schemes—for example, QAOA with a small number of layers can be run within the coherence time of today's devices. The machine learning integration [262, 264] can help by pre-optimizing some angles or reducing the search space so the quantum circuit can be simpler. Furthermore, the system may engage error mitigation techniques [404, 818, 1422] (like Richardson extrapolation or zero-noise extrapolation) as part of its interface if high accuracy is needed from a noisy quantum output [924]. The hardware selection module within the system can determine if a certain problem size should be directed to an annealer or a gate QPU [912]; for instance, a problem requiring all-to-all connectivity with 100 qubits might be easier on a gate model (with full connectivity) than on a sparse-connected annealer that would require complex embedding [814, 1430].

### Hybrid Quantum-Classical Computing Platforms:

The invention is also compatible with emerging hybrid platforms that incorporate both classical and quantum processors tightly [900, 902, 904]. For example, some cloud services (like AWS Braket, Azure Quantum) allow orchestration of classical and quantum computations. Our system can be deployed on such platforms to minimize latency—the optimization loop might run in a cloud environment where calls to quantum hardware (like D-Wave Advantage or IonQ) are local to that data center, reducing communication delays. Additionally, hardware like quantum-inspired annealers (Fujitsu Digital Annealer, Toshiba's simulated bifurcation machines) can be used in lieu of actual quantum hardware as a fallback or supplement [510, 916]. These are classical hardware designed to solve QUBO problems quickly by simulating quantum processes. The system treats them similarly through the same interface [910] (the formulation doesn't change; only the solver backend toggles to a “quantum-inspired” mode if real QPU is unavailable). This ensures that even if a quantum processor [912] is temporarily offline or if the cost of usage is high at times, the system can still perform optimization using these deterministic solvers in a way that's transparent to the overall operation.

Addressing Hardware Limitations: Given the current state of quantum hardware, the invention employs several strategies to handle limitations: Qubit Count: If the optimization requires more qubits than available, the system either uses problem decomposition [808, 1428] (solving smaller sub-problems sequentially or in parallel if multiple QPUs are available) or variable fixing [808] (where less sensitive variables are assigned fixed values based on heuristics or ML, reducing the number of free variables for the quantum solver [1218]). It can also dynamically decide to only optimize the most critical subset of variables quantumly and let classical controllers handle the rest [916].

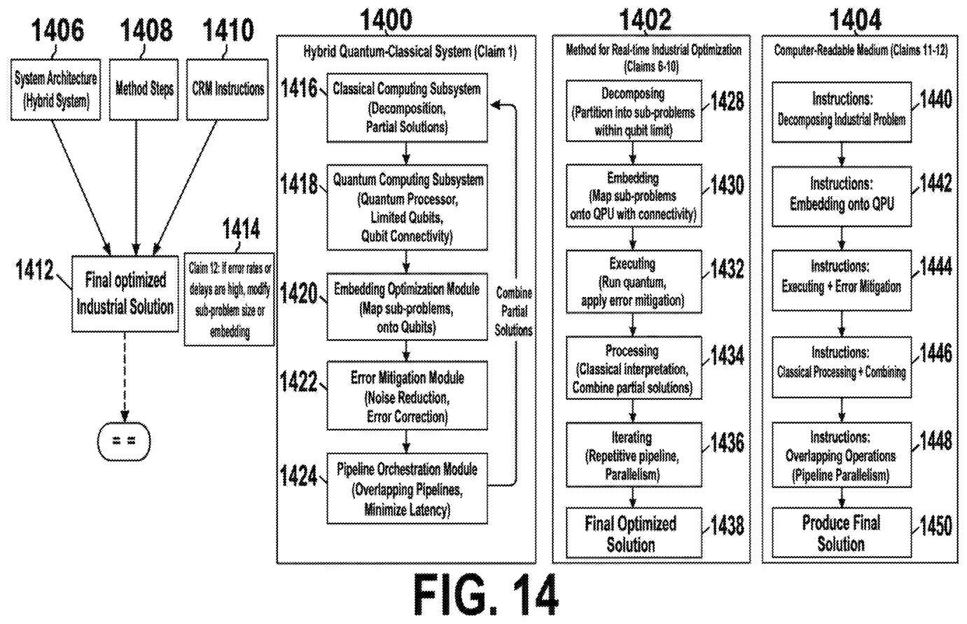

Connectivity Constraints: In annealers, not every pair of qubits can interact unless embedded, which can use extra qubits and reduce effective capacity. The system's embedding algorithm [814, 1420] tries to optimize embedding [1430] to use as few extra qubits as possible. If an embedding fails for full problem, the system might cluster variables that interact strongly and solve cluster by cluster. The architecture inherently supports iterative refinement [1436] which can circumvent some connectivity issues by solving piecewise and coordinating at a higher level. Noise and Errors: For gate QPUs [912], the system might use error-corrected hardware if available (in future) or currently use error mitigation [404, 818, 914, 1422]. For example, it can run circuits at different noise levels (by artificial delay or adding noise) and extrapolate to zero noise, or use majority voting by running the same computation multiple times. The classical verification step, as illustrated in FIG. 5 [514, 522] (comparing candidate solutions via a classical model or constraints check) also acts as a safety net against any one incorrect quantum computation result being blindly applied. Latency: The time to send data to a cloud quantum computer and get results might be non-trivial. To manage this, the system can perform pipeline parallelism, as illustrated in FIG. 14 [1424, 1448]: while one optimization result is being applied, the next sensor data [928] is already being acquired and possibly a new quantum job started. Also, the system can adjust control frequency to align with quantum computation times, e.g., if a quantum solver typically returns in 2 seconds, the control loop might run at 2-second intervals, or run a fast intermediate classical optimization on the off seconds. The hybrid nature ensures a graceful handling of these timing issues [508, 516].

Future-Proof Design: As quantum hardware improves (more qubits, less noise, faster gate operations), the system can automatically leverage those improvements by simply scaling up the problem sizes it sends or reducing reliance on decomposition [1428]. For instance, a future annealer with 5000 qubits fully connected could take on a much larger chunk of the optimization directly-our system would detect that and simplify the pipeline (less chunking, fewer iterative loops). The modular design means swapping in a new quantum backend [420] (say a different vendor or a entirely new algorithm) requires minimal changes to the system's configuration.

Classical Hardware Integration: It should be noted that the invention doesn't eliminate classical computing—in fact it's deeply integrated. The control servers running the optimization logic, ML models, and interfacing logic are high-performance classical computers (or distributed computing nodes) that ensure all surrounding tasks are handled efficiently. The result is a heterogeneous computing environment: classical CPUs/GPUs for data and ML, quantum processors for optimization kernels, [900, 902, 904]. This distribution is orchestrated such that each type of hardware is used where it is most effective [908, 916, 1416].

In conclusion, the system is compatible with a wide range of quantum hardware (annealers, gate-model QPUs) and is designed to operate within their limits by using hybrid strategies [900]. It maximizes what current technology can do and is ready to scale up as hardware progresses. By not tying the invention to a specific quantum machine, it ensures longevity and broad applicability-whether the plant has access to a D-Wave annealer, an IBM quantum cloud service, or any future quantum device, the optimization module [266] can integrate and function, bringing quantum benefits to industrial process control.

### Alternative Embodiments

While the description so far has focused on a waste-to-energy “industrial digestive system” with a particular control architecture, the invention can take many forms and be applied to various domains. The following are alternative embodiments and variations, illustrating the flexibility and breadth of the invention:

Different Industrial Processes: The methodology is equally applicable to other complex industrial systems beyond waste-to-energy & materials, as illustrated in FIG. 2 [200]. For example, in refinery operations, where crude oil is processed through distillation columns and reactors, a quantum optimization module [266] can manage cut points, hydrogen feed rates, and catalyst regeneration schedules to maximize yield and minimize energy use. In pharmaceutical manufacturing, a multi-stage synthesis and separation process can be optimized for throughput and purity. In water treatment plants, numerous variables (chemical dosing, pump scheduling, membrane backwash timing) can be balanced to ensure water quality at minimal energy. The core invention-hybrid quantum real-time optimization-remains the same; only the specifics of sensors; [240, 250, 260], actuators [280, 282, 284], and objectives change. Each of these domains faces the same type of challenge: many interacting decisions under constraints, which is exactly what the invention addresses.

Varying Levels of Quantum Involvement: Not all embodiments require a quantum computer to be in the direct real-time loop. In one variant, the quantum optimization might be used in a supervisory capacity. For instance, the quantum module [912] might run less frequently (say once an hour or when a significant change is detected) to provide a new optimal setpoint trajectory or policy, which the classical control [916] then follows in the interim. This could be useful if quantum resources are scarce or if the process doesn't change extremely rapidly. Another variant is the opposite: heavy quantum use where multiple quantum sub-systems [904] run in parallel for different aspects of the plant. One could imagine dividing the plant into sections (pretreatment, digestion, energy conversion, waste handling, etc.), each with its own quantum-optimized controller focusing on that sub-process, coordinated by a top-level classical supervisor [916] to ensure they all align. This distributed approach could make the system more modular and resilient (one section can still optimize even if another's quantum module is offline).

### Different Encoding and Algorithm Choices:

The invention isn't limited to QUBO/Grover/QAOA/VQE. Alternative quantum algorithms or encodings can be plugged in. For example, one embodiment might use Quantum Machine Learning (QML) algorithms to directly assist in control (like a quantum neural network processing sensor data for anomaly detection). Another could use quantum linear solvers (like the HHL algorithm for solving linear equations) if part of the control problem involves solving large linear systems in model-predictive control-though current hardware makes this theoretical. If a new algorithm emerges (say a specialized quantum algorithm for constrained optimization or multi-objective Pareto optimization), the system can incorporate it. Similarly, encodings might evolve: one could use qutrits or qudits (quantum systems with more than two levels) if hardware supports them, to encode variables with more than binary choices directly. The patent covers these variations as it fundamentally is about integrating quantum computation with industrial control in a broad sense.

Machine Learning Variations: In some embodiments, the ML component [262, 264] might be minimal or even absent (if, say, a user wants a purely optimization-driven approach). In others, it could be greatly expanded. For example, an embodiment might use deep reinforcement learning where the agent's “action” is to select quantum optimization outcomes or tweak their parameters, learning end-to-end to maximize long-term reward of the process. Or unsupervised learning could cluster operating data to automatically identify modes (without prior knowledge) and the quantum optimizer could then optimize per mode. The degree of ML integration can be tailored: a simpler system might just use static rules for parameter tuning (no learning), whereas a more advanced one uses continual learning.

User Interaction and Overrides: Another variation concerns how operators interact with the system. In one embodiment, the system could be fully autonomous—it just runs and the operators monitor high-level performance. In another, operators might set certain biases or manual overrides that the quantum optimizer must respect. For instance, an operator might specify “for the next hour, prioritize maximum power output even if efficiency drops slightly,” perhaps for business reasons. The system can take this user input as a change in the objective weight [414] or as a constraint [416] and then do its optimization accordingly. There could also be a mode where the system presents a few optimal scenarios (like one favoring efficiency, one favoring throughput) and the operator chooses which to implement (like a decision-support tool) [1505, 1507]. All these are within scope as they just alter how the objectives or constraints are fed into the optimization.

Deployment Models: The physical deployment of the system can vary. In one embodiment, the quantum hardware could be on-site (for example, a company may have its own quantum annealer installed in a facility). In that case, the control system is directly wired to the quantum hardware-[910, 912], potentially reducing latency and increasing security (sensitive plant data doesn't leave the premises). In another embodiment, everything might be cloud-based: sensor data [928] is securely sent to a cloud service [420] where the quantum optimization and ML processing happen, and then control commands [930] are sent back. There could also be a hybrid: local classical control and data processing [916], but quantum calls go to the cloud [420]. Each approach has different considerations (on-site hardware needs maintenance but offers faster turnaround; cloud offers flexibility and access to latest hardware but requires reliable connectivity). The invention is flexible to each—we can adjust the frequency and fallback strategies [510] depending on connectivity and hardware availability.

Scaling Down or Up: While the description emphasizes large industrial systems, the concept can scale down to smaller systems or up to networks of systems.

Scaling down: one might implement this on a pilot plant or lab setup, using a small quantum computer to optimize a bench-scale process experiment, thereby finding optimal conditions before scaling to full plant. The same approach helps researchers handle complex experimental setups with many variables [1134, 1136, 1142, 1144].

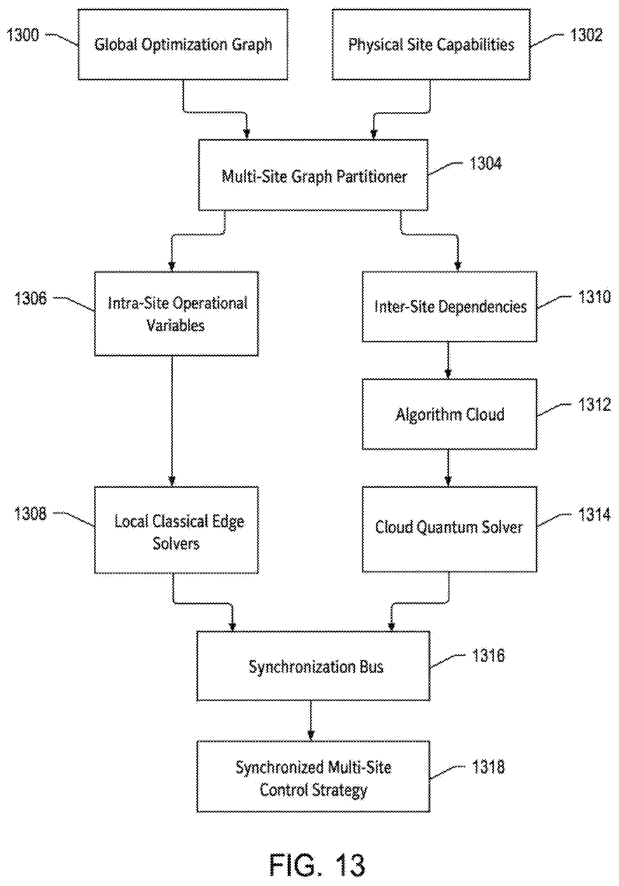

Scaling up: imagine a network of industrial sites (like multiple waste-to-energy plants in different locations connected via a grid). The invention could optimize not only within each site but also at a higher level, deciding how to distribute loads or share resources across sites, as illustrated in FIG. 13 [1300, 1302]. This becomes a multi-system optimization (almost like a smart grid or supply chain optimization) the quantum module could then be solving even bigger problems that encompass all sites, . . . utilizing a Multi-Site Graph Partitioner, [1304]. To bypass near-term QPU qubit limitations across such distributed facilities, a global orchestrator algorithmically cuts the optimization graph [1300] based on a physical capability registry of each site, [1302], routing highly localized variables to classical edge solvers [1308]. The resulting inter-site dependency chunk—representing heavily coupled logistical and resource-sharing variables—is sub-partitioned to fit within the specific qubit connectivity limits of the central cloud quantum solver-[1310, 1314].

Furthermore, for bench-scale and laboratory deployments, the system may include an Automated High-Throughput Experimentation (HTE) interface, as illustrated in FIG. 11 [1134]. This translation layer decodes abstract quantum search parameters into hardware-specific machine code, mapping logical variables directly to robotic kinematic coordinates and volumetric dispense instructions for automated liquid handlers [1136, 1154].

Brief Description: FIG. 13 is a network topology diagram illustrating the distributed multi-site quantum partitioning architecture used to route localized edge computing variables separately from centralized quantum cloud dependencies. Detailed Description: FIG. 13 depicts a scalable enterprise architecture designed to bypass finite QPU qubit constraints. A massive Global Optimization Graph [1300] is algorithmically assessed by a Multi-Site Graph Partitioner [1304]. This chunking engine executes optimization logic cuts based on physical limits defined by Physical Site Capabilities [1302]. The partitioner executes bipartite routing: Intra-Site Operational Variables [3306] are split and delivered to Local Classical Edge Solvers [1308] deployed at localized nodes (e.g., Site A, Site B, Site C). Highly coupled Inter-Site Dependencies [1310] are routed over network protocols to the Algorithm Cloud [1312] interfacing with a Cloud Quantum Solver [1314]. A central Synchronization Bus [1316] converges the independently solved local setpoints and global dependencies, merging them to dispatch a comprehensive Synchronized Multi-Site Control Strategy [1318] back to the physical transformation hardware nodes.

Specific Control Strategies: Alternative embodiments might integrate the quantum optimizer [709] at different control hierarchy levels. We already discussed supervisory vs direct control. Another approach is in-MPC-loop quantum computing: where the quantum solver [1218] might be called at each time step of a model predictive control algorithm as the optimizer. For example, a linear MPC problem with integer decisions each step could call a QUBO solver [1216] instead of a MILP solver. This blends established MPC theory with quantum solving. Or one could embed quantum optimization in scheduling/planning layers while using conventional PID on the real-time layer. Prioritizing Objectives Differently: In some variants, reliability or safety might be the top priority, so the system might be configured to only use quantum suggestions when it's very confident-[406]. In others, pushing performance is key, so it might aggressively use quantum outputs frequently and fine-tune them with classical control. The balance can be adjusted to the industry: e.g., in nuclear plant control (if ever applied), one would emphasize safety above all; in a profit-driven manufacturing scenario, one might push the envelope more as long as safety interlocks remain [518, 522]. Each of these alternative embodiments is a tweak or extension of the same fundamental inventive concept: integrating quantum computing into the control loop of an industrial process to achieve superior optimization. The breadth of these examples demonstrates that the invention is not limited to a particular process or algorithm—it is a general architecture and method. Therefore, any variations that employ quantum algorithms in conjunction with classical control and/or machine learning to manage and optimize an industrial system should be considered within the scope of this invention. The Embodiments will reflect this broad applicability, ensuring coverage of various modifications and uses that a person skilled in the art might implement in view of this disclosure.

### Comparison to Prior Art.

The proposed Industrial Digestive System Quantum Optimization differs significantly from prior art in both approach and capabilities. Below, we compare it with existing methods and related inventions across classical, heuristic, and quantum domains:

Versus Classical Optimization and Control: Traditional advanced control methods, such as linear programming, nonlinear programming, or Model Predictive Control (MPC), operate within the limits of classical computational power. They often require simplifications of the plant model to keep computations tractable, resulting in suboptimal performance for complex processes. For example, a classical MPC might linearize a nonlinear process or use a reduced-order model, which means the obtained solution is optimal only for that approximate model. In contrast, our invention can consider a much more complex model (including discrete decisions and nonlinear effects) by offloading heavy computation to the quantum module [912], as shown in FIG. 9. Classical solvers also struggle with combinatorial explosion—if an optimization has many binary or integer choices, classical methods (like Mixed-Integer Programming solvers) can take prohibitively long times, and real-time usage is nearly impossible when the problem size is large. Our hybrid system [900] addresses this by using quantum algorithms that naturally handle combinatorics more efficiently, thereby scaling to larger problem sizes in real-time. Furthermore, classical control is often sequential and myopic (greedy adjustments), whereas the quantum approach evaluates a broad range of possibilities simultaneously, finding global or near-global optima that classical methods might miss. Essentially, where classical control might reach a steady state that is a local optimum, the quantum-enhanced system is more likely to find a globally optimal operating point due to its ability to escape local minima (quantum annealing can tunnel through energy barriers that trap classical algorithms).

Versus Heuristic and Rule-Based Approaches: Many industrial facilities use heuristic optimizers like genetic algorithms, simulated annealing, or simply human-crafted rules (“if X happens, do Y”). These methods can sometimes handle complex problems but have drawbacks: they often require a lot of tuning, may not adapt to changes unless re-run or re-written, and do not guarantee finding the best solution. A genetic algorithm might need hundreds or thousands of iterations to evolve a good solution and might still only find a fairly good solution, not the absolute best. In time-critical scenarios, heuristics may be stopped early, yielding suboptimal decisions. The invention improves upon this by leveraging quantum parallelism-effectively exploring many solution candidates at once-which can converge to a high-quality solution faster than typical random-search-based heuristics. Also, because it's in a closed loop [300, 326], as shown in FIG. 3, it continually updates; a genetic algorithm might be run once a day offline, but our system is online and adjusting continuously. Rule-based systems, on the other hand, lack flexibility; they are predefined and cannot easily cope with novel situations. Our system, being optimization-driven, can handle novel conditions by simply recalculating the optimum for those new conditions, something a fixed rule cannot do. Additionally, through machine learning [262, 264], our system's rules (in the form of cost function weights or learned constraints [414, 416]) evolve based on data, whereas traditional heuristics remain static until manually revised.

Versus Existing Quantum Computing Approaches in Industry: There are a few known attempts to apply quantum computing to industrial optimization problems, but they differ in scope and integration. For example, one prior approach (as evidenced by recent patents and research (Quantum computing based hybrid solution strategies for large-scale discrete-continuous optimization problems (patent)|DOE patents)) decomposes an optimization into a two-step hybrid algorithm: solve part classically, then part quantumly, and iterate offline until an answer is found. That approach is typically aimed at design or planning problems, not real-time control, and it does not involve direct sensor feedback or continuous operation. Our invention, in contrast, is embedded in real-time operations, directly using sensor inputs [928] and sending control outputs [930], as shown in FIG. 9. Another example is Accenture's “multi-state quantum optimization engine” for business decision making (Accenture Awarded US Patent for Combining Classical and Quantum Computing With Potential to Address Previously Unsolvable Business Problems), which indeed uses quantum computing to generate decision alternatives. However, that is focused on business scenarios like supply chain or drug discovery, and it operates by running simulations in parallel. Our system is distinguished by being closed-loop with a physical process—it's not just suggesting plans to humans, it's automatically controlling an industrial process [918]. Moreover, our invention specifically addresses the intricacies of process control (like actuator constraints, safety interlocks, etc.) through validation and safety gating [518, 522], which prior quantum optimization applications have not dealt with in detail.

Integration Level: A key novelty of our system is the deep integration of quantum optimization into the control system architecture. Prior art might use quantum computers to solve a problem and then separately implement the solution, but here the quantum module [912] is one component in an autonomous control loop, as shown in FIG. 3 and FIG. 9. This means it must handle all the timing, reliability, and iterative refinement aspects of a control system-something unique in this design [508, 510, 518]. The combination of quantum computing with machine learning [262, 264] in a live control system is also novel; it's more common to see quantum algorithms tested on static problem sets or ML used for off-line optimization, but our approach merges them in real-time. Performance Comparison: To summarize differences, Table 1 (below in Diagrams and Tables) provides a high-level comparison of classical, heuristic, and the quantum-enhanced approach of this invention across various criteria. In brief, classical methods might offer precise solutions for small problems but scale poorly (exponential slow-down) as complexity grows, whereas our quantum approach scales to larger problems by leveraging quantum resources. Heuristics are more scalable than exact classical methods but often provide approximate solutions and require long run-times or tuning; the quantum approach tends to find better-quality solutions faster for combinatorial problems due to quantum annealing and interference effects guiding the search. In terms of real-time adaptability, classical methods like MPC can adapt but are limited by computation time (they may default to slower update rates, e.g., once every few minutes for a large nonlinear MPC), and heuristics are usually off-line or slow to converge, while our system is inherently built for continuous real-time updates thanks to the fast feedback loop and quantum speed advantages, including decomposition, execution, and iteration [1428, 1432, 1436], as shown in FIG. 14.

Prior Patents: A survey of existing patents in industrial optimization shows focus areas like scheduling, supply chain optimization using quantum computing, or hybrid solvers for specific formulated problems. None of these prior solutions teach or suggest the specific configuration of our invention: the use of a quantum optimization module [266] within an industrial plant's control system [276] actively adjusting process variables in real-time. For instance, U.S. Pat. No. 10,095,981 (Accenture) teaches hybrid classical-quantum simulations for business decisions, and another recent patent (U.S. Pat. No. 11,769,070 by You et al.) proposes a method to split large optimization problems for quantum solution (Quantum computing based hybrid solution strategies for large-scale discrete-continuous optimization problems (Patent)|DOE Patents), but those are algorithmic techniques not tied to controlling a live process with sensors [240, 250, 260] and actuators [280, 282, 284]. Our invention's uniqueness lies in applying quantum computing in a closed-loop process control context, effectively bridging a gap between theoretical optimization solutions and practical industrial automation. It uses known quantum algorithms in a new and non-obvious way to solve a problem (real-time industrial optimization) that was previously unsolvable with such depth and speed.

In conclusion, compared to prior art, the Industrial Digestive System Quantum Optimization offers a fundamentally new capability: real-time, continuous, multi-objective optimization of a complex industrial process through a hybrid quantum-classical system [900], as shown in FIG. 9. This is a departure from static or design-time quantum optimization approaches and goes well beyond what classical or heuristic controllers can do. The detailed comparison and the referenced table underscore these differences, highlighting the novelty and advantages of the invention in achieving superior performance and adaptiveness.

### Enumerated Embodiments and Architecture Variants (Set A)

### System Embodiment: Quantum-Optimized Industrial Digestive System

A cyber-physical system for processing heterogeneous or homogeneous materials (input) wherein the input comprises waste materials, molecular or elemental feedstocks, or other raw materials of varied composition in a liquid, solid, or gaseous state, into one or more usable products, the system comprising:

An industrial digestive system (IDS) [200], as shown in FIG. 2, that includes: a plurality of interconnected processing stages, each stage configured to alter physical, chemical, or biological properties of input materials; sensors [240, 250, 260] monitoring at least one property of the input materials, intermediate states, or outputs; actuators [280, 282, 284] controlling operational parameters of the processing stages; and

A quantum optimization module [266] operatively connected to the industrial digestive system, the quantum optimization module comprising: —a problem encoder configured to receive sensor data and operational parameters from the industrial digestive system and formulate a multi-objective optimization problem in a quantum-friendly format [268, 906], as shown in FIG. 2 and FIG. 9; a quantum solver submodule [270, 912] that employs at least one quantum algorithm selected from the group consisting of: quantum annealing on a QUBO/Ising model, Grover's search for unstructured optimal solutions, a Quantum Approximate Optimization Algorithm (QAOA), and a Variational Quantum Eigensolver (VQE); a control interface configured to output optimized setpoints or routing instructions to the actuators [326, 930], as shown in FIG. 3 and FIG. 9; wherein the quantum optimization module iteratively refines the operational parameters of the industrial digestive system by: —collecting and updating real-time sensor data [300, 302]; encoding said data and system constraints into a cost function with penalty terms for physical feasibility [701, 703], as shown in FIG. 7; executing the quantum solver submodule to generate a candidate solution [316]; and applying the candidate solution via the control interface [324, 326], thereby enhancing process efficiency and output quality by leveraging quantum computation for multi-objective decision-making.

### Quantum-Enhanced Optimization Method

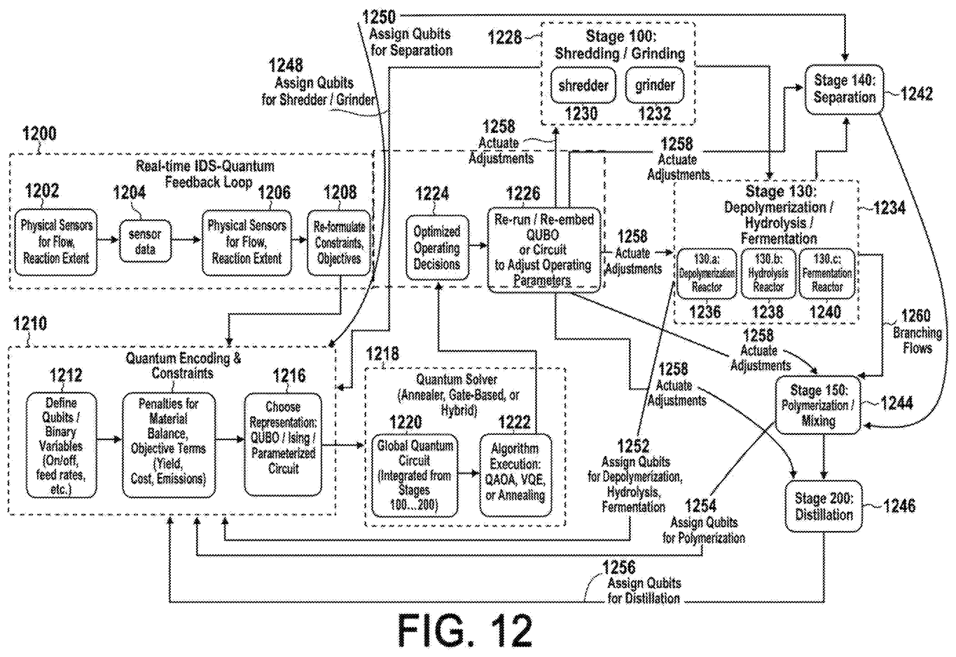

A method for optimizing transformations of heterogeneous or homogeneous materials (input) wherein the input comprises waste materials, molecular or elemental feedstocks, or other raw materials of varied composition in a liquid, solid, or gaseous state within an industrial digestive system, the method comprising: Receiving sensor data indicative of material composition, process states, and output quality from the industrial digestive system [300, 302], as shown in FIG. 3; Formulating a multi-objective optimization problem, said problem including a set of binary or discretized decision variables corresponding to process selections, mixture allocations, or operating conditions, at least one objective function to be maximized or minimized, and penalty-based constraints for material balances and feasibility [312, 1210], as illustrated in FIG. 3 and FIG. 12; Encoding the multi-objective optimization problem into a quantum Hamiltonian or quantum circuit representation [418, 1216], as shown in FIG. 4 and FIG. 12, the representation incorporating: a binary encoding scheme for real-valued mixture ratios, and penalty coefficients ensuring stoichiometric, safety, or capacity constraints are upheld; Executing at least one quantum algorithm selected from the group consisting of QUBO-based quantum annealing, Grover's search, QAOA, or VQE, so as to find a quantum state that minimizes or maximizes the encoded objective functions [1218, 1222];

Decoding the resulting quantum state to obtain an optimized set of process parameters or routing instructions for the industrial digestive system; and Applying said optimized process parameters or routing instructions to the industrial digestive system [324, 326], thereby improving overall efficiency, resource recovery, or output product quality.

### Classical Post-Processing Embodiment

The system of Embodiment 1, wherein the quantum solver submodule further comprises a classical post-processing unit that refines candidate solutions returned by the quantum algorithm via a local search or gradient-based method before sending final control signals to the actuators [916, 1434], as shown in FIG. 9 and FIG. 14.

### Adaptive Partitioning Embodiment

The method of Embodiment 2, further comprising: adaptive partitioning of the global optimization problem into subproblems based on domain heuristics, wherein each subproblem is separately encoded and solved on a quantum processor, and subproblem solutions are iteratively merged, thus enabling a divide-and-conquer approach for large-scale industrial processes [1428, 1434], as shown in FIG. 14.

### Machine Learning Surrogate Embodiment

The system of Embodiment 1, wherein the problem encoder includes a machine learning surrogate [262, 264], as shown in FIG. 2, that approximates chemical reaction yields or intermediate process states, thereby reducing the complexity of direct simulation and enabling faster quantum optimization runs.

### Quantum Surrogate Model Embodiment

The method of Embodiment 2, further comprising: using quantum kernel-based regression or variational quantum neural networks as surrogate models to estimate multi-output yield or product qualities, and iteratively updating the surrogate model with newly observed data from the industrial digestive system, such that the quantum solver receives increasingly accurate objective function parameters [262, 264, 306], as shown in FIG. 2 and FIG. 3.

### Selective Quantum Backend Embodiment

The system of Embodiment 1, wherein the quantum optimization module is configured to selectively switch between a quantum annealing back-end and a QAOA-based back-end depending on real-time constraints, hardware availability, or problem size, ensuring robust operation under varying computational resources [910, 912], as shown in FIG. 9.

### Discrete Binning Embodiment

The method of Embodiment 2, wherein the step of encoding the multi-objective optimization problem includes a custom discrete binning scheme for converting continuous material percentage variables into a minimal set of binary qubits, reducing qubit overhead while preserving adequate resolution of mixture composition [410, 1212], as shown in FIG. 4 and FIG. 12.

### Safety Validation Embodiment

The system of Embodiment 1, further comprising: a safety validation layer which receives candidate solutions from the quantum solver submodule, checks for compliance with critical safety thresholds or chemical hazard constraints, and only passes feasible solutions to the actuators [518, 522], as shown in FIG. 5.

### Adaptive Grover Threshold Embodiment

The method of Embodiment 2, wherein Grover's search is conducted via an adaptive threshold approach such that: the system initially marks states exceeding a baseline performance criterion as “acceptable,” after identifying such a state, the baseline criterion is updated to a higher threshold, Grover's search is repeated, iteratively refining toward an optimal or near-optimal solution in O(√N) steps, with N being the size of the solution space.

### Industrial Pipeline Routing Embodiment

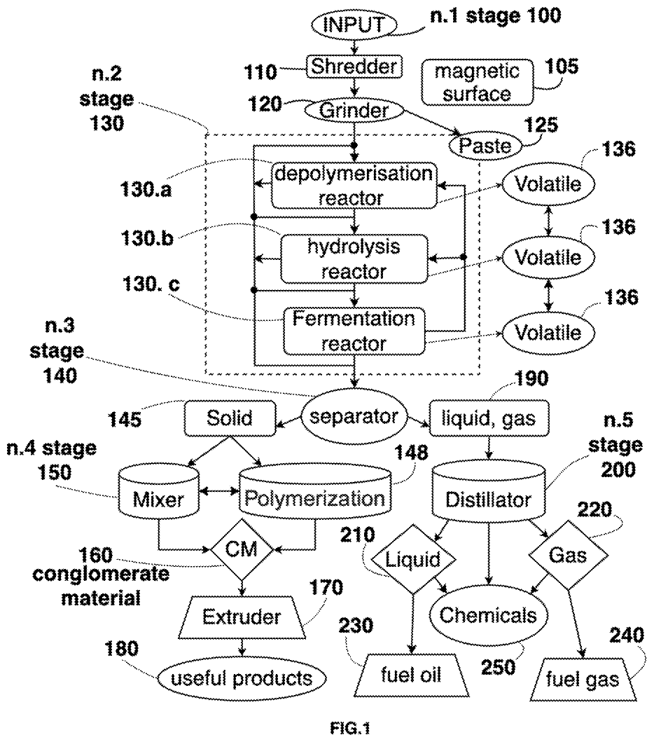

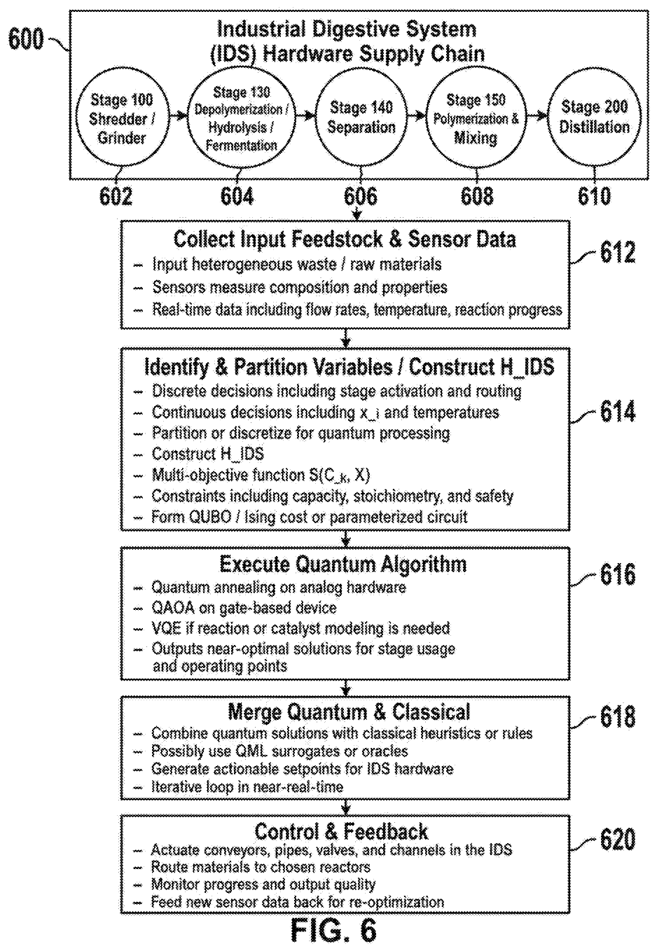

The system of Embodiment 1, wherein the industrial digestive system further comprises: an intake apparatus accepting uncategorized waste or mixed biomass, and a multi-stage pipeline incorporating biological digestion reactors, chemical conversion units, and material sorting stages, such that the quantum optimization module continuously determines the optimal routing of said uncategorized waste across the pipeline to maximize energy output, chemical yield, or composite material production, as shown in FIG. 1 and FIG. 6.

### Real-Time Re-Optimization Embodiment

The method of Embodiment 2, further comprising a real-time feedback loop where the quantum solver submodule is triggered to re-optimize whenever the sensor data indicates that input material composition or process performance deviates by more than a predefined threshold, thus maintaining near-optimal operation under fluctuating conditions [300, 316, 326], as shown in FIG. 3.

### Annealer Constraint Embedding Embodiment

The system of Embodiment 1, wherein the quantum annealer used in the quantum solver submodule includes a hardware architecture that supports penalty-based constraint embedding to ensure that solutions violating stoichiometric or material capacity constraints incur an energy penalty, driving the system toward physically valid configurations [703, 814], as shown in FIG. 7 and FIG. 8.

### Hierarchical Penalty Weighting Embodiment

The method of Embodiment 2, wherein the penalty-based constraints incorporate hierarchical weighting of feasibility, safety, and yield objectives, ensuring that physically infeasible or unsafe solutions are assigned higher energy penalties than suboptimal but feasible solutions, resulting in robust solution selection under quantum optimization [416, 703], as shown in FIG. 4 and FIG. 7.

### Dynamic Objective and Hamiltonian Adjustment Embodiment

The system of Embodiment 1, wherein the problem encoder is configured to dynamically adjust QUBO coefficients or Hamiltonian parameters based on: changes in real-time cost metrics (e.g., electricity prices, reagent availability), user-defined priority shifts (e.g., emphasis on waste minimization over maximum energy yield) [414], as shown in FIG. 4, and predictive analytics from a machine learning engine [264], as shown in FIG. 2, thereby enabling a flexible quantum optimization strategy that aligns with evolving industrial objectives.

### Enumerated Embodiments and Architecture Variants (Set B)

### Hybrid Quantum-Classical Control Method:

A system for industrial process optimization comprising a hybrid quantum-classical control loop [900], as shown in FIG. 9, wherein a classical computing unit [902] and a quantum processor [912] operate cooperatively to optimize process parameters in real-time. The classical unit may perform initial data processing and provide an estimated solution which the quantum processor refines, or vice versa, and both units exchange information iteratively until an optimization criterion is met. This Embodiment ensures protection for any co-processing approach where classical algorithms (e.g. heuristics, simulators) work in tandem with quantum algorithms (e.g. quantum annealing or gate-based variational circuits) to control the industrial “digestive” process. This covers scenarios such as using a quantum annealer for the combinatorial aspects of the process while a classical PID/MPC controller handles fast continuous variables, with a coordination mechanism between them [908, 916].

### Alternative Problem Encoding Formats

The method of industrial process optimization, wherein the process's optimization problem is encoded into a quantum-friendly format selected from a group consisting of QUBO models, Ising models, continuous-variable representations, and parameterized quantum circuit formulations, [418], as shown in FIG. 4. This Embodiment safeguards the invention across different quantum hardware paradigms. For example, if instead of a QUBO on an annealer, one uses a gate-model quantum computer with a QAOA or VQE algorithm, the core idea remains protected. It explicitly covers constructing an Ising Hamiltonian or an objective Hamiltonian representing the process, including all constraints and objectives [700, 701], as shown in FIG. 7 and either solving it via adiabatic/annealing methods or via parameterized circuits whose parameters are optimized, perhaps with a classical optimizer in the loop. Any encoding that maps the real-world industrial optimization into a form solvable by a quantum processor, including binary, ternary, or even continuous qubit representations [1216], as shown in FIG. 12, would fall under this Embodiment. This prevents design-arounds where someone might use a different encoding technique, say, formulating the problem for a continuous-variable quantum computer or a different qubit mapping, to achieve the same optimization.

### Machine Learning Integration for Prediction and Refinement

The system for quantum-enhanced industrial process optimization, further comprising an AI/ML module [262, 264], as shown in FIG. 2, that learns from process data to improve optimization outcomes. In particular, the system uses machine learning models, such as neural networks or Bayesian learners, trained on historical and real-time sensor data to predict future process states or estimate uncertain parameters, and these predictions are used to inform or constrain the quantum optimization. For instance, a machine learning model could forecast the calorific value or composition of incoming waste batches, and the quantum optimizer uses that forecast to plan optimal reactor settings proactively. Additionally, the ML module can analyze the results of past optimizations and actual process performance to continuously refine the optimization strategy, e.g. adjusting penalty weights or suggesting new quantum circuit parameters [414, 416], as shown in FIG. 4. This Embodiment covers the seamless integration of learning algorithms with quantum optimization—ensuring that if any competitor tries to bolt on a predictive analytics component to a quantum-controlled industrial process, it would still infringe. It also covers using ML for anomaly detection or rapid state estimation, including digital twin models, that feed into the optimization loop.

### Iterative Adaptive Feedback Loop

An industrial process optimization method with dynamic feedback, wherein the optimization is performed in an iterative, adaptive loop that recalculates and updates control decisions based on new data inputs over time. This Embodiment emphasizes that the invention is not a one-shot optimization but a continuous method. Concretely, after implementing an optimal set of control parameters, the system monitors the resulting process outputs via sensors [300, 302], as shown in FIG. 3, and any deviation or change in conditions triggers the formulation of a new optimization problem instance in real-time, which is then solved (by the quantum-classical engine) to adjust the controls [316, 326]. The cycle repeats continuously or at predetermined intervals. Key here is protecting the concept of dynamic re-optimization: even if an implementation only re-runs the optimization every hour or only for certain process phases, as long as it's an iterative feedback-driven approach using quantum computing, it falls under this Embodiment. This would cover, for example, a scenario where the system initially optimizes for current conditions, then as a new type of waste is fed into the system or as a catalyst ages, the same quantum optimization is rerun with updated inputs, thereby adapting the operating setpoints. The Embodiment ensures the patent covers any kind of closed-loop control where quantum computing is repeatedly applied as conditions evolve.

### Safety Validation and Fallback Mechanisms

The industrial quantum optimization system, further comprising safety validation and fallback sub-systems to guarantee robust operation in an industrial environment. This Embodiment covers features such as: before applying any quantum-derived control action, the system automatically checks it against critical safety constraints, e.g. temperature or pressure limits, environmental emission standards, using a fast classical verification module [514, 522], as shown in FIG. 5. If a candidate control action would violate a safety threshold or if the quantum optimizer fails to find a solution within a required time, the system invokes a fallback mechanism—for example, reverting to a predefined safe operating mode [528] or handing off control to a conventional control system until the quantum optimizer recovers [510]. The Embodiment also covers redundancy measures, like running a parallel classical optimization to cross-check the quantum solution's feasibility.

### Industrial Process Optimization System

An industrial process control system for real-time optimization of a multi-stage “industrial digestive” process, the system comprising: a set of sensors [240, 250, 260], as shown in FIG. 2, configured to measure operational parameters of each stage of the industrial process, producing sensor data indicative of process state variables; a set of actuators [280, 282, 284] configured to adjust control variables of the process, the actuators including flow regulators, valves, pumps, heaters, or other control devices affecting the process; a classical control module [276] comprising one or more processors programmed with control algorithms to maintain process stability and safety, the classical control module receiving sensor data and providing baseline control commands to the actuators; a quantum optimization module [266] communicatively connected to the classical control module, sensors, and actuators, the quantum optimization module including:
a data interface that receives real-time sensor data and process performance targets;
a Quantum Industrial Problem Compiler that constructs an optimization problem representing the industrial process performance objective(s) and constraints, by encoding control decision variables including at least some discrete decision variables), and forming a cost function to be optimized;
a quantum processor or quantum processor interface [910, 912], as shown in FIG. 9, that transmits the optimization problem to a quantum computing resource and obtains from the quantum computing resource an optimized solution for the decision variables, wherein the quantum computing resource is configured to evaluate the optimization problem using quantum algorithms; and
a solution integration component that translates the optimized solution into control setpoints or commands and communicates these setpoints to the classical control module or directly to the actuators [930];
wherein the classical control module and quantum optimization module operate in a cooperative closed-loop manner, such that the system iteratively: (i) gathers current sensor data, (ii) solves an updated optimization problem via the quantum computing resource to determine improved control actions, and (iii) applies the improved control actions through the actuators, thereby continuously optimizing the industrial process in real-time.

### Hybrid Quantum-Classical Optimization Method

A method for controlling an industrial process in real-time using a hybrid quantum-classical optimization, the method comprising:
(a) Monitoring the industrial process via a plurality of sensors to obtain real-time data representing current process conditions and performance metrics, [300, 302], as shown in FIG. 3;
(b) Formulating an Optimization Problem at each of a series of time steps, by using the current process conditions to define an objective function representing a performance goal of the process and to define constraints representing operational limits, the objective function including multiple terms corresponding to different performance aspects of the process, [312];
(c) Encoding the Optimization Problem into a quantum-solvable format, including representing at least a subset of decision variables as binary variables suitable for a Quadratic Unconstrained Binary Optimization (QUBO) or as qubits in a quantum circuit, and incorporating the objective function and constraints into that format [1216], as shown in FIG. 12;
(d) Solving the Optimization Problem using Quantum Computing by inputting the encoded problem into a quantum algorithm, the quantum algorithm selected from the group consisting of: a quantum annealing process, a gate-model quantum algorithm (QAOA, Grover's search, or VQE), or a hybrid algorithm involving quantum and classical computation, thereby obtaining an output representing optimized values for the decision variables [1218, 1222];
(e) Interpreting and Applying the Quantum Output by converting the optimized values for decision variables into control commands or setpoints for actuators in the industrial process;
(f) Actuating the control commands through classical control hardware to adjust the industrial process, for example, changing flow rates, temperatures, or other inputs, in accordance with the optimized values [324, 326];
(g) Repeating steps (a)-(f) continuously or at predefined intervals, such that the method forms a feedback loop where each iteration uses latest sensor data to re-optimize and update the control actions;
wherein a classical control subsystem runs in parallel to maintain stability and implement fine adjustments, and the method ensures any rapid fluctuations or unsafe transients are regulated by the classical subsystem while the quantum optimization provides strategic setpoint updates, thereby achieving both safe operation and improved optimality of the industrial process over time.

### QUBO Model Embodiment

The system of Embodiment 4-6, wherein the quantum optimization module formulates the optimization problem as a Quadratic Unconstrained Binary Optimization (QUBO) model [418], with binary decision variables representing discrete control choices in the process, and coefficients in the QUBO cost function set to encode the industrial process's performance objectives and constraint penalties [701, 703], such that the quantum computing resource can solve for a binary string minimizing the cost function and corresponding to an optimal set of control decisions for the process.

### Quantum Annealer Embodiment

The system of Embodiment 4-6, wherein the quantum computing resource comprises a quantum annealer having a plurality of qubits and inter-qubit couplers, the quantum annealer being programmed with an Ising model equivalent to the optimization problem, and wherein the quantum optimization module performs a minor-embedding of the optimization problem's variables and constraints onto the hardware connectivity of the quantum annealer [814, 816], as shown in FIG. 8, executes an annealing process to find a low-energy state, and reads out the state of the qubits as the optimized solution for the control variables.

### Gate-Model QAOA Embodiment

The system of Embodiment 4-6 wherein the quantum computing resource comprises a gate-model quantum processor [912], and the quantum optimization module is configured to utilize a Quantum Approximate Optimization Algorithm (QAOA) for solving the encoded optimization problem, by constructing a parameterized quantum circuit with alternating phase separation and mixing operators corresponding to the cost function and running the circuit with variational parameter updates until a near-optimal solution for the control variables is obtained [1222].

### Grover Search Embodiment

The system of Embodiment 6, wherein the quantum optimization module is further configured to implement Grover's quantum search algorithm for specific sub-problems of the industrial process control, by constructing a quantum oracle that recognizes states, candidate solutions, meeting a desired criterion and applying amplitude amplification, thereby enabling the identification of a feasible or optimal solution with quadratic speedup in cases where the optimization can be framed as a search problem.

### Machine Learning Refinement Embodiment

The system of Embodiment 6 wherein the machine learning integration is provided, comprising a machine learning model or engine [262, 264] that:
analyzes historical and real-time sensor data to improve the accuracy of the optimization problem formulation, by predicting process behavior or outcomes of candidate control actions; and/or
dynamically adjusts the weighting of multiple objectives or the penalty factors for constraints in the cost function based on learned performance trade-offs; and/or
selects which quantum algorithm or hardware backend to use based on the current state or problem type, learned from past optimization instances;
whereby the machine learning model continuously refines the control policy by learning from the outcomes of previous quantum optimizations, improving both the speed of convergence and the quality of solutions over time.

### Iterative Hybrid Decomposition Embodiment

The system of Embodiment 6, wherein the classical control module and quantum optimization module operate in an iterative hybrid loop such that the optimization problem can be decomposed into sub-problems [1428], as shown in FIG. 14, with a first sub-problem solved by the classical control module or a classical algorithm and a second sub-problem solved by the quantum optimization module, and intermediate results exchanged between them, iteratively converging to a final optimized solution [1434], for example, the classical module optimizes continuous variables given a tentative discrete configuration, and the quantum module optimizes the discrete configuration, encoded in qubits, given tentative continuous variable settings, and this process repeats until the combination of discrete and continuous decisions is jointly optimal.

### Adaptive Objective Weighting Embodiment

The method of Embodiment 7, wherein in step (c) encoding the optimization problem includes representing multi-objective criteria as a weighted sum in the cost function or as separate terms with associated weighting parameters, and the method further comprises adjusting these weighting parameters adaptively based on either predefined schedules or feedback from machine learning such that the real-time optimization can emphasize different objectives under different conditions, for instance, shifting priority from efficiency to throughput during peak demand hours), all while remaining a single unified optimization solved by the quantum algorithm [414, 416].

### Verification and Fail-Safe Embodiment

The method of Embodiment 7, further comprising a verification step after (e) and (f), wherein the system uses a classical simulation or a simplified process model to evaluate the expected outcome of the applied control commands, comparing it to the actual sensor measurements subsequently obtained, and if a significant deviation is detected, indicating the optimization result may be suboptimal or conditions changed rapidly, the system triggers an earlier re-formulation of the optimization problem or engages a fail-safe control mode [514, 522, 528], thereby ensuring robustness and safety in the control loop even in the presence of modeling uncertainties or quantum solver errors.

### Hardware Selection Embodiment

The system of Embodiment 6, wherein the quantum optimization module is compatible with multiple quantum hardware types and further comprises a hardware selection layer [910] that can route the encoded optimization problem to one of: a quantum annealer, a gate-model quantum processing unit, or a quantum-inspired classical solver [912, 916], based on criteria including problem size, variable connectivity requirements, solution time constraints, and hardware availability; and wherein the system can seamlessly switch between different hardware or solver types without altering the high-level control functionality, thereby providing flexibility and resiliency, for example, using a quantum-inspired solver as backup if quantum hardware is unavailable.

### Waste-to-Energy Conversion Embodiment

The system of Embodiment 6, wherein the industrial process is a waste-to-energy conversion system comprising preprocessing units, biological or chemical digesters, and energy generation units, and the control decisions optimized by the quantum module include at least: feedstock allocation among digesters, retention times, mixing speeds, heating levels, catalyst or enzyme dosing, and power generation setpoints, with objectives of maximizing energy output, gas or electricity, maintaining stable digestion, preventing overload or inhibition), and minimizing emissions or residue, all of which are balanced in the cost function solved by the quantum optimization module in real-time, as shown in FIG. 1 and FIG. 6.

### Computer-Readable Medium Embodiment

An optimization engine for industrial processes, tangibly embodied on a non-transitory computer-readable medium [1404], as shown in FIG. 14, and operatively coupled to sensor inputs and actuator outputs of an industrial system, wherein the engine comprises program instructions that when executed perform the steps of any of the methods of Embodiments 27 or 914, thereby enabling a computing system to carry out hybrid quantum-classical optimization-based control of the industrial system as described [1440, 1446, 1450]. Enumerated Embodiments and Architecture Variants (Set C): Transformation of the Industrial Digestive System Objective Function into a Quantum Hamiltonian

### Method Embodiment

Transformation of the IDS Objective Function into a Quantum Hamiltonian A method for transforming an Industrial Digestive System (IDS) objective function into a quantum-suitable Hamiltonian [700], as shown in FIG. 7, the method comprising:
Identifying a multi-process chemical system characterized by:
   A set of processes P={p_1, p_2, . . . , p_n};
   A set of input materials M={m_1, m_2, . . . , m_l};
   A combination C_k={c_{k1}, c_{k2}, . . . , c_{km} of said processes, each having criteria values C_{i_k}=c_{1k}, c_{2k}, . . . , c_mk}∵;
   A set of criteria weights W={w_1, w_2, . . . , w_m};
   Optimal output targets O_n={o_1, o_2}, specifically including “steel-like” and “ethanol” product properties;
   A set of input material percentages X={x_1, x_2, . . . , x_l};
   A matrix A=a_{ij} quantifying the amount of each output o_j produced by processing material m_i in process p_i;
   A set of process or configuration variables V={v_1, v_2, . . . , v_r};
   A score function S(C_k, X)=Σ_i(w_i c_{ik}(p_i))+Σ_iΣ_j(x_i a_{ij} o_j), and an overall objective of finding C_optimal, R_optimal, V_optimal, P_optimal=arg min {S(C_1, X_1), S(C_2, X_2), . . . , (C_m, X_m)}, such that the difference between the actual outputs and the targets (O_1, O_2) is minimized.

Defining Decision Variables based on the IDS processes, material allocations, and process parameters, each decision variable taking a discrete or binary-encoded form. Said variables include at least one of:
A binary indicator for selecting a specific process within C_k;
A discrete encoding for the percentage of each input material x_i allocated to a selected process;
Binary or discretized parameters v_r representing operating conditions (temperature, flow rates, reaction times) in each process p_i.

Formulating a Cost or Energy Function that merges the IDS score function S(C_k, X) with any necessary penalty terms enforcing physical or safety constraints [701, 703], as shown in FIG. 7, wherein:
Each criterion weight w_i and each output metric o_j is mapped to a corresponding cost or reward coefficient;
Hard constraints (e.g. material conservation, capacity limits) are encoded via large penalty coefficients to ensure infeasible states have higher cost/energy;
The objective of minimizing the difference between actual and target outputs {o_1, o_2} is added as a penalty or sub-cost term in the energy function.

Converting the Cost Function to a Quadratic or Hamiltonian Form suitable for quantum computation, comprising:
Binary Variable Representation: Expressing each discrete decision variable {x_i, c_{k_i}, v_r} as a binary or spin variable z_p∈{0,1} or s_p∈{±1} [707], as shown in FIG. 7; Quadratic Terms: For each interaction or coupling between variables (e.g. interplay between material allocation x_i and process choice c_{k_i}), adding terms Q_{pq} z_p z_q to the Hamiltonian, where Q_{pq} is derived from the contribution to S(C_k, X);
Penalty Encoding: Incorporating constraint violations (such as exceeding capacity) as high-energy states through a penalty coefficient λ. For instance, constraints of the Σ_i x_{ij}=1 are added as λ(Σ_i x_{ij}−1)\hat{ }2.

Obtaining the Final Quantum Hamiltonian, denoted H_IDS, expressed in one of the following representative forms:
A QUBO cost function: H_IDS(z)=∈{_φ,q} Q_{pq} z_p, z_q+Σ_p Q_p z_p;
An Ising model form: H_IDS(s)=Σ_{p,q} J_{pq} s_p, s_q+Σ_p h_p s_p;
A parameterized quantum circuit or Hamiltonian encoding suitable for a variational quantum algorithm (e.g. QAOA or VQE), where the cost function is embedded into a diagonal operator in the computational basis [1216], as shown in FIG. 12. Whereby, by transforming the Industrial Digestive System's original objective function S(C_k, X) and constraints into a quantum-suitable Hamiltonian H_IDS, a quantum computer or quantum-inspired solver can search for the global optimum of the Industrial Digestive System configuration (C_optimal, R_optimal, V_optimal, P_optimal) via ground-state energy minimization or analogous quantum optimization techniques [1218, 1222], as shown in FIG. 12, thus providing a novel, computationally enhanced means of achieving the target outputs {o_1, o_2} and maximizing performance in waste or chemical processing operations.

### Enumerated Embodiments and Architecture Variants (Set D)

Computer-Implemented Hamiltonian Formulation Method. A computer-implemented method for formulating a quantum optimization problem from an industrial process, the method comprising: obtaining an objective function that quantifies a performance metric of an industrial digestive system (IDS); transforming the objective function into a quantum Hamiltonian representation [700], as shown in FIG. 7, such that an extremum of the objective function corresponds to an extremum (ground state or excited state) energy of the quantum Hamiltonian; and providing the quantum Hamiltonian to a quantum computing solver for subsequent optimization [1218], as shown in FIG. 12.

Multi-Term Hamiltonian Embodiment: The method of Embodiment 1, wherein the objective function comprises a plurality of sub-objectives corresponding to different stages or units of the industrial digestive system, and transforming the objective function into the quantum Hamiltonian includes combining terms representing each sub-objective with respective weight factors to form a multi-term Hamiltonian [701]. Penalty-Term Hamiltonian Embodiment: The method of Embodiment 1, wherein the objective function includes one or more process constraints, and transforming the objective function comprises adding penalty terms to the quantum Hamiltonian for each constraint, each penalty term being weighted to energetically penalize any quantum state that violates the corresponding constraint [703].

Continuous-Variable Discretization Embodiment: The method of Embodiment 1, wherein the objective function includes at least one continuous process variable, and the transforming step further comprises discretizing each continuous variable into a set of binary or multi-valued variables representable by qubits, such that the quantum Hamiltonian encodes an approximation of the continuous variable's effect on the objective function [410], as shown in FIG. 4.

Industrial Process Optimization System. An industrial process optimization system, comprising:
a quantum processor [912], as shown in FIG. 9; a classical processor [916]; a sensor interface configured to receive real-time operational data from an industrial digestive system (IDS) [240, 250, 260], as shown in FIG. 2: an actuator interface configured to transmit control commands to the IDS [280, 282, 284]; and
a control logic coupled to the quantum processor, the classical processor, the sensor interface, and the actuator interface, the control logic being configured to:
   compute, using the classical processor and the real-time operational data, an objective function representing a performance metric of the IDS;
   transform the objective function into a quantum Hamiltonian suitable for input to the quantum processor;
   solve the quantum Hamiltonian using a hybrid quantum-classical algorithm executed cooperatively by the quantum processor and the classical processor to determine optimized control parameters for the IDS; and
   cause the actuator interface to apply the optimized control parameters to the IDS,
   wherein the control logic iteratively updates the objective function and repeats the transform and solve operations in real time to adapt to changes in the IDS during operation.

Quantum Processor Selection Embodiment: The system of Embodiment 5, wherein the quantum processor is one of: (i) a quantum annealing processor configured to solve the Hamiltonian via quantum annealing; or (ii) a gate-model quantum processor configured to execute a variational quantum algorithm to solve the Hamiltonian, the control logic being further configured to select a corresponding quantum algorithm compatible with the type of quantum processor to perform the solve operation [910, 912]. Adaptive Feedback Controller Embodiment: The system of Embodiment 5, wherein the control logic includes a feedback controller configured to adjust one or more of: the objective function, parameters of the quantum Hamiltonian, or algorithm settings, in response to differences between an expected performance metric and an observed performance metric of the IDS after applying the optimized control parameters, thereby providing adaptive real-time refinement of the optimization [300, 316, 326], as shown in FIG. 3. Backup Classical Optimization Embodiment: The system of Embodiment 5, wherein the classical processor is further configured to execute a backup classical optimization routine to compute interim control parameters for the IDS if a solution from the quantum processor is not obtained within a predetermined time threshold, thereby ensuring continuous and stable operation of the industrial process [508, 510, 528], as shown in FIG. 5.

Industrial Process-Type Embodiment: The system of Embodiment 5, wherein the industrial digestive system (IDS) is selected from the group consisting of a chemical production system having a series of reaction and separation units, a petrochemical refining process, a pharmaceutical manufacturing process, and a wastewater treatment process, and wherein the objective function includes terms for at least two performance criteria selected from throughput, product quality, yield, energy consumption, or waste output of the process.

Real-Time Hybrid Quantum-Classical Control Method: A hybrid quantum-classical optimization method for real-time control of an industrial process, the method comprising:
(a) receiving real-time sensor data from an industrial digestive system (IDS) representing current process state information [300, 302], as shown in FIG. 3;
(b) computing, by a classical processor, an objective function that quantifies performance of the IDS based on the sensor data;
(c) transforming, by the classical processor, the objective function into a quantum Hamiltonian that encodes an optimization problem equivalent to optimizing the performance of the IDS; [700], as shown in FIG. 7;
(d) solving the quantum Hamiltonian by executing a hybrid quantum-classical algorithm, wherein a quantum processor evaluates candidate solutions to the Hamiltonian and a classical processor adjusts algorithm parameters based on the evaluations, to obtain an optimized set of control settings for the IDS [900], as shown in FIG. 9; and
(e) applying the optimized set of control settings to the IDS in real time to adjust operation of the industrial process [324, 326]; wherein steps (a) through (e) are repeated iteratively such that the objective function and the quantum Hamiltonian are continuously updated and re-solved to adapt the control settings to changing conditions or disturbances in the IDS.

Variational Quantum Algorithm Embodiment. The method of Embodiment 10, wherein the hybrid quantum-classical algorithm in step (d) is a variational quantum algorithm that iteratively updates a set of parameters for a parameterized quantum circuit executed on the quantum processor, the method further comprising: measuring an expectation value of the quantum Hamiltonian for a given set of circuit parameters on the quantum processor; and adjusting the parameters on the classical processor using an optimization routine to minimize the expectation value, such that the quantum processor and classical processor collectively converge toward an optimal solution [1216, 1222], as shown in FIG. 12. Quantum Annealing Embodiment: The method of Embodiment 10, wherein solving the quantum Hamiltonian in step (d) comprises performing quantum annealing on the quantum processor to drive the quantum system into a low-energy state of the Hamiltonian, the resulting state representing a candidate solution that improves the performance metric of the IDS.

QUBO-to-Ising Mapping Embodiment: The method of Embodiment 10, wherein transforming the objective function into the quantum Hamiltonian in step (c) comprises formulating a quadratic unconstrained binary optimization (QUBO) model of the industrial process optimization problem [418], as shown in FIG. 4, and mapping the QUBO model onto an Ising Hamiltonian with qubit spin variables [707], as shown in FIG. 7, such that each possible configuration of qubit spins corresponds to a candidate set of process control decisions for the IDS.

Constraint Penalty Hamiltonian Embodiment. The method of Embodiment 10, wherein the objective function includes multiple sub-objectives and at least one constraint, and step (c) further comprises encoding each sub-objective as a distinct term in the quantum Hamiltonian and encoding each said constraint by adding a penalty term to the Hamiltonian weighted to ensure that any quantum state representing a violation of the constraint has a higher energy than states satisfying the constraint, thereby biasing the optimization toward solutions that satisfy all operational constraints of the IDS [701, 703].

Dynamic Quantum Algorithm Selection Embodiment: The method of Embodiment 10, further comprising dynamically selecting a quantum optimization algorithm for executing step (d) from among a plurality of available quantum algorithms based on one or more characteristics of the objective function or the computational resources, wherein the available quantum algorithms include at least a quantum annealing approach and a gate-based quantum circuit variational approach [910, 912]. Classical Interim Control Embodiment. The method of Embodiment 10, wherein during the iterative repetition of steps (a)-(e), if the quantum processor fails to produce an optimized solution within a predefined time interval, the method temporarily invokes a classical optimization procedure on the classical processor to generate an interim set of control settings for the IDS, and subsequently resumes the hybrid quantum-classical solving in step (d), such that real-time control of the industrial process is maintained without interruption [510, 528], as shown in FIG. 5. Industrial Application Embodiment: The method of Embodiment 10, wherein the industrial digestive system (IDS) is selected from the group consisting of a continuous chemical manufacturing process, an oil refining process, a pharmaceutical production line, an energy grid management system, and a water treatment facility, and wherein the performance metric quantified by the objective function is specific to the selected IDS and includes at least one of yield, efficiency, throughput, cost, or environmental impact.

### Enumerated Embodiments and Architecture Variants (Set E)

Quantum-Optimized Waste-to-Resource System: An industrial digestive system for waste-to-energy and waste-to-material conversion, comprising: a feedstock processing assembly including a plurality of heterogeneous and homogeneous waste or other raw materials, molecules and elements of varied composition in a liquid, solid, or gaseous state; conversion units (e.g., anaerobic digesters, gasifiers, fermenters, pyrolysis reactors), each configured to convert input waste into one or more output resource streams; a sensor network operatively coupled to the conversion units to monitor real-time operational parameters, feedstock characteristics, and output stream metrics (gas composition, liquid effluent quality, solid residue content) [240, 250, 260], as shown in FIG. 2; a hybrid quantum-classical control system [900], as shown in FIG. 9, including a classical process controller [916] and a quantum computing module [912], interconnected via a high-speed communication interface for data exchange and control signals [930]; a feedback loop mechanism enabling iterative communication between the sensor network, the classical controller, and the quantum computing module for continuous process adjustment; [300, 316, 326], as shown in FIG. 3; wherein the hybrid quantum-classical control system is configured to optimize industrial waste processing operations in real-time by: (i) aggregating sensor data and formulating at least one optimization problem representing process control decisions (including feedstock allocation, conversion unit operating conditions, and output targets) as an encoded model (using quadratic unconstrained binary optimization or an Ising model) suitable for quantum computation [418], as shown in FIG. 4; (ii) applying quantum optimization algorithms, including at least one of a Quantum Approximate Optimization Algorithm (QAOA), a Variational Quantum Eigensolver (VQE), or a quantum annealing routine, to solve the encoded optimization problem for optimal control parameters [1218, 1222], as shown in FIG. 12—thereby enhancing process efficiency, maximizing resource recovery (energy and materials), and improving chemical transformation yields; and (iii) adjusting control variables of the conversion units in real-time based on the quantum-derived optimal parameters via the classical controller, whereby the system dynamically adapts to changing feedstock conditions and balances multiple performance objectives (energy output, material recovery, and emission reduction) through a quantum-optimized feedback control loop.

### Hybrid Quantum-Classical Process Control Method

A method for real-time optimization of an industrial digestive system (IDS) using a hybrid quantum-classical process control, the method comprising: Monitoring heterogeneous waste streams and process conditions by collecting sensor data on feedstock composition, operating parameters (temperature, pressure, pH, etc.), and output quantities/qualities from multiple waste conversion units in the system [300, 302], as shown in FIG. 3; Encoding a multi-objective optimization problem that models the industrial digestion process, including variables for assigning portions of the waste feedstock to specific conversion units, setting operating conditions for each unit, and target levels for outputs, the problem being formulated in a quantum-representable form (as a QUBO or equivalent Ising model, or as parameterized quantum circuits for variational algorithms) [418, 1216], as shown in FIG. 4 and FIG. 12; Quantum Computing Optimization by inputting the encoded problem into a quantum computing module and solving it using a quantum algorithm selected from a group consisting of QAOA, VQE, or quantum annealing, wherein the chosen algorithm evaluates numerous possible feedstock allocation combinations and process parameter settings in parallel to maximize energy yield and resource recovery while minimizing emissions—for example, using QAOA to find an optimal assignment of waste streams to conversion units, and/or using VQE to simulate molecular-level reactions for selecting optimal catalysts or reaction conditions; Applying Optimized Controls by transferring the solution from the quantum computing module to the classical process controller and adjusting process control parameters in real-time, including redirecting waste feedstock flows to the designated conversion units as determined by the quantum solution, tuning operating set-points (such as reactor temperature, airflow, retention time, or catalyst dosage) for each unit, and activating relevant actuators or valves [280, 282, 284], as shown in FIG. 2; and Iterative Feedback and Learning by continuously or periodically repeating the monitoring, encoding, quantum computing optimization, and applying steps in a closed-loop manner, such that new sensor data is used to update the optimization problem and the quantum algorithm is re-run to refine the control outputs, thereby forming an adaptive hybrid quantum-classical feedback loop that responds to feedstock variability and process disturbances, optionally incorporating machine learning [262, 264], as shown in FIG. 2, to improve the optimization model or algorithm parameters over time based on historical data.

Conversion Unit Allocation Embodiment: The system of Embodiment 1, wherein the feedstock processing assembly comprises a plurality of conversion units selected from the group consisting of anaerobic digesters, gasifiers, fermentation reactors, pyrolysis units, and incineration chambers, and wherein the control system dynamically allocates portions of the heterogeneous waste feedstock to one or more of said conversion units in real-time based on the quantum-optimized decision output to maximize overall conversion efficiency.

QUBO Feedstock Allocation Embodiment: The system of Embodiment 1, wherein the hybrid quantum-classical control system encodes the waste feedstock allocation problem as a quadratic unconstrained binary optimization (QUBO) model that represents decisions for assigning different types or portions of waste to the available conversion units, and solves the QUBO model using a quantum annealer, yielding an optimal or near-optimal allocation that maximizes energy yield from the waste and minimizes unutilized residues [701, 703], as shown in FIG. 7.

Multi-Output Stream Optimization Embodiment: The system of Embodiment 1, wherein the industrial digestive system produces multiple distinct output streams including (i) a combustible gas output, (ii) a liquid effluent output, and (iii) a solid residual output, and wherein the hybrid quantum-classical control system is configured to optimally balance the quantities and qualities of these output streams by adjusting feedstock distribution and process conditions via quantum multi-objective optimization, such that an increase in one output (energy-rich gas, for example) does not unduly reduce the yield or quality of the other outputs beyond predefined acceptable trade-offs.

Composite Multi-Objective Cost Function Embodiment: The system of Embodiment 1, wherein the quantum optimization performed by the control system incorporates multiple objectives in a single composite cost function, including at least maximizing energy production, maximizing material recovery (of useful liquids or solids), and minimizing pollutant emissions, by assigning weighting factors to each objective or using a Pareto-optimization approach within the quantum algorithm, such that the solution obtained by the quantum computing module represents an optimal trade-off among the specified objectives to improve overall sustainability of the process: [414, 416], as shown in FIG. 4.

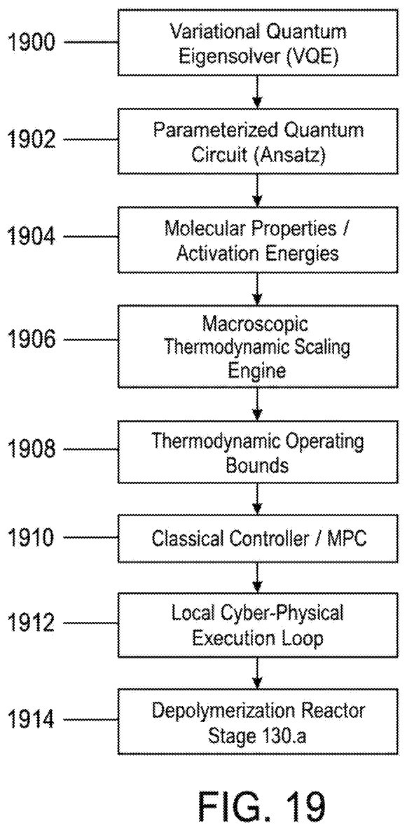

VQE Reaction Modeling Embodiment: The system of Embodiment 1, wherein the control system utilizes a Variational Quantum Eigensolver (VQE) algorithm as part of its optimization process to perform molecular-level reaction modeling for one or more conversion units—simulating, for example, the interaction of feedstock molecules with a catalyst or the biochemical pathway of anaerobic digestion—and uses the VQE-derived results to identify optimal catalyst selections or reaction parameters, subsequently adjusting the operating conditions or adding the selected catalyst in the corresponding conversion unit to enhance chemical transformation efficiency and product yield [1900, 1904], as shown in FIG. 19.

QAOA Discrete Control Embodiment: The system of Embodiment 1, wherein the quantum computing module executes a Quantum Approximate Optimization Algorithm (QAOA) on a gate-based quantum processor to optimize discrete control decisions, including scheduling of batch processing or selection of processing pathways for incoming waste batches, thereby improving throughput by finding an optimal sequence or combination of process steps for each waste batch that maximizes energy extraction and resource recovery [912, 1222], as shown in FIG. 9 and FIG. 12.

Machine Learning Strategy Refinement Embodiment: The system of Embodiment 1, wherein the hybrid quantum-classical control system further comprises a machine learning module configured to analyze historical sensor data and past optimization outcomes to adaptively refine the optimization strategy, whereby the machine learning module updates parameters of the quantum optimization (or modifies the cost function and constraints) over time to improve convergence speed and solution quality as the system processes varying waste streams [262, 264].

Real-Time Control Cycle Synchronization Embodiment: The system of Embodiment 1, wherein the feedback loop mechanism operates at a control cycle frequency that enables substantially real-time adjustments, and the quantum computing module is configured to deliver optimization solutions within each control cycle or at predetermined intervals, the system further synchronizing the quantum computation output with classical control signals so that updated setpoints or control actions are applied without causing instability, thus ensuring stable continuous operation of the industrial digestive process under quantum-guided control [508, 516], as shown in FIG. 5.

### Quantum Hardware Interface Embodiment

The system of Embodiment 1, wherein the quantum computing module comprises one of: (a) a dedicated quantum annealing processor, (b) a gate-model quantum processing unit with qubits executing quantum circuits, or (c) a high-performance classical emulator of quantum algorithms, and wherein the classical process controller interfaces with said quantum computing module via a communication link that transmits encoded optimization problems and retrieves computed solutions with low latency, thereby allowing the integrated system to utilize quantum optimization within timeframes suitable for real-time process control, [910, 912, 916], as shown in FIG. 9.

Ising Hamiltonian Control Embodiment: The system of Embodiment 1, wherein process control decisions are formulated as an Ising model Hamiltonian whose ground state corresponds to an optimal set of control actions (including feedstock routing and process parameter settings), and the quantum computing module applies an adiabatic quantum annealing process to find or approximate said ground state, thus obtaining the optimized control actions that minimize the energy of the Ising formulation (which represents the cost or negative performance of the system): [700, 707], as shown in FIG. 7.

Asynchronous Quantum-Classical Feedback Embodiment: The system of Embodiment 1, wherein the hybrid control system is configured in an asynchronous quantum-classical feedback architecture such that the quantum computing module provides updated optimization solutions at periodic intervals that may span multiple classical control cycles, and further comprising a predictive control buffer that applies interim control actions (using the last quantum solution or a classical model) during the intervals between quantum computation updates, whereby continuous process regulation is maintained and the latest quantum-optimized adjustments are incorporated once available without requiring the quantum module to operate every cycle [510, 528], as shown in FIG. 5.

### Coordinated Multi-Algorithm Quantum Workflow Embodiment

The system of Embodiment 1, wherein the control system employs a hybrid workflow with multiple quantum algorithms in coordination, such that a first quantum algorithm is used to optimize a first subset of decision variables (for example, using QAOA or quantum annealing to determine the optimal assignment of various waste streams to the different conversion units), and a second quantum algorithm is used to optimize a second subset of decision variables (for example, using VQE or another variational technique to fine-tune continuous process parameters or reaction conditions within a selected conversion unit), the control system integrating the results of both quantum optimizations to implement a unified, improved control action for the industrial digestive system [900, 908].

### Waste Stream Classification and Preprocessing Embodiment

The method of Embodiment 2, wherein prior to encoding the optimization problem, the method further comprises classifying and preprocessing incoming waste streams by type or composition using sensor data and machine learning techniques, and grouping the waste inputs into categories, such that the optimization encoding can treat each category as a distinct feedstock type with known characteristics—reducing the complexity of the optimization problem for the quantum algorithm and improving solution relevance for each waste category [410], as shown in FIG. 4.

### Combinatorial Feedstock Assignment Embodiment

The method of Embodiment 2, wherein the step of encoding the optimization problem includes formulating a combinatorial feedstock allocation sub-problem that assigns each classified waste batch to a particular conversion unit or sequence of units, and associating an energy yield value with each potential assignment, and wherein solving the problem with the quantum algorithm comprises using a quantum annealer to maximize the total energy yield by selecting the combination of assignments that produces the highest aggregated energy output (such as total biogas or syngas production) from all conversion units.

### Catalyst or Biochemical Additive Selection Embodiment

The method of Embodiment 2, wherein the method further comprises evaluating multiple catalyst or biochemical additive options for at least one conversion process (either in a chemical reactor or a biological digester) by utilizing a VQE-based quantum chemistry simulation to predict the reaction efficiency or product yield with each catalyst option, and selecting the catalyst that yields the optimal performance according to the VQE simulation, whereupon the selected catalyst is applied to the process and the optimization routine incorporates this catalyst choice into subsequent control calculations [1900, 1904].

### Emission-Constrained Quantum Optimization Embodiment

The method of Embodiment 2, wherein minimizing emissions is explicitly integrated into the quantum optimization by including emission penalty terms or constraints in the encoded cost function, the method further comprising adjusting process parameters (including combustion air flow rates, reactor temperatures, or residence times) based on the quantum solution to maintain pollutant emissions (such as CO_2, CH_4, NO_X, or SO_X levels) below regulatory thresholds, thereby ensuring that the quantum-optimized control strategy achieves environmental compliance in addition to efficiency and resource recovery objectives.

### Enumerated Embodiments and Architecture Variants (Set F):

### Quantum Hamiltonian Formulation for Industrial Digestive System

A quantum software framework for optimizing a cyber-physical “Industrial Digestive System” (IDS) that converts heterogeneous waste feedstocks, molecules and elements into usable outputs (biofuels, chemicals, or composite materials), the framework comprising: An Objective/Hamiltonian Construction Module configured to: Parse IDS parameters, including:
A set of processes {p_1, p_2, . . . , p_n} representing chemical or biological transformation stages;
A set of input materials {m_1, m_2, . . . , m_l} representing heterogeneous waste streams;
A set of criteria weights {w_1, w_2, . . . , w_m} correlating each performance criterion (e.g. yield, energy consumption, emissions) to its importance in the overall objective;
Process variables {v_1, v_2, . . . , v_r} specifying operating conditions (such as temperature, pressure, flow rates);
Desired outputs {o_1, o_2, . . . , o_k} reflecting target qualities (e.g., steel-like material, ethanol purity);
Formulate an IDS-specific score function S(C_k, X) or equivalent multi-objective cost function that captures both the yield benefits and the penalty terms for resource usage, operating costs, and environmental impact;
Encode said score or cost function into a quantum Hamiltonian H_IDS [700], as shown in FIG. 7, by mapping decision variables (feedstock allocation, process activation, catalyst choice) to qubits, constructing penalty terms for constraints [703] and combining objective terms into either a Quadratic Unconstrained Binary Optimization (QUBO), Ising model, or parameterized Hamiltonian form suitable for quantum algorithms [418], as shown in FIG. 4. A Quantum Optimization Engine that, upon receiving the Hamiltonian H_IDS, executes at least one quantum algorithm selected from the group consisting of: Quantum Annealing, wherein H_IDS is programmed into an annealer that seeks the ground state reflecting an optimal or near-optimal allocation of the heterogeneous inputs and process settings;
Quantum Approximate Optimization Algorithm (QAOA), wherein a parameterized circuit is evolved under cost and mixing Hamiltonians to minimize [symbol] H_IDS [symbol] : Variational Quantum Eigensolver (VQE), wherein a parameterized ansatz simulates reaction pathways or process conditions, adjusting parameters via a classical optimizer to minimize the expectation of H_IDS.

A Hybrid Control Interface that receives the quantum-optimized solution from the Quantum Optimization Engine and orchestrates real-time process commands (e.g., routing feedstock, adjusting reactor setpoints) via a classical automation layer [916, 930], as shown in FIG. 9 continually re-updating H_IDS based on sensor data and target performance metrics, thus forming a closed-loop quantum-classical feedback system for the Industrial Digestive System [300, 316, 326], as shown in FIG. 3.

### Method for Quantum Hamiltonian-Based Control of a Cyber-Physical Waste Refinery

A computer-implemented method of controlling an Industrial Digestive System (IDS) that receives uncategorized waste feedstocks and converts them into energy, biofuels, chemicals, or composite materials, said method comprising:

Receiving real-time process data, including sensor readings of the incoming feedstock composition, intermediate states, and output qualities, as well as the IDS's operational constraints (capacity, temperature limits, etc.) and performance objectives (energy maximization, emissions minimization, product purity) [300, 302], as shown in FIG. 3.

Constructing a multi-objective function F(x) that captures both yield-enhancing terms (e.g. total generated biogas or useful material) and penalty terms (energy cost, waste disposal cost, or pollutant emissions).

Encoding F(x) into a quantum Hamiltonian H_IDS(z) wherein the binary/spin variables z represent discrete process decisions (which reactor to use, how much feedstock to send, whether to apply a certain catalyst), and continuous process settings are discretized into qubits through binary expansions or multi-level encodings [410], as shown in FIG. 4.

Applying a quantum algorithm to find or approximate the ground state of H_IDS. The algorithm comprises at least one of:

Quantum Annealing: embedding H_IDS onto a quantum annealing architecture and running an anneal schedule to sample low-energy solutions; QAOA: preparing a parameterized circuit with cost and mixing operators for the IDS problem, iteratively refining angles via classical feedback; VQE: constructing a domain-specific ansatz for the process configurations, measuring [symbol] H_IDS [symbol] , and using a classical optimizer to converge on minimal energy.

Interpreting the quantum solution vector arg min H_IDS as real-time control instructions (activating processes, setting feed rates, specifying catalysts) and implementing these instructions via the IDS's classical control system (programmable logic controllers, actuators, valves) [324, 326]. Repeating steps (1)-(5) in iterative feedback cycles at a frequency determined by process dynamics, optionally integrating machine learning [262, 264], as shown in FIG. 2, to refine weights in H_IDS or accelerate the quantum algorithm parameter search, thereby achieving a continuously optimized waste-refinery process that adapts to feedstock and market changes in real time.

### Hybrid Discrete-Continuous Encoding

The quantum software framework of Embodiment 1, wherein continuous operating variables (e.g., reactor temperature, flow velocity, retention time) are discretized into binary expansions to fit into the QUBO or Ising model, and penalty terms are added to enforce maximum or minimum thresholds, guaranteeing physically valid states in the quantum Hamiltonian solution [410, 707], as shown in FIG. 4 and FIG. 7.

### Quantum Machine Learning Integration

The method of Embodiment 2, wherein a quantum machine-learning model (e.g., a quantum neural network or Quantum Kernel-based regressor) is trained on historical IDS performance data to predict yields or emissions for certain feedstock distributions, and said model is embedded into the quantum optimization loop as an oracle or a subroutine, enabling more accurate selection of process configurations within the quantum Hamiltonian approach [262, 264].

### Reactive Catalyst Optimization Via VQE

The system of Embodiment 1, wherein the quantum optimization engine leverages Variational Quantum Eigensolver subroutines to model the electronic structure of reaction intermediates in the IDS, guiding catalyst selection for a given feedstock composition, thus directly integrating quantum chemistry calculations into the process-level optimization Hamiltonian [1900, 1904], as shown in FIG. 19. Quantum Approximate Scheduling of Batch Inputs: The method of Embodiment 2, wherein part of the Hamiltonian includes a scheduling sub-Hamiltonian representing discrete time slots or batch windows for feeding waste into the IDS, and QAOA is used to find an optimal schedule that maximizes throughput and evenly distributes workload across multiple reactor units, reducing downtime and balancing energy load while respecting capacity constraints [1216, 1222], as shown in FIG. 12. Dynamic Objective Weighing for Multi-Output Systems: The method of Embodiment 2, wherein the quantum Hamiltonian incorporates time-varying weight coefficients for different outputs (biofuels, chemicals, recovered solids) so that, in response to external market signals or user-defined priorities, the quantum solver can shift the optimization emphasis from one output to another without redesigning the entire cost function. This is achieved by parameterizing objective weights {w_E, w_M, w_emissions} as dynamic variables fed into each Hamiltonian update cycle [414], as shown in FIG. 4.

### Constraint Satisfaction Oracle Using Grover's Search:

The quantum software framework of Embodiment 1, wherein a Grover-based subroutine is used to handle hard constraint satisfaction (e.g., ensuring feedstock composition meets stoichiometric requirements), by marking states that meet certain feasibility thresholds, and amplitude-amplifying them to find feasible solutions more efficiently before the main optimization is executed with QAOA or quantum annealing.

### Active Learning for Real-Time Feedstock Characterization:

The method of Embodiment 2, wherein each iteration includes an active learning phase that collects new sensor data on the waste composition, updates a surrogate function for reaction yields, and refines the quantum Hamiltonian's coefficients accordingly, ensuring that the quantum optimization remains robust even if the feedstock properties diverge significantly from previously observed values (e.g., new types of plastic content or inert contaminants [262, 264, 306]. Distributed Quantum Optimization Network:

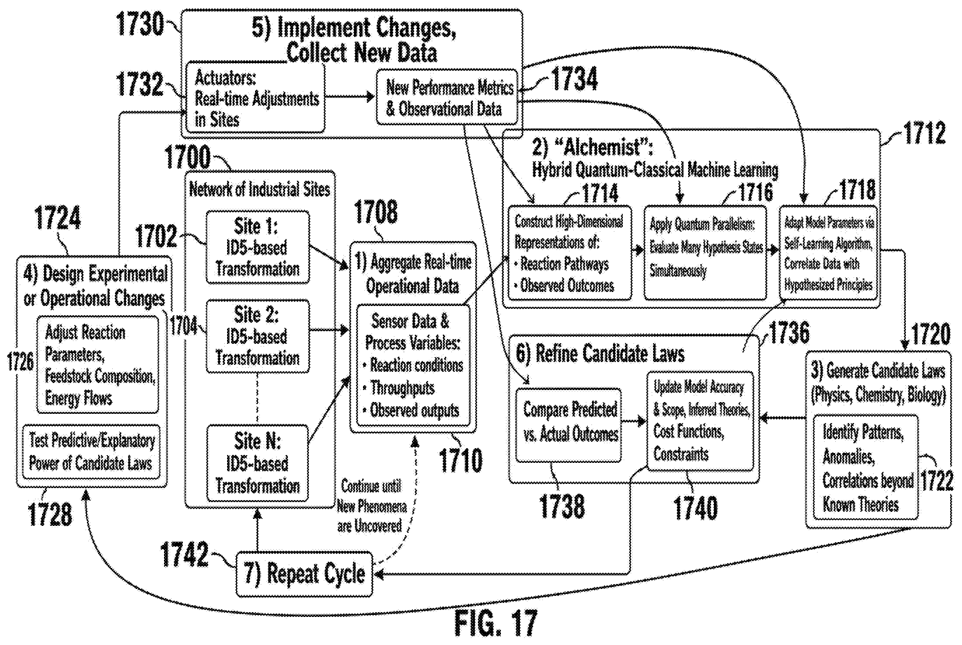

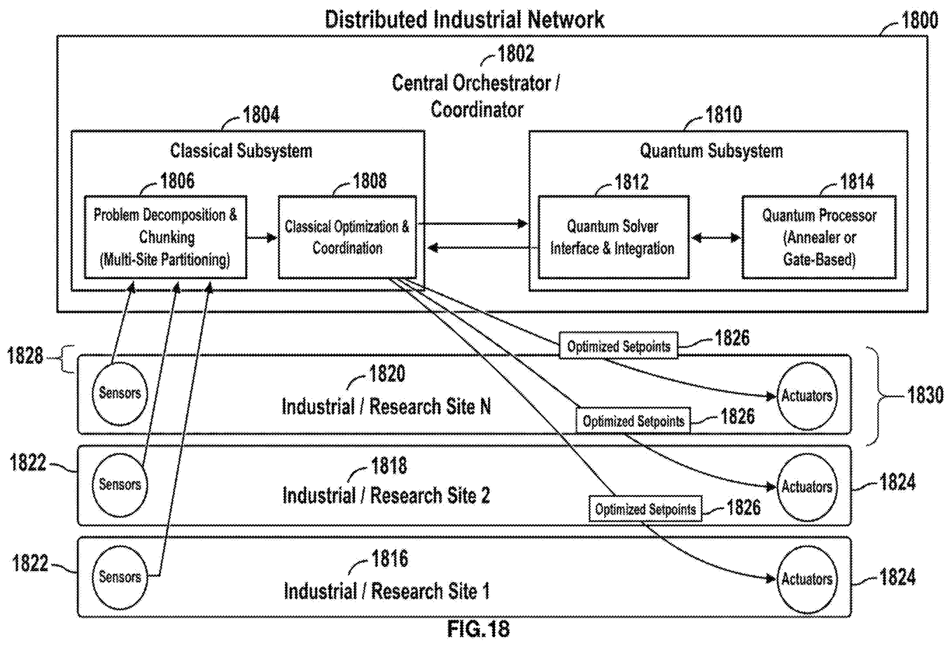

The framework of Embodiment 1, wherein multiple quantum processors are utilized in parallel, each focusing on a sub-Hamiltonian (e.g., separate sections of the IDS pipeline—sorting, anaerobic digestion, pyrolysis, chemical finishing), with a classical orchestration layer merging partial quantum solutions into an overall feasible configuration, thereby scaling to large industrial plants with dozens of processes and thousands of sensor-actuator nodes [1800, 1802, 1808], as shown in FIG. 18. Asynchronous Quantum-Classical Coordination: The method of Embodiment 2, wherein the quantum solver runs asynchronously with respect to the main control loop, providing updated solutions whenever it converges to a new minimum of H_IDS, and the classical controller enacts those solutions only if they represent an energy or throughput improvement of at least a threshold percentage, thus preventing frequent toggling of actuators and ensuring stable industrial operation-[508, 510, 528], as shown in FIG. 5. Penalized Emissions Minimization in the Hamiltonian: The framework of Embodiment 1, wherein an emissions penalty term λ_E Σ(C_pollutant−C_threshold)\hat{ }2 is embedded in H_IDS to heavily penalize process states producing pollutant concentrations exceeding target levels, thus forcing the quantum solver to prioritize low-emission solutions and maintain regulatory compliance [703]. Interleaving Classical LP/MPC with Quantum Optimization:

The method of Embodiment 2, wherein classical linear or model-predictive control (MPC) logic is used for short timescale stability (ensuring immediate safety and smooth operation), while the quantum Hamiltonian solver handles longer-horizon or more combinatorial aspects (e.g., feedstock routing, advanced process scheduling), with both levels exchanging constraints and solutions to achieve synergy between classical real-time control and quantum global optimization [1910], as shown in FIG. 19. System-Level Summation of Outputs in QUBO Form:

The software of Embodiment 1, wherein the objective function includes the summation of partial yield metrics from each process, such that S(C_k,X)≡Σ_i(Σ_j α_ij x_ij)−Σ′ penalties, and all higher-order coupling terms (representing interactions between processes or parallel feed lines) are mapped to quadratic couplings in the QUBO matrix, ensuring the quantum solver captures multi-unit interactions for a truly system-level optimum [418, 701]. Integration with Existing Cyber-Physical Patent Embodiments: The quantum software framework of Embodiment 1, applied onto an existing cyber-physical system patent protecting the IDS hardware (conveyors, reactor vessels, sensors, and actuators), thereby extending said patent to incorporate a quantum computational layer that encodes the industrial objective function into a Hamiltonian and solves it with quantum algorithms, resulting in a real-time, adaptive quantum-optimized industrial digestive system [200, 266], as shown in FIG. 2. Enumerated Embodiments and Architecture Variants (Set G)

Quantum-Enhanced Industrial Digestive System Software: A quantum software system designed to control a cyber-physical “Industrial Digestive System” (IDS) that converts heterogeneous, potentially uncategorized waste into multiple valuable outputs (biofuels, chemicals, reusable composites), said software comprising: A Quantum Model Builder configured to: Collect input from a set of sensors monitoring waste composition, process states, and output qualities of the IDS's multi-stage waste conversion hardware [240, 250, 260], as shown in FIG. 2; Identify discrete decision variables (e.g., which process to activate, how to route feedstock) and continuous decision variables (e.g., fraction x_i of each material, reaction temperature) from the objective function S(C_k, X); Partition or discretize these variables (e.g., dividing continuous percentages into finite steps, splitting large combinatorial sub-problems by domain heuristics) to reduce the search space into a quantum-tractable subset [410], as shown in FIG. 4: Construct an Industrial Digestive System Hamiltonian H_IDS [700], as shown in FIG. 7, or a QUBO/Ising cost function capturing the multi-objective nature (e.g. energy yield, emissions penalties, product purity) and the relevant constraints (capacity, stoichiometry, safety) [701, 703]. A Quantum Optimization Module that receives the Hamiltonian H_IDS and executes at least one of: Quantum Annealing, loading the cost function into an analog quantum annealer to find low-energy solutions; QAOA, applying a parameterized circuit to a gate-based quantum processor with cost and mixing operators reflecting S(C_k, X), iteratively refining angles (γ, β) [1216, 1222], as shown in FIG. 12; VQE, if the system includes chemical-level modeling of catalysts or reaction pathways, using a variational ansatz to minimize [symbol] H_IDS [symbol] via a hybrid quantum-classical loop [1900, 1904], as shown in FIG. 19. A Hybrid Integration Layer bridging the quantum solver with a classical industrial control system [900, 908], as shown in FIG. 9, wherein: Partial solutions from the quantum solver are merged with classical heuristics, domain rules, or sub-problem solutions; The system iterates these solutions in near-real-time feedback loops, adjusting process setpoints and material flows in the IDS hardware [300, 326], as shown in FIG. 3: Quantum Machine Learning subroutines can act as surrogates or oracles—either classifying feasibility of certain feedstock combos or approximating reaction yields—and are trained iteratively on the system's historical data to improve quantum solution quality [262, 264]. Method of Hybrid Quantum-Classical Partial Problem Decomposition for an IDS: A computer-implemented method for operating an Industrial Digestive System under a large-scale optimization problem, the method comprising: Gathering sensor data about each waste input's composition and real-time conditions (e.g. flow rate, temperature, reaction progress) to form a global objective function S(C_k, X) from the attached text, capturing yield benefits, cost, and constraints [300, 302]; Partitioning the overall objective into sub-problems amenable to quantum computation, including at least one combinatorial sub-problem with discrete choices (e.g. which process chain, how to batch schedule) and optionally a set of discretized continuous variables for partial quantum encoding [1428], as shown in FIG. 14; Encoding each sub-problem into a quantum-ready form—e.g., QUBO or a parameterized quantum circuit—and applying a chosen quantum algorithm (quantum annealing, QAOA, or VQE) to solve or approximate the sub-problem's optimal state: Integrating quantum solutions back into a classical orchestration layer that merges partial solutions, resolving conflicts or refining continuous variables with classical optimization or heuristics, thereby assembling a feasible global configuration (e.g., {C_optimal, X_optimal}) [1434]; Implementing the global configuration by sending updated actuator commands (material routing, process setpoints) to the IDS hardware, [324, 326]: Iterating steps (1)-(5) in a feedback loop, with new sensor data prompting re-encoding or re-partitioning if feedstock composition or performance goals shift, thus ensuring a dynamically self-optimizing Industrial Digestive System harnessing both quantum and classical computational resources.

### Quantum ML Surrogate Modeling:

The quantum software system of Embodiment 1, wherein a quantum machine learning model (such as a quantum kernel method or variational quantum regressor) is trained on historical or simulated data to approximate S(C_k, X), thus reducing the cost of evaluating candidate solutions during the quantum optimization loop. The quantum solver uses said surrogate model as an oracle to prune infeasible combinations or guide searching high-potential regions of the combinatorial spacer [262, 264].

### Iterative Active Learning Subroutine

The method of Embodiment 2, wherein after partial solutions are tested physically or in a high-fidelity simulation, the system updates the quantum Hamiltonian coefficients or the penalty terms, then re-runs the quantum solver, forming an active learning loop that converges on an improved solution over successive cycles, even if the full problem size exceeds direct quantum hardware capacity [414, 416]. Discrete-Continuous Hybrid Approach:

The quantum software of Embodiment 1, wherein the system encodes discrete process combinations and discretized continuous percentages {x_i} into a single QUBO or Ising formulation, dividing the continuous domain into bins (e.g. 0%, 10%, 20%, . . . ) and using multiple qubits per variable. A classical local optimizer may further refine the best quantum solution by fine-tuning continuous parameters around the discrete optimum. [410, 707]. Grover's Constraint Oracle for Feasibility Checking:

The method of Embodiment 2, further comprising constructing a Grover-based oracle for sub-problems requiring strict constraint satisfaction (e.g. stoichiometric or safety thresholds). Feasible states are flagged as “good solutions,” letting the system amplitude-amplify valid states before or during QAOA/annealing, speeding the search for feasible combinations in a vast design space.

Batch Scheduling with QAOA:

The software of Embodiment 1, wherein one sub-problem specifically addresses scheduling of large waste batches into finite time slots across multiple reactors, mapped onto a QAOA circuit that minimizes overlapping usage of capacity-limited equipment and maximizes throughput. The circuit's cost Hamiltonian penalizes idle or overload states, while the mixer Hamiltonian enforces binary scheduling constraints [704], as shown in FIG. 7. Catalyst and Reaction Pathway Optimization via VQE:

The method of Embodiment 2, further comprising a specialized Variational Quantum Eigensolver subroutine modeling molecular interactions or reaction pathways for one or more catalytic processes in the IDS, adjusting the quantum ansatz's parameters to discover an energy-minimized reaction path. The chosen path or catalyst data is then integrated into the overarching quantum Hamiltonian, ensuring the system not only picks process steps but also tailors reaction chemistry for maximum yield [1900, 1904], as shown in FIG. 19. Quantum-Inspired Heuristics in Absence of Sufficient Qubits:

The system of Embodiment 1, wherein if the full combinatorial problem size surpasses the available qubit count, a quantum-inspired classical solver (e.g. simulated quantum annealing) is used for partial optimization or to create an initial guess, and the actual quantum hardware focuses on a smaller but critical sub-problem. The final solution merges both partial quantum solutions and classical heuristics to scale beyond near-term quantum device limits [510, 914], as shown in FIG. 5 and FIG. 9. Advanced Decomposition with Real-Time Embedding Adjustments:

The method of Embodiment 2, wherein the partitioning (step 2) uses a dynamic decomposition strategy, iteratively reassigning sub-problems to the quantum solver depending on their current complexity or effect on the global cost. If a sub-problem is solved or becomes irrelevant due to feedstock changes, a new sub-problem is formed for the quantum solver, effectively rotating high-priority tasks through the limited quantum hardware in real time [814, 1428], as shown in FIG. 8 and FIG. 14. Adaptive Multi-Objective Weighting:

The software of Embodiment 1, wherein the IDS Hamiltonian includes distinct cost terms for energy output, material purity, emissions, and operating costs. A time-varying weighting vector w(t) is used, letting the quantum solver shift emphasis among these objectives based on external signals (e.g. electricity prices, emission penalties). The system updates w(t) each control cycle to reflect dynamic business or regulatory conditions, ensuring the quantum optimization remains aligned with the IDS's real-time priorities [414], as shown in FIG. 4. Self-Optimizing Industrial Digestive System Integration:

The method of Embodiment 2, applied to the physical IDS hardware described in a prior patent, wherein the quantum software is deployed on a cyber-physical architecture such that sensor data from the waste inputs and process outputs is continuously fed into the quantum solver. The solver's best solution is implemented via actuators controlling feedstock sorting, reactor operation, and post-processing steps, forming a self-optimizing plant that can handle waste composition changes, unknown contaminants, and multi-output demands (e.g. maximizing ethanol yield vs. composite material production) far more efficiently than purely classical optimization loops [200, 240, 280], as shown in FIG. 2. Enumerated Embodiments and Architecture Variants (Set H): Method for Quantum-Assisted Transformation of Heterogeneous Input into Usable Products

A method of transforming an input—wherein the input comprises waste materials, molecular or elemental feedstocks, or other raw materials of varied composition in liquid, solid, or gaseous form—into one or more usable products, the method comprising:

Inputting the feedstock into an Industrial Digestive System (IDS) [200], as shown in FIG. 2, equipped with multi-stage processing units and sensor arrays [240, 250, 260], said sensor arrays monitoring at least one property of the input (composition, physical characteristics, or chemical attributes). Submitting the sensor data and operational parameters to a Quantum Model Builder, which: Identifies relevant decision variables (e.g., which processes to activate, how to route materials) and any continuous operating parameters (fractions x_i, reaction temperatures, etc.) based on a multi-objective function S(C_k, X) describing yield, emissions, and resource usage; Partitions or discretizes large, continuous, or combinatorial sub-problems, reducing them into quantum-tractable subsets (via domain heuristics, finite-step discretization, or partial sub-problem isolation) [410], as shown in FIG. 4; Constructs an Industrial Digestive System Hamiltonian H_IDS [700], as shown in FIG. 7, or a QUBO/Ising cost function reflecting the multi-objective nature (energy yield, emissions penalties, product purity) plus relevant constraints (capacity, stoichiometry, safety) [701, 703]. Generating at least one quantum optimization query by feeding the Hamiltonian or cost function H_IDS into a Quantum Optimization Module [266], as shown in FIG. 2, which executes at least one quantum approach selected from: Quantum Annealing, mapping H_IDS onto an analog annealer for sampling low-energy solutions; QAOA (Quantum Approximate Optimization Algorithm), applying a parameterized quantum circuit with cost and mixing operators that capture the IDS objectives, iteratively refining angles γ, β [1216, 1222], as shown in FIG. 12; VQE (Variational Quantum Eigensolver), if chemical-level modeling (catalyst optimization, reaction pathway design) is required, employing a variational ansatz to minimize [symbol] H_IDS [symbol] via a hybrid quantum-classical loop. Receiving a candidate solution from the Quantum Optimization Module, then actuating transportation mechanisms—including doors, conveyors, pipes, valves, or hermetically sealed channels—to route the input through the IDS processes (e.g., shredders, depolymerizers, hydrolysis/fermentation reactors, separators, polymerization mixers, distillation units) as prescribed by the quantum-derived configuration [1228, 1236, 1238, 1240, 1242, 1244, 1246], as shown in FIG. 12, and through path control functions [1503], as shown in FIG. 15. Monitoring progress of the input along the selected processing pathway, including intermediate and final product characteristics, via real-time sensor feedback or historical data, wherein the system: Iteratively updates the quantum cost function or Hamiltonian with newly measured properties (feed composition changes, reaction yields, byproduct formation); Re-runs or refines the quantum optimization step in a closed-loop manner [300, 316, 326], as shown in FIG. 3, thus adapting operating parameters or feed distribution dynamically to enhance efficiency, product quality, and resource recovery. Outputting one or more usable products (biofuels, chemicals, reusable conglomerates, or other valuable materials) from the Industrial Digestive System in accordance with the quantum-optimized strategy.

### Quantum-Enhanced Industrial Digestive System (IDS) Software and Hardware Integration

A system for transforming heterogeneous input materials into valuable products, the system comprising: An Industrial Digestive System (IDS) including: Multi-stage processing hardware (e.g., shredders, grinders, depolymerizers, hydrolysis/fermentation reactors, separators, polymerizers, distillation units), each stage equipped with sensors capturing composition, flow rate, temperature, and other operational data [1228, 1230, 1232, 1236, 1238, 1240, 1242, 1244, 1246], as shown in FIG. 12; Actuators, valves, and feed conduits enabling reconfiguration of material flow across the various processing stages [280, 282, 284], as shown in FIG. 2, and path control functions [1503], as shown in FIG. 15. A Quantum Model Builder configured to: Collect sensor data from the IDS's multi-stage hardware, including real-time measurements of material composition, reactor states, and product outputs [300, 302], as shown in FIG. 3; Identify discrete and continuous decision variables from a multi-objective function S(C_k, X) describing yield, product quality, or emission targets; Construct an Industrial Digestive System Hamiltonian H_IDS or a QUBO/Ising cost formulation capturing the relevant constraints (capacity, stoichiometry, safety) and multi-objective performance metrics [700, 701, 703], as shown in FIG. 7. A Quantum Optimization Module [266], as shown in FIG. 2, communicatively coupled to the Quantum Model Builder, executing at least one quantum algorithm to find or approximate a solution to H_IDS, the module comprising:
A quantum annealing processor or a gate-based device (QAOA, VQE), selecting an algorithm based on the problem structure (discrete routing, chemical modeling, or multi-objective weighting) [910, 912], as shown in FIG. 9;
A feedback channel receiving partial or final solutions from quantum computations and merging them with classical heuristic or machine learning outputs if necessary [916]. A Hybrid Integration Layer bridging the quantum solver and the IDS's classical control system, wherein: Quantum solutions are combined with domain heuristics or sub-problem solutions from classical AI to produce near-real-time setpoints for each IDS stage [930], as shown in FIG. 9: The system iterates these solutions in a feedback loop, adjusting process routing or operating conditions to match quantum-derived configurations, while sensor updates refine subsequent quantum runs [300, 316, 326], as shown in FIG. 3: Quantum Machine Learning subroutines may act as oracles or surrogates—classifying feasible feedstock combos, approximating reaction yields-trained iteratively on the system's historical data to improve subsequent quantum optimization [262, 264], as shown in FIG. 2. Operational Flow: Input feedstocks are introduced into the IDS, directed by the quantum-optimized configuration to specific processing stages (e.g., from shredding to depolymerization to fermentation, or from separation to polymerization to distillation), producing final valuable outputs (fuels, chemicals, composites). Repeated quantum-classical cycles ensure continuous re-optimization, enabling flexible adaptation to feedstock variability, desired product specs, or changes in operating constraints.

### Enumerated Embodiments and Architecture Variants (Set I)

Comprehensive Cyberphysical System: A quantum cyberphysical manufacturing machine, comprising: one or more reactors configured to perform chemical or material transformation processes [1236, 1238, 1240], as shown in FIG. 12; a plurality of sensors, including quantum sensors, arranged to monitor process conditions and material properties in real time [240, 250, 260], as shown in FIG. 2; a set of actuators, including quantum-assisted actuators, configured to manipulate materials and control reaction parameters [280, 282, 284]; one or more sorting units and pipelines for transporting and distributing materials between processing stages [1242], as shown in FIG. 12, and path control functions [1503], as shown in FIG. 15; and a control system communicatively coupled to the reactors, sensors, actuators, and sorting units, the control system including a hybrid quantum-classical control module [900, 908], as shown in FIG. 9, configured to process sensor data and manage operations in real time, wherein the control module leverages quantum computing resources [912] to optimize operational parameters and enhance manufacturing process efficiency.

Quantum-Optimized Control Software: A control software system for a quantum cyberphysical manufacturing machine, the software comprising: a quantum computing module [912], as shown in FIG. 9, configured to execute optimization algorithms for determining optimal manufacturing process parameters; a classical computing module [916] including artificial intelligence and machine learning algorithms for process control and decision support [262, 264], as shown in FIG. 2; a communication interface [910], as shown in FIG. 9, enabling hybrid operation between the quantum computing module and the classical computing module; wherein the software system analyzes real-time sensor data [300, 302], as shown in FIG. 3, employs quantum computing-based optimization in conjunction with classical AI/ML to generate control commands [930], and adaptively updates control policies through self-learning, thereby providing real-time process control and predictive optimization of industrial manufacturing operations. Quantum-Assisted Reaction Simulation and Material Characterization: A reaction simulation and material characterization system integrated with a quantum cyberphysical manufacturing machine, the system comprising: a quantum computing-based simulation module configured to model and predict chemical and material reaction pathways in real time using an Industrial Digestive System (IDS) mathematical model [1122, 1124, 1126, 1128], as shown in FIG. 11; a quantum-enhanced material characterization module configured to analyze and determine properties of materials during processing using quantum-assisted sensing or computation techniques [1104]; wherein outputs from the simulation module and the material characterization module are used to dynamically adjust processing parameters of the manufacturing machine [1112], enhancing reaction pathways and improving material transformation efficiency. In some embodiments, reaction pathway or catalyst modeling may further employ variational quantum eigensolver outputs [1900, 1904], as shown in FIG. 19.

Quantum-Classical Hybrid Control Loops: A hybrid control system for real-time decision-making in a quantum cyberphysical manufacturing machine, comprising: a quantum algorithm module [266, 270], as shown in FIG. 2, configured to calculate optimal control parameters for material flow, reaction conditions, and energy usage in real time; a classical control module [276] including artificial intelligence algorithms, the classical module configured to receive the optimal control parameters from the quantum algorithm module and regulate the machine's actuators and processes accordingly [280, 282, 284]; a feedback network linking sensors of the manufacturing machine to both the quantum algorithm module and the classical control module [300, 316, 326], as shown in FIG. 3; wherein the quantum algorithm module and the classical control module operate in a closed-loop manner, the quantum module providing optimized setpoints [930], as shown in FIG. 9, and the classical module ensuring stable execution and predictive adaptation, thereby enabling continuous real-time decision-making and adaptive control of the manufacturing process.

General-Purpose Quantum Industrial Manufacturing: A general-purpose industrial manufacturing system utilizing a quantum cyberphysical manufacturing machine, wherein the system is configured to execute a variety of complex manufacturing processes, comprising: capability to convert waste materials into valuable resources under quantum-optimized control, including transforming waste or biomass into products such as biogas and biofuel, using an Industrial Digestive System (IDS) [200], as shown in FIG. 2; capability to produce advanced and composite materials through process parameters determined and refined by quantum computing algorithms [1218, 1222], as shown in FIG. 12; and a unified hybrid quantum-classical control framework [900], as shown in FIG. 9, that dynamically adapts to different manufacturing workflows in real time, applying quantum computing for process optimization and classical control for robust operation, thereby optimizing efficiency, resource utilization, and product yield across diverse industrial processes.

Enumerated Embodiments and Architecture Variants (Set I): Comprehensive Cyberphysical System: A quantum cyberphysical manufacturing machine, comprising: one or more reactors configured to perform chemical or material transformation processes [1236, 1238, 1240], as shown in FIG. 12; a plurality of sensors, including quantum sensors, arranged to monitor process conditions and material properties in real time [240, 250, 260], as shown in FIG. 2; a set of actuators, including quantum-assisted actuators, configured to manipulate materials and control reaction parameters [280, 282, 284]; one or more sorting units and pipelines for transporting and distributing materials between processing stages [1242], as shown in FIG. 12, and path control functions [1503], as shown in FIG. 15; and a control system communicatively coupled to the reactors, sensors, actuators, and sorting units, the control system including a hybrid quantum-classical control module [900, 908], as shown in FIG. 9, configured to process sensor data and manage operations in real time, wherein the control module leverages quantum computing resources [912] to optimize operational parameters and enhance manufacturing process efficiency.

Quantum-Optimized Control Software: A control software system for a quantum cyberphysical manufacturing machine, the software comprising: a quantum computing module [912], as shown in FIG. 9, configured to execute optimization algorithms for determining optimal manufacturing process parameters; a classical computing module [916] including artificial intelligence and machine learning algorithms for process control and decision support [262, 264], as shown in FIG. 2; a communication interface [910], as shown in FIG. 9, enabling hybrid operation between the quantum computing module and the classical computing module; wherein the software system analyzes real-time sensor data [300, 302], as shown in FIG. 3, employs quantum computing-based optimization in conjunction with classical AI/ML to generate control commands [930], and adaptively updates control policies through self-learning, thereby providing real-time process control and predictive optimization of industrial manufacturing operations.

### Quantum-Assisted Reaction Simulation and Material Characterization

A reaction simulation and material characterization system integrated with a quantum cyberphysical manufacturing machine, the system comprising: a quantum computing-based simulation module configured to model and predict chemical and material reaction pathways in real time using an Industrial Digestive System (IDS) mathematical model [1122, 1124, 1126, 1128], as shown in FIG. 11; a quantum-enhanced material characterization module configured to analyze and determine properties of materials during processing using quantum-assisted sensing or computation techniques [1104]; wherein outputs from the simulation module and the material characterization module are used to dynamically adjust processing parameters of the manufacturing machine [1112], enhancing reaction pathways and improving material transformation efficiency. In some embodiments, reaction pathway or catalyst modeling may further employ variational quantum eigensolver outputs [1900, 1904], as shown in FIG. 19. Quantum-Classical Hybrid Control Loops: A hybrid control system for real-time decision-making in a quantum cyberphysical manufacturing machine, comprising: a quantum algorithm module [266, 270], as shown in FIG. 2, configured to calculate optimal control parameters for material flow, reaction conditions, and energy usage in real time; a classical control module [276] including artificial intelligence algorithms, the classical module configured to receive the optimal control parameters from the quantum algorithm module and regulate the machine's actuators and processes accordingly [280, 282, 284]; a feedback network linking sensors of the manufacturing machine to both the quantum algorithm module and the classical control module [300, 316, 326], as shown in FIG. 3; wherein the quantum algorithm module and the classical control module operate in a closed-loop manner, the quantum module providing optimized setpoints [930], as shown in FIG. 9, and the classical module ensuring stable execution and predictive adaptation, thereby enabling continuous real-time decision-making and adaptive control of the manufacturing process.

General-Purpose Quantum Industrial Manufacturing: A general-purpose industrial manufacturing system utilizing a quantum cyberphysical manufacturing machine, wherein the system is configured to execute a variety of complex manufacturing processes, comprising: capability to convert waste materials into valuable resources under quantum-optimized control, including transforming waste or biomass into products such as biogas and biofuel, using an Industrial Digestive System (IDS) [200], as shown in FIG. 2; capability to produce advanced and composite materials through process parameters determined and refined by quantum computing algorithms [1218, 1222], as shown in FIG. 12; and a unified hybrid quantum-classical control framework [900], as shown in FIG. 9, that dynamically adapts to different manufacturing workflows in real time, applying quantum computing for process optimization and classical control for robust operation, thereby optimizing efficiency, resource utilization, and product yield across diverse industrial processes.

### Enumerated Embodiments and Architecture Variants (Set J)

### Quantum-Enhanced Industrial Digestive System for High-Throughput Experimentation

A fully integrated hardware and software industrial digestive cyber-physical system (IDS) for high-throughput experimentation [1100], as shown in FIG. 11, comprising: at least one IDS processing unit [1102] configured for reaction discovery, material property optimization, and chemical synthesis; one or more quantum computing modules [106] running quantum-driven optimization models integrated with the IDS processing unit(s) to guide experimental conditions; and a real-time process feedback loop 1110 that dynamically adjusts experimental parameters based on sensor data [1104] and quantum model outputs or optimized conditions [1108]. Quantum-Assisted Experimental Design and Screening Optimization:

A method for optimizing experimental design and screening in high-throughput experimentation, implemented by a quantum computing module within the IDS, comprising: utilizing one or more quantum computing algorithms [1116], as shown in FIG. 11, to evaluate and select optimal combinations of reaction parameters, screening conditions, and input material combinations [1118]; leveraging quantum-enhanced search techniques, including at least one of the Quantum Approximate Optimization Algorithm (QAOA), Grover's search algorithm, or variational quantum circuits, to identify high-potential experimental configurations; and automatically configuring the IDS's experimental hardware to execute trials using the selected optimal parameters and conditions [1120].

### Quantum Chemistry-Based Reaction and Material Simulation:

A quantum-assisted reaction simulation module integrated into the IDS for modeling chemical reactions and material interactions [1122], as shown in FIG. 11, comprising: a quantum processing unit [1124] configured to perform quantum chemistry calculations-[1126], including at least one of a Variational Quantum Eigensolver (VQE), the Harrow-Hassidim-Lloyd (HHL) algorithm for solving linear systems, or quantum phase estimation, to simulate chemical reaction pathways; a simulation engine [1128] that uses results from the quantum chemistry calculations to predict reaction outcomes and material interaction properties; and an optimization component [1132] that analyzes the simulation results [1130] to recommend adjustments to catalysts or reaction conditions, thereby improving catalyst efficiency and guiding subsequent experimental runs within the IDS.

### Fully Automated IDS-Integrated HTE Workflow:

A high-throughput experimentation (HTE) workflow fully integrated within a quantum-enabled IDS [1134], as shown in FIG. 11, wherein the workflow is automated end-to-end and comprises: iterative experimental execution cycles [1138] carried out by automated hardware components and sensors of the IDS [1136], each cycle adjusting reaction parameters based on the measured results of previous cycles;
a hybrid quantum-classical feedback loop [1142] that processes real-time data from sensors and quantum model outputs to update experimental conditions on-the-fly [1140]; and
an orchestration software layer [1144] coordinating all IDS components such that experimental iterations, parameter adjustments, and process optimizations occur dynamically without manual intervention [1146]. General-Purpose HTE Platform for Multi-Industry Applications:

An industrial cyber-physical platform for high-throughput experimentation across multiple industries [1148], as shown in FIG. 11, comprising:
a modular IDS architecture [1150] configurable for various domains including pharmaceuticals, energy, and advanced materials;
a quantum-enhanced process control system [1152] that adapts and optimizes experiment protocols for different product discovery, material synthesis, and chemical process scaling applications; and
integrated industrial automation components [1154], including sensors, actuators, and robotic handlers, enabling scalable execution of experiments under quantum-optimized control, thereby supporting novel product discovery and process scale-up in diverse industries.

### Enumerated Embodiments and Architecture Variants (Set K)

### Quantum Circuit IDS Hardware:

Method of Converting IDS Hardware Stages into a Quantum Circuit: A method of converting a multi-stage Industrial Digestive System (IDS), comprising at least the hardware supply chain stages shown in FIG. 1, including Stage 100 for shredding/grinding, Stage 130 for depolymerization/hydrolysis/fermentation, Stage 140 for separation, Stage 150 for polymerization and mixing, and Stage 200 for distillation), into a quantum circuit for process optimization and control, the method comprising: Identifying each distinct unit operation, including a shredder [110], grinder [120] depolymerization reactor [130.a], hydrolysis reactor [130.b] fermentation reactor [130.c], separator [140], mixer [150], polymerization stage [148], distillator [200], liquid output branch [210], gas output branch [220], fuel oil output [230], fuel gas output [240], chemicals output [250], extruder [170], and useful products output [180], as shown in FIG. 1, as a functional stage or output branch in the supply chain, each functional stage having a set of decision variables (e.g., on/off status, process settings, feed ratios) and material flows (solid, liquid, gas, conglomerate). Defining a set of binary or discretized variables to represent the operating modes, routing choices, or throughput rates of each stage; for instance: a qubit or group of qubits for each stage to encode whether that stage is active or at a specific operating level (temperature, pressure, reaction time); and additional qubits to encode any branching flows [1260], as shown in FIG. 12. Mapping these variables into a quantum-encoded representation suitable for quantum algorithms, including at least one of: a Quadratic Unconstrained Binary Optimization (QUBO) or Ising model, where interactions among qubits capture constraints (like throughput limits) and objectives (like yield, energy use, emissions); or a parameterized quantum circuit that represents stage-level decisions as phase shifts or rotation gates, structured for a variational algorithm (e.g. QAOA or VQE) [1216, 1220], as shown in FIG. 12. Constructing a global quantum circuit (or Hamiltonian) that integrates all stage-level sub-circuits, such that the entire IDS pipeline is captured in a single quantum model. This includes: penalty terms or multi-qubit gates ensuring material balances and stoichiometric constraints across stages; and objective terms rewarding higher-value outputs while penalizing costs or suboptimal synergy among stages [700, 701, 703], as shown in FIG. 7.

Outputting a final quantum circuit specification or Hamiltonian that can be executed on a quantum solver, including a quantum annealer, gate-based quantum processor, or hybrid quantum-classical system [1218, 1222], as shown in FIG. 12, whereby the solution space of possible IDS operating configurations, including reactor settings, feed allocations, and output choices, is searched in superposition, permitting more efficient discovery of optimal or near-optimal transformations than classical exhaustive search. Optionally incorporating real-time sensor feedback from the physical IDS, including measurements of flow rates or reaction extents at each reactor [1202, 1204], as shown in FIG. 12, back into the quantum model, thus refining qubit assignments or re-running the quantum circuit in iterative control loops.

Whereby, the method transforms the hardware supply chain stages shown in FIG. 1 into a structured quantum circuit or cost function that can be tackled by quantum optimization algorithms, allowing a systematically improved approach to controlling or designing the multi-stage industrial process.

### System for Executing the Quantum Circuit Integration on IDS Hardware:

A system for applying the quantum circuit created in Embodiment 1 to the IDS hardware pipeline depicted in FIG. 1, comprising: a quantum processor [912] as shown in FIG. 9, interfaced with a classical control unit [916], the classical control unit collecting real-time operational data from each stage; a feedback interface that periodically runs the quantum circuit or updates the QUBO/Ising formulation with current operational data, obtains a quantum-derived solution, and sends new setpoints or routing instructions [930] to the physical actuators controlling the shredder, reactors, separator, mixer, polymerization stage, extruder, and distillation stage; wherein the system iterates these quantum-classical updates to maintain near-optimal performance across the multi-stage process, achieving high yields of the final product with reduced cost and improved throughput.

### Multi-Layered Quantum Circuit for Stage-by-Stage Decision:

The method of Embodiment 1, wherein each stage is mapped into a layer of the quantum circuit or Hamiltonian, such that: the first layer encodes the shredder/[110] and grinder [120] settings and the ratio of input material allocated to subsequent reactors; the second layer represents each reactor group, including the depolymerization reactor [130.a] hydrolysis reactor [130.b], and fermentation reactor [130.c], with qubits specifying which reactor is active, at what load, and how outputs route to next stages; the third layer includes separation strategies [140] and polymerization or mixing commands [148, 150]; and the final layer captures distillation or further chemical splitting [200], ensuring multi-output synergy is accounted for, wherein the layered approach allows advanced quantum algorithms like QAOA to alternately apply cost operators for each stage and “mixer” operators [704], as shown in FIG. 7, that couple decisions across stages, forming a stage-by-stage quantum circuit.

### Parameterized Quantum Gates Reflecting Reactor Kinetics

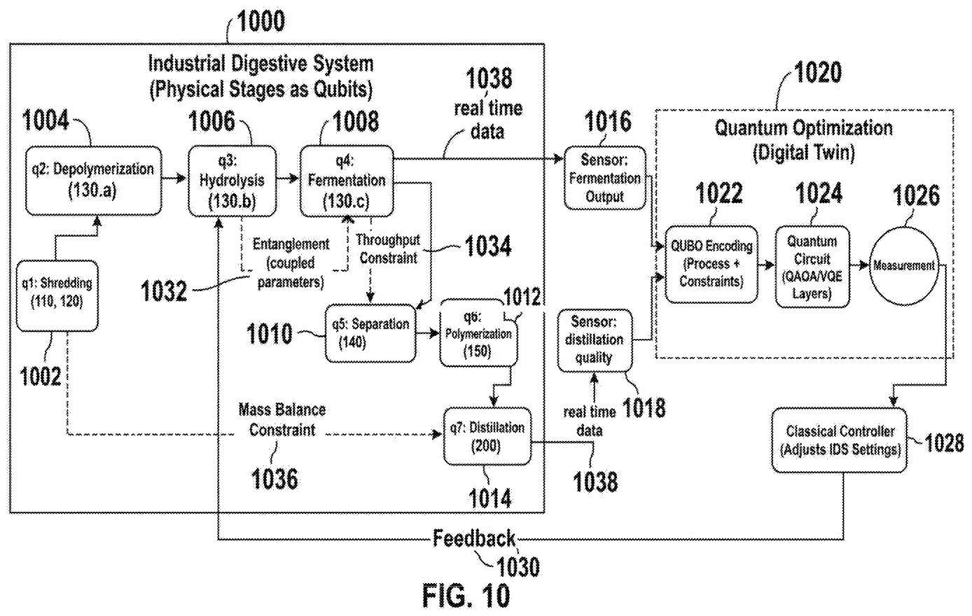

The method of Embodiment 1, wherein each reactor's reaction kinetics or stoichiometric conversion rates are encoded as parameterized gates in a gate-model quantum processor, for instance: R_Z(θ) or R_X(θ) gates representing variations in reaction time, enzyme/catalyst usage, or temperature setpoints; multi-qubit entangling gates capturing interactions or synergy if multiple reactors share partial feedstock streams; and a final measurement step [1026], as shown in FIG. 10, reading out the aggregated cost or objective from the circuit's sample distribution, thereby guiding updates to reactor parameter angles.

Hybrid Quantum-Classical Workflow with Material Constraints

The system of Embodiment 2, wherein classical heuristics or partial solvers handle continuous constraints, including fluid flow rates or partial doping percentages in real time, while the quantum circuit focuses on combinatorial or discrete decisions, including which reactor chain to utilize, or on/off states of fermentation/hydrolysis lines. The classical solver [916], as shown in FIG. 9, is integrated to refine continuous variables around the quantum-chosen discrete states, enabling a hybrid approach that handles all constraints in synergy [900, 908]. QUBO/Ising Encoded Emissions Minimization:

The method of Embodiment 1, further comprising encoding emissions constraints or greenhouse gas cost into the QUBO or Ising Hamiltonian, for example by penalizing solutions that allocate too high a fraction of feedstock to processes with undesirable byproduct, including excess CO2; CH4 or unburned volatiles), thereby driving the quantum solver to favor more environmentally friendly configurations of the hardware supply chain [1703]. Synthesis of Composite Materials Post-Extruder

The method of Embodiment 1, wherein the polymerization/mixer stage [150], the conglomerate material route [160], the extruder [170], and the useful products output [180], as shown in FIG. 1, are collectively modeled as a sub-Hamiltonian dealing with blending ratios and filler materials to produce final conglomerate composites with desired mechanical or chemical properties. Qubit states in that sub-Hamiltonian capture potential blend recipes, including doping amounts, and the quantum solution picks or tunes the best composite formula based on real-time performance feedback.

Integration with Multi-Objective Output Tracking

The system of Embodiment 2, wherein multiple objectives, including maximizing useful products [180], chemicals [250], fuel oil [230], fuel gas [240], liquid outputs [210], or gas outputs [220], as shown in FIG. 1, are combined in a single quantum cost function. Different weighting coefficients can be updated over time if the operator decides to prioritize certain outputs, and the quantum solver re-runs to find the new best hardware supply chain route, including a fermentation route or polymerization route [414], as shown in FIG. 4.

### Enumerated Embodiments and Architecture Variants (Set N)

Quantum-Optimized Industrial Digestive Process System: A system for optimizing an industrial digestive process using quantum computing, the system comprising: At least one data acquisition module configured to collect sensor data and process state information from the industrial digestive process [240, 250, 260], as shown in FIG. 2; A quantum optimization engine [266], as shown in FIG. 2, implemented by a processor and memory, said engine being programmed to:
Formulate a multi-objective industrial process optimization problem as a QUBO or Ising model [418], as shown in FIG. 4; (b) Transmit the QUBO or Ising parameters to a quantum computing backend [420]: (c) Receive from the quantum computing backend at least one candidate solution; and (d) Decode the candidate solution into control settings for the industrial digestive process; A control interface configured to issue commands to actuators [280, 282, 284], as shown in FIG. 2, that regulate material flow, process operating conditions, or on/off states of digestion equipment, wherein the commands are derived from the decoded candidate solution to implement an optimized configuration in the industrial digestive process.

Cloud-Based Quantum Backend Embodiment: The system of Embodiment 1, wherein the quantum computing backend is a cloud-based quantum processing service [420], as shown in FIG. 4, and the system further comprises a secure communication layer for transmitting the encoded optimization problem and receiving the solution from the cloud service.

Operator Interface Embodiment: The system of Embodiment 1 or 2 further comprising a user interface [1507], as shown in FIG. 15, enabling an operator to:
adjust objective weights among energy output, chemical yield, and cost minimization [414], as shown in FIG. 4: initiate new optimization cycles based on process feedback; and
view recommended configurations produced by the quantum optimization engine.

Computer-Readable Medium Embodiment: A non-transitory computer-readable medium [1404], as shown in FIG. 14, storing instructions that, when executed by one or more processors, cause the processors to perform the optimization operations of Embodiment 1.

Continuous or Periodic Closed-Loop Refinement Embodiment The system of Embodiment 1 or 2, wherein the quantum optimization engine is configured to run continuously or periodically such that the industrial digestive process settings are iteratively refined in a closed-loop manner as new sensor data or operator inputs become available [300, 316, 326], as shown in FIG. 3. Penalty-Based Constraint Encoding Embodiment: The system of Embodiment 1 or 2, wherein penalty-based constraint encoding is employed to incorporate at least one constraint selected from: a material conservation constraint, a process throughput capacity constraint, a one-hot discrete setting constraint, or a carbon-to-nitrogen ratio constraint [703], as shown in FIG. 7. Surrogate Reaction Yield Model Embodiment: The system of Embodiment 1 or 2, wherein precomputed reaction yield data or a surrogate machine learning model [262, 264], as shown in FIG. 2, is embedded in the quantum optimization engine to provide approximate process performance values for different combinations of feedstock and operating conditions, thereby enabling efficient evaluation of the objective function during quantum computation.

### Explicit

Fractional Flow Domain Embodiment: The system of Embodiment 1, wherein the decision variables representing material flows from a feedstock to at least one industrial process are fractional and the system further comprises discretizing said fractional flows into multiple binary variables, each binary variable indicating one of a predefined set of flow percentages selected from 0%, 20%, 40%, 60%, 80%, and 100%, thereby allowing the quantum optimization to handle partially allocated flows using a QUBO or Ising encoding [410, 418], as shown in FIG. 4. Strict One-Hot Flow Routing Embodiment: The system of Embodiment 4-78, wherein if the industrial digestive system requires that each feedstock be directed to exactly one process, the fractional flow variables are replaced by strictly binary flow decisions x_{ij}∈{0,1}, ensuring that each material type j is routed to exactly one process i. Maximization to Minimization

Sign Convention Embodiment: The system of Embodiment 1, wherein the quantum computing resource minimizes a cost Hamiltonian H_cost [701], as shown in FIG. 7, and the system further comprises flipping the sign of terms related to profit or outputs in the objective function to transform a maximization problem into a minimization problem, such that a multi-objective function F(x) to be maximized is expressed in the quantum Hamiltonian as Cost(x)=−F(x)+penalty terms. Profit and Undesirable-Cost Sign Convention Embodiment. The system of Embodiment 10, further comprising defining Cost(x)=−(profit terms)+(undesirable cost terms) so that min(Cost(x)) is equivalent to max(profit terms−undesirable terms), aligning the industrial process objectives with the quantum solver's native minimization routine.

### Scaling and Normalization

Embodiment: The system of Embodiment 1, further comprising rescaling or normalizing large real-valued coefficients in the cost function or constraints, wherein capacities, energy terms, or flow levels exceeding the dynamic range of the quantum solver's hardware are normalized to dimensionless values or scaled within acceptable bounds to preserve the relative weight of the objectives.

Penalty Constant Tuning Embodiment: The system of Embodiment 12, wherein the penalty constants λ used for enforcing constraints are automatically tuned or iteratively adjusted to be sufficiently large to disfavor constraint violations while not overshadowing legitimate differences among feasible solutions, thereby maintaining a balance between feasibility enforcement and optimal solution quality [703]. Constraint

Aware Feasible-Subspace Embodiment: The system of Embodiment 1, wherein the quantum optimization employs a constraint-aware approach that precludes generating invalid states, the approach comprising: initializing the quantum state in a feasible subspace of the solution space [705], as shown in FIG. 7, and applying a specialized mixer Hamiltonian [704] in a quantum approximate optimization algorithm (QAOA) that only transitions between feasible states,

thereby ensuring the algorithm does not waste amplitude on states violating material conservation, process safety limits, or other critical constraints.

Specialized Mixer Hamiltonian Embodiment: The system of Embodiment 14, wherein said specialized mixer Hamiltonian enforces one-hot encodings of discrete operating modes and flow allocation constraints at each step of the quantum evolution so that only states with valid allocations and settings are explored [704]. Hybrid Penalty and Constraint-Preserving Encoding Embodiment: The system of Embodiment 1, wherein the quantum optimization engine is configured to selectively apply penalty-based encoding or constraint-preserving encodings, choosing between them based on the strictness of each constraint, such that mandatory safety constraints are always enforced via constraint-aware mixing and optional operational constraints are encoded as penalty terms in the cost function [703, 704]. Enumerated Embodiments and Architecture Variants (Set O)

### Explicit Hamiltonian for IDS)

Explicit Hamiltonian Optimization Method: A method of optimizing an industrial digestive system using a quantum solver, the method comprising: Defining a set of binary variables z∈{0,1}\hat{ }N representing one or more of:
(i) selection among process combinations {C_k};
(ii) discrete allocations of input materials {m_i} in fractional or one-hot encoded form; and
(iii) on/off or multi-level operational modes for individual processes; Constructing an explicit cost Hamiltonian H_IDS(z) [700, 701], as shown in FIG. 7, to be minimized by the quantum solver, said Hamiltonian comprising:
(a) objective terms reflecting at least one weighted criterion of industrial performance and an output mismatch term comparing produced outputs to a target product profile; and
(b) constraint penalty terms [703] enforcing at least one of:
selecting exactly one process combination C_k;
ensuring material flow fractions sum to unity;
limiting total material throughput to process capacity; and
enforcing on/off or discrete mode logic for each process; Submitting the constructed Hamiltonian H_IDS(z) to a quantum computing resource configured to minimize a QUBO or Ising representation [418], as shown in FIG. 4; and Receiving from the quantum computing resource a solution z\hat{ }* that, when decoded into process combination selection, material allocations, and process operational modes, optimally or near-optimally configures the industrial digestive system according to the defined criteria and constraints [1218, 1222], as shown in FIG. 12. Enumerated Embodiments and Architecture Variants (Set P): Integrated Multi-Stage Processing System: An industrial system comprising a sequence of processing modules (mechanical, chemical, physical, and biological) arranged to collectively convert heterogeneous feedstock into a plurality of useful output products. The system is characterized by a unified architecture (“hardware supply chain”), as shown in FIG. 1, including shredding/grinding stage [100], depolymerization/hydrolysis/fermentation stage [130], separation stage [140], polymerization/mixing stage [150], and distillation stage [200], that can produce useful products [180], fuel oil [230], fuel gas [240], chemicals [250], biofuels, and reusable composite materials from mixed inputs within a single facility. Unlike prior single-process plants, this integrated design enables dynamic routing of materials between modules, allowing every fraction of the input to be processed in its optimal pathway.

Quantum-Enhanced Control Unit: The IDS includes a quantum computing module [266], as shown in FIG. 2, integrated with the process control system, wherein operational decisions (such as feed distribution, reaction condition settings, and process scheduling) are optimized using quantum algorithms. This control unit formulates plant-wide optimization problems as a Hamiltonian or objective function representing yield, efficiency, and cost targets [700, 701], as shown in FIG. 7, and employs quantum solvers, including quantum annealers or gate-based quantum processors [910, 912], as shown in FIG. 9, to find optimal or near-optimal solutions. The quantum control unit works in conjunction with classical controllers [916] in a hybrid loop, adjusting process parameters in real time based on quantum optimization outputs [930]. This is a novel application of quantum computing in industrial process control, yielding superior resource allocation and responsiveness, including reducing energy use and waste by optimal scheduling of equipment.

Industrial Applications and Configurations: Dependent embodiments can detail specific embodiments of the IDS for various sectors. For example: an IDS configuration for municipal solid waste processing, where the input waste is sorted, biochemically digested to biogas, and thermochemically converted to fuels and char, all under quantum-optimized control; or an IDS for agricultural biomass that produces bio-ethanol, fertilizer, and electricity in one system. Another application embodiment may cover integration of renewable energy (solar/wind powering certain stages, with quantum-optimized scheduling to match energy availability) to maximize sustainability. The IDS's ability to drastically reduce landfill disposal by converting waste into valuable products and to flexibly switch product outputs based on demand is emphasized as an innovative outcome. In all cases, the combination of multi-modal processing hardware with quantum-driven optimization software yields an industrial plant with unprecedented efficiency and flexibility [900, 908], as shown in FIG. 9. Enumerated Embodiments and Architecture Variants (Set Q): Hybrid Quantum-Classical Industrial Optimization System. A hybrid quantum-classical industrial optimization system [1400], as shown in FIG. 14, comprising:
a classical computing subsystem [1416] configured to decompose an industrial optimization problem into multiple sub-problems [1428], each sub-problem sized to fit within a qubit count limit of a quantum processor;
a quantum computing subsystem [1418] including a quantum processor with a limited number of qubits and predefined qubit connectivity, the quantum processor configured to execute quantum operations on the sub-problems received from the classical computing subsystem [1432]; an embedding optimization module [1420] configured to map each sub-problem onto available qubits of the quantum processor in accordance with the quantum processor's connectivity constraints [1430], thereby accommodating limited qubit connectivity by optimizing the assignment of problem variables to physical qubits;
an error mitigation module [1422] configured to apply noise reduction and error correction techniques to quantum computational results produced by the quantum computing subsystem, thereby compensating for quantum noise and computation errors;
a pipeline orchestration module [1424] configured to coordinate operations between the classical computing subsystem and the quantum computing subsystem such that quantum computations and classical computations are executed in overlapping pipelines to minimize latency [1448]; wherein the system iteratively combines partial solutions from the quantum computing subsystem with classical processing [1434] to produce a final solution to the industrial optimization problem [1438], mitigating hardware limitations including qubit count constraints, restricted qubit connectivity, quantum noise, quantum errors, and communication latency. In some embodiments, the hybrid quantum-classical industrial optimization system further mitigates hardware limitations through problem decomposition [808], embedding optimization [814], use of a quantum processor with limited qubits [816], and error mitigation [818], as shown in FIG. 8. Computer-Implemented Hybrid Quantum-Classical Optimization Method: A computer-implemented method [1402], as shown in FIG. 14, for performing real-time industrial optimization using a hybrid quantum-classical system [1400], the method comprising:
decomposing an industrial-scale optimization problem into a plurality of smaller sub-problems [1428], each sub-problem formulated such that its size does not exceed a predetermined qubit count available on a quantum processor;
embedding each sub-problem onto the quantum processor by mapping elements of the sub-problem to physical qubits according to connectivity constraints of the quantum processor [1430], thereby ensuring that logical relationships in the sub-problem are assigned to qubits that are connected or within the topology of the quantum hardware;
executing quantum computations on the quantum processor for each embedded sub-problem to generate intermediate result data [1432], while applying error mitigation techniques [1422] during or after each quantum computation to counteract the effects of quantum noise and gate errors on the intermediate result data;
processing the intermediate result data on a classical processor by interpreting or refining the results and integrating them into a partial solution of the overall optimization problem [1434]; iterating the decomposing, embedding, executing, and processing steps for remaining or updated sub-problems [1436], and orchestrating these steps using a pipeline orchestration module [1424] such that at least one sub-problem is being processed by the classical computing subsystem [1416] while another sub-problem is concurrently being executed on the quantum computing subsystem [1418], thereby employing pipeline parallelism [1448] to reduce waiting time and latency;
producing a final optimized solution for the industrial optimization problem [1438] by combining results from the quantum computations with computations performed by the classical processor once all sub-problems have been solved or the solution converges within a real-time requirement-[1450]. Qubit-Constrained Decomposition Method: The method of Embodiment 2, wherein the decomposing step comprises partitioning a complex industrial optimization problem into sub-problems whose scope and variables are constrained such that each sub-problem can be solved using the available qubit count and qubit connectivity of the quantum processor without requiring logical qubits beyond the hardware's capacity [808, 816], as shown in FIG. 8. Connectivity-Constrained Embedding Method: The method of Embodiment 2, wherein the embedding step comprises transforming each sub-problem into a graph-based representation and assigning nodes or variables of that graph to specific physical qubits on the quantum processor such that any required interaction between two variables in the sub-problem is mapped onto a direct or short-path connection between the corresponding qubits, thereby optimizing the embedding to conform to the quantum processor's limited connectivity and minimizing any embedding-induced overhead [814], as shown in FIG. 8. Error-Mitigation Method. The method of Embodiment 2, wherein the executing step's error mitigation comprises performing multiple runs of the quantum computation for a given sub-problem under different controlled noise conditions and extrapolating the outcomes to approximate a zero-noise result, and/or applying classical filtering to identify and correct anomalies in the quantum output, thereby improving the accuracy and reliability of the intermediate results obtained from the noisy quantum processor [818], as shown in FIG. 8. Pipeline Parallelism Method: The method of Embodiment 2, wherein orchestrating the steps in parallel comprises queuing and launching a next quantum computation on the quantum processor for a subsequent sub-problem before the classical processor has finished processing the results of a current sub-problem, such that the method continuously overlaps quantum execution with classical processing and sub-problem preparation, thereby reducing overall computation time and mitigating latency associated with quantum operations [1424, 1448], as shown in FIG. 14. Computer-Readable Medium for Hybrid Quantum-Classical Optimization: A non-transitory computer-readable storage medium [1404], as shown in FIG. 14, storing instructions that, when executed by one or more processors comprising at least one classical processor and at least one quantum processor, cause the processors to perform a hybrid quantum-classical optimization method, the method comprising: decomposing an industrial optimization problem into multiple sub-problems sized to not exceed a qubit count limit of the quantum processor [1440]; embedding each sub-problem onto available qubits of the quantum processor by mapping problem variables to the qubits in a manner that adheres to the quantum processor's connectivity constraints; [1442]; executing each sub-problem on the quantum processor to obtain quantum result data, including applying error mitigation techniques to the quantum result data to compensate for noise and computational errors during execution [1444]; processing the quantum result data on the classical processor and combining results from multiple sub-problems to build toward a solution of the industrial optimization problem [1446]; overlapping the decomposing, embedding, executing, and processing operations such that while one sub-problem is being executed on the quantum processor, the classical processor is simultaneously processing results of another sub-problem or preparing additional sub-problems for execution, thereby implementing a pipeline parallelism strategy to minimize latency in obtaining the solution; [1448]; yielding an optimized solution for the industrial optimization problem through the coordinated quantum-classical processing of the sub-problems [1450]. Dynamic Hardware-Responsive Computer-Readable Medium: The non-transitory computer-readable storage medium of Embodiment 7, wherein the instructions for decomposing the problem and embedding sub-problems are further configured to dynamically adjust the size or formulation of subsequent sub-problems based on feedback from the quantum processor's performance or result accuracy, such that if increased error rates or hardware delays are detected, the instructions modify the decomposition strategy or embedding parameters in real-time to maintain solution quality and timeliness [1414], as shown in FIG. 14. Enumerated Embodiments and Architecture Variants (Set S): Independent Hybrid Quantum-Classical Industrial Control System:

A hybrid quantum-classical control system [900], as shown in FIG. 9, for optimizing an industrial process that transforms one or more inputs into at least one output, the system comprising: a quantum computing module [912] configured to solve at least a portion of an optimization problem representing performance objectives of the industrial process; a classical computing module [916] configured to (i) receive sensor data from the industrial process [240, 250, 260], as shown in FIG. 2, (ii) formulate the optimization problem for the quantum computing module, and (iii) integrate quantum-derived solutions with any additional classical optimization to determine control actions; and one or more actuators [280, 282, 284] configured to implement the control actions in real time to adjust at least one operating condition of the industrial process, wherein the hybrid quantum-classical control system iteratively refines the control actions as new sensor data is acquired, thereby maintaining or improving performance objectives across a variety of complex industrial processes.

Independent Hybrid Quantum-Classical Industrial Optimization Method: A method of optimizing an industrial process that transforms one or more inputs into at least one output, the method comprising: collecting, via one or more sensors, real-time data indicative of operating conditions in the industrial process [300, 302], as shown in FIG. 3; formulating an optimization problem from the collected data, the optimization problem including performance objectives and constraints associated with the industrial process [312]; solving at least a portion of the optimization problem using a quantum computing system that receives the optimization problem from a classical computing system [1218, 1222], as shown in FIG. 12; combining partial or complete solutions from the quantum computing system with any additional classical optimization results to generate a final solution; and applying the final solution in real time to one or more actuators that modulate operating conditions of the industrial process [324, 326], wherein the steps of formulating, solving, and combining are repeated in a feedback loop so that the industrial process is continually optimized based on updated sensor data. Industrial Process-Type Embodiment: The system of Embodiment 1, wherein the industrial process is selected from the group consisting of: a waste-to-energy process, a petroleum refinery process, a pharmaceutical production process, a water treatment process, or any other process that involves multi-stage transformations of input materials under constraints to produce at least one desired output. Dynamic Control Setting Embodiment: The system of Embodiment 1, wherein the quantum computing module is configured to optimize control settings such as reactor temperatures, flow rates, or chemical dosage levels, and wherein the classical computing module continuously monitors sensor data to detect changes in input composition or output quality and re-formulates the optimization problem accordingly. Composition-Responsive Re-Optimization Embodiment: The method of Embodiment 2, further comprising: detecting a change in input material composition through sensor readings; dynamically modifying one or more constraint parameters in the optimization problem to reflect the composition change; and re-solving the modified optimization problem in real time so as to adjust the process to maintain or improve throughput and output quality. Refinery Control System Embodiment: The system of Embodiment 1, wherein the industrial process is a refinery operation that processes crude oil through at least one distillation column [200], as shown in FIG. 1, and reactor, and wherein: the quantum computing module manages decision variables including distillation cut points, hydrogen feed rates, and catalyst regeneration schedules; the classical computing module provides continuous monitoring of temperature, pressure, and flow rate data from the refinery; and the actuators include valves, pumps, and reactor feed controls configured to adjust said decision variables in response to quantum-derived solutions. Refinery Optimization Method Embodiment: The method of Embodiment 2, wherein the industrial process is a petroleum refinery, and the formulating step includes: defining optimization objectives to maximize refining yield and minimize energy consumption; incorporating cut point selection, hydrogen feed control, and catalyst activity levels as decision variables; and generating a quantum-amenable representation, including a QUBO or parameterized circuit) [418, 1216], as shown in FIG. 4 and FIG. 12, reflecting said objectives and constraints,

wherein partial or full solutions to the representation are combined with classical simulation results to yield an updated set of operational setpoints for the refinery equipment.

Pharmaceutical Manufacturing System Embodiment: The system of Embodiment 1, wherein the industrial process is a pharmaceutical manufacturing process involving multi-stage synthesis and separation, and the classical computing module is further configured to: collect real-time data on reaction yields, byproduct formation, and separation purity from in-line analytics; incorporate reaction kinetics models or learned surrogate models to guide quantum-based optimization of step times, temperatures, and feedstock ratios; and implement any resulting control solutions by adjusting reactor dwell times, catalyst injection rates, or separation conditions (e.g., column pressure, solvent composition) via the actuators. Pharmaceutical Manufacturing Method Embodiment: The method of Embodiment 2, wherein the industrial process is a pharmaceutical manufacturing process and the step of applying the final solution includes: regulating at least one reactor's temperature profile and feed rate according to quantum-derived control setpoints; maintaining desired purity in a separation column by adjusting flow speeds or solvent composition as dictated by the combined quantum-classical optimization; and iterating the cycle of measurement, problem formulation, quantum-based optimization, and actuation to sustain high-quality product output in real time. Water Treatment System Embodiment: The system of Embodiment 1, wherein the industrial process is a water treatment plant featuring chemical dosing units, pumps, and membranes or filters, and wherein the quantum computing module is configured to optimize parameters including chemical dosage levels, pump scheduling, and membrane backwash intervals, while the classical computing module incorporates sensor data on turbidity, biological load, and chemical composition to dynamically update the optimization problem. Water Treatment Method Embodiment: The method of Embodiment 2, wherein the industrial process is a water treatment plant and the step of solving the optimization problem comprises: formulating constraints to ensure regulatory compliance on water quality metrics, including contaminant thresholds; and pH levels); mapping chemical dosing rates, pump operation schedules, and membrane backwash timing into a quantum-compatible representation; obtaining from the quantum computing system a configuration of these process parameters that balances energy consumption, throughput, and effluent water quality; and continuously adjusting said parameters via the actuators in response to new sensor readings. Predictive Machine Learning Embodiment: The system of Embodiment 1, wherein the hybrid quantum-classical control system further comprises a machine learning module [262, 264], as shown in FIG. 2, configured to predict future changes in input feedstock or operating conditions and proactively incorporate these predictions into the quantum optimization, thereby enhancing the system's responsiveness to expected disturbances. Actuator-Limitation Recalculation Embodiment: The method of Embodiment 2, further comprising: periodically evaluating the performance of at least one actuator in light of the quantum-derived control actions; identifying any actuator limitation or operational delay that hinders achieving the ideal setpoints; and re-calculating the quantum-classical optimization to account for said limitations, ensuring feasible and robust implementation of the optimized process control. Variable Feedback-Interval Embodiment. The method of Embodiment 2, wherein the real-time feedback loop is performed in intervals ranging from seconds to hours, with the interval determined by the dynamic response time of the industrial process, quantum solver availability, or safety-critical constraints requiring rapid updates.

Quantum Parallelism: Feedback Method: A method for continuously optimizing an industrial process in real time using a hybrid quantum-classical framework, the method comprising: collecting real-time sensor data from the industrial process, including measurements indicative of operating conditions, resource usage, and output quality [300, 302], as shown in FIG. 3; formulating an optimization problem that captures performance objectives for the industrial process, wherein said optimization problem includes: a cost function reflecting one or more metrics to be improved, penalty or constraint terms representing physical limits or safety requirements [701, 703], as shown in FIG. 7, and weight parameters adjustable through machine learning algorithms based on historical or newly acquired sensor data [414], as shown in FIG. 4; leveraging quantum parallelism by submitting the optimization problem, or a relevant portion thereof, to a quantum computing module capable of exploring multiple solution candidates simultaneously, thereby guiding the industrial process toward a high-quality solution more efficiently than random-search-based heuristics or offline optimization routines; applying partial or full results from the quantum computing module, in conjunction with any classical optimization steps, to derive updated control parameters for actuators in the industrial process, said updated parameters implemented in real time through a closed-loop control interface; [930], as shown in FIG. 9; adapting dynamically to novel or changing conditions by recalculating the optimum whenever sensor data indicates a significant deviation from expected operating conditions, wherein machine learning algorithms adjust cost function weights or learned constraints automatically, in contrast to static rule-based systems that require manual reprogramming; and repeating the collecting, formulating, leveraging, applying, and adapting steps in an ongoing feedback loop, such that quantum-enabled optimization continuously refines control decisions even under shifting input parameters or unforeseen disturbances, convergence to high-performing solutions is faster than would be achieved by daily or sporadic genetic-algorithm-based searches, and the system remains more flexible and up-to-date than traditional rule-based heuristics by evolving its optimization rules through data-driven insight.

Multi-Site Hybrid Optimization Coordination Method: A method of coordinating hybrid quantum-classical optimization across a plurality of industrial or research sites, each site having multiple variables under experimental or operational control, the method comprising: partitioning a global multi-site optimization problem [1300], as shown in FIG. 13, into subproblems that reflect: site-internal variables describing local operating conditions or experimental parameters for each individual site [1306], and inter-site coordination variables governing resource sharing, load distribution, or material flows between two or more sites [1310]; collecting real-time or experimental data from each site through sensor inputs and aggregating said data in a central or distributed computing framework; encoding each subproblem into a quantum-solvable format, such that: internal site subproblems are associated with local objectives and constraints, and inter-site subproblems are associated with global optimization goals, including efficient distribution of loads or shared resources across the network of sites; solving at least a portion of the subproblems using a quantum computing module in conjunction with a classical computing module, thereby performing a hybrid optimization that: focuses quantum resources on complex combinatorial tasks, utilizes classical methods for continuous or linearizable parts of the problem, and assembles partial solutions through an iterative chunking process to handle large-scale multi-site complexity; [1304, 1308, 1314]; integrating the quantum-derived partial solutions with local classical optimizations to form an updated global solution, wherein each site receives optimized setpoints or control parameters [1318]; implementing the updated global solution by executing control actions or experimental adjustments at each site in near real time, thereby enabling researchers or operators to handle complex setups with many variables while scaling optimization beyond a single site to an entire network of industrial manufacturing or waste-to-materials plants; and iterating the partitioning, collecting, encoding, solving, integrating, and implementing steps in response to changing operational conditions or experimental objectives, wherein the method delivers a continuously adaptive, multi-system optimization comparable to a “smart grid” or supply chain, leveraging quantum parallelism for high-level cross-site decisions in conjunction with local classical control.

Bench or Pilot-Scale Hybrid Optimization Method. A method of verifying or optimizing an industrial process configuration at a bench or pilot scale using a hybrid quantum-classical optimization approach, the method comprising: implementing a scaled-down version of the industrial process in a laboratory or pilot-plant setup, wherein said setup includes a limited number of sensors and actuators corresponding to a bench-scale experiment; [1136], as shown in FIG. 11; collecting real-time experimental data reflecting key operational variables and performance metrics of the pilot-scale process;
formulating an optimization problem that captures target objectives, including yield, purity, or energy usage), and constraints, including safe operating limits; or reagent availability, based on the bench-scale data; solving the optimization problem with a small quantum computing resource in coordination with a classical computing module, the quantum module focusing on complex or combinatorial variables and the classical module addressing simpler or continuous parameters; deriving an updated control strategy from the combined quantum-classical solution and applying it to the bench-scale process through actuators and manual adjustments, thereby identifying near-optimal operating conditions under scaled-down circumstances; iterating the above steps to refine the control strategy as new data is acquired, wherein the same approach is capable of handling complex experimental setups with numerous interdependent variables; and scaling the pilot-verified or bench-scale-verified control strategy to a full industrial plant or larger operational setting once satisfactory performance is demonstrated at the smaller scale

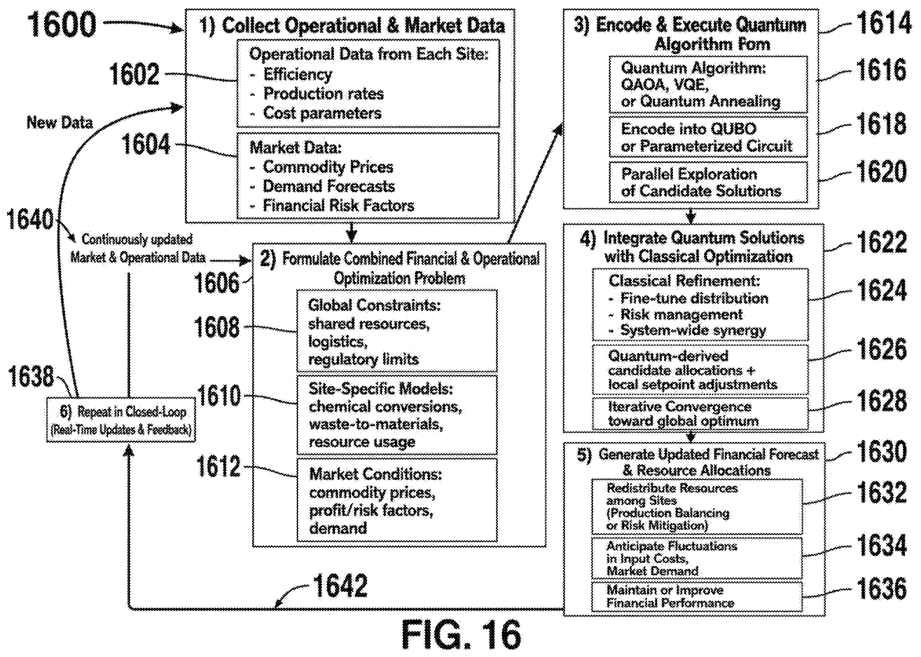

Quantum-Based Financial Forecasting and Resource Allocation Method: A method for generating quantum-based financial forecasts and optimizing resource allocation within a network of industrial manufacturing sites operating an Industrial Digestive System (IDS), each site connected via a grid and configured to convert input materials into valued outputs, the method comprising: collecting operational data from the plurality of industrial sites, including process efficiency metrics, production rates, and cost-of-operations parameters, alongside market-related data relevant to financial forecasting [1600, 1602, 1604], as shown in FIG. 16; formulating a combined financial and operational optimization problem that incorporates: site-specific transformation models, including chemical or waste-to-materials conversions; global constraints, including shared resource limits, inter-site logistics, regulatory or contractual obligations; and market conditions, including commodity prices, demand forecasts, and financial risk factors) [1606, 1608, 1610, 1612]; encoding at least a portion of the combined problem into a quantum-compatible representation, including a QUBO or parameterized quantum circuit), and executing a quantum algorithm to explore multiple solution candidates in parallel, thereby deriving candidate forecasts and resource allocation strategies [1614, 1616, 1618, 1620]; integrating quantum-derived candidate solutions with classical optimization steps to refine local site setpoints, system-wide distribution decisions, and financial risk assessments, thus iteratively converging toward a global optimum for both operational transformations and profitability targets [1622, 1624, 1626, 1628]; generating an updated financial forecast, including recommended resource allocations and operational adjustments, for each industrial site in the network, wherein these recommendations: anticipate future fluctuations in input costs or market demand, redistribute resources among sites to balance production or mitigate risk, and maintain or improve overall financial performance under evolving market or operational conditions [1630, 1632, 1634, 1636]; and reiterating the collecting, formulating, encoding, integrating, and generating steps in a closed-loop fashion, regularly updating the combined financial and operational optimization as new data is acquired, thereby enabling continuous alignment of process-level decisions with real-time market signals and global business objectives for the entire network of industrial manufacturing sites [1638, 1640, 1642]. Geographically Distributed Multi-System Optimization Method: A method for coordinating hybrid quantum-classical optimization across a plurality of geographically distributed industrial or research sites, each site configured to convert one or more inputs into at least one output, the method comprising: partitioning a large-scale multi-system optimization problem into multiple chunks, each chunk corresponding to either (a) internal site-specific variables regulating local processes at a single site, or (b) inter-site coordination variables governing resource distribution or load sharing among two or more sites; [1800, 1802, 1806], as shown in FIG. 18; collecting sensor or experimental data from each site to characterize local operating conditions or experimental parameters, wherein said data are aggregated in a central or distributed classical computing module [1816, 1818, 1820, 1822]; encoding each partitioned chunk into a quantum-computable format suitable for solution by a quantum optimization module, thereby reflecting both local constraints within each site and global objectives shared across all sites; executing quantum and classical computations iteratively on the partitioned chunks, including: solving site-specific subproblems using quantum or classical solvers to optimize local performance objectives; and solving inter-site coordination subproblems using quantum or classical solvers to optimize resource allocation, load balancing, or material flows between sites [1804, 1808, 1810, 1812, 1814]; combining solutions from the site-specific subproblems and the inter-site subproblems into an integrated multi-system solution that satisfies both local operational constraints and global optimization criteria; implementing the integrated multi-system solution by adjusting control actions at each site in real time through actuators, experimental parameters, or network distribution settings [1824, 1826, 1830], thereby ensuring coordinated optimization across the entire network of industrial or research sites; and iterating the partitioning, collecting, encoding, executing, combining, and implementing steps in response to updated sensor or experimental data [1828], enabling continued adaptation to changing conditions or evolving research objectives, wherein the method accommodates complex experimental setups with numerous variables at each site and scales to multi-site industrial networks, including waste-to-energy or waste-to-materials plants), connected via a grid, leveraging a chunking approach to manage large problem sizes and a hybrid quantum-classical framework to achieve near real-time performance.

### Enumerated Embodiments and Architecture Variants (Set T):

Independent Hybrid Quantum-Classical Industrial Optimization System. A hybrid quantum-classical optimization system [900], as shown in FIG. 9, for controlling an industrial process that transforms one or more input materials into one or more output products, the system comprising:
a quantum computing module [912] configured to solve, at least in part, a multi-objective optimization problem representing performance objectives of the industrial process;
a classical computing module [916] communicatively coupled to the quantum computing module, the classical computing module being configured to: collect sensor data from the industrial process [240, 250, 260], as shown in FIG. 2; formulate a quantum-amenable representation of the multi-objective optimization problem by incorporating system constraints and at least one objective function that combines efficiency, throughput, cost, or other performance metrics, [418], as shown in FIG. 4; integrate partial or approximate solutions from the quantum computing module with additional classical optimization routines to generate at least one control solution; and one or more actuators [280, 282, 284] that receive the control solution and adjust one or more operating parameters of the industrial process in near real time based on the integrated optimization output,
   wherein the system executes a feedback loop [300, 316, 326], as shown in FIG. 3, in which the quantum computing module is repeatedly supplied with updated problem formulations reflecting newly acquired sensor data, enabling continuous adaptation to evolving process conditions and improving at least one performance objective over conventional static or heuristic-driven control methods.

### Independent Hybrid Quantum-Classical Industrial Optimization Method

A method of optimizing an industrial process that transforms one or more input materials into one or more output products using a hybrid quantum-classical approach, the method comprising: receiving real-time sensor data indicative of current operating conditions of the industrial process [300, 302], as shown in FIG. 3; formulating a multi-objective optimization problem by encoding the operating conditions, at least one objective function combining yield, energy consumption, or cost metrics, and relevant physical or safety constraints into a quantum-compatible representation [418, 1216], as shown in FIG. 4 and FIG. 12; processing the multi-objective optimization problem in a quantum computing module, wherein the quantum computing module evaluates candidate solutions in parallel using a quantum algorithm selected from quantum annealing, a variational quantum eigensolver, or a quantum approximate optimization algorithm [1218, 1222], as shown in FIG. 12; refining partial or approximate solutions from the quantum computing module within a classical computing module, including error mitigation, constraint validation, or local continuous optimization steps [1422, 1434], as shown in FIG. 14; outputting an updated control solution to one or more actuators in the industrial process, thereby adjusting at least one operating parameter in near real time [324, 326]; and iterating the receiving, formulating, processing, refining, and outputting steps in response to changes in sensor data, wherein this iterative loop continuously adjusts the process to improve at least one performance objective relative to static or purely classical optimization techniques.

Computer-Readable Medium for Real-Time Multi-Objective Optimization: A non-transitory computer-readable storage medium [1404], as shown in FIG. 14, storing instructions that, when executed by one or more processors comprising a quantum computing module and a classical computing module, cause the processors to perform a method for real-time multi-objective optimization of an industrial process, the method comprising: collecting sensor measurements characterizing an operational state of the industrial process; preparing a quantum-computable version of a multi-objective optimization model, said model capturing operating constraints, at least one performance metric, and interdependencies among process variables [1440, 1442]; submitting the quantum-computable version to the quantum computing module, which employs a quantum algorithm to generate an initial set of candidate solutions in parallel [1444]; verifying each candidate solution via the classical computing module by applying constraint checks, noise-mitigation, or local heuristic corrections [1446]; selecting or aggregating the verified solutions to derive one or more updated control parameters; issuing the updated control parameters to actuators in the industrial process to modify real-time operating conditions; and repeating the above steps in a continuous feedback loop [1448, 1450], enabling adaptive optimization as new sensor measurements become available and refining the multi-objective solution space over time, whereby quantum parallelism in tandem with classical post-processing provides improved solution quality and adaptive responsiveness relative to static or purely heuristic-based methods.

Industrial Digestive System Process Embodiment. The system of Embodiment 1, wherein the industrial process is an industrial digestive system [200], as shown in FIG. 2, configured to convert heterogeneous feedstocks, including organic waste or biomass, into energy or material outputs, and the system's quantum computing module is specifically encoded to manage constraints relating to chemical balances, reactor capacities, and reaction temperatures [701, 703], as shown in FIG. 7. Machine Learning Adaptive Weighting Embodiment: The system of Embodiment 1, further comprising a machine learning component [262, 264], as shown in FIG. 2 configured to: adjust weights in the multi-objective cost function based on observed correlation between control actions and performance outcomes, [414, 416], as shown in FIG. 4; and predict future process states or disruptions to proactively re-formulate the optimization problem,

whereby the hybrid quantum-classical system dynamically evolves its optimization rules instead of relying on fixed, rule-based heuristics.

Joint Discrete-Continuous Optimization Embodiment. The method of Embodiment 2, wherein the step of processing the multi-objective optimization problem in a quantum computing module includes: representing discrete process decisions, including on/off states; or routing choices, in a QUBO form solvable via quantum annealing, and mapping continuous process parameters, including temperature setpoints, onto discrete bins or expansions for partial quantum treatment [410, 418], thereby facilitating joint discrete-continuous optimization across a quantum-classical boundary.

Pipeline Parallelism Embodiment: The method of Embodiment 2, wherein the iterative loop implements pipeline parallelism, such that: while the quantum computing module solves one set of subproblems, the classical computing module refines previously acquired solutions or awaits new sensor data, and results are integrated on-the-fly to maintain near real-time control without halting industrial operations [1424, 1448], as shown in FIG. 14. Multi-Site Computer-Readable Medium Embodiment: The computer-readable storage medium of Embodiment 3, wherein the instructions further cause the processors to: chunk a large-scale multi-site optimization problem into subproblems, each corresponding to one facility's local process variables or cross-site resource distribution constraints [1800, 1802, 1806], as shown in FIG. 18; assign subproblems selectively to quantum or classical solvers based on complexity; and coordinate partial solutions via a central orchestration layer that merges local optimum points into a global optimum [1808, 1812, 1826], thereby enabling multi-facility synchronization and grid-level load balancing for waste-to-energy or chemical manufacturing networks.

### Industry-Specific Dependent Enumerated Embodiments and Architecture Variants

Refinery Operation Embodiment: The system of Embodiment 1, wherein the industrial process is a refinery operation, including one or more distillation columns [200], as shown in FIG. 1, and downstream reactors, and the quantum computing module is configured to optimize at least one of: distillation cut points to balance product yields, hydrogen feed rates to manage hydrocracking or hydrotreating reactions, or catalyst regeneration schedules to extend reactor up-time, such that refined products are produced with higher yield and lower energy consumption compared to fixed-schedule or heuristic-based operations.

Pharmaceutical Manufacturing Workflow Embodiment: The method of Embodiment 2, wherein the industrial process is a pharmaceutical manufacturing workflow comprising multi-stage synthesis and separation, and formulating the multi-objective optimization problem includes embedding reaction yields, impurity profiles, and stage throughput targets, wherein quantum parallelism accelerates the search for feasible operating windows that maximize product purity while minimizing waste or batch time.

In some embodiments, such pharmaceutical or reaction-development workflows are implemented within an automated high-throughput experimentation workflow [1134], as shown in FIG. 11. Water Treatment Plant Embodiment: The method of Embodiment 2, wherein the industrial process is a water treatment plant operation, and the quantum-compatible representation includes variables for chemical dosing rates, pump scheduling, and membrane backwash timing, thereby achieving energy-efficient water treatment under fluctuating contamination levels or supply demands.

### Advanced or Specialized Dependent Embodiments

Quantum Finance Prediction and Resource Allocation Embodiment: The system of Embodiment 1, further comprising a quantum finance prediction module integrated into the hybrid quantum-classical framework, the quantum finance prediction module being configured to: process market data alongside internal operating cost data; forecast commodity prices or demand scenarios relevant to the industrial process; and incorporate these forecasts into a global cost function that determines financial risk versus production optimization, [1600, 1602, 1604, 1606], as shown in FIG. 16, such that multi-objective trade-offs include both technical process parameters and economic variables, enabling site operators to enhance profitability and resource allocation efficiency [1630, 1632, 1636]. Pilot or Bench-Scale Verification Embodiment: The method of Embodiment 2, wherein applying the updated control solution includes scaling the same approach down to a laboratory pilot plant or bench-scale experiment [1136], as shown in FIG. 11, thereby verifying process parameters on a smaller quantum resource, refining them iteratively at pilot scale, and ultimately adopting the verified control strategy in a full-scale industrial deployment.

Self-Learning Alchemist Mode Embodiment: The computer-readable storage medium of Embodiment 3, wherein the instructions cause the processors to implement a self-learning “Alchemist” mode [1712], as shown in FIG. 17, in which: the system continually identifies emerging patterns or anomalies in sensor data not explained by known scientific principles; [1722]; the quantum computing module tests hypothetical models of new physical, chemical, or biological relationships by adjusting specialized reaction pathways; or operational parameters [1724, 1726]; and the classical computing module validates each hypothesis through iterative experimentation [1730, 1738], thereby potentially uncovering novel phenomena or unknown relationships in nature that may serve as candidate empirical relationships for theoretical modeling. Alchemist Scientific Discovery Method: A method of discovering previously unknown relationships in physics, chemistry, or biology using a self-learning hybrid quantum-classical machine learning engine, referred to as the “Alchemist,” integrated with a network of industrial processes employing an Industrial Digestive System (IDS), the method comprising: aggregating, from each industrial site in the network, real-time operational data derived from IDS-based transformation processes and sensor feedback loops [1700, 1708], as shown in FIG. 17, wherein the network includes multiple facilities converting diverse inputs into outputs under varying physical, chemical, or biological conditions; inputting the aggregated operational data into a hybrid quantum-classical machine learning module [1712], configured to: construct high-dimensional representations of process variables, reaction pathways, and observed outcomes [1714]; apply quantum parallelism to evaluate many scientific hypothesis states simultaneously [1716]; and adapt model parameters iteratively using a self-learning algorithm that correlates the aggregated data with hypothesized principles [1718]; generating from the quantum machine learning module one or more candidate laws or theoretical constructs in physics, chemistry, or biology; [1720], each candidate law being inferred from patterns, anomalies, or emergent correlations that cannot be explained by known scientific principles alone [1722]: designing, based on the candidate laws, experimental or operational changes at one or more industrial sites to test the predictive or explanatory power of said candidate laws, such changes including, for example, adjusting reaction parameters, feedstock compositions, or energy flows [1724, 1726]; implementing the designed changes in real time through actuators at the respective industrial sites [1730, 1732], and collecting resultant performance metrics and observational data; [1734], wherein this new data is fed back into the hybrid quantum-classical machine learning module; refining each candidate law based on the difference between predicted and actual outcomes [1738], thereby improving the Alchemist model's accuracy and scope for capturing novel phenomena in physics, chemistry, or biology [1740]; and repeating the foregoing steps in an ongoing cycle [1742], wherein the self-learning hybrid quantum-classical machine learning engine autonomously evolves its underlying cost functions, constraint sets, and inferred theories, progressively uncovering new scientific insights beyond what fixed-rule or purely classical heuristics can discover, and enabling the invention to adapt to unknown natural relationships and generate novel physical, chemical, or biological principles.

### DETAILED DESCRIPTION OF DIAGRAMS AND TABLES

FIG. 1 illustrates a physical hardware supply chain of an Industrial Digestive System (IDS) configured to transform heterogeneous or homogeneous input materials into one or more usable outputs through a sequence of mechanical, chemical, biological, separation, polymerization, and distillation stages. As shown in FIG. 1, a first stage [100] receives an input stream and includes a shredder [110] and a grinder [120] for mechanical size reduction and preparation of the incoming material. A magnetic surface [105] may be associated with the first stage [100] for magnetic separation or material handling, and the grinder [120] may generate or direct a paste stream [125] toward subsequent processing.

A second stage [130] includes a depolymerization reactor [130.a], a hydrolysis reactor [130.b], and a fermentation reactor [130.c]. These reactors are arranged as part of a transformation region in which the prepared input material may undergo chemical, enzymatic, biological, or combined conversion steps. Volatile outputs [136] may be produced or removed from one or more of the depolymerization reactor [130.a], hydrolysis reactor [130.b], and fermentation reactor [130.c]. A third stage [140] provides separation of transformed material into one or more output fractions. As shown in FIG. 1, a solid fraction [145] is directed toward downstream material processing, while a liquid and gas fraction [190] is directed toward a distillation pathway. The solid fraction [145] may be routed to a fourth stage [150] including a mixer and a polymerization unit [148]. The polymerization unit [148] and the mixer may cooperate to generate a conglomerate material stream [160], which is directed through an extruder [170] to produce useful products [180].

The liquid and gas fraction [190] is routed to a fifth stage [200] including a distillator or distillation unit. The distillation unit [200] separates or converts the liquid and gas fraction [190] into multiple downstream product streams. A liquid branch [210] may produce fuel oil [230], while a gas branch [220] may produce fuel gas [240]. The distillation unit [200] may also generate chemicals [250] as an additional product stream. In this manner, FIG. 1 shows a multi-output IDS hardware supply chain in which a single input may be mechanically prepared, chemically or biologically transformed, separated, polymerized, extruded, distilled, and converted into useful products [180], fuel oil [230], fuel gas [240], and chemicals [250].

FIG. 2: System Architecture Diagram. Description: FIG. 2 illustrates the architecture of the hybrid quantum optimization system integrated with an industrial process. On the left, the Industrial Process, shown as the Digestive System [200], includes multiple stages such as a waste input [210], a reactor/digester [220], and an energy conversion unit [230]. A plurality of sensors, including a first sensor [240], a second sensor [250], and a third sensor [260], are configured to monitor the industrial process and provide process data representative of input conditions, intermediate process states, output quality, or operational performance. At the lower portion of the process architecture, a plurality of actuators, including a first actuator [280], a second actuator [282], and a third actuator [284], receive control signals to affect operation of the industrial process [200]. The Classical Control Module [276] is represented in the diagram as a PLC/DCS-based control layer including a controller [278] that directly interfaces with both the sensors [240, 250, 260] and the actuators [280, 282, 284] for basic and supervisory control loops. Above the classical layer, the quantum optimization module [266] is depicted, including a problem formulation engine [268], a quantum solver [270], and a quantum processing unit (QPU) [272], which may represent either an on-premises quantum computer or a cloud based quantum service. The problem formulation engine [268] receives sensor data, operational objectives, machine-learning outputs, and feedback information, and formulates a quantum-compatible optimization problem. The quantum solver [270] processes the formulated optimization problem and interfaces with the QPU [272] to generate quantum-derived candidate solutions or optimized control parameters. Additionally, a Machine Learning Module [262] is shown alongside the data flow. Within the Machine Learning Module [262], an ML Engine [264] performs data preprocessing, adaptive modeling, prediction, or parameter tuning based on historical and real-time process data. The machine learning outputs may be supplied to the problem formulation engine [268], the quantum solver [270], and/or the controller [278], thereby improving optimization accuracy and operational responsiveness. Arrows in FIG. 2 indicate the principal data and control flows: sensor data from the industrial process [200] is provided into both the classical control module [276] and the quantum optimization module [266]; the quantum optimization module [266] sends optimized setpoints or candidate control parameters to the controller [278]; and the controller [278] implements control actions through the actuators [280, 282, 284] to affect the physical process. Feedback or status data [274] are also provided from the quantum optimization workflow to the control architecture so that solver state, feasibility information, or optimization feedback may be incorporated into subsequent control decisions. A feedback loop is therefore highlighted around this cycle. In operation, FIG. 2 shows a layered control system including the physical layer (industrial process [200], sensors [240, 250, 260], actuators [280, 282, 284]), the classical control layer (classical control module [276] and controller [278]), and the quantum optimization layer (quantum optimization module [266], including the problem formulation engine [268], quantum solver [270], and QPU [272]), all interlinked in real time. Sensor data from the industrial process [200] may be processed by the Machine Learning Module [262], formulated into quantum-compatible optimization problems by the problem formulation engine [268], solved through the quantum solver [270] and QPU [272], and integrated through the classical control module [276] and controller [278] to actuate the process via actuators [280, 282, 284]. In this manner, FIG. 2 clarifies how the physical IDS, machine learning, quantum optimization, and classical control cooperate in a closed hybrid quantum-classical control architecture to optimize industrial transformation operations in real time. In some embodiments, transmission of timestamped optimization snapshots and serialized artifacts between a localized cyber-physical execution loop and a distributed computation environment is protected using cryptographic communication protocols to support data integrity and to reduce risk of unauthorized manipulation of industrial control payloads.

FIG. 4 illustrates a dynamic quantum formulation compiler pipeline configured to ingest physical analog telemetry and digitally convert it into a structurally bounded quantum-computable artifact. As shown in FIG. 4, the pipeline begins with an Input Detection module [400], which represents the cyber-physical ingress point at which process inputs, sensed conditions, or operational signals are detected for subsequent computational treatment. Streaming Telemetry Data [402] are transmitted from the Input Detection module [400] to a Dual-Layer Error Mitigation Pipeline [404]. The Dual-Layer Error Mitigation Pipeline [404] manages sensor noise, telemetry uncertainty, or measurement instability prior to quantum formulation. The mitigated telemetry state is then used to generate Quantitative Confidence Indicators [406], which provide confidence values, reliability measures, or related quantitative indicators associated with the incoming telemetry. The mitigated and confidence-scored process state is captured within a Timestamped Optimization Snapshot [408]. The Timestamped Optimization Snapshot [408] provides a bounded representation of the process state at a defined time and supplies information both to downstream discretization and to final artifact construction. To satisfy quantum solver constraints, a Continuous-Variable Discretization Block [410] performs binary expansion, finite-step discretization, or other conversion of continuous process variables into logical variables suitable for quantum-compatible encoding. A Variable Dictionary [412] maps the resulting logical solver variables to corresponding physical equipment tags, process variables, or operational identifiers. A Target Objective Weighting Feed [414] provides objective weights, priority values, or performance-emphasis parameters to the compiler. A Categorized Constraints Module [416] provides operational limits, symbolic penalty terms, feasibility restrictions, safety constraints, capacity constraints, or other categorized constraints. The Timestamped Optimization Snapshot [408]. Variable Dictionary [412], Target Objective Weighting Feed [414], and Categorized Constraints Module [416] are combined to generate a Serialized Artifact [418]. The Serialized Artifact [418] may include, for example, a QUBO formulation, an Ising formulation, or a quantum circuit representation.

The Serialized Artifact [418] is dispatched to an Algorithm Cloud [420] for quantum evaluation, quantum-inspired computation, solver selection, or downstream optimization processing. Iii this manner, FIG. 4 illustrates the digital translation layer between continuous cyber-physical process telemetry and a discrete, bounded, quantum-computable optimization artifact.

FIG. 5. Diagram Explanation. FIG. 5 illustrates a cyber-physical runtime orchestrator and validation gateway configured to mediate quantum computation attempts, classical fallback routing, solution validation, safety checking, and actuation before physical control actions are applied. Process Algorithm [500], as shown in FIG. 5, represents the runtime process algorithm executed by the system. The workflow begins at a Snapshot Build State [502], in which a current process snapshot, sensor state, optimization state, or control state is assembled for downstream compilation and solver execution. From the Snapshot Build State [502], the workflow proceeds to a Compile State [504], where the snapshot is converted into a solver-ready representation. The compiled problem then proceeds to a Quantum Attempt State [506], where the system attempts to obtain a quantum-derived solution. A Timeout Threshold Decision [508] determines whether the quantum attempt has exceeded a permitted runtime threshold. If a solution is returned within the threshold, the workflow proceeds toward validation. If the timeout threshold is exceeded, the workflow routes to a Tiered Classical Fallback Sequence [510], which may invoke one or more classical fallback solvers, conservative controls, heuristic methods, or backup optimization procedures. The fallback path may further access an Offline Precomputed Library [512] containing precomputed solutions, safe configurations, or reference control states.

The workflow then reaches a Validate State [514], where a returned quantum solution, fallback solution, or precomputed solution is evaluated for acceptability. A Staleness Threshold Decision [516] determines whether the data used to generate the candidate solution remains sufficiently current. If the data is stale, the workflow returns toward the Snapshot Build State [502] for a refreshed snapshot. If fresh data is available, the workflow proceeds to an Actuation Stability & Validation Gateway [518].

The Actuation Stability & Validation Gateway [518] performs additional checks before any control action is applied to the physical system. A Reverse-Scaling Decoder [520] converts normalized, encoded, discretized, or solver-domain outputs back into physical control quantities. A Model-Based Feasibility Check [522] evaluates whether the decoded candidate commands are feasible under a process model, physical constraints, or operational requirements. A Safety Guardrail Clamping stage [524] then limits, clamps, or bounds candidate control actions to remain within safety, stability, or equipment operating limits. If the candidate commands pass the safety and feasibility logic, the workflow proceeds to an Actuate State [526], where validated and bounded control commands may be applied to the physical process. If a command is clamped but remains acceptable, it may still proceed to the Actuate State [526]. If a critical failure occurs, the workflow routes to a Safe Hold State [528], in which the system maintains or transitions to a safe operating condition rather than applying unsafe control actions.

Path Control [530] represents the downstream routing or actuation interface through which validated control actions are dispatched. The Path Control [530] block may receive commands from the Actuate State [526], and may also participate in feedback routing toward the Snapshot Build State [502], thereby enabling continuous runtime iteration. In this manner, FIG. 5 shows a runtime orchestration architecture in which quantum attempts, classical fallback sequences, offline libraries, validation checks, staleness checks, reverse scaling, feasibility testing, safety clamping, actuation, safe hold, and path control operate together to ensure that quantum-derived or fallback-derived control actions are timely, feasible, and safe before being applied to an industrial process. FIG. 15. Diagram Explanation. FIG. 15 illustrates a control system interface configured for input detection, path control, operational control functions, computer-based control, and data storage. As shown in FIG. 15, an Input Detection block [1501] represents a function or module configured to detect, receive, or classify input information associated with the industrial process, including material inputs, sensor-derived inputs, operator inputs, or process-state signals.

A Valves/Path Control block [1503] represents the control function for directing material flow, routing process streams, actuating valves, selecting pathways, or controlling movement through channels, conduits, pipes, conveyors, or other process paths. The Valves/Path Control block [1503] may correspond to downstream routing or actuation logic used to implement validated control instructions generated by the hybrid quantum-classical control system.

An Operations block [1505] represents operational control functions of the system, including execution of process commands, management of operating modes, control of unit operations, and coordination of industrial process activities. The Operations block [1505] may receive instructions from a computer or control terminal and may coordinate with the Input Detection block [1501] and Valves/Path Control block [1503] to execute process control strategies.

A computer or control terminal [1507] is communicatively coupled to the Input Detection block [1501], the Valves/Path Control block [1503], and the Operations block [1505]. The computer or control terminal [1507] may provide a user interface, control interface, supervisory controller, or processing environment through which the system receives, displays, processes, or dispatches operational commands. A data store or database [1509] is coupled to the computer or control terminal [1507] and may store sensor data, input data, process records, optimization snapshots, historical performance information, control settings, or operational logs. In this manner, FIG. 15 shows a simplified control interface in which the computer or control terminal [1507] interacts with the data store [1509] and coordinates Input Detection [1501], Valves/Path Control [1503], and Operations [1505], thereby supporting computer-assisted control, routing, data management, and execution of process operations within the broader Industrial Digestive System control architecture.

FIG. 3 illustrates the iterative workflow of the hybrid quantum optimization process as a flowchart. As shown in FIG. 3, the workflow includes Step 1: Data Collection [300], in which sensors [302] provide process information to a Read Current Sensor Data step [304]. The collected sensor data may include, for example, temperature, pressure, flow, composition, quality, or other operational measurements of the industrial process. The workflow further includes an ML Prediction/Tuning step [306], including ML Predict+Parameter Tuning [308], which may predict near-future process states, estimate unmeasured variables, or suggest parameter adjustments before formulation of the optimization problem. Step 2: Problem Setup [310] includes Formulate Optimization Problem [QUBO/Circuit] [312], in which the current process state, objective tens, and constraints are translated into a quantum-compatible formulation. Step 3: Quantum Solve [314] includes a Quantum Solver [316], which may comprise an annealer or gate-based quantum processing unit configured to process the formulated optimization problem. Step 4: Solution Analysis [318] includes a Solution Valid? decision [320]. If a candidate solution does not satisfy the applicable constraints or feasibility criteria, the workflow proceeds to Adjust Constraints/Penalties [322] and returns to Step 2: Problem Setup [310], thereby forming an inner validity loop. If the solution is valid, the workflow proceeds to Step 5: Implement Control [324], in which control actions are applied to actuators [326]. The industrial process then proceeds to Step 6: Process Response [328], in which the Industrial Process Responds & Outputs [330]. The resulting process response is fed back toward Step 1: Data Collection [300], thereby closing the real-time adaptive loop. In this manner, FIG. 3 shows how the system repeatedly senses, predicts, formulates, solves, validates, actuates, and measures the industrial process in a continuous quantum-classical control cycle.

### Table 1: Comparison of Classical, Heuristic, and Quantum Optimization Approaches

Table 1 below summarizes the comparative discussion set forth in this section regarding classical, heuristic, and quantum-based optimization approaches in the context of industrial process optimization.

| | | Heuristic | |
|---|---|---|---|
| Criterion | Classical Methods | Methods | Quantum-Based Approach |
| Scalability | Classical methods, | Heuristic | The quantum-based approach |
| and Real- | including model | methods, | described herein may leverage |
| Time | predictive control | including genetic | quantum superposition, tunneling, or |
| Feasibility | (MPC) and mixed- | algorithms and | related quantum search mechanisms to |
| | integer linear | rule-based | explore larger solution spaces and |
| | programming | approaches, may | support near real-time optimization for |
| | (MILP), may provide | bandle | complex industrial problems. |
| | precise results for | moderately large | |
| | smaller or more | search spaces, | |
| | structured problems, | but can require | |
| | but can struggle with | many iterations | |
| | large combinatorial | and do not | |
| | spaces and may | guarantee | |
| | require | selection of the | |
| | simplifications. | best solution. | |
| Solution | Classical methods | Heuristic | The quantum-based approach may |
| Quality and | may identify optimal | methods | improve the likelihood of finding near- |
| Optimality | solutions for simpler, | generally | global optima or high-quality candidate |
| | linear, or well- | provide | solutions by searching complex |
| | conditioned | acceptable or | solution landscapes more efficiently. |
| | problems, while | “good enough” | |
| | complex integer, | solutions but | |
| | nonlinear, or highly | lack guaranteed | |
| | constrained industrial | global | |
| | problems may lead to | optimality. | |
| | suboptimal or | | |
| | computationally | | |
| | expensive outcomes. | | |
| Adaptability | Classical methods | Heuristic | The quantum-based approach is |
| | may require | methods may | designed for continuous re- |
| | recomputation or | require | optimization, as illustrated in FIG. 3, |
| | model adjustment | rerunning or | allowing the system to respond to |
| | when process | manual rule | sensor-detected disturbances, |
| | conditions change. | updates when | feedstock changes, output quality |
| | | process | deviations, or other operational |
| | | conditions | changes. |
| | | change. | |
| Multi- | Classical methods | Heuristic | The quantum-based approach may |
| Objective | often combine | methods may use | encode multiple objectives into a single |
| Handling | multiple objectives | ad hoc or | quantum-compatible cost function with |
| | into a weighted cost | sequential | adjustable weights, enabling real-time |
| | function determined | optimization | trade-off management among yield, |
| | offline. | approaches. | energy consumption, emissions, |
| | | | throughput, cost, product quality, or |
| | | | other performance criteria. |
| Human | Classical approaches | Heuristic | The quantum-based approach may |
| Intervention | often require expert | approaches often | reduce human intervention by |
| and Ease of | tuning, parameter | require rule | incorporating self-optimization, |
| Use | selection, and model | maintenance, | machine learning, and adaptive |
| | maintenance. | repeated | feedback, while allowing operators to |
| | | oversight, and | provide high-level preferences or |
| | | tuning. | objective priorities. |
| Computa- | Classical methods | Heuristic | The quantum-based approach may |
| tional | typically rely on | methods may run | offload at least a portion of the |
| Resources | CPU-based solvers | on standard | complex optimization to specialized |
| | and may require | processors but | quantum hardware or quantum- |
| | significant | often require | inspired resources, while classical |
| | computational | many | hardware performs data processing, |
| | resources for large- | simulations or | formulation, validation, and post- |
| | scale problems. | iterations. | processing. |

Overall, Table 1 summarizes how the disclosed quantum-based approach combines hybrid computation, continuous adaptation, and multi-objective optimization to support real-time industrial control with reduced manual intervention.

### Table 2: Encoding and Algorithm Mapping for Example Industrial Problems

Table 2 below summarizes the example encoding and algorithm mapping discussed in this section, showing how representative industrial optimization tasks may be transformed into quantum-compatible encodings and mapped to suitable quantum or hybrid quantum-classical algorithms.

| Industrial | | |
|---|---|---|
| Optimization | | Suitable Quantum or Hybrid |
| Task | Quantum-Compatible Encoding | Algorithm |
| Waste | Binary variables may represent allocation | Quantum annealing or QAOA |
| feedstock | fractions or assignment decisions for directing | may be used to solve the |
| allocation | feedstock to one or more digesters or | resulting QUBO formulation and |
| | processing units. Penalty terms may be used to | select an optimized allocation |
| | prevent capacity violations, while reward or | mix. |
| | objective terms may favor increased biogas | |
| | output, product yield, or resource recovery. | |
| Reactor | Operating ranges such as temperature, | A Variational Quantum |
| setpoint | pressure, residence time, flow rate, pH, or | Eigensolver (VQE) on a gate- |
| optimization | catalyst dosage may be discretized into binary | model QPU may be used to |
| | or multi-level variables. Multi-objective terms | identify low-energy |
| | may encode yield, efficiency, energy usage, or | configurations corresponding to |
| | product quality, while constraint terms may | preferred setpoints, or a QUBO- |
| | encode safety limits or feasible operating | based quantum annealer may be |
| | ranges. | used when the discretized |
| | | formulation is suitable for |
| | | annealing. |
| Process | Time slots may be mapped into binary | Quantum annealing or QAOA |
| scheduling | variables indicating batch start times, | may be used to solve the |
| | equipment assignments, or processing | corresponding QUBO |
| | windows. Constraints may be used to prevent | scheduling problem and identify |
| | overlapping resource usage, equipment | optimized batch schedules. |
| | overload, or infeasible sequencing, while | |
| | objective terms may maximize throughput or | |
| | minimize idle time. | |
| Fault- | Each possible routing path, control | Grover's search may be used to |
| tolerant | configuration, or operating mode may be | identify viable configurations |
| control | represented by binary switches, one-hot | satisfying defined feasibility |
| configuration | variables, or index encodings. The objective | criteria, while quantum |
| | function may penalize configurations that fail | annealing may be used to |
| | maintain acceptable outputs, violate | penalize and avoid |
| | operational constraints, or produce unstable | configurations that fail to meet |
| | process behavior. | performance thresholds. |
| Catalyst | One-hot encoding may represent catalyst | Quantum annealing or QAOA |
| selection and | choice, while binary or digital variables may | may be used to solve the discrete |
| dose | represent dose levels, concentration ranges, or | catalyst-selection and dosage |
| optimization | activation conditions. The cost function may | QUBO, while quantum |
| | reflect trade-offs between reaction rate, | chemistry analyses, including |
| | catalyst usage, selectivity, product quality, and | VQE, may inform the cost |
| | operating cost. | parameters or reaction-energy |
| | | estimates used in the |
| | | optimization. |

In essence, Table 2 summarizes how a variety of industrial optimization tasks, ranging from resource allocation to reactor setpoint selection, process scheduling, fault-tolerant configuration, and catalyst optimization, can be transformed into quantum-friendly formulations such as QUBO models, Ising Hamiltonians, or parameterized circuit representations. These formulations may then be solved or approximated using quantum annealing, QAOA, VQE, Grover's search, or hybrid quantum-classical workflows, thereby illustrating the flexibility of the disclosed approach for complex industrial scenarios.

Brief Description: FIG. 19 is a schematic block diagram illustrating a parameter-based transformation optimization model bridging atomic-level variational quantum eigensolver outputs to macroscopic factory-floor model predictive control (MPC) boundaries.

Detailed Description: FIG. 19 illustrates a programmatic pipeline configured to translate quantum-derived molecular information into actionable industrial control constraints. As shown in FIG. 19, a Variational Quantum Eigensolver (VQE) [1900] operates as the upstream quantum computational module and executes a Parameterized Quantum Circuit (Ansatz) [1902] to simulate electron-level or molecular-scale interactions. The resulting computational output provides Molecular Properties/Activation Energies [1904], which are supplied to a Macroscopic Thermodynamic Scaling Engine [1906]. The scaling engine converts the quantum-derived molecular information into plant-relevant Thermodynamic Operating Bounds [1908], including operating envelopes such as temperature, pressure, or related process constraints suitable for industrial control.

These operating bounds are then provided to a Classical Controller/MPC [1910], which incorporates the thermodynamic limits into a control framework for governing industrial operation. The Classical Controller/MPC [1910] communicates the resulting constrained control actions into a Local Cyber-Physical Execution Loop [1912], thereby enabling direct implementation at the plant level. The Local Cyber-Physical Execution Loop [1912] governs operation of physical process equipment, illustrated in FIG. 19 as a Depolymerization Reactor, Stage 130.a [1914]. Accordingly, FIG. 19 demonstrates how outputs from a quantum computational chemistry layer may be translated through a thermodynamic scaling layer into bounded industrial control instructions, thereby connecting microscopic quantum-derived reaction insights to macroscopic real-time process control. In some embodiments, this control architecture may be applied within the broader IDS quantum optimization flow illustrated in FIG. 6 and to the physical hardware supply chain illustrated in FIG. 1.

Explication of FIG. 6 IDS Hardware Supply Chain [600], as shown in FIG. 6: Shows the main physical Industrial Digestive System supply chain stages: Stage 100: Shredder/Grinder [602], Stage 130: Depolymerization/Hydrolysis/Fermentation [604], Stage 140: Separation [606], Stage 150: Polymerization & Mixing [608], and Stage 200: Distillation [610].

Step 1 (INPUT & SENSING) [612]: The system inputs heterogeneous waste or raw materials. A network of sensors measures relevant properties, including composition, temperature, flow rates, reaction progress, or other process-state parameters. This data forms the basis for quantum optimization by capturing current process states. Step 2 (QUANTUM MODEL BUILDER) [614]: Identify discrete decisions, including which stage or stages to run; and how to route feedstock, and continuous variables, including fractions x_i, temperature, reaction time), or other operating variables, from the multi-objective function S(C_k, X). Partition or discretize large or continuous variables into quantum-tractable subsets, including finite steps or sub-problem chunking. Construct the IDS Hamiltonian H_IDS or a QUBO/Ising cost function, embedding constraints including capacity, stoichiometry, and safety, and performance objectives including energy yield, emission penalties, and product purity. Step 3 (QUANTUM OPTIMIZATION MODULE) [616]: The quantum solver, including a quantum annealer, gate-based QAOA, or VQE for reaction-level modeling, processes the built Hamiltonian or cost function to find near-optimal solutions. The quantum optimization module outputs an optimized configuration of stage usage and operating parameters.

Step 4 (HYBRID INTEGRATION LAYER) [618]: Merges quantum solutions with any classical heuristics or sub-problem solutions that cannot be handled purely by the quantum solver, including advanced domain rules or partial continuous constraints. Optionally uses Quantum ML or surrogates for feasibility checks or reaction yield approximations. Produces actionable setpoints or routing commands for the IDS in a real-time iterative loop.

Step 5 (ACTUATE & MONITOR IN IDS) [620]: Using the quantum-derived setpoints, actuate the system, including conveyors, pipes, valves, channels, or other industrial control elements, routing input into the desired sequence of unit operations, including grinder→, reactor→, separator→, polymerizer→, distillator, or other selected stages. Monitor intermediate or final outputs, including biofuels, chemicals, composites, or other usable products, via sensors. Feed updated data back into the quantum model builder for re-optimization if conditions, including feedstock composition, reaction rates, or external constraints), have changed.

FIG. 7. Diagram Explanation. FIG. 7 illustrates the construction of an overarching system Hamiltonian and the restriction of the computational search space through cost terms, penalty terms, and constraint-preserving mixer logic. As shown in FIG. 7, Logical Solver Variables [707], including variables such as z_p and s_p, and Continuous Fractional Allocations [708], including allocation variables such as x_ij, are provided as inputs to an Overarching System Hamiltonian H_IDS [700].

The Overarching System Hamiltonian [700] represents the combined mathematical formulation of the industrial optimization problem. The Hamiltonian may include objective terms, constraint terms, allocation variables, binary or spin variables, and process-dependent coupling terms that collectively encode the desired operation of the Industrial Digestive System.

A Generic Cost Hamiltonian H_cost [701] is derived from or associated with the Overarching System Hamiltonian [700]. The Generic Cost Hamiltonian [701] includes Yield/Reward Terms [702], which represent desired objectives such as output yield, product quality, energy recovery, throughput, resource recovery, or other performance metrics. The Generic Cost Hamiltonian [701] also includes Penalty Constraint Terms [703], which represent penalties for infeasible, unsafe, or undesired states, including violations of material balance, capacity limits, stoichiometric requirements, safety thresholds, routing constraints, or other operational constraints.

The Overarching System Hamiltonian [700] may also be associated with a Specialized Mixer Hamiltonian H_mix [704]. The Specialized Mixer Hamiltonian [704] is configured to restrict or guide the movement of the quantum search process through valid regions of the solution space. The mixer directs the optimization toward a Feasible Subspace Boundary [705], which defines a region of states satisfying selected physical, logical, or operational constraints.

As illustrated in FIG. 7, the Feasible Subspace Boundary [705] excludes Physically Impossible States [706]. Such physically impossible states may include states that violate conservation laws, exceed process capacity, route materials through incompatible process paths, select mutually exclusive operating modes, or otherwise fail to correspond to implementable IDS configurations. The feasible portion of the search space may then be provided to or explored by a Global Quantum-Accelerated Optimizer [709].

In this manner, FIG. 7 shows how logical solver variables [707] and continuous allocation variables [708] are incorporated into H_IDS [700], how objective and reward behavior is represented through yield/reward terms [702], how feasibility is enforced through penalty constraint terms [703], and how a specialized mixer Hamiltonian [704] may constrain the search to feasible subspaces [705] while excluding physically impossible states [706]. The resulting formulation supports global quantum-accelerated optimization [709] of industrial process decisions while preserving physical and operational validity.

FIG. 10. DRAWING CIRCUIT Quantum Circuit Model for IDS Optimization. The Industrial Digestive System (IDS) hardware process can be mapped onto a quantum circuit to enhance optimization and control. The diagram below illustrates how each physical stage of the IDS corresponds to a qubit in a quantum circuit, with entanglement and quantum gates representing inter-stage dependencies and constraints. Real-time sensor data and measurements integrate the physical process with quantum optimization, creating a feedback loop for dynamic, real-time process optimization.

IDS Stages Qubits for Process Stages: Each major IDS stage is represented as a qubit in the quantum circuit. The Industrial Digestive System physical-stage mapping is identified as [1000], as shown in FIG. 10. For example, q1 corresponds to Shredding (110,120) [1002], q2 to Depolymerization (130.a) [1004], q3 to Hydrolysis (130.b) [1006], q4 to Fermentation (130.c) [1008], q5 to Separation (140) [1010], q6 to Polymerization (150) [1012], and q7 to Distillation (200) [1014]. These qubit labels (shown in the diagram as q1-q7) map the physical equipment directly onto logical quantum bits.

Entanglement of Dependent Stages: Where stages influence each other, their qubits are entangled. In the diagram, a dashed entanglement link [1032] connects the Hydrolysis qubit (q3) [1006] and the Fermentation qubit (q4) [1008]. This represents their coupled parameters (e.g. hydrolysis output conditions affecting fermentation input requirements). Entangling these qubits encodes the dependency so that quantum states of those stages are correlated during optimization.

Controlled Gates for Constraints: Key process constraints are enforced via controlled operations (penalty terms) between qubits. For instance, a mass balance constraint [1036] is shown as a controlled link between q1 (Shredding input) [1002] and q7 (final Distillation output) [1014], ensuring the total throughput is conserved (mass in =mass out). Similarly, a throughput limit constraint [1034] links Fermentation (q4) [1008] and Separation (q5) [1010], reflecting a capacity limit (e.g. fermentation output cannot exceed what separation can handle). These constraints appear as dashed lines labeled “Mass Balance Constraint” and “Throughput Constraint,” acting like penalty-encoded gates that energetically punish infeasible combinations in the quantum solution.

Flow of Quantum Information and Feedback Measurement Interface: After the quantum circuit computes an optimal configuration, a measurement operation (represented by the circle labeled “Measurement”) [1026] collapses the qubit states to a classical result. This measurement provides the optimal process parameters or decisions (such as settings for temperatures, flow rates, etc.). In the diagram, the measurement node [1026] feeds into a Classical Controller [1028].

Classical Control & Feedback Loop: The Classical Controller [1028] reads the measured quantum output (optimal settings) and translates it into real-world control actions on the IDS hardware. In the diagram, this is indicated by the arrow from Measurement [1026] to the Classical Controller; [1028], and a feedback arrow [1030] from the controller back to the Hydrolysis stage (q3) [1006]. This feedback loop means the controller can adjust the hydrolysis reactor (or other stages) in real time based on the quantum-optimized solution. The feedback connection closes the loop, allowing continuous updating of stage operating parameters. Essentially, the quantum optimizer suggests adjustments, and the classical control system applies them to the physical process, improving performance iteratively.

Algorithmic Mapping: QUBO Encoding & Quantum Optimization QUBO/Ising Model Encoding: The IDS optimization problem (choosing optimal operating conditions, equipment settings, etc.) is first mapped into a QUBO (Quadratic Unconstrained Binary Optimization) or Ising model formulation. The diagram's “QUBO Encoding” node [1022] represents this step within the Quantum Optimization (Digital Twin) [1020]. Here, binary variables correspond to discrete decisions in the process (for example, turning a unit on/off, selecting high vs. low throughput) and penalty terms encode constraints like mass balance [1036] and throughput limits, [1034]. This cost function captures both the performance objective (e.g. maximize output or efficiency) and penalties for violating any process constraints, preparing the problem for quantum solving.

Parameterized Quantum Circuit (QAOA/VQE): The encoded problem is then fed into a parameterized quantum algorithm. In the diagram, the “Quantum Circuit (QAOA/VQE Layers)” block [1024] represents algorithms like QAOA (Quantum Approximate Optimization Algorithm) or VQE (Variational Quantum Eigensolver). These algorithms use a layered quantum circuit to gradually find optimal solutions: they apply a series of quantum gates that represent the problem's cost function and mixing operations. For example, QAOA uses alternating phases-one phase applies gates encoding the QUBO/Ising cost (entangling the stage qubits according to the penalty terms and process model), and another phase “mixes” the qubit states to explore new configurations. Multiple layers (repetitions of these phases) refine the solution. The parameters of these gates are adjusted iteratively (either by a classical optimizer in VQE or by trial and error in QAOA) to minimize the cost encoded by the QUBO. In essence, this quantum circuit optimizes reaction conditions and material allocations across the IDS, searching for the lowest-cost (most efficient and feasible) operating point.

Solution Readout: After the QAOA/VQE circuit has been executed with optimized parameters, measuring the qubits yields the best found configuration (for example, a bitstring where each qubit's state suggests an optimal decision for its corresponding stage). This measured solution is represented by the Measurement node [1026] and is then passed to the Classical Controller [1028] for implementation, as described above.

Real-Time Sensor Integration Live Data Feeds: To make the optimization dynamic, real-time sensor data [1038] from the IDS feeds into the quantum model. In the diagram, sensors monitor key stages, including a Sensor: Fermentation Output [1016] and a Sensor: distillation quality [1018], and send data to the QUBO Encoding block [1022]. These are shown as arrows from Fermentation (q4) [1008] and Distillation (q7) [1014] to Sensor nodes, [1016, 1018], which then connect into the QUBO Encoding node [1022]. This means that the current state of the process (yields, concentrations, throughput, etc.) continuously updates the quantum optimization problem. For example, if a sensor detects a drop in fermentation output quality, that information is fed into the QUBO model so the quantum algorithm can re-optimize the settings to correct or accommodate this change.

Iterative Optimization: With sensor data updating the cost function in real time, the quantum optimizer re-runs iteratively to find new optimal settings under the current conditions. The feedback loop (sensor→quantum model→optimized output→controller→process adjustment) operates continuously or in discrete time steps. This is depicted by the combination of sensor data arrows [1038] going into the quantum circuit and the controller feedback arrow [1030] going back to the process. As a result, the IDS operates under a quantum-assisted control scheme that can respond to disturbances or changing feedstock on the fly. The process and quantum computer effectively work in tandem: the quantum circuit processes live data to output optimal control actions, and the physical system is immediately tuned, ensuring the system is always near an optimal operating point despite external fluctuations.

Hybrid Quantum-Physical Workflow Overall, the diagram presents a hybrid flowchart/quantum-circuit view of the IDS. The top timeline (within the Industrial Digestive System subgraph [1000]) shows the physical process flow through stages 110→200, while the right side (the Quantum Optimization subgraph [1020]) shows the digital quantum workflow (QUBO formulation [1022]→QAOA/VQE circuit [1024]→measurement [1026]). Entanglement [1032] and controlled-gate notations bridge the two, illustrating how quantum computations encode the process constraints and couplings. The measurement and sensor links demonstrate the quantum-classical interface, tying the quantum optimizer to physical sensor inputs [1016, 1018] and control outputs-through the Classical Controller [1028]. This integrated diagram makes it clear how quantum algorithms optimize industrial operations: by translating the IDS supply chain into a quantum circuit, we can leverage quantum computation to find optimal control settings that are fed back to run the industrial process more efficiently and robustly in real time.

FIG. 8. Diagram Explanation: FIG. 8 illustrates a classical and quantum pipeline architecture configured to mitigate quantum hardware constraints while maintaining control over an industrial process. The Industrial Process [800], as shown in FIG. 8, includes Sensors [802] and Actuators [804]. Sensors [802] provide real-time data about the current state of the industrial process, including temperatures, flow rates, composition, process state variables, or other operational measurements. Actuators [804] receive updated setpoints or control actions to adjust the industrial process. Classical Subsystem [806]: The Classical Subsystem [806] includes Problem Decomposition & Variable Fixing [808] and Pipeline Orchestration & Control Coordination [810]. Problem Decomposition & Variable Fixing [808] breaks down large optimization tasks into smaller sub-problems to fit limited qubit resources, and optionally fixes less critical variables using heuristics, machine learning, domain rules, or classical preprocessing. As shown by the direct connection from Problem Decomposition & Variable Fixing [808] to Embedding Optimization [814], the resulting sub-problems may be passed from the classical subsystem [806] to the quantum subsystem [812] for mapping onto the quantum processor. Pipeline Orchestration & Control Coordination [810] oversees scheduling and parallelization of quantum tasks, merges partial solutions, coordinates feedback and updates, and outputs control commands to actuators [804]. Quantum Subsystem [812]: The Quantum Subsystem [812] includes Embedding Optimization [814], a Quantum Processor [816], and Error Mitigation [818]. Embedding Optimization [814] receives decomposed sub-problems from Problem Decomposition & Variable Fixing [808] and adapts each sub-problem to the quantum processor's qubit connectivity, minimizing overhead or extra qubits and addressing connectivity constraints. The Quantum Processor [816] executes the sub-problem using annealing, gate-model algorithms, or other quantum methods, subject to hardware qubit limits. Error Mitigation [818] reduces noise or gate errors and improves result fidelity before returning data to the classical subsystem. The flow of data starts at Sensors [802], proceeds to Problem Decomposition→& Variable Fixing [808] in the Classical Subsystem [806], then follows the decomposition-to-embedding connection to Embedding→Optimization [814], Quantum→Processor [816], and Error Mitigation→[818] in the Quantum Subsystem [812]. Results are returned to Pipeline Orchestration→& Control Coordination [810], which coordinates feedback and updates with the classical decomposition stage and provides control outputs to Actuators [804]. In this manner, FIG. 8 forms a continuous feedback loop to handle hardware constraints, including limited qubit count, restricted connectivity, noise or gate errors, and latency.

FIG. 9. Diagram Explanation: FIG. 9 illustrates a hybrid quantum-classical optimization system [900], as shown in FIG. 9, configured to coordinate classical and quantum computational resources for real-time optimization of an industrial process.

Industrial Process (I): The Industrial Process [918] is the physical system or plant that generates Real-time Sensor Data [928] and receives Control Signals [930]. Real-time Sensor Data [928] flows from the Industrial Process [918] back into the computational architecture, while Control Signals [930] flow from the Classical Computing Module [916] to the Industrial Process [918] to implement updated operating commands or setpoints.

Classical Subsystem (C): The Classical Subsystem [902] includes a Problem Formulation block [906], a Hybrid Optimization Engine [908], a Quantum Hardware Limitation Mitigation block [914], and a Classical Computing Module [916]. Problem Formulation [906] translates the industrial optimization problem into a quantum-friendly representation, including a QUBO, circuit, oracle, or related quantum-compatible formulation. The Hybrid Optimization Engine [908] orchestrates where sub-problems should be solved, including whether they should be processed by quantum resources or classical resources, and merges results from the quantum and classical computational paths. Quantum Hardware Limitation Mitigation [914] handles partitioning of large problems, error mitigation strategies, embedding challenges, fallback measures, or related compensation if quantum hardware is unavailable, limited, noisy, or delayed. The Classical Computing Module [916] performs classical optimization tasks, manages baseline or continuous optimization, processes quantum-derived outputs, and supplies final commands back to the Industrial Process [918] through Control Signals [930]. As further shown in FIG. 9, the Classical Computing Module [916] may also return processed information, refined parameters, baseline optimization results, or updated classical constraints to the Problem Formulation block [906], thereby enabling the optimization problem to be reformulated during subsequent iterations.

Quantum Subsystem (Q): The Quantum Subsystem [904] includes a Hardware Interface Layer [910] and a Quantum Computing Module [912]. The Hardware Interface Layer [910] selects and communicates with the appropriate quantum hardware, including an annealer, gate-based system, quantum processor, or cloud-based quantum service. Optimization Tasks & Data [920] are supplied to the Hardware Interface Layer [910], and a QUBO/Circuit representation [922] is transmitted from the Hardware Interface Layer [910] to the Quantum Computing Module [912]. The Quantum Computing Module [912] executes quantum algorithms, including annealing, QAOA, VQE, Grover's search, or related quantum optimization procedures, to solve decomposed or quantum-compatible sub-problems. Quantum Results [924] are returned from the Quantum Computing Module [912] to the Hardware Interface Layer [910].

The bidirectional arrows indicate continuous data exchange and iteration: Real-time Sensor Data [928] flows from the Industrial Process [918] to the Classical Subsystem [902]. Control Signals [930] flow back from the Classical Subsystem [902] to the Industrial Process [918]. Optimization Tasks & Data [920] flow from the Hybrid Optimization Engine [908] through the Hardware Interface Layer [910] to the Quantum Computing Module [912]. Quantum Results [924] are returned for post-processing, error mitigation, or integration with classical computations, and Processed Results [926] are returned toward the Hybrid Optimization Engine [908]. In addition, feedback from the Classical Computing Module [916] may be supplied to the Problem Formulation block [906] to update the formulation based on classical processing, refined constraints, processed sensor data, or prior optimization results. These feedback paths ultimately produce updated control settings for the Industrial Process [918]. By combining quantum and classical resources, FIG. 9 shows how the system adapts to different hardware platforms, including annealers, gate-based QPUs, and hybrid cloud services, while ensuring robust, real-time optimization of complex industrial processes.

FIG. 13. Diagram Explanation. FIG. 13 illustrates a distributed multi-site quantum partitioning architecture used to route localized edge computing variables separately from centralized quantum cloud dependencies. As shown in FIG. 13, a Global Optimization Graph [1300] and Physical Site Capabilities [1302] are provided as inputs to a Multi-Site Graph Partitioner [1304]. The Global Optimization Graph [1300] represents the overall optimization problem across multiple industrial or research sites, while the Physical Site Capabilities [1302] represent the available process equipment, local resources, site constraints, computational capacity, or operational capabilities of each site.

The Multi-Site Graph Partitioner [1304] divides the global optimization problem into localized and inter-site portions. Intra-Site Operational Variables [1306] represent variables that can be handled locally at an individual site, including local operating conditions, local routing, local setpoints, local resource usage, or other site-internal variables. These Intra-Site Operational Variables [1306] are routed to Local Classical Edge Solvers [1308], which solve or refine local subproblems using classical computation, edge computing resources, heuristics, local models, or local control rules.

Inter-Site Dependencies [1310] represent variables or constraints that connect multiple sites, including shared resources, inter-site material flows, load balancing, logistics, coordination constraints, or other dependencies that cannot be resolved by a single site alone. These Inter-Site Dependencies [1310] are routed to an Algorithm Cloud [1312], which coordinates remote or centralized optimization resources. The Algorithm Cloud [1312] provides the inter-site optimization portion to a Cloud Quantum Solver [1314], which may solve or approximate the inter-site dependencies using quantum annealing, QAOA, VQE, hybrid quantum-classical computation, or other quantum-compatible optimization methods.

Results from the Local Classical Edge Solvers [1308] and the Cloud Quantum Solver [1314] are provided to a Synchronization Bus [1316]. The Synchronization Bus [1316] integrates local site-level solutions and centralized quantum-derived inter-site solutions, resolves timing or coordination differences, and produces a unified control output. The resulting Synchronized Multi-Site Control Strategy [1318] provides a coordinated operational strategy for the distributed industrial or research network.

In this manner, FIG. 13 shows how a global optimization graph [1300] may be partitioned according to physical site capabilities [1302], with intra-site operational variables [1306] handled locally by classical edge solvers [1308] and inter-site dependencies [1310] routed through an algorithm cloud [1312] to a cloud quantum solver [1314]. The synchronization bus [1316] then combines the resulting partial solutions into a synchronized multi-site control strategy [1318], enabling distributed industrial optimization while efficiently allocating quantum resources to the portions of the problem most suited for centralized or cloud-based quantum solving.

FIG. 18. Diagram Explanation: FIG. 18 illustrates a Distributed Industrial Network [1800] including a Central Orchestrator/Coordinator [1802] configured to manage optimization and control across multiple industrial or research sites. Multiple Sites: Industrial/Research Site 1 [1816], Industrial/Research Site 2 [1818], and Industrial/Research Site N [1820] are shown as distributed sites within the network. Each site includes Sensors [1822] and Actuators [1824]. The Sensors [1822] collect real-time data, including reaction rates, process variables, operating conditions, or related telemetry, while the Actuators [1824] adjust local process parameters, including feed rates, temperature, mixing, or other operational settings. Each site transforms its specific inputs into one or more outputs, including, for example, waste to energy, chemical feedstock to refined products, or related industrial transformations.

In some embodiments, the system operates as a closed-loop workflow in which telemetry is ingested from physical and/or industrial environments, data is normalized and optionally error-mitigated, objectives and constraints are constructed and categorized, a mathematically bounded problem representation including QUBO, Ising, and/or a parameterized circuit) is compiled, one or more solver backends are invoked, candidate solutions are decoded and validated, and validated control actions are dispatched to local execution environments, with resulting telemetry feeding back for iterative refinement. In some embodiments, fallback policies reroute to alternative backends or conservative controls if feasibility or safety checks fail.

Central Orchestrator (CO): The Central Orchestrator/Coordinator [1802] includes a Classical Subsystem [1804] and a Quantum Subsystem [1810]. Within the Classical Subsystem [1804], a Problem Decomposition & Chunking Multi-Site Partitioning) block [1806] receives sensor data from all sites; and partitions or “chunks” the global optimization problem into subproblems, including, for example, per-site variables and inter-site coordination variables. A Classical Optimization & Coordination block [1808] executes classical optimization routines, merges quantum results with partial local solutions, and orchestrates final control decisions across multiple sites.

Within the Quantum Subsystem [1810], a Quantum Solver Interface & Integration block [1812] prepares subproblems or chunks for quantum computation- and handles data exchange and result integration. A Quantum Processor Annealer or Gate-Based) [1814] executes quantum algorithms, including annealing, QAOA, VQE, or related methods, to solve subproblems or refine global solutions that classical methods alone find challenging. Data Flow: Sensor data from the Sensors [1822] at each site is transmitted to the Central Orchestrator/Coordinator [1802]. Problem decomposition and chunking are performed by the Problem Decomposition→& Chunking block [1806], which breaks down the multi-system optimization problem into smaller quantum-compatible subproblems. Quantum and classical collaboration is then performed through the Classical Optimization & Coordination block [1808], the Quantum Solver Interface & Integration block [1812], and the Quantum Processor [1814], such that quantum computations are performed on especially complex or combinatorial portions while classical optimization handles simpler or continuous portions. The resulting solutions are integrated to form an optimal or near-optimal multi-site control strategy. Optimized Setpoints [1826] are then transmitted back to the distributed sites and applied through the Actuators [1824], thereby closing the feedback loop and enabling real-time distributed optimization across all locations. In the illustrated embodiment, a bracketed sensor-side grouping [1828] identifies the distributed sensing side of the site network, and a bracketed actuator-side grouping [1830] identifies the distributed actuation side receiving the Optimized Setpoints [1826].

Scalability: By chunking large problems into subproblems distributed across multiple quantum or classical solvers, the architecture scales to large networks of industrial or research sites while leveraging limited quantum resources efficiently. As quantum hardware and algorithms improve, including more qubits, better connectivity, and reduced noise, the same overall framework automatically accommodates bigger subproblems or fewer decomposition steps.

Accordingly, FIG. 18 reflects how a Hybrid Quantum-Classical Optimization System can simultaneously manage multiple industrial or research sites in a multi-system optimization scenario, continuously refining control strategies to achieve global objectives such as energy efficiency, yield maximization, or resource sharing across all locations.

FIG. 11. FIG. 11 Diagram Explanation. (1) Quantum-Enhanced IDS for High-Throughput Experimentation. As illustrated in FIG. 11, a Quantum-Enhanced IDS for High-Throughput Experimentation [1100] includes an IDS Processing Unit [1102], which is the hardware environment performing reaction discovery, material optimization, or chemical synthesis. Sensor Data [1104] is transmitted from the IDS Processing Unit [1102] to Quantum Computing Modules [1106], which run specialized optimization models using real-time data. The Quantum Computing Modules [1106] generate Optimized Conditions [1108], which are provided to a Real-Time Process Feedback Loop [1110]. The Real-Time Process Feedback Loop [1110] continuously returns Adjust Parameters [112] instructions to the IDS Processing Unit [1102], thereby tying together sensor measurements and quantum-driven conditions in a continuous feedback cycle.

(2) Quantum-Assisted Experimental Design and Screening Optimization. A Quantum-Assisted Experimental Design block [1114] includes Quantum Algorithms [1116], such as QAOA, Grover's, VQE, or related approaches, which search a high-dimensional parameter space. These algorithms provide outputs to an Evaluate & Select Optimal Reaction Params, Screening Conditions, Material Combos block [1118], which performs evaluation and selection of optimum combinations of reaction conditions or materials. The selected outputs are then used to Auto-Configure IDS Experimental Hardware [1120], thereby enabling rapid or on-demand reconfiguration of the experimental platform.

(3) Quantum Chemistry-Based Reaction & Material Simulation. A Quantum Chemistry-Based Simulation block [1122] includes a Quantum Processing Unit [1124], which executes chemistry algorithms such as VQE, HHL, or Quantum Phase Estimation. Quantum Chemistry Calculations [1126] are transmitted to a Simulation Engine [1128], which interprets the quantum outputs to predict reaction outcomes, reaction pathways, and material interactions. Simulation Results [1130] are then supplied to an Optimization Component [1132], which uses the simulation results to recommend adjustments to catalysts or reaction conditions for improved yields, thereby enabling informed iterative experimentation.

(4) Fully Automated IDS-Integrated HTE Workflow. A Fully Automated IDS-Integrated HTE Workflow block [1134] includes Automated Experimental Hardware & Sensors [1136], which carry out iterative experiments and gather data. Iterative Cycles Measuring Results [1138] are communicated to a Hybrid Quantum-Classical Feedback Loop [1142], and On-the-fly Updates [1140] may be returned toward the Automated Experimental Hardware & Sensors [1136]. The Hybrid Quantum-Classical Feedback Loop [1142] merges quantum model outputs with classical data analysis in real timer and interfaces with an Orchestration Software Layer [1144], which coordinates data flows, triggers new experiments, and adjusts parameters. Coordinate Iterations & Data Flows [1146] are managed across these elements so that the workflow can operate without human intervention. (5) General-Purpose HTE Platform for Multi-Industry Applications. A General-Purpose HTE Platform [1148] includes a Modular IDS Architecture [1150] supporting varied industrial domains, including pharmaceuticals, energy, and advanced materials. The Modular IDS Architecture [1150] interfaces with a Quantum-Enhanced Process Control block [1152], which extends adaptive experimentation protocols across diverse product discovery or scale-up scenarios. The Quantum-Enhanced Process Control block [1152] further interfaces with Industrial Automation [1154], including robotic handlers, sensors, and actuators, thereby ensuring that the platform can scale to large experiments under quantum-optimized control in different industries. Together, these subgraphs illustrate how quantum capabilities are woven into an industrial cyber-physical system, offering a comprehensive high-throughput experimentation framework for research, process optimization, scale-up, and multi-domain innovation under one integrated quantum-enabled control architecture.

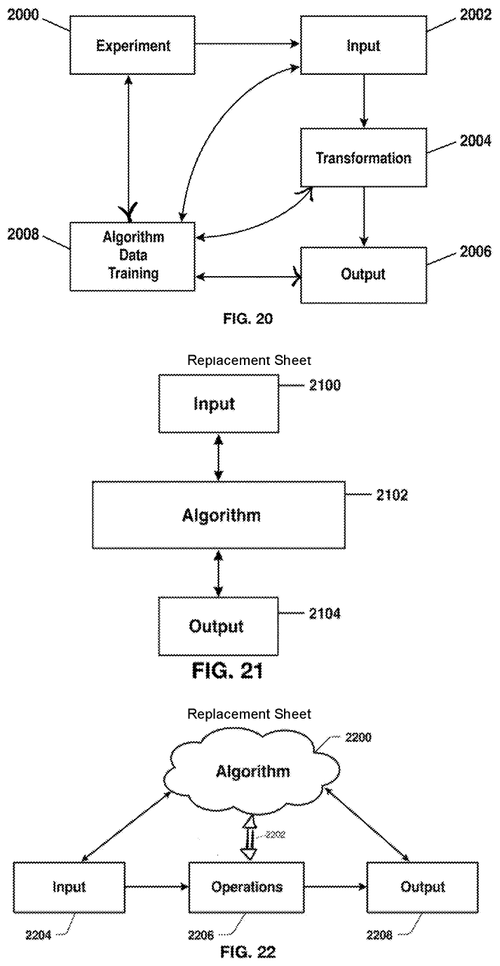

FIG. 20. Diagram Explanation. FIG. 20 illustrates an experiment-input-transformation-output loop configured to generate and update algorithm training data. As shown in FIG. 20, an Experiment block [2000] represents an experimental operation, test, trial, process run, or controlled execution of an industrial or research procedure. The Experiment block [2000] provides information or conditions to an Input block [2002], which represents the input materials, parameters, conditions, variables, feedstocks, or data supplied to a transformation process. The Input block [2002] is directed to a Transformation block [2004]. The Transformation block [2004] represents a physical, chemical, biological, computational, or industrial transformation performed on or using the input. The Transformation block [2004] produces an Output block [2006], which represents the resulting product, measurement, response, process result, performance metric, material output, or observed outcome of the transformation. An Algorithm Data Training block [2008] receives information from the Output block [2006] and is also linked with the Experiment block [2000], the Input block [2002], and the Transformation block [2004]. The Algorithm Data Training block [2008] represents the process of collecting, organizing, and using experimental, input, transformation, and output data to train or update an algorithm, machine learning model, optimization model, or quantum-classical control model. The arrows shown in FIG. 20 illustrate feedback relationships among the Experiment block [2000], the Input block [2002], the Transformation block [2004], the Output block [2006], and the Algorithm Data Training block [2008]. In this manner, FIG. 20 shows how experimental results and transformation outputs may be fed back into algorithm data training, thereby enabling iterative improvement of input selection, transformation control, optimization parameters, and future experimental design.

FIG. 21. Diagram Explanation. FIG. 21 illustrates a simplified input-algorithm-output relationship for algorithmic processing embodiments. As shown in FIG. 21, an Input block [2100] represents input data, input materials, operational variables, sensor-derived information, user-defined parameters, process-state information, or other information supplied to an algorithmic processing function.

An Algorithm block [2102] represents an algorithm, computational model, optimization routine, machine learning model, quantum algorithm, hybrid quantum-classical workflow, or other computational logic configured to process the input [2100]. The bidirectional relationship between the Input block [2100] and the Algorithm block [2102] indicates that the algorithm may receive input information and may also request, refine, update, or recondition input information during iterative execution.

An Output block [2104] represents the output produced by the Algorithm block [2102], including optimized parameters, candidate solutions, control recommendations, classification results, predicted outcomes, process settings, or other algorithm-generated results. The bidirectional relationship between the Algorithm block [2102] and the Output block [2104] indicates that output information may be evaluated, fed back, or used to refine subsequent algorithmic processing. In this manner, FIG. 21 shows a generalized algorithmic processing structure in which input [2100], algorithmic processing [2102], and output [2104] may operate in an iterative or feedback-enabled relationship.

FIG. 22. Diagram Explanation. FIG. 22 illustrates an algorithm-centric operational model in which an Algorithm block [2200] communicates with input, operations, and output functions. As shown in FIG. 22, the Algorithm block [2200] may represent an algorithm cloud, remote algorithmic service, optimization engine, machine learning model, quantum-assisted optimization module, hybrid quantum-classical algorithm, or other computational environment configured to coordinate or influence industrial process operations.

An Input block [2204] represents input data, material input, sensor information, feedstock information, process-state information, operator instructions, objective weights, or other information supplied into the operational workflow. An Operations block [2206] represents the operational portion of the system, including process execution, unit-operation control, material transformation, routing, actuation, or industrial procedure management. An Output block [2208] represents the resulting output of the operations, including products, process results, control results, measured performance, optimized output streams, or other operational outcomes.

A bidirectional Algorithm-Operations interface [2202] is shown between the Algorithm block [2200] and the Operations block [2206]. The bidirectional interface [2202] indicates that the algorithm may provide control instructions, optimized setpoints, routing commands, or decision logic to operations, and that operations may return process data, performance measurements, or status information to the algorithm. Additional arrows show communication between the Algorithm block [2200] and the Input block [2204], communication between the Algorithm block [2200] and the Output block [2208], and process flow from the Input block [2204] through the Operations block [2206] to the Output block [2208].

In this manner, FIG. 22 shows an algorithm-centered control architecture in which input information [2204], operational execution [2206], and output information [2208] are coordinated through an Algorithm block [2200] and a bidirectional Algorithm-Operations interface [2202], enabling adaptive control, feedback, optimization, and data-driven improvement of industrial process operations.

FIG. 12 illustrates a stage-by-stage quantum encoding and closed-loop optimization workflow for an Industrial Digestive System (IDS). The figure depicts a real-time IDS-Quantum Feedback Loop [1200], a Quantum Encoding & Constraints section [1210], a Quantum Solver section [1218], and a physical IDS stage architecture including Stage 100 [1228], Stage 130 [1234], Stage 140 [1242], Stage 150 [1244], and Stage 200 [1246].

Stages 100, 130, 140, 150, and 200: Stage 100 [1228] corresponds to Shredding/Grinding and includes a shredder [1230] and a grinder [1232]. Stage 130 [1234] corresponds to Depolymerization, Hydrolysis, and Fermentation, and includes a depolymerization reactor [1236] identified as stage 130.a, a hydrolysis reactor [1238] identified as stage 130.b, and a fermentation reactor [1240] identified as stage 130.c. Stage 140 [1242] corresponds to Separation. Stage 150 [1244] corresponds to Polymerization/Mixing. Stage 200 [1246] corresponds to Distillation. As illustrated in FIG. 12, the IDS pipeline moves materials sequentially, or in some cases through branching flows [1260], from earlier stages to later stages.

Real-Time IDS-Quantum Feedback Loop: In the real-time IDS-Quantum Feedback Loop [1200], physical sensors for flow and reaction extent [1202] generate sensor data [1204], which is used together with additional physical sensing inputs [1206] to monitor current process behavior. Based on this information, the system may re-formulate constraints and objectives [1208] whenever operating conditions deviate from expected values. This continuous sensing and updating structure enables the system to adapt its optimization model in real time, as shown in FIG. 12.

Quantum Encoding & Constraints: In the Quantum Encoding & Constraints block [1210], the system defines qubits or binary variables [1212] representing unit-operation decisions such as on/off selections, feed rates, temperature levels, routing states, or other operating parameters. Penalties for material balance, objective terms, and emissions [1214] are incorporated so that throughput limits, stoichiometric constraints, safety constraints, or inter-stage dependencies are reflected in the encoded problem. The system then chooses a representation [1216], including a QUBO formulation, an Ising model, or a parameterized circuit for a gate-based system. In this way, each unit operation is assigned qubits or sets of binary variables, and the objective function may reward maximizing yield or product quality while minimizing cost, energy use, or emissions. Quantum Solver: The encoded problem is passed to the Quantum Solver [1218], which may be an annealer, a gate-based system, or a hybrid quantum-classical solver. Within this block, a global quantum circuit [1220], integrated from stages 100 through 200, represents the overall IDS problem, and algorithm execution [1222] may use QAOA, VQE, quantum annealing, or related techniques. The solver explores possible configurations in superposition and seeks near-optimal solutions more efficiently than classical exhaustive search across large combinatorial spaces.

Optimized Operating Decisions and Re-Execution: The solver produces optimized operating decisions [1224], which may be used directly or may trigger re-run or re-embed operations of the QUBO or circuit to adjust operating parameters [1226]. As shown in FIG. 12, this update loop enables the quantum model to be re-executed with revised constraints, objectives, or measured process conditions so as to continually refine operating decisions.

Assignment of Qubits to IDS Stages: FIG. 12 further shows explicit assignment of qubits to physical IDS stages. Qubits may be assigned for the shredder/grinder [1248], for separation [1250], for depolymerization, hydrolysis, and fermentation [1252], for polymerization [1254], and for distillation [1256]. These assignments reflect the mapping of stage-level process decisions and parameters into quantum variables or subspaces of the overall optimization problem.

Actuation and Closed-Loop Optimization: The resulting operating solution is translated into actuate adjustments [1258] applied across the physical IDS stages, including Stage 100 [1228], Stage 130 [1234], Stage 140 [1242], Stage 150 [1244], and Stage 200 [1246]. Physical sensors continue to measure actual flow rates or reaction extent, and the resulting data is fed back into the optimization loop. Thus, FIG. 12 illustrates a closed-loop optimization cycle in which sensor data updates the quantum model, the quantum solver is re-run or updated, and fresh operating parameters are applied on-the-fly to the IDS hardware.

By encoding each IDS stage into quantum variables and constraints, the system can centrally optimize the multi-stage pipeline to identify favorable operating conditions in real time, leveraging quantum parallelism to manage the combinatorial complexity associated with large-scale industrial digestion and transformation processes.

FIG. 14. Diagram Explanation. System Architecture: FIG. 14 illustrates the hybrid quantum-classical system architecture, method steps, and computer-readable medium instructions for real-time industrial optimization. The System Architecture reference [1406], Method Steps reference [1408], and CRM Instructions reference [1410] are shown as inputs leading toward a Final Optimized Industrial Solution [1412]. Claim 12 logic [1414] further indicates that if error rates or delays are high, the system may modify sub-problem size or embedding. System Architecture (Hybrid System): The Hybrid Quantum-Classical System [1400], as shown in FIG. 14, includes a Classical Computing Subsystem [1416], a Quantum Computing Subsystem [1418], an Embedding Optimization Module [1420], an Error Mitigation Module [1422], and a Pipeline Orchestration Module [1424]. The Classical Computing Subsystem [1416] handles sub-problem decomposition and partial solutions. The Quantum Computing Subsystem [1418] includes a quantum processor with limited qubits and qubit connectivity. The Embedding Optimization Module [1420] fits sub-problems onto available qubits by mapping sub-problems onto qubits.

The Error Mitigation Module [1422] reduces noise and performs error correction. The Pipeline Orchestration Module [1424] runs or coordinates classical and quantum tasks in overlapping pipelines to reduce latency and minimize waiting time. These pieces iteratively combine partial solutions until converging on a final optimized industrial solution [1412].

Method Steps: FIG. 14 further outlines a Method for Real-time Industrial Optimization [1402], shown in the figure as corresponding to claims 6-10. The method steps include Decomposing [1428] the industrial-scale problem by partitioning it into sub-problems within a qubit limit; Embedding [1430] the sub-problems onto the quantum processor or QPU with connectivity constraints; Executing [1432] quantum computations while applying error mitigation; Processing [1434] intermediate results on the classical side through classical interpretation and combination of partial solutions; Iterating [1436] these steps through a repetitive pipeline and parallelism; and producing a Final Optimized Solution [1438]. These method steps describe how the industrial-scale optimization problem is decomposed, embedded, executed, processed, and iterated until a final solution is produced. Computer-Readable Medium: FIG. 14 also depicts a Computer-Readable Medium [1404], shown in the figure as corresponding to claims 11-12, which includes executable instructions stored in a non-transitory computer-readable medium. These instructions, when executed, cause the system to perform Instructions: Decomposing Industrial Problem [1440], Instructions: Embedding onto QPU [1442], Instructions: Executing+Error Mitigation [1444], Instructions: Classical Processing+Combining [1446], Instructions: Overlapping Operations (Pipeline Parallelism) [1448], and Produce Final Solution [1450]. The computer-readable medium instructions thereby implement the same hybrid quantum classical workflow in software-executable form. Dynamic Adjustment: Claim 12 logic [1414] covers dynamic adjustments to sub-problem size or embedding strategy based on real-time error rates, hardware delays, or quantum processor performance. If increased error rates, limited qubit availability, connectivity constraints, or execution delays are detected, the system may modify the decomposition strategy, reduce or change sub-problem size, or adjust embedding parameters to preserve solution quality and timeliness.

Final Solution: The Final Optimized Industrial Solution [1412] symbolizes the final optimized solution for the industrial optimization problem, produced after iterative feedback, decomposition, embedding, quantum execution, error mitigation, classical processing, and pipeline parallelism across classical and quantum resources. Overall, FIG. 14 shows how the system architecture [1400], method steps [1402], and computer-readable medium [1404] work together to decompose a large industrial optimization problem, embed it onto a limited quantum processor, mitigate errors and constraints, overlap computations in pipelines, and converge to a high-quality final optimized industrial solution [1412] that addresses qubit count limits, qubit connectivity issues, quantum noise, hardware delay, and latency. FIG. 16. Diagram Explanation. Data Collection (Step 1): FIG. 16 illustrates a hybrid quantum-classical method for combining operational transformations and market data to generate financial forecasts and optimize resource allocation across an industrial network. The system begins with Collect Operational & Market Data [1600]. The system gathers Operational Data from Each Site [1602], including process efficiency, production rates, and operational cost parameters, and Market Data [1604], including commodity prices, demand forecasts, and financial risk factors. These inputs feed into an overarching optimization problem that considers both the physical or chemical transformation details of the IDS sites and the economic landscape. Formulating a Combined Financial & Operational Optimization Problem (Step 2): The system formulates a Combined Financial & Operational Optimization Problem [1606]. Global Constraints [1608] may include shared resources, logistical limits, regulatory limits, or other network-wide restrictions across the sites. Site-Specific Models [1610] may include each site's transformation processes, including chemical conversions, waste-to-materials transformations, and resource usage. Market Conditions [1612] may include commodity prices, expected demand, profit or risk factors, and other market-driven considerations. These factors affect decisions around production levels, resource allocation, and financial strategy. Encoding & Executing a Quantum Algorithm (Step 3): The system performs Encode & Execute Quantum Algorithm [1614]. The quantum algorithm block [1616] may include QAOA, VQE, quantum annealing, or related quantum optimization methods. The system may Encode into QUBO or Parameterized Circuit [1618] at least part of the combined problem, including resource distribution, site-level operating parameters, scheduling decisions, or financial allocation variables. Parallel Exploration of Candidate Solutions [1620] allows the quantum algorithm to explore many solution candidates in parallel, harnessing quantum superposition, interference, or quantum-assisted search to identify promising resource allocations and forecast scenarios more efficiently than classical exhaustive methods. Integrate Quantum Solutions with Classical Optimization (Step 4): The system then Integrates Quantum Solutions with Classical Optimization [1622]. Classical Refinement [1624] may include fine-tune distribution, risk management, system-wide synergy evaluation, or other classical post-processing operations. Quantum-derived candidate allocations and local setpoint adjustments [1626] are received from the quantum algorithm and refined through classical optimization or heuristics. Iterative Convergence toward global optimum [1628] reflects the repeated refinement of candidate solutions until the combined physical, operational, and financial objectives approach a global or near-global optimum. Generating Updated Financial Forecast & Resource Allocations (Step 5): The system generates an Updated Financial Forecast & Resource Allocations [1630]. The system may Redistribute Resources among Sites [1632] for production balancing, risk mitigation, or resource optimization. The system may Anticipate Fluctuations in Input Costs and Market Demand [1634], thereby allowing the network to respond to changing commodity prices, demand forecasts, supply constraints, or cost variations. The system may also Maintain or Improve Financial Performance [1636] under changing market or operational conditions. Closed-Loop Reiteration (Step 6): The system may Repeat in Closed-Loop [1638] with real-time updates and feedback. Continuously updated Market & Operational Data [1640] are supplied as New Data back into the collection and formulation stages. The closed-loop feedback path [1642] returns updated information from the financial forecast and resource allocation stage toward the earlier stages of the method, thereby allowing steps (1) through (5) to be repeated as new operational or market data arrives. This creates a feedback loop that aligns local site decisions with real-time market signals and global business objectives, ensuring ongoing adaptation to evolving demands, production constraints, and financial goals. Brief Description of the Algorithm. Data Ingestion: Continuously gather operational metrics, including efficiencies, production rates, and cost-of-operations parameters, together with market factors, including commodity prices, demand forecasts, and risk data [1600, 1602, 1604]. Model Construction: Combine local site-level transformation constraints with global resource constraints and market-driven constraints, including supply-demand conditions, price forecasts, regulatory limits, and logistics constraints [1606, 1608, 1610, 1612]. Quantum Encoding: Represent discrete resource allocation constraints [1606, 1608, 1610, 1612]. Quantum Encoding: Represent discrete resource allocation, scheduling decisions, site-level operating parameters, and financial allocation variables as binary or discrete variables in a QUBO. Ising, or parameterized circuit representation [1618]. Quantum Solve: Utilize a quantum algorithm, including QAOA, VQE, or quantum annealing [1616], to sample or search for near-optimal solutions in parallel [1620], thereby addressing the combinatorial complexity of multi-site resource allocation and financial forecasting. Classical Refinement: Post-process quantum-derived candidates with classical techniques, including linear programming, heuristic optimization, risk management, fine-tune distribution, or system-wide synergy evaluation [1624], to integrate continuous variables and practical constraints. Financial & Operational Update: Generate new resource allocation schemes and financial forecasts, including profit margins, input cost of expectations, potential revenues, risk scenarios, and recommended production or distribution adjustments [1630, 1632, 1634, 1636]. Closed-Loop Execution: Deploy updated strategies across the network of sites and feed back new market and operational performance data [1640] through the closed-loop feedback path [1642] into subsequent optimization cycles [1638], ensuring continuous adaptation. This hybrid quantum-classical approach enables faster identification of globally beneficial resource distributions while simultaneously producing financial forecasts, thereby reducing guesswork and improving resilience in a multi-site industrial environment.

FIG. 17. Diagram Explanation Alchemist. Network of Industrial Sites; Multiple IDS-enabled facilities operate under diverse physical, chemical, or biological conditions. As shown in FIG. 17, a Network of Industrial Sites [1700] includes Site 1: IDS-based Transformation [1702], Site 2: IDS-based Transformation [1704], and Site N: IDS-based Transformation [1706]. Each site is instrumented with sensors or process-monitoring interfaces that capture high-level metrics, including temperature, flow rate, reaction yields, reaction conditions, throughputs, observed outputs, or other process variables, and feed them back to the central system. Data Aggregation (Step 1): Aggregate Real-time Operational Data [1708] collects real-time operational data, including process conditions, sensor feedback, and outputs from each site. Sensor Data & Process Variables [1710] may include reaction conditions, throughputs, observed outputs, and other relevant process-state information. This aggregated data is the raw material for discovering new scientific laws, as it includes signals from many different transformations or reactions across different IDS installations. “Alchemist”: Hybrid Quantum-Classical Machine Learning (Step 2): The “Alchemist”: Hybrid Quantum-Classical Machine Learning module [1712] receives the aggregated operational data and applies hybrid quantum-classical learning to infer, test, or refine candidate principles. High-Dimensional Representation: The system constructs large-scale models capturing reaction pathways, input-output correlations, observed outcomes, and related process relationships using Construct High-Dimensional Representations [1714]. Quantum Parallelism: A quantum computing backend applies quantum parallelism [1716] to evaluate many hypothesis states at simultaneously, searching for hidden patterns, anomalies, or correlations that a purely classical approach might miss. Adaptive Self-Learning: The “Alchemist” adapts model parameters via a self-learning algorithm [1718], correlating data with hypothesized principles and adjusting its internal hypothesis space to align with emergent data, forming a self-learning capability that can propose new universal principles or candidate principles derived from the observed data. Generate Candidate Laws (Step 3): Generate Candidate Laws [1720] represents the step in which the quantum machine learning engine identifies candidate scientific laws or theoretical constructs in physics, chemistry, or biology. The system identifies patterns, anomalies, and correlations beyond known theories [1722], thereby gleaning new insights from anomalies, strong correlations, unexpected relationships, or emergent data patterns in the aggregated operational data.

Design Experimental or Operational Changes (Step 4): Based on the candidate laws, the system proceeds to Design Experimental or Operational Changes [1724]. These changes may include altering feedstock compositions, reaction time, energy input, reaction parameters, feedstock composition, or energy flows [1726]. The system may also test the predictive or explanatory power of candidate laws [1728]. These proposed changes are meant to test the predictive or explanatory power of each candidate laws; if real-world outcomes match predictions, it confidence in the discovered principle may be strengthened. Implement Changes, Collect New Data (Step 5): Implement Changes, Collect New Data [1730] represents the operational testing phase. Actuators [1732] at the industrial sites carry out the recommended modifications in real time, including changes to process parameters, routing, feedstock composition, energy inputs, or other control variables. New Performance Metrics & Observational Data [1734] are then collected from the post-change results and fed back to the Alchemist. This immediate feedback cycle ensures that the system observes how actual production or transformation metrics vary with the experimental or operational changes. Refine Candidate Laws (Step 6): Refine Candidate Laws [1736] represents the stage in which the system compares predicted outcomes, according to the candidate laws, with actual observed results. Compare Predicted vs. Actual Outcomes [1738] identifies discrepancies, confirmations, or partial matches between a candidate law and measured behavior. Update Model Accuracy & Scope, Inferred Theories, Cost Functions, Constraints [1740] updates the model, hypothesis space, inferred theories, cost functions, and constraints based on the comparison. Any discrepancies lead to model or hypothesis updates, refining the scope of these emergent principles. Over time, the Alchemist's internal theories become more robust.

Repeat Cycle (Step 7): Repeat Cycle [1742] represents the continuous closed-loop iteration of the process. Steps (1)-(6) run continuously, with the engine re-analyzing newly gathered data and further refining, modifying, or discarding candidate laws. This iterative approach can eventually uncover novel phenomena in physics, chemistry, or biology—beyond what static heuristics or purely classical methods could achieve. Brief Description of the Algorithm. Data Integration: Real-time data from multiple IDS sites is aggregated through the Network of Industrial Sites [1700] and Aggregate Real-time Operational Data [1708], ensuring broad coverage of operating conditions and transformations. Quantum ML Hypothesis Generation: The “Alchemist” [1712] uses high-dimensional representations [1714], quantum parallelism [1716], and adaptive self-learning [1718] to generate or test an array of scientific hypotheses, effectively searching vast parameter spaces. Candidate Law Extraction: Through pattern recognition, including quantum-enhanced correlation detection, the system generates Candidate Laws [1720] and identifies patterns, anomalies, and correlations beyond known theories [1722]. Experimental Steering: The system designs experimental or operational changes [1724] at the industrial sites, including adjustments to reaction parameters, feedstock composition, and energy flows [1726], to validate or falsify candidate laws. Implementation & Observation: Sites implement the changes through actuators [1732], and the system collects new performance metrics and observational data [1734], capturing any emergent phenomena. Refinement: The “Alchemist” refines candidate laws [1736] by comparing predicted versus actual outcomes [1738] and updating model accuracy, scope, inferred theories, cost functions, and constraints [1740], thereby honing or discarding the candidate laws accordingly. Continuously Evolving Knowledge: Repeating the cycle [1742] fosters an increasingly sophisticated understanding of underlying physics chemistry, or biology, effectively discovering phenomena previously unknown or not fully understood. In essence, this closed-loop approach merges industrial-scale experimentation with a self-learning quantum machine learning engine, systematically pushing scientific frontiers by testing novel hypotheses in real-world, multi-site industrial digestion processes.

1. A hybrid quantum-classical cyber-physical control system for real-time, deterministic optimization and automated actuation of an industrial process, the system comprising:
a physical industrial plant comprising a plurality of hardware stages configured to transform a material feedstock into a measurable output, the physical industrial plant operating within a localized cyber-physical execution loop;
a physical sensor network configured to continuously monitor the plurality of hardware stages and generate streaming analog telemetry data;
a quantum industrial problem compiler executing on at least one classical processor, configured to discretize the streaming analog telemetry data into a set of logical variables, map the logical variables to physical equipment tags utilizing a variable dictionary, and compile a structurally bounded, quantum-computable serialized artifact encoding a multi-objective cost function and physical plant constraints;
a latency-aware hybrid orchestrator configured to dispatch the structurally bounded, quantum-computable serialized artifact to a quantum computing resource, govern an execution flow via a defined state machine, and trigger a tiered classical fallback sequence utilizing an offline precomputed library if a response latency from the quantum computing resource exceeds a configurable timeout threshold parameter;
an actuation stability and validation gateway executing on an edge-side classical controller, configured to receive a candidate solution bitstring from the quantum computing resource, de-quantize the candidate solution bitstring into continuous engineering setpoints via a reverse-scaling decoder, and apply a mathematical gradient dampening bounding function to project any out-of-bounds parameters into safe operational boundaries; and
a plurality of physical actuators configured to receive bounded continuous engineering setpoints from the actuation stability and validation gateway and mechanically alter thermodynamic and kinematic states of the plurality of hardware stages.

2. The control system of claim 1, further comprising a dual-layer error mitigation pipeline configured to map a real-time physical variance (σ\hat{ }2_sensor) of the streaming analog telemetry data into a dynamic penalty modifier (λ′) injected into the structurally bounded, quantum-computable serialized artifact using a confidence decay function defined by λ′=λ·exp(−κ·σ\hat{ }2_sensor), wherein λ is a baseline constraint penalty and κ is a tunable sensitivity parameter.

3. The control system of claim 1, wherein the mathematical gradient dampening bounding function clamps a dispatched actuator setpoint (u_act(t)) based on a raw de-quantized target (u_raw(t)), a previous physical state (u_act(t−1)), and a hardware-specific maximum rate of change (Δ_max), according to the bounding equation: u_act(t)=u_act(t−1)+max(min(u_raw(t)−u_act(t−1), Δ_max), −Δ_max), thereby mechanically decoupling erratic quantum solver variance from physical plant stability.

4. The control system of claim 1, wherein the quantum industrial problem compiler executes an automated penalty tuning subroutine configured to programmatically resolve physical constraint failures by escalating a penalty multiplier (λ_k) for a violated constraint k in a subsequent compilation cycle utilizing a gradient-ascent update rule defined by λ_k\hat{ }(t+1)=λ_k\hat{ }(t)+η·exp(γ·v_k), wherein v_k is a measured violation magnitude, η is a base learning rate, and γ is a severity scalar.

5. The control system of claim 1, wherein the latency-aware hybrid orchestrator further comprises a cryptographic cyber-physical security integration configured to generate a cryptographic hash of the structurally bounded, quantum-computable serialized artifact, sign the cryptographic hash utilizing an asymmetric key pair prior to dispatch, and automatically reject the candidate solution bitstring from the quantum computing resource upon detecting a signature authentication mismatch, thereby structurally preventing malicious network manipulation of the physical industrial plant.

6. The control system of claim 1, further comprising a dynamic multi-objective weight tuning application programming interface (API) configured to ingest real-time external economic market signals and programmatically inject updated scalar weights directly into the structurally bounded, quantum-computable serialized artifact in-memory, bypassing a full algorithmic recompilation latency.

7. A computer-implemented method for enforcing safety-critical physical constraints in a hybrid quantum-classical industrial control system, the method comprising:
ingesting physical sensor data characterizing a current operational state of a physical industrial plant;
identifying at least one hard physical safety constraint defining a physically impossible material flow or a dangerous thermodynamic state of the physical industrial plant;
constructing, via a classical processor, an overarching system Hamiltonian comprising a cost Hamiltonian modeling target operational objectives and a specialized mixer Hamiltonian (H_mix) configured to establish a strict feasible subspace boundary;
structurally restricting quantum amplitude transfers exclusively to the feasible subspace boundary using the specialized mixer Hamiltonian, thereby preventing a quantum computing evaluation of the physically impossible material flow or the dangerous thermodynamic state;
executing a quantum optimization algorithm on a quantum processing unit using the overarching system Hamiltonian to derive an optimal quantum ground state bounded entirely within the feasible subspace boundary;
decoding the optimal quantum ground state into a set of physically executable setpoints; and
actuating physical machinery within the physical industrial plant according to the physically executable setpoints.

8. The method of claim 7, wherein the at least one hard physical safety constraint is a mass-balance routing constraint, and wherein the specialized mixer Hamiltonian (H_mix) utilizes Pauli-X (σ\hat{ }x) and Pauli-Y (σ\hat{ }y) exchange operators formulated as: H_mix=½·Σ_{(i,j)∈E}β·(σ_i\hat{ }x σ_j\hat{ }x+σ_i\hat{ }y σ_j\hat{ }y), to exclusively swap probability amplitudes between degenerate physically feasible states.

9. The method of claim 7, wherein executing the quantum optimization algorithm includes mapping logical variables of the overarching system Hamiltonian onto a restricted physical qubit connectivity graph of the quantum processing unit utilizing a programmatic minor-embedding graph algorithm, and further comprising dynamically calibrating an intra-chain coupling strength (J_chain) across a plurality of physical qubits representing a single logical variable to strictly exceed a maximum logical problem weight (J_chain>max |J_{ij}|) to prevent thermal noise-induced chain breaks during execution.

10. A distributed hybrid quantum-classical control architecture for orchestrating cyber-physical manufacturing operations across a network of geographically distinct industrial sites, the architecture comprising:
a plurality of localized classical edge solvers respectively deployed across the geographically distinct industrial sites, each industrial site comprising physical sensors and actuators operating within a local cyber-physical execution loop;
a central synchronization bus configured to aggregate streaming telemetry from the plurality of localized classical edge solvers to formulate a global optimization graph;
a multi-site graph partitioner configured to algorithmically cut the global optimization graph into sub-partitions based on a physical capability registry associated with each respective industrial site;
a bipartite routing engine configured to route a first sub-partition comprising intra-site operational variables to the localized classical edge solvers for localized deterministic execution, and to route a second sub-partition comprising highly coupled inter-site logistical dependencies to an algorithm cloud interfacing with a central quantum solver subject to specific physical qubit connectivity limits;
wherein the central synchronization bus is further configured to converge locally optimized edge setpoints solved by the localized classical edge solvers with quantum-optimized inter-site dependencies solved by the central quantum solver; and
a network dispatch module configured to physically actuate a synchronized multi-site control strategy across the geographically distinct industrial sites based on the converged setpoints.

11. The architecture of claim 10, wherein the highly coupled inter-site logistical dependencies comprise shared resource limits, grid energy demands, and multi-facility material flow balancing parameters.

12. The architecture of claim 10, wherein each of the localized classical edge solvers operates as a deterministic fail-safe configured to maintain continuous localized thermodynamic operation at an individual industrial site in the event of a network latency timeout or a disconnection from the central synchronization bus.

13. A method for performing automated macroscopic physical plant scaling and closed-loop high-throughput experimentation (HTE) utilizing a self-learning hybrid quantum-classical machine learning engine, the method comprising: defining a physical feedstock library and available physical unit operations comprising automated liquid handlers, micro-bioreactors, and in-line analytical sensors; simulating, via a variational quantum eigensolver (VQE) executing on a quantum processor, an electron-orbital transition state of a proposed chemical reaction to compute an atomic activation energy (E_a); compiling a quantum-computable optimization artifact that incorporates the computed atomic activation energy (E_a) as a targeted optimization parameter alongside a plurality of physical hardware safety constraints;
solving the quantum-computable optimization artifact via the quantum processor to select an optimal discrete experimental configuration comprising selected material catalysts, solvents, and thermal parameters from a combinatorial space;
translating the optimal discrete experimental configuration into machine-executable instrument abstraction code comprising robotic kinematic coordinates and volumetric dispense instructions;
dispatching the machine-executable instrument abstraction code to mechanically actuate a physical robotic payload to execute the proposed chemical reaction;
ingesting analytical sensor telemetry measuring a physical empirical yield of the proposed chemical reaction to capture observational data (D_obs); and
programmatically updating a candidate scientific reaction model (M_c) representing a proposed physical law within the self-learning hybrid quantum-classical machine learning engine based on a measured mathematical divergence between a predicted yield and the physical empirical yield.

14. The method of claim 13, wherein programmatically updating the candidate scientific reaction model (M_c) utilizes a machine-executable Bayesian falsification metric to update a posterior probability based on the observational data (D_obs) according to the equation: P(M_c|D_obs)=[P(D_obs|M_c)·P(M_c)]/P(D_obs), wherein the candidate scientific reaction model (M_c) is autonomously purged from system memory if a marginal likelihood falls below a predefined strict mathematical rejection threshold.

15. The method of claim 13, further comprising executing a macroscopic thermodynamic scaling engine on a classical processor to translate the computed atomic activation energy (E_a) into a macroscopic thermodynamic operating bound defining a strict physical temperature envelope for an industrial model predictive controller (MPC).

16. The method of claim 15, wherein executing the macroscopic thermodynamic scaling engine comprises applying an inverted Arrhenius transfer function to determine a minimum required absolute temperature (T_min) to achieve a target industrial physical reaction rate (k_target), formulated as T_min=E_a/[R·ln(A/k_target)], where R is a universal gas constant and A is a pre-exponential collision factor.

17. The method of claim 13, wherein the quantum-computable optimization artifact is a Quadratic Unconstrained Binary Optimization (QUBO) Hamiltonian (H_EX4) formulated to embed a strict physical safety penalty preventing thermodynamic solvent boiling, configured as λ_safety·(T−T_boil(s_j))_+\hat{ }2, wherein T is the thermal parameter and T_boil(s_j) is a boiling point of a selected solvent candidate s_j.

18. The method of claim 13, wherein translating the optimal discrete experimental configuration into the machine-executable instrument abstraction code comprises generating a vendor-agnostic JSON payload mapping logical quantum output variables directly to physical pipetting coordinates.

19. The method of claim 13, further comprising generating a set of warm-start initial parameters via a classical machine learning surrogate model analyzing historical HTE sensor data, and injecting the set of warm-start initial parameters into a parameterized quantum circuit of the variational quantum eigensolver (VQE) to reduce a requisite quantum circuit depth prior to simulating the electron-orbital transition state.

20. A non-transitory computer-readable storage medium storing instructions that, when executed by a hybrid cyber-physical control architecture comprising at least one classical processor and at least one quantum processor, cause the hybrid cyber-physical control architecture to perform operations comprising:
ingesting continuous analog sensor telemetry characterizing a physical state of an industrial manufacturing process; digitally translating the continuous analog sensor telemetry into a serialized quantum-computable artifact comprising an objective function and structural penalty weights representing critical physical safety constraints;
dispatching the serialized quantum-computable artifact to the at least one quantum processor;
receiving a logical candidate solution bitstring generated by the at least one quantum processor;
reverse-scaling the logical candidate solution bitstring into de-quantized continuous engineering setpoints;
executing a model-based feasibility check to verify the de-quantized continuous engineering setpoints do not exceed maximum thermodynamic or kinematic capacities of a targeted physical actuator;
applying a rate-limiting gradient dampening bounding function to clamp the de-quantized continuous engineering setpoints into bounded execution commands; and
transmitting the bounded execution commands to the targeted physical actuator to dynamically alter the physical state of the industrial manufacturing process in a continuous, deterministic feedback loop.
